(19) United States
(12) Patent Application Publication
(10) Pub. No.: US 2004/0194027 A1
(43) Pub. Date: Sep. 30, 2004

(54) Computerized electronic document producing, editing and accessing system for maintaining high-security

(76) Inventors: Akira Suzuki, Kanagawa (JP); Masami Koide, Tokyo (JP); Takefumi Hasegawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/743,092

(22) Filed: Dec. 23, 2003

(30) Foreign Application Priority Data
Dec. 27, 2002 (JP) 2002-379748
Jul. 11, 2003 (JP) 2003-195626
Aug. 22, 2003 (JP) 2003-299135
Sep. 19, 2003 (JP) 2003-327778
Sep. 19, 2003 (JP) 2003-328753

(51) Int. Cl. G06F 17/21

(52) U.S. Cl. 715/515

(57) ABSTRACT

An electronic document producing, distributing and accessing system prevents a malicious program from being mixed into an electronic document without being influenced by an operating environment of a computer by providing a document producing application and a document accessing application by the same application provider. In the electronic document having an encapsulated document structure, a document information file stores document information that is a substance of expression of a document. An operating program file stores an operating program that materializes the document information, a limitation being given to the operating program by a security function when the operating program is interpreted and executed by a computer. The document information file and the operating program file are encapsulated as a single document.

### BACKGROUND OF THE INVENTION

1. Field of the Invention

The present invention generally relates to electronic documents and, more particularly, to a computerized electronic document producing, editing and accessing system which provides high-security.

2. Description of the Related Art

Recently, computers are widely used as a tool for displaying and producing various kinds of information. Generally, such information is referred to as “electronic document”. The electronic document is produced as digital information by a program generally referred to as a “document producing application program” that is operated on a computer, and is stored in a memory medium. The produced digital information is displayed by an application referred to as an “access application program” for reading and displaying the information.

There are many cases in which an application for producing and editing electronic documents and an application for accessing the electronic documents share the same program. WORD (registered trade mark of Microsoft Corporation) and EXCEL (registered trade mark of Microsoft Corporation) are typical applications for producing, editing and accessing electronic documents.

In order to use electronic documents, a user must install a corresponding application program in a storage medium of a computer.

Moreover, there are many cases in which a person who produces electronic documents is different from a person who uses or accesses the produced electronic documents. Accordingly, in a recent electronic document accessing system, a person who accesses electronic documents must prepare an application program which can interpret the format of the digital information of the electronic documents produced by a person who produced the electronic documents.

On the other hand, an information processing apparatus having multimedia data and a program for reproducing the multimedia data is suggested in Japanese Laid-Open Patent Application No. 8-36519. Using such a technique, information produced by a producing person (who produces the information) can be reproduced in a different computer environment.

Additionally, Japanese Laid-Open Patent Application No. 2003-015941 suggests a document data structure (an encapsulated document) which encapsulates into a single file a plurality of content files, a document structure file which defines the contents files and structures thereof, and an operation program based on the document structure file. According to this patent document, an accessing person can access an electronic document in a computer environment different from that of a producing person by encapsulating the electronic document and the operation program for accessing the electronic document.

However, there is a new problem arises due to a program being incorporated into an electronic document. That is, there is a possibility that a program incorporated in an electronic document performs an operation which an accessing person (who accesses the electronic document). For example, one can incorporate a malicious program into an electronic document so as to give damage to an accessing person due to an execution of the malicious program during the access to the electronic document. Accordingly, the information based on the above-mentioned technique cannot be handled safely.

Moreover, at present, mixing of a computer virus has become a problem since distribution of electronic documents using a network such as Internet has become popular. Thus, many techniques have been suggested so as to maintain security protection.

For example, a technique to package a plurality of files with different security requirements is suggested in Japanese Laid-Open Patent Application No. 10-105449.

Additionally, a technique to change an operating right of a program according to a security level is suggested in Japanese Laid-Open Patent Application No. 6-103058.

Further, there are suggested various techniques such as in, for example, Japanese Laid-Open Patent Applications No. 2000-305828, No. 2001-229067 and No. 2001-265636.

However, the conventional security protection systems merely control document information alone or a program alone, and do not protect the security of document information which is encapsulated with an operation program for accessing the document information.

The following summarizes the conventional electronic document systems.

First, there is a method which needs an application program which can interpret a format of an electronic document to be accessed and displays the accessed electronic document.

Second, there is a method in which an access program is provided in an electronic document so that an accessing person can access the electronic document by executing the access program.

However, the former method is influenced by the environment of a computer for accessing since the application program for accessing the electronic document is needed. Moreover, since the latter method accesses an electronic document by the program provided in the electronic mail, a malicious program can be described in the program and it is difficult to prevent mixing of a computer virus, and, thus, the latter method is not suitable for electronic documents to be distributed through a network.

In recent years, with development of computers, many unspecified persons have come to produce electronic documents expressed by digital information in large quantities. Moreover, while the network infrastructure represented by the Internet etc. is established, an opportunity to distribute the produced electronic documents to many people is increasing in order to notify many people of useful information. Further, since electronic documents distributed through a network is increasing, a case where those who receive and access the electronic documents cannot identify the producer of the electronic documents is increasing. There may be a person who abuses this fact so as to insert harmful data into an electronic document so as to change a setting of a computer or delete or tamper data stored in a computer against the intension of a person who accesses the electronic document. Therefore, there is a problem in that a person who access an electronic document cannot feel safe and secure in accessing electronic documents that are distributed by unidentified producers.

In the meantime, if the distributed electronic document is expressed by only plain text data, there is a slight risk in accessing electronic documents produced by unidentified producer since it is difficult to insert harmful data into the electronic documents. However, in the form of electronic documents that are popular now, a risk in accessing the electronic documents is high since a macro function, which registers a series of operations and automatically performs the operations, is added to the electronic documents for the purpose of improving the expression level and edit capability of the electronic documents.

Moreover, it is also mentioned as a problem, besides an unidentified document producer inserts a harmful program in an electronic document, that a document producer may insert contents that violates a copyright into an electronic document. Many unidentified document producers insert various contents into electronic documents since various contents exist on a network can be easily acquired due to the development of the Internet and the contents can be easily processed and edited due to the development of computer hardware and software. According to the above-mentioned circumstances, a possibility that contents infringing a copyright is contained in an electronic document is increasing. It is mentioned as a cause of infringement of a copyright by a document producer that there is no means to determine whether a copyright is claimed by the producer in the contents, or there is no means to request licensing of a copyright due to lack of communication with the producer of the contents. Moreover, if a document producer or a content producer wants to claim a copyright of contents against a person who accesses the electronic document, there is a problem in that it is difficult for the document producer to provide a means for claiming a copyright against a person who accesses the electronic document.

Due to the existence of the above-mentioned infringement problem of a copyright, a person having a copyright pays too much attention to protection of the copyright, and at present situation, there is a limitation in placing other author's literally work on the Web, etc. For example, if a photograph image of which copyright is to be claimed is placed on the web, there is a high possibility that the photograph is illegally used, and, thus, there is a problem in that a photographic image cannot be easily placed on the Web. On the other hand, in the peer-to-peer file exchange format represented by the nap star, etc., a problem of infringement of copyrights developed even into a social problem since an approach of protecting copyrights of contents has not been established. Besides the problem of infringement of copyrights, there also is a problem in that if a document producer inserts contents that offends public order and morals into an electronic document, it is difficult to cause the contents that offends public order and morals not to be displayed on the side of a person who accesses the electronic document.

In order to solve such a problem, conventionally, there are suggested various security systems that improve accuracy of security by setting a security level according to a hierarchy confidence digital signature system, or setting a security level for each file, such as disclosed in Japanese Laid-Open Patent Applications No. 6-103058, No. 10-105449, No. 2001-143009, No. 2001-309157 and No. 2002-32285.

However, in the conventional security systems including the security systems disclosed in the above-mentioned patent documents, the above-mentioned risk of electronic documents increases with improvement in an expression capability, an edit capability, a long-time legibility and a portability of electronic documents. For this reason, if a person who accesses electronic documents cannot trust a document producer, there is a problem in that the accessing person cannot access the electric documents, which has abundant powers of expression, with feeling of safe and secure. Moreover, the method of using an electronic signature technology is conventional and well-known so as to prevent an electronic document from being tampered by a third party having an ill will during transmission of the electronic document from a document producer to an accessing point. However, in such a method, there is no consideration given to a security function with respect to a case where a document producer intentionally attempts occurrence of failures, and, thus, the accessing person cannot access electronic documents with feeling of safe and secure.

In the meantime, a user who has less opportunity to produce electronic documents or a user who wants to accurately evaluate the performance of an entire application program does not sell application programs, and it is desirable for those users to develop a sales method of electronic documents in which a user can pay use fees in accordance with a number of electronic documents produced or an amount of use of application programs.

### SUMMARY OF THE INVENTION

It is a general object of the present invention to provide an improved and useful electronic document producing, editing, accessing system in which the above-mentioned problems are eliminated.

A more specific object of the present invention is to provide an electronic document producing, distributing and accessing system which prevents a malicious program from being mixed into an electronic document without being influenced by an operating environment of a computer by providing a document producing application and a document accessing application by the same application provider.

Another object of the present invention is to provide an encapsulated document structure which can prevent a malicious program from being mixed into an electronic document without being influenced by operating environment of a computer.

A further object of the present invention is to provide an electronic document file and an apparatus for producing such an electronic document file which can prevent a harmful electronic document from being accessed without identifying a document producer of the electronic document by causing a document producing application to guarantee safety of accessing the electronic document.

Another object of the present invention is to provide an encapsulated document file structure and an encapsulated document file system in which an application program provided is prevented from being falsely used and a user can pay use fees in accordance with a number of electronic documents produced or an amount of use of application programs.

Yet another object of the present invention is to provide an encapsulated document file structure and an encapsulated document file system in which contents information of an electronic document can be displayed even if an application program for displaying the contents information in the electronic document is not installed in a computer of an accesser, and copyrights of the contents information of the electronic document can be protected.

In order to achieve the above-mentioned invention, there is provided according to one aspect of the present invention an encapsulated document structure comprising: a document information file storing document information that is a substance of expression of a document; and an operating program file storing an operating program that materializes the document information, a limitation being given to the operating program by a security function when the operating program is interpreted and executed by a computer, wherein the document information file and the operating program file are encapsulated as a single document.

Accordingly, since the operating program file, which materializes the document information file, is encapsulated into a single file together with the document information file concerned, the document can be accessed under a computer environment different from a computer environment of the document producer. Additionally, since a limitation is applied to the operating program by the security function when interpreted and executed by a computer, a malicious program is prevented from mixing into the operating program, which achieves a safe access to the document.

Additionally, there is provided according to another aspect of the present invention an encapsulated document structure comprising: a document information file storing contents information that is a substance of expression on a document; location information indicating a location where an operating program file is stored, the operating program file storing an operating program for materializing the document information file; and a feature amount retaining file retaining an encrypted feature amount regarding the operating program file, wherein the document information file, the location information and the feature amount retaining file are encapsulated into a single file.

Accordingly, since the location information, which indicates the location where the operating program for materializing the document information file is saved, is encapsulated together with the document information file, it becomes possible to access the document information file under a computer environment different from a computer environment of the document producer. The encrypted feature amount of the operating program file retained in the feature amount retaining file is decrypted so as to obtain the decrypted feature amount, and the feature amount of the distributed operating program file is computed so as to obtain the computed feature amount. Thus, it becomes possible to verify a tamper or alteration on the operating program in the middle of distribution of the encapsulated document file by comparing the decrypted feature amount with the computed feature amount. Therefore, a malicious program is prevented from being mixed into the operating program, which achieves a safe access to the encapsulated document file.

Additionally, there is provided according to another aspect of the present invention an encapsulated document structure comprising: document information file storing contents information that is a substance of expression on a document; and location information indicating a location where an operating program file containing an operating program for materializing the document information file is stored, wherein the document information file and the location information are encapsulated into a single file, and a feature amount regarding the operating program file is stored outside the single file.

Accordingly, since the location information, which indicates the location where the operating program for materializing the document information file is saved, is encapsulated together with the document information file, it becomes possible to access the document information file under a computer environment different from a computer environment of the document producer. The feature amount of the operating program file stored in the location indicated by the location information is computed so as to obtain the computed feature amount and the computed feature amount is compared with the feature amount of the operating program stored outside the encapsulated document file. Thereby, it becomes possible to verify a tamper or alteration on the operating program in the middle of distribution of the encapsulated document file, and a malicious program is prevented from being mixed into the operating program, which achieves a safe access to the encapsulated document file.

Additionally, there is provided according to another aspect of the present invention a document file producing apparatus producing an electronic document file having an encapsulated document structure, said encapsulated document structure comprising: a document information file storing document information that is a substance of expression of a document; and an operating program file storing an operating program that materializes the document information, a limitation being given to the operating program by a security function when the operating program is interpreted and executed by a computer, wherein the document information file and the operating program file are encapsulated as a single document.

Additionally, there is provided according to another aspect of the present invention an encapsulated document producing and editing apparatus comprising: decryption key information provided beforehand; an operating program file that is decrypted from the decryption key information; and encapsulated document producing and editing means having user interface means for producing and editing a document information file in accordance with a user operation and encapsulating means for encapsulating the produced document information file, the decryption key information and the operating program file into a single file. Accordingly, the above-mentioned encapsulating document having a high security can be easily provided.

Additionally, there is provided according to another aspect of the present invention an encapsulated document producing and editing apparatus comprising: an operating program file provided beforehand; encapsulated document producing and editing means having user interface means for producing and editing a document information file in accordance with a user operation and encapsulating means for encapsulating the produced document information file and the operating program file into a single file; and decryption means for decrypting the encapsulated single file. Accordingly, the above-mentioned encapsulating document having a high security can be easily provided.

Additionally, there is provided according to another aspect of the present invention an encapsulated document producing and editing apparatus comprising: encapsulated document producing and editing means having user interface means for producing and editing a document information file in accordance with a user operation; an operating program file provided beforehand; and decryption means for decrypting the produced document information file and the operating program file, wherein the encapsulated document producing and editing means has encapsulating means for encapsulating the encrypted document information file and the operating program file into a single file. Accordingly, the above-mentioned encapsulating document having a high security can be easily provided.

Additionally, there is provided according to another aspect of the present invention 77. A start program for starting an operating program file provided in an encapsulated document comprising: decryption key information for decrypting encrypted digital information; the operating program file that is decrypted in accordance with the decryption key information; document information file that is materialized on a computer by the decrypted operating program; and encapsulating means for encapsulating the decryption key information, the operating program file and the document information file into a single file, the start program comprising: reading means for reading the encrypted decryption key information and the operating program file from the encapsulated document file; decryption means for decrypting the decryption key information using a public key provided by a third party authentication authority, and decrypting the operating program using the decrypted decryption key information; and operating program starting means for starting the decrypted operating program. Accordingly, the encapsulated document having a security function can be reproduced with a high security by merely starting the start program.

Additionally, there is provided according to another aspect of the present invention an encapsulated document producing apparatus comprising: document information file acquisition means for acquiring a document information file storing contents information that is a substance of expression regarding a document; operating program file acquisition means for acquiring an operation program file storing an operating program, which is interpreted and executed by a computer, for materializing the document information file acquired by the document information file acquisition means; feature amount computing means for computing a feature amount of the operating program file; feature amount retaining file producing means for encrypting the feature amount of the operating program file computed by the feature amount computing means, and saving the encrypted feature amount in a feature amount retaining file; and encapsulating means for encapsulating the document information file, the operating program file and the feature amount retaining file into a single document. Accordingly, it becomes possible to easily produce the encapsulated document file having a high-security.

Additionally, there is provided according to another aspect of the present invention a program tamper verification method performed by an information processing unit for verifying a tamper on an operating program file that materializes a document information file that is a substance of expression regarding a document, the operating program file and the document information file are encapsulated into an encapsulated document file, the program tamper verification method comprising the steps of: computing a feature amount of the operating program file in the encapsulated document file when materializing the document information file; decrypting an encrypted feature amount of the operating program file that was been retained; comparing the decrypted feature amount of the operating program file with the computed feature amount of the operating program file; limiting materialization of the document information file performed by the operating program file when the decrypted feature amount of the operating program file does not match the computed feature amount of the operating program file. Accordingly, the verification of a tamper or alteration on the operation program file in the middle of distribution of the encapsulated document file can be achieved by merely decrypting a small amount of data (about 20 bytes) such as the feature amount of the operating program without decrypting the entire operating program file. Thereby, is becomes possible to provide a conveniently usable encapsulated document file that can perform verification of a tamper or alteration on the operating program file in the encapsulated document file at a high speed.

Additionally, there is provided according to another aspect of the present invention a program tamper verification method performed by an information processing unit for verifying a tamper on an operating program file that materializes a document information file that is a substance of expression regarding a document, the operating program file and the document information file are encapsulated into an encapsulated document file, the program tamper verification method comprising the steps of: computing a feature amount of the operating program file stored at a location indicated by location information retained in the encapsulated document file when materializing the document information file; decrypting a decrypted feature amount of the operating program previously retained; comparing the decrypted feature amount of the operating program file with the computed feature amount of the operating program file; limiting materialization of the document information file performed by the operating program file when the decrypted feature amount of the operating program file does not match the computed feature amount of the operating program file.

Accordingly, the verification of a tamper or alteration on the operation program file in the middle of distribution of the encapsulated document file can be achieved by merely decrypting a small amount of data (about 20 bytes) such as the feature amount of the operating program without decrypting the entire operating program file. Thereby, is becomes possible to provide a conveniently usable encapsulated document file that can perform verification of a tamper or alteration on the operating program file in the encapsulated document file at a high speed.

Additionally, there is provided according to another aspect of the present invention a tamper verification apparatus comprising: reading means for reading an encapsulated document file having an encapsulated document structure; and tamper verification means for performing verification of a tamper on an operating program stored in the encapsulated document file based on a feature amount of the operating program file that materializes a document information file stored in the encapsulated document file and read by the reading means, wherein the encapsulated document structure comprises the document information file, the operating program file and a feature amount retaining file that retains an encrypted feature amount of the operating program.

Accordingly, the tamper verification on the operating program file is performed based on the feature amount of the operating program file, which materializes the document information file retained in the encapsulated document file. Thereby, since the tamper verification on the operating program file can be performed in the middle of distribution of the encapsulated document file, it becomes possible to prevent mixing of a malicious program, which results in a safe access to the document.

Additionally, there is provided according to another aspect of the present invention an encapsulated document producing process program causing a computer to perform the functions of: acquiring a document information file installed in the computer, the document information file containing contents information that is a substance of expression regarding a document; acquiring an operating program file that is interpreted and executed by the computer so as to materialize the document information file acquired by the function of acquiring the document information file; computing a feature amount of the operating program file; encrypting the feature amount of the operating program file computed by the function of computing the feature amount by using decryption key information; saving the decrypted feature amount of the operating program file in a feature amount retaining file; and encapsulating the document information file, the operating program file and the feature amount retaining file into a single document file. Accordingly, it becomes possible to easily produce the encapsulated document file having the file structure providing a high security.

Additionally, there is provided according to another aspect of the present invention a processor readable storage medium storing an encapsulated document producing process program causing a computer to perform the functions of: acquiring a document information file installed in the computer, the document information file containing contents information that is a substance of expression regarding a document; acquiring an operating program file that is interpreted and executed by the computer so as to materialize the document information file acquired by the function of acquiring the document information file; computing a feature amount of the operating program file; encrypting the feature amount of the operating program file computed by the function of computing the feature amount by using decryption key information; saving the decrypted feature amount of the operating program file in a feature amount retaining file; and encapsulating the document information file, the operating program file and the feature amount retaining file into a single document file. Accordingly, it becomes possible to easily produce the encapsulated document file having a file structure providing a high security by causing a computer to read the encapsulated document producing process program stored in the processor readable storage medium.

Additionally, there is provided according to another aspect of the present invention a start program causing a computer to perform the functions of: reading an encapsulated document file having an encapsulated document structure; and performing verification of a tamper on an operating program stored in the encapsulated document file based on a feature amount of the operating program file that materializes a document information file stored in the encapsulated document file and read by the reading means, wherein the encapsulated document structure comprises the document information file, the operating program file and a feature amount retaining file that retains an encrypted feature amount of the operating program.

Accordingly, the tamper verification on the operating program file is performed based on the feature amount of the operating program file that materializes the document information file stored in the encapsulated document file. Thereby, since it becomes possible to perform the verification of a tamper or alteration in the middle of distribution of the encapsulated document file. Thus, a malicious program is prevented from being mixed into the operating program file, which results in a safe access to the document.

It should be noted that the above-mentioned start program may be stored in a processor readable storage medium so that the above-mentioned start program is read and executed by a computer.

Additionally, there is provided according to another aspect of the present invention an electronic document file comprising: a plurality of operating programs and operating program use information provided by an operating program provider; and a contents file and contents use information produced by the operating program provider or a document producer. Accordingly, the application provider guarantees safety of the electronic document file, and, thereby, the document accesser can access the electronic document file with security even if the document accesser does not know the document producer.

Additionally, there is provided according to another aspect of the present invention an electronic document file producing apparatus comprising: reading means for reading a plurality of operating programs and operating program use information; contents file producing means for producing a contents file and contents file use information; and information producing means for producing information to be stored in an electronic document file, wherein the electronic document file comprises: a plurality of operating programs and operating program use information provided by an operating program provider; and a contents file and contents use information produced by the operating program provider or a document producer. Accordingly, the electronic document file producing apparatus can produce the electronic document file mentioned above.

Additionally, there is provided according to another aspect of the present invention an encapsulated document structure comprising: an operating program read by a provided-side computer connected to a network so as to cause the provided-side computer to perform various functions; use information regarding an encapsulated document provided to the provided-side computer through the network; and sending location information for sending the use information to a providing-side computer connected to the network, wherein the operating program, the use information and the sending location information are encapsulated into a single document, and the operating program includes use information transmitting program for transmitting the use information according to the sending location information at a predetermined timing.

Accordingly, the providing-side computer (the encapsulated document provider) acquires use information of the encapsulated document by sending the use information based on the sending location information at a predetermined timing. Thereby, the application program, which is the operating program to be provided, is prevented from being falsely used. Moreover, it becomes possible for the user to make a payment in accordance with a number of use of the encapsulated documents or an amount of use of the application program.

Additionally, there is provided according to another aspect of the present invention an encapsulated document structure comprising: a storage area where contents information, which is a substance of expression on a document, is stored; an operating program read by a provided-side computer connected to a network so as to cause the provided-side computer to perform various functions; and use information regarding an encapsulated document provided to the provided-side computer through the network, wherein the storage area, the operating program and the use information are encapsulated into a single document, and the operating program includes an encrypted contents information display program for displaying the contents information stored in the storage area.

Accordingly, an unfair use of the contents information display program can be prevented by encrypting the contents information display program. For example, the contents information cannot be displayed unless the encapsulated document is sent to a specific decrypting apparatus. Thereby, the provided-side computer (document producer) is prevented from distributing the encapsulated document to an accessing side (document accesser) without going through the providing-side computer (encapsulated document provider).

Additionally, there is provided according to another aspect of the present invention an encapsulated document processing apparatus, comprising: request information receiving means for receiving request information from a provided-side computer through a network; encapsulated document producing means for producing an encapsulated document having a predetermined encapsulated document structure in accordance with the request information received by the request information receiving means; and encapsulated document transmitting means for sending the encapsulated document produced by the encapsulated document producing means to the provided-side computer through the network, wherein the predetermined encapsulated document structure comprises: an operating program read by the provided-side computer connected to a network so as to cause the provided-side computer to perform various functions; use information regarding an encapsulated document provided to the provided-side computer through the network; and sending location information for sending the use information to a providing-side computer connected to the network, wherein the operating program, the use information and the sending location information are encapsulated into a single document, and the operating program includes use information transmitting program for transmitting the use information according to the sending location information at a predetermined timing. Accordingly, the contents information display program can be prevented from being falsely used.

Additionally, there is provided according to another aspect of the present invention an encapsulated document processing apparatus, comprising: use information receiving means for receiving use information from a provided-side computer through a network; charge information producing means for producing charge information of use fee of the encapsulated document by computing the use fee in accordance with the request information received by the use information receiving means; charge information transmitting means for transmitting the charge information of the use fee produced by the charge information producing means to the provided-side computer through the network; payment information receiving means for receiving payment information on the use fee from the provided-side computer through the network; and permission information transmitting means for transmitting permission information to the provided-side computer through the network when the charge information on the use fee is received by the payment information receiving means, the permission information for permitting and execution of a saving process of contents information that is a substance of expression on a document.

Accordingly, by producing the charge information on the use fee according to the use information and sending to the provided-side computer, a user can make a payment in accordance with a number of the encapsulating documents (electronic documents) or an amount of use of the application programs. Moreover, by sending the encapsulated document to the provided-side computer after receiving the payment information on the use fee from the provided-side computer, the contents information display program can be prevented from being falsely used.

Additionally, there is provided according to another aspect of the present invention an encapsulated document structure, comprising: contents information that is a substance of expression on a document; an operating program read by an accessing-side computer connected to a network, the operating program causing the accessing-side computer to perform various functions; and sending location information for sending various kinds of information to a providing-side computer connected to the through the network, wherein the contents information, the operating program and the sending location information are encapsulated into a single document, and wherein the operating program includes: an operation processing program of which operation process on the contents information is limited based on authority information; and a limitation cancellation program for canceling a limitation in the operation process of the operation processing program by sending various kinds of information based on the sending location information.

Accordingly, by limiting the operation process applicable to the contents information in the encapsulated document file based on the authority information, the contents information in the encapsulated document can be prevented from being falsely used, and it becomes possible to protect copyrights of the contents information.

Additionally, there is provided according to another aspect of the present invention an encapsulated document processing apparatus, comprising: storage area acquisition means for acquiring a storage area where contents information, which is a substance of expression on a document, is saved; request information receiving means for receiving request information through from a provided-side computer through a network; operating program producing means for producing and operating program in accordance with the request information received by the request information receiving means, the operating program being read by the an accessing-side computer and causing the accessing-side computer to perform various kinds of functions; sending location information setting means for setting sending location information for sending various kinds of information to a providing-side computer through the network; encapsulation means for encapsulating the storage area, the operating program produced by the operating program producing program and the sending location information set by the sending location information setting means into a single document; and encapsulated document transmitting means for transmitting the encapsulated document produced by the encapsulating means to the provided-side computer through the network, wherein the operating program producing means includes: an operation processing program of which operation process on the contents information is limited based on authority information; and a limitation cancellation program for canceling the limitation in the operation process of the operating program by sending various kinds of information based on the sending location information.

Accordingly, by limiting the operation process applicable to the contents information in the encapsulated document file based on the authority information, the contents information in the encapsulated document can be prevented from being falsely used, and it becomes possible to protect copyrights of the contents information.

Additionally, there is provided according to another aspect of the present invention an encapsulated document processing apparatus, comprising: decryption key request information receiving means for receiving decryption key request information from an accessing-side computer through a network, the decryption key request for requesting decryption key information for decrypting encrypted contents information, which is a substance of expression on a document; decryption key producing means for producing the decryption key information based on the decryption key request information received by the decryption key request information receiving means; and decryption key information transmitting means for transmitting the decryption key information, which is produced by the decryption key producing means, to the accessing-side computer through the network.

Accordingly, by sending the decryption key information to the accessing-side computer, the accessing-side computer becomes capable of decrypting the encrypted contents information. As a result, it becomes possible to display the contents information on a display apparatus.

Additionally, there is provided according to another aspect of the present invention an encapsulated document processing apparatus, comprising; decryption key production request information receiving means for receiving decryption key production information request information from a providing-side computer through a network, the decryption key production information request information for requesting decryption key producing information necessary for producing decryption key information for decrypting encrypted contents information, which is a substance of expression regarding a document; decryption key producing information producing means for producing the decryption key producing information based on the decryption key producing information request information received by the decryption key production request information receiving means; decryption key producing information transmitting means for transmitting the decryption key producing information, which is produced by the decryption key producing information producing on means, to an accessing-side computer through the network; and fee-charging means for charging a use fee of the contents information to the accessing-side computer when the decryption key producing information is transmitted by the decryption key producing information transmitting means.

Accordingly, by charging the use fee of the contents information to the accessing-side computer when the decryption key information is transmitted, the providing-side computer is capable of charging, as an intermediary between the document producer and the document accesser, the use fee of the contents information, which is produced, edited or added by the document producer, to the document accesser.

Other objects, features and advantages of the present invention will become more apparent from the following detailed description when read in conjunction with the accompanying drawings.

### BRIEF DESCRIPTION OF THE DRAWINGS

FIG. 1 is a block diagram showing a hardware structure of a computer, which is usable as a part of an information processing apparatus according to the present invention;

FIG. 2 is a flowchart showing as a reference a flow of a conventional electronic document accessing process;

FIG. 3 is an illustration showing a basic data structure of an encapsulated document according to a first embodiment of the present invention;

FIG. 4 is an illustration showing an outline of an accessing process of the encapsulated document;

FIG. 5 is an illustration showing a data structure of the encapsulated document;

FIG. 6 is an illustration showing an example of a data structure of a library file;

FIG. 7 is an illustration of another example of the data structure of the library file;

FIG. 8 is an illustration showing a data structure of an operating program stored in the encapsulated document;

FIG. 9 is an illustration showing a data structure of a display information file, which specifies information regarding extended programs included in the operating program;

FIG. 10 is an illustration showing an example of the encapsulated document described according to the XML format;

FIG. 11 is an illustration showing an example of a display of the encapsulated document described according to the XML format as shown in FIG. 10;

FIG. 12 is an illustration of a more specific example of the encapsulated document shown in FIG. 3, which is rewritten according to the above-mentioned encapsulated document structure.

FIG. 13 is a flowchart of an operation of accessing the encapsulated document when the encapsulated document has the structure shown in FIG. 13;

FIG. 14 is a flowchart of an operation flow of an encrypted, encapsulated document;

FIG. 15 is a flowchart of an accessing operation for accessing the encrypted, encapsulated document;

FIG. 16 is a flowchart of an example in which information encrypted with a public key is encapsulated;

FIG. 17 is a flowchart of the example in which information encrypted with a public key is encapsulated;

FIG. 18 is an outline block diagram of a structure of an encapsulated document producing and editing apparatus;

FIG. 19 is a flowchart of a producing procedure of an encrypted encapsulated document using the encapsulated document producing and editing apparatus;

FIG. 20 is an illustration of a data structure of a start program;

FIG. 21 is a flowchart of an operation of the start program to start the encapsulated document when an accesser accesses the encapsulated document;

FIG. 22 is a flowchart of a start process control of the encapsulated document;

FIG. 23 is an illustration of another data structure of the start program;

FIG. 24 is an outline flowchart of another start process control of the encapsulated document;

FIG. 25 is an illustration for explaining correspondence between kinds of operation rights and modes of the operation rights;

FIG. 26 is an illustration of a further example of the data structure of the encapsulated document;

FIG. 27 is an illustration of an example of the data structure of the encapsulated document including a start program;

FIG. 28 is an illustration showing an example of the data structure of the encapsulated document in which a prevention of a tamper is considered;

FIG. 29 is an illustration showing an example of the data structure of the encapsulated document containing an auxiliary operating program;

FIG. 30 is an outline flowchart of a start process control of the encapsulated document;

FIG. 31 is a flowchart of a document access process for the encapsulated document performed by a personal computer;

FIG. 32 is an illustration showing a file structure of a file defining a relationship between kinds of media and extended operating programs;

FIG. 33 is an illustration showing kinds of extended operating programs;

FIG. 34 is an illustration showing an example of a display on which a page turn-over button appears;

FIG. 35 is an illustration showing an example of description of a file of a functional operating program;

FIG. 36 is an illustration showing a process using an auxiliary program for an encoding part of a file;

FIG. 37 is an illustration showing a scaling function for a displayed image by the extended operating program;

FIG. 38 is an illustration showing a viewpoint change function for a displayed image, which is a three-dimensional image, by the extended operating program;

FIG. 39 is an illustration showing a display function for a dynamic image as a static image and a reproducing function of the dynamic image by the extended operating program;

FIG. 40 is an illustration showing an audio reproducing function and a text information converting function of a reproduced sound by the extended operating program;

FIG. 41 is an illustration showing a structure of the extended operating program to be included in the encapsulated document;

FIG. 42 is an illustration showing an example of a document display, which displays three sets of digital information (PRG1, PRG2, PRG3);

FIG. 43 is diagram of a hardware of a personal computer which can be used for achieving the present invention;

FIG. 44 is an illustration showing an outline of a function of an operating system;

FIG. 45 is an illustration showing a data structure of an encapsulated document file;

FIG. 46 is a flowchart of an encapsulated document producing process;

FIG. 47 is an illustration for explaining an example of a feature amount retaining file;

FIG. 48 is a flowchart of a tamper verification process;

FIG. 49 is an illustration for explaining correspondence between kinds of operation rights and operation right modes;

FIG. 50 is an illustration for explaining another example of the amount feature retaining file;

FIG. 51 is an illustration for explaining a further example of the amount feature retaining file;

FIG. 52 is an illustration showing a data structure of the encapsulated document file;

FIG. 53 is a flowchart of an encapsulated document producing process;

FIG. 54 is a flowchart of a tamper verification process;

FIG. 55 is a flowchart of another encapsulated document producing process;

FIG. 56 is a flowchart of a tamper verification process;

FIG. 57 is an illustration showing a data structure of the encapsulated document file;

FIG. 58 is a flowchart of a tamper verification process;

FIG. 59 is an illustration showing a data structure of the encapsulated document file;

FIG. 60 is a flowchart of a tamper verification process;

FIG. 61 is a flowchart of a feature amount verification process;

FIG. 62 is an illustration showing a structure of an electronic document file;

FIG. 63 is an illustration showing information contained in operating program use information described in XML format;

FIG. 64 is an illustration for explaining an outline of an electronic document authentication using an electronic document file according to the present invention;

FIG. 65 is a flowchart showing a process procedure for the electronic document authentication performed by an application provider;

FIG. 66 is a flowchart showing a process procedure for the electronic document authentication performed by a document producer;

FIG. 67 is a flowchart showing a process procedure for the electronic document authentication performed by the document accesser;

FIG. 68 is an illustration showing an example of information for limiting an execution of an operating program;

FIG. 69 is an illustration of an entire structure of an example of an electronic document authentication system using the electronic document file according to the present invention;

FIG. 70 is an illustration of an entire structure of another example of the electronic document authentication system using the electronic document file according to the present invention;

FIG. 71 is a block diagram of a computer used by the application provider, the document producer and the document accesser in the electronic document authentication system;

FIG. 72 is a flowchart showing a process procedure for tamper verification performed on the contents file by the application provider;

FIG. 73 is a flowchart showing a process procedure for tamper verification performed on the contents file by the document producer;

FIG. 74 is a flowchart showing a process procedure for tamper verification performed on the contents file by the document accesser;

FIG. 75 is a flowchart showing a process procedure for protection of copyrights of contents performed by the application provider;

FIG. 76 is a flowchart showing a process procedure for protection of copyrights of contents performed by the document producer;

FIG. 77 is a flowchart showing a process procedure for protection of copyrights of contents performed by the document accesser;

FIG. 78 is a flowchart of a process procedure for sending a use permission request for copyrights;

FIG. 79 is an illustration showing a format of contents file use information displayed when the use permission request is made;

FIG. 80 is an illustration showing an entire structure of an example of the electronic document authentication system according to the present invention;

FIG. 81 is an illustration for explaining an outline of the electronic document authentication performed using the electronic document file according to the present invention;

FIG. 82 is a flowchart showing a process procedure of a first process for the electronic document authentication performed by the application provider;

FIG. 83 is a flowchart showing a process procedure of a first process for the electronic document authentication performed by the document producer;

FIG. 84 is a flowchart showing a process procedure of a second process for the electronic document authentication performed by the application provider;

FIG. 85 is a flowchart showing a process procedure of a second process for the electronic document authentication performed by the document producer;

FIG. 86 is a flowchart showing a process procedure for the electronic document authentication performed by the document accesser;

FIG. 87 is an illustration showing an example of a file structure of the encapsulated document file according to the present invention;

FIG. 88 is a illustration for explaining an outline of the structure of the electronic document system which performs an offer process of the encapsulated document file;

FIG. 89 is a flowchart showing a flow of a request process of the encapsulated document file;

FIG. 90 is a flowchart showing a flow of the offer process of the encapsulated document file;

FIG. 91 is a flowchart showing a flow of a distribution process of the encapsulated document file;

FIG. 92 is a flowchart showing a flow of an access process of the encapsulated document file;

FIG. 93 is a sequence chart for explaining a flow of a fee-charging process of use fee of the electronic document application program;

FIG. 94 is a sequence chart for explaining a flow of a fee-charging process of use fee of the electronic document application program;

FIG. 95 is an illustration of an example of a format of use information;

FIG. 96 is a flowchart showing a flow of an unfair use detection process;

FIG. 97 is an illustration showing an example of a file structure of the encapsulated document file according to the present invention;

FIG. 98 is a flowchart showing a flow of an offer process of the encapsulated document file;

FIG. 99 is a flowchart showing a flow of a distribution process of the encapsulated document file;

FIG. 100 is a flowchart showing a flow of a feature amount determining process;

FIG. 101 is an illustration showing an example of a structure of the encapsulated document file according to the present invention;

FIG. 102 is an illustration showing an example of a structure of the encapsulated document file, which contains encrypted contents information, according to the present invention;

FIG. 103 is an illustration for explaining an outline of an electronic document system as a contents information distribution system according to the present invention;

FIG. 104 is a flowchart showing a flow of a request process of the encapsulated document file;

FIG. 105 is a flowchart showing a part of a flow of an offer process of the encapsulated document file;

FIG. 106 is a flowchart showing a part of the flow of the offer process of the encapsulated document;

FIG. 107 is a flowchart showing a part of the flow of the offer process of the encapsulated document;

FIG. 108 is a flowchart showing a flow of a distribution process of the encapsulated document file;

FIG. 109 is a flowchart showing a part of a flow of an access process of the encapsulated document file;

FIG. 110 is a flowchart showing a part of the flow of the access process of the encapsulated document file;

FIG. 111 is a flowchart showing a part of the flow of the access process of the encapsulated document file;

FIG. 112 is an illustration for explaining a flow of a fee-charging process for contents information;

FIG. 113 is a flowchart showing a flow of an operation process performed on a computer of a document accesser for charging use fees of the contents information and displaying the contents information in the encapsulated document file;

FIG. 114 is an illustration showing an outline of a screen for charging a use fee;

FIG. 115 is an illustration of an example of a file structure of the encapsulated document file according to the present invention;

FIG. 116 is a flowchart showing a flow of an operation process performed on a computer of a document accesser for charging use fees of the contents information and displaying the contents information in the encapsulated document file;

FIG. 117 is an illustration showing a relationship between decryption key information and log information of the document accesser; and

FIG. 118 is an illustration for explaining a status of encryption of the contents information in the contents information distribution service process.

### DETAILED DESCRIPTION OF THE PREFERRED EMBODIMENTS

A description will be given, with reference to the drawings, of various embodiments according to the present invention.

A description will now be given of a first mode for carrying out the present invention.

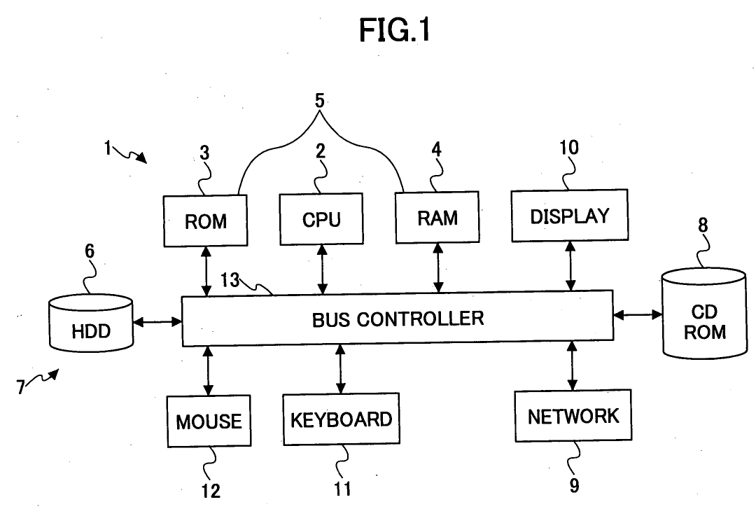

FIG. 1 is a block diagram showing a hardware structure of a computer, which is usable as a part of an information processing apparatus according to the present invention.

A personal computer 1 shown in FIG. 1 comprises: a CPU for processing information; a primary storage device 5 including a ROM 3 and a RAM 4 for storing information; a secondary storage device 7 including a hard disk drive (HDD) 6 for storing results of processing, etc.; a removable medium 8 such as a CD-ROM for storing, distributing and acquiring information; a network interface 9 connected to a network for communicating with other external computers to exchange information; a display 10 for displaying information thereon; and a keyboard 11 and a mouse 12 for inputting instructions and information to the personal computer 1. A bus controller 13 operates to arbitrate data exchanged between the above-mentioned sections.

Generally, in the personal computer 1, when a user turns on a power, the CPU 2 starts a program referred to as a loader in the ROM 3, and reads from the HDD 6 a program of an operating system for managing hardware and software of the computer and stores the program in the RAM 4 so as to start the operating system. The operating system starts a program according to an operation of a user, and reads and saves information. As a typical operating system, there are known the Windows (trademark) and the UNIX (trademark). A program that runs on the operating system is referred to as an application.

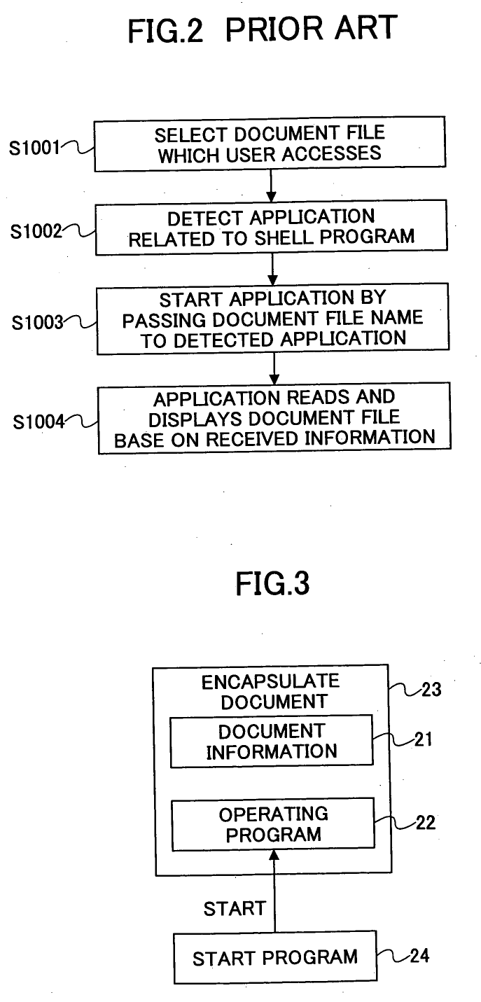

FIG. 2 is a flowchart showing as a reference a flow of a conventional electronic document accessing process using the personal computer 1. As a conventional accessing process of electronic document, as shown in FIG. 2, a user selects a document file having document information, which the user wants to access (step S1001). Then, a shell application program to which a shell application program is related in the operating system of the computer 1 is detected according to the extension of the document file concerned (step S1002). Then, the detected application program is started by providing a file name as an argument (step S1003). The started application program decides a storing location of the document file concerned from the information of the received argument, and reads and displays the document file (step S1004). That is, when an accessing person or accessing party (hereinafter referred to as an accesser) accesses an electronic document using a computer, the accesser starts first an application program, and the started application program reads digital information of the electronic document to be accessed and displays the electronic document by interpreting the digital information of the electronic document.

On the other hand, according to a first embodiment of the present invention, basically, as shown in FIG. 3, a document information file 21 serving as an expressive substance of a document and a file 22 of an operating program that expresses and materializes the document information file 21 are encapsulated into a single document. An encapsulated document 23 having an encapsulated data structure serves as an object to be accessed. Then, the electronic document becomes accessible by starting the file 22 of the operating program from a starting program 24.

The encapsulated document 23 can be stored in not only the CD-ROM 8 but also other various storage media including magnetic storage media such as a flexible disk, a hard disk or a magnetic tape and optical storage media such as a CD, a CD-R, a CD-RW, a DVD-ROM or a DVD-RAM. Some of the storage media storing the encapsulated document can be easily carried. The encapsulated document 23 can be transmitted through the network 9 such as a LAN or and the Internet.

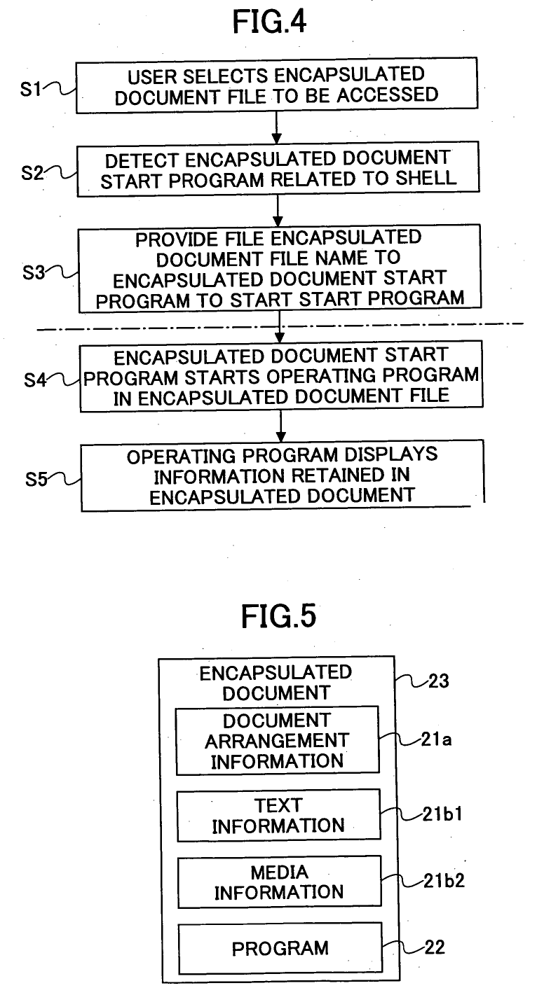

A description will now be given, with reference to FIG. 4, of an outline of an accessing process of the encapsulated document 23. First, a user selects a file of an encapsulated document to be accessed using the mouse 12 or the keyboard 11 (step S1). Then, a shell program in the operating system of the computer 1 detects a related encapsulated document start program 24 (step S2), and provides a file name of the encapsulated document 23 to the encapsulated document start program 24 concerned so as to start the start program 24 (step S3). The started encapsulated document start program 24 starts an operating program 22 in the file of the encapsulated document 23 (step S4), and the started operating program displays on the display 10 the contents of the document information file 21 retained in the file of the encapsulated document 23 (step S5).

There are two points which are considerably different from the conventional technique. The fist point is that the file 22 of the operating program for displaying the expressive substance of the document information file 21 in the document is retained in the file of the encapsulated document 23 concerned. The second point is that the file 22 of the operating program is operated first by starting from the external start program 24.

A description will now be given, with reference to FIG. 5 through FIG. 10, of an outline of basic items of the encapsulated document structure.

FIG. 5 is an illustration showing a data structure of the encapsulated document 23. The encapsulated document 23 consists of, as shown in FIG. 5, a document arrangement information 21a as a document structure file that indicates a display state such as a structure and arrangement of an entire document, a text information 21b1 as a contents file indicating contents of text of the document, media information 21b2 as a contents file indicating other static images and dynamic images, and the file 22 of a plurality of operating programs that displays the contents of the document and detects user operations. The above-mentioned information has a structure of unit of an individual file that can be managed by the operating system of the general-purpose personal computer 1.

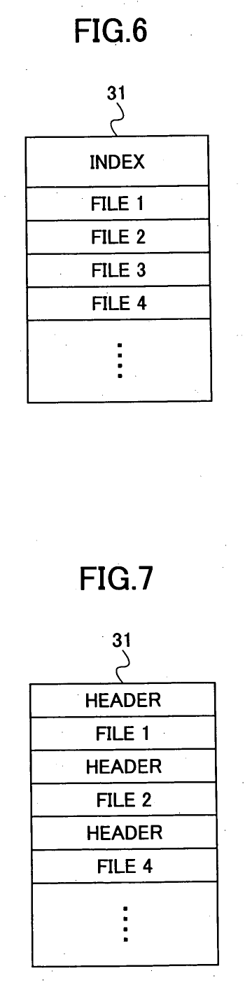

FIG. 6 is an illustration showing an example of a data structure of a library file. FIG. 7 is an illustration of another example of the data structure of the library file.

Each of the files 21a, 21b1, 21b2 and 22 is stored in a single file referred to as a library file 31 as shown in FIGS. 6 and 7. Thereby, an encapsulation means is constituted which encapsulates the document arrangement information 21a (document structure file), the text information 21b1 (contents file), the media information 21b2 (contents file) and the file 22 of the operating program. As a file format of the library file 31, generally, there are a ZIP format, an LHA format, etc., and those formats may be used.

Here, the library file 31 has a file structure, which stores the plurality of files 21a, 21b1, 21b2 and 22 in a single file (library file 31). The library file 31 uses an archiver program which has a storing function and a uncompressing function so as to handle the plurality of files 21a, 21b1, 21b2 and 22 as a single file (library file 31).

The library file 31 illustrated in FIG. 6, index information, which indicates a location of each of the files 21a, 21b1, 21b2 and 22 in the index file, is added to the library file that stores the plurality of files 21a, 21b1, 21b2 and 22. Thereby, a location search of the files 21a, 21b1, 21b2 and 22 can be achieved. Additionally, as another example of the library file 31 shown in FIG. 6, header information is added to each of the files 21a, 21b1, 21b2 and 22 so as to achieve a location search of the files 21a, 21b1, 21b2 and 22 by pointing the location.

As mentioned above, the file structure of the encapsulated document 23 is of a library file format that manages the plurality of files 21a, 21b1, 21b2 and 22, which together constitute the encapsulated document 23, by an index (refer to FIG. 6) or a header (refer to FIG. 7). Since the encapsulated document 23 encapsulates the plurality of files 21a, 21b1, 21b2 and 22 into the single library file 31, the user can manage and store the plurality of files 21a, 21b1, 21b2 and 22 as a single file, apparently.

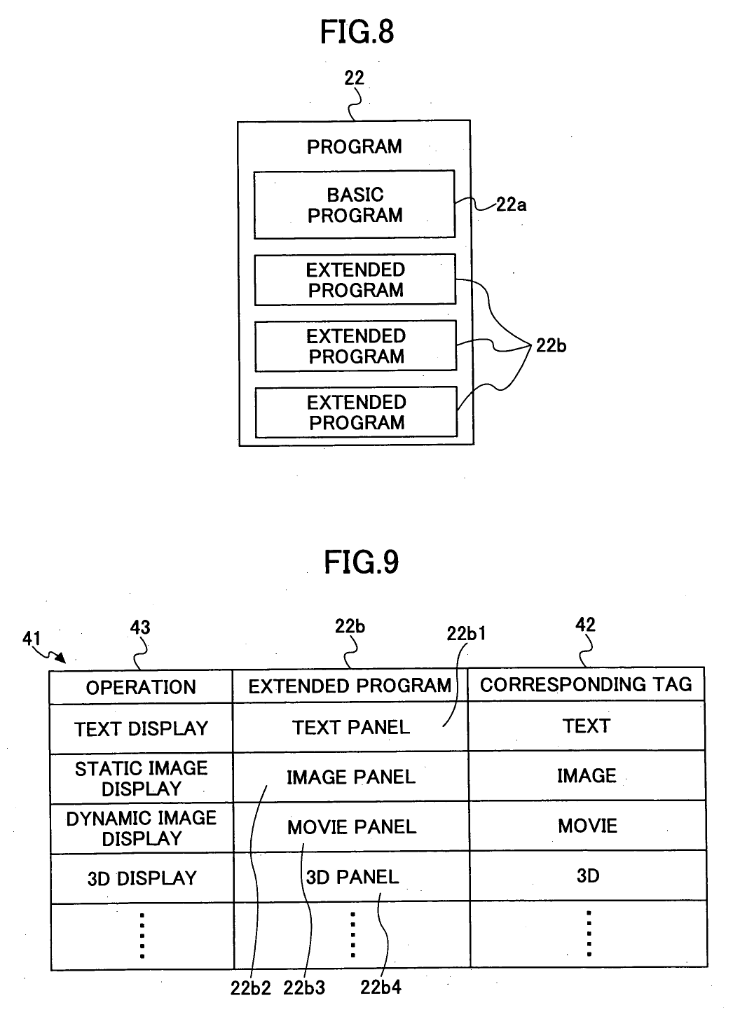

FIG. 8 is an illustration showing a data structure of the operating program file 22 stored in the encapsulated document 23. FIG. 9 is an illustration showing a data structure of the display information file, which specifies information regarding extended programs included in the operating program file 22.

The plurality of operating program file 22 stored in the encapsulated document 23 comprises a basic operating program 22a and extended operating programs (or auxiliary operating programs) 22b as shown in FIG. 8.

The basic operating program 22a can be called when starting the encapsulated document 23, and is a program which exists only one in common to the entire encapsulated document 23. The basic operating program 22a is started by the start program 24, which is interpreted and executed by the personal computer 1, in response to an access to the encapsulated document 23 in the personal computer 1.

Extended operating programs 22b are added in response to the contents of the contents information contained in the encapsulated document 23, and is prepared in response to, for example, a kind of the display media as shown in FIG. 9. For example, when the contents file included in the encapsulated document 23 is only the text information 21b1, in addition to the basic operation program 22a, the Text Panel program 22b1 from among the extended auxiliary programs 22b is stored in the encapsulated document 23. Additionally, when the media information 22b2 as a contents file representing a static image or a dynamic image is contained in the encapsulated document 23, in addition to the basic operation program 22a, the Image Panel program 22b2, the Movie Panel program 22b3 and the 3D Panel program 22b4 from among the extended auxiliary programs 22b are stored in the encapsulated document 23. The basic operating program 22a is started by the start program 24, which is interpreted and executed by the personal computer 1, in response to an access to the encapsulated document 23 in the personal computer 1.

Here, FIG. 9 shows an example of an extended auxiliary program reference file 41. The extended auxiliary program reference file 41 specifies an extended auxiliary programs 22b and corresponding tags 42 and corresponding operations 43. The extended auxiliary program reference file 41 is stored in the encapsulated document 23 as the operating program file 22.

Next, a description will be given of the document arrangement information 21a. The document arrangement information 21a is a file which describes arrangement and display size of each medium in the encapsulated document 23 and a file of each medium. In the present embodiment, the information is described according to a general-purpose XML format.

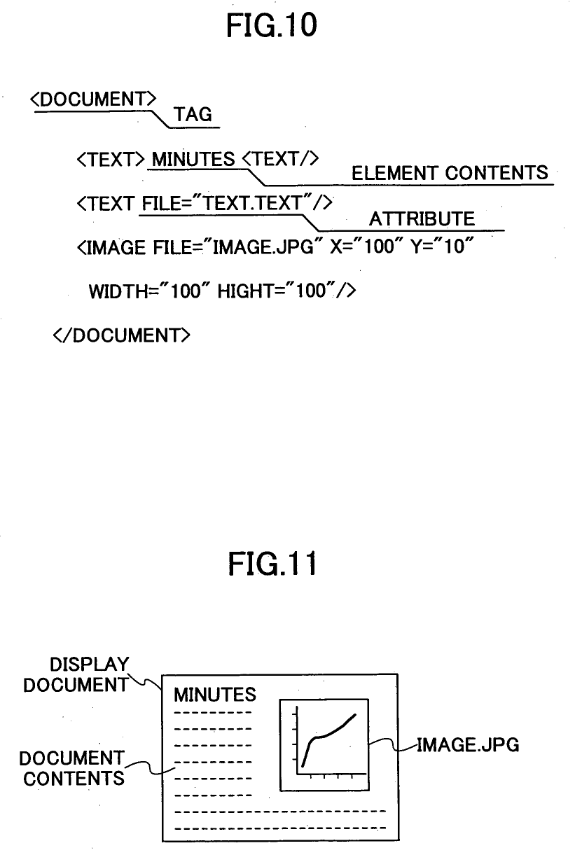

FIG. 10 is an illustration showing an example of the encapsulated document 23 described according to the XML format. The XML format is a file format which describes each element as a so-called tag, and a document is described by an assembly of the tags as shown in FIG. 10. In this case, it is also possible to take a nesting structure which describes a tag in a tag, and attribute information may be added to each tag by an attribute, which represents the attribute information.

FIG. 11 is an illustration showing an example of a display of the encapsulated document 23 described according to the XML format as shown in FIG. 10. The encapsulated document 23 as shown by the example of a display in FIG. 11 is displayed based on the description according to the XML format illustrated in FIG. 10. First, a tag <Document> representing the whole document is described, and the configuration of the document is described therein. In a case where a tag <TEXT> is used so as to describe a title first, the contents in the tag are displayed when the attribute is omitted. The following tag <TEXT> is an example which reads text information from a file “BODYTEXT.TXT”. The following tag <IMAGE> is the arrangement information that indicates to display a static image as “IMAGE.JPG” with a size indicated by WIDTH and HEIGHT according an X-Y coordinates as a starting point.

As mentioned above, the document arrangement information 21a indicates designation and arrangement of files according to the XML format.

Although a description of the document arrangement information 21a was made with the XML format as an example, other description languages such as the HTML format may be used, and an original description format may also be used.

Additionally, a general-purpose file format may be used for the media information 21b2 representing the remaining static image, dynamic image, 3D image and audio image, or an original format may be used for a case of a special specification.

As stated thus far, the file structure of the encapsulated document 23 consists of the document arrangement information 21a representing the structure of the whole document, a plurality of the contents files (the text information 21b1 and the media information 21b2) such as a text information file and an image file that are displayed corresponding to the document arrangement information 21a and a plurality of operating programs 22.

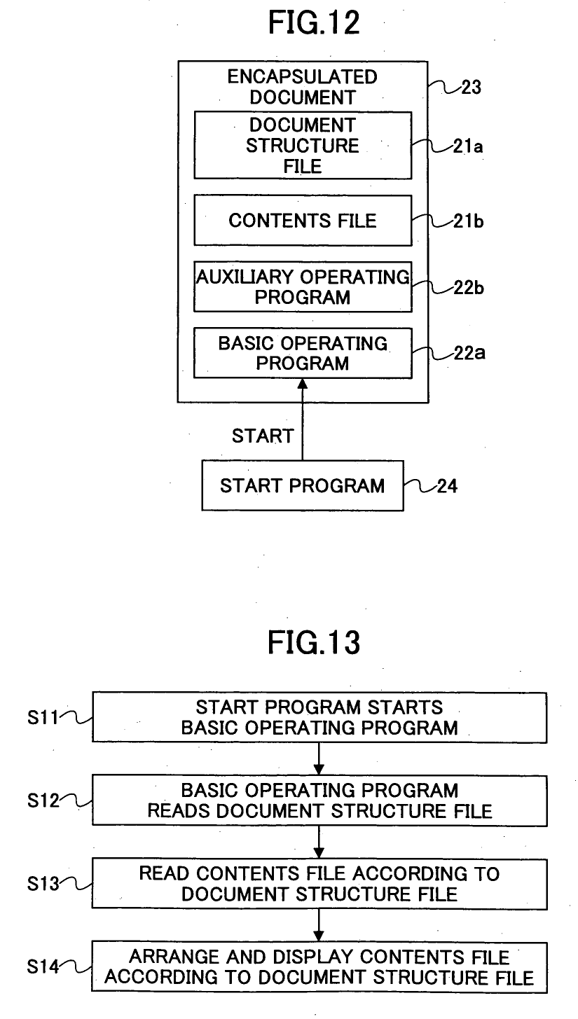

FIG. 12 shows an illustration of a more specific example of the encapsulated document 23 shown in FIG. 3, which is rewritten according to the above-mentioned encapsulated document structure. That is, the encapsulated document 23 comprises the document structure file 21a, the contents file 21b, the basic operating program 22a called first by the start program 24 and auxiliary operating program 22b required for the display operation of the document.

FIG. 13 is a flowchart of an operation of accessing when the encapsulated document 23 has the structure shown in FIG. 13. As shown in FIG. 13, first the start program 24 causes the basic start program 24 to start the basic operating program 22a in the encapsulated document 23 (step S11). Then, the basic operating program 22a reads the document structure file 21a (step S12). Then, the basic operating program 22a reads the contents file 21b in accordance with the read document structure file 21a (step S13). Thereafter, the basic operating program 22a displays the information on the read contents file 21b on the display 10 in accordance with the document structure file 21a (step S14).

Conventionally, the application program called within the operating system can freely access resources (input and output devices, storage media) usually usable by a computer. This is because the operating system cannot interpret what process is to be performed by the application program. Thus, a malicious program such as computer virus can be mixed into an execution file such as an application program.

In order to eliminate such a problem, according to the present embodiment, the operating program 22 in the encapsulated document 23, which is called by the starting program 24, is started with a limitation in the operation right. Accordingly, in the present embodiment, a malicious operating program such as a computer virus can be prevented from being mixed into the operating program. For example, the operating program 22 is protected from computer virus by causing the operating program 22 to operate with limitation (restriction of operation rights) that only reading files in the encapsulated document 23 is permitted. This is because if the operating program 22 has only a reading function, a virus cannot multiplies and cannot perform a malicious operation since the function is limited to only a reading function.

However, the mere limitation in the operation of the operating program 22 may limit the function of the encapsulated document 23. Thus, as one example, signature information for authentication is provided in the encapsulated document 23 so that the operating program is started only when it is authenticated. A “public key” may be used to achieve this method.

There are suggested various public key systems which can be applied to the above-mentioned method, and a description thereof will be given below.

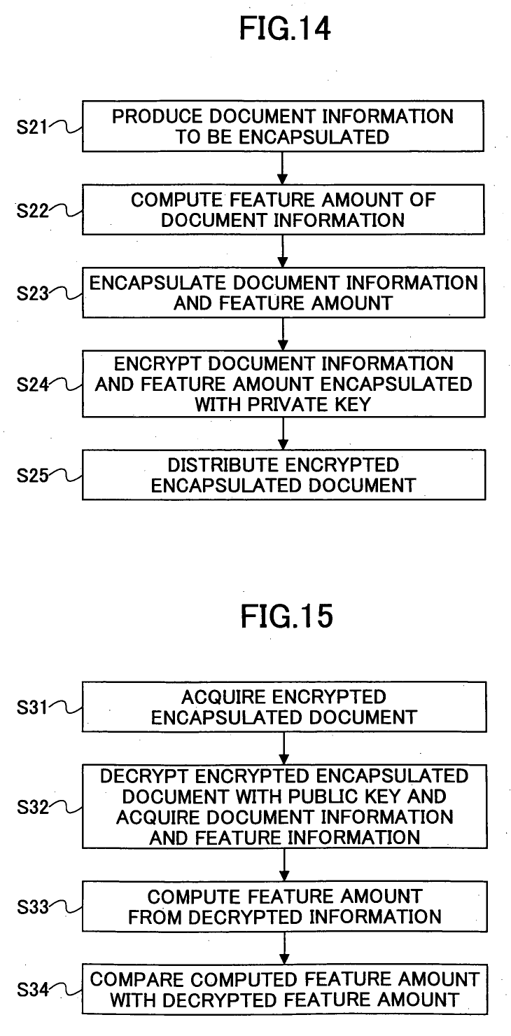

First, a description will be given, with reference to FIG. 14, of an operation flow of producing an encrypted, encapsulated document. FIG. 14 is a flowchart of the operation flow of the encrypted, encapsulated document.

First, a producer produces document information required for the encapsulated document 23 (step S21). Here, the document structure file 21a, the contents file 21b and the operating program 22 corresponds to the required document information. Next, a feature amount of the document information 21, which is changed to the encapsulated document 23, is computed (step S22). A method of computing the feature amount is known in the electronic signature art, and a description thereof will be omitted. Subsequently, the document information 21 and the feature amount are encapsulated into a single file (step S23). The document information 21 and the amount feature that area encapsulated are encrypted with a private key (step S24). Then, the encrypted, encapsulated document is distributed to accessers (persons or parties who will access the encapsulated document)(step S25). The encrypted, encapsulated document 23 can be produced by an encapsulated document producing and editing apparatus performing the above-mentioned process.

Next, a description will be given, with reference to FIG. 15, of an accessing operation. FIG. 15 is a flowchart of the accessing operation for accessing the encrypted, encapsulated document 23.

First, the file of the encrypted, encapsulated document 23 is acquired (step S31). Next, the file of the encrypted, encapsulated document 23 is decrypted with a public key, which makes a pair with the above-mentioned private key, so as to acquire the document information and the feature amount (step S32). Next, a feature amount is computed from the decrypted document information (step S33). Finally, an inspection is performed to determine whether or not the decrypted, encapsulated document 23 is tampered or altered by comparing the decrypted feature amount with the computed feature amount (step S34).

By encrypting the encapsulated document 23 with the public key system as mentioned above, the encapsulated document 23 is prevented from being tampered or altered during transmission. That is, the electronic authentication such as shown in FIG. 15 is performed by the start program 24 so that the start program causes the operating program 22 only when the authentication completes normally, and, thereby, preventing a start of the file of the encapsulated document 23, which has been tampered during transmission. The public key and the private key used here may be ones that are third party certificated so as to improve reliability. Moreover, the public key may be added to the encapsulated document 23.

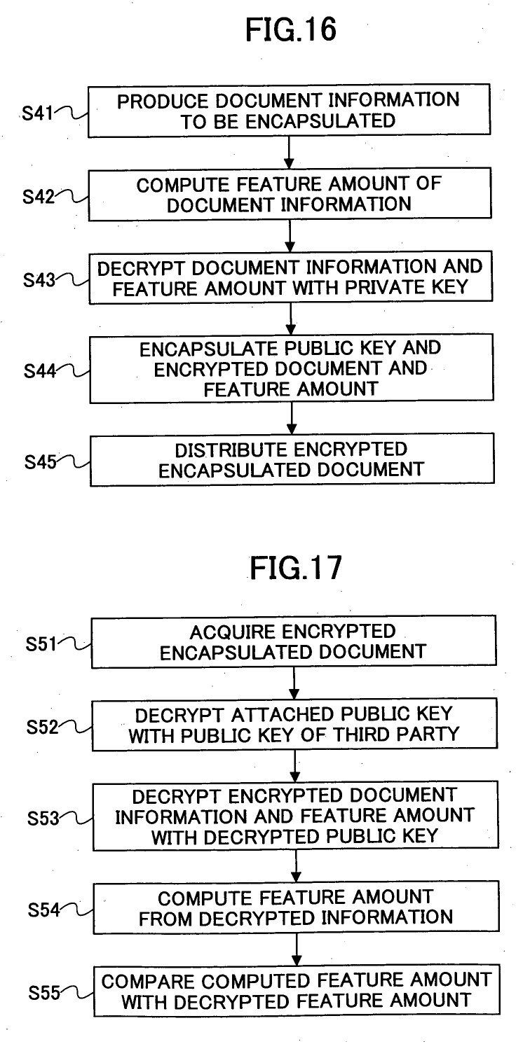

Additionally, although the example in which the decryption is applied after the encapsulation was mentioned, the encapsulation may be applied after each set of information is encrypted. FIG. 16 and FIG. 17 are flowcharts of an example in which information encrypted with a public key is encapsulated.

First, as shown in FIG. 16, a producer produces document information necessary for the encapsulated document 23 (step S41). Here, the document structure file 21a, the contents file 21b and the operating program 22 correspond to the necessary document information. Next, a feature amount of the document information 21, which is changed to the encapsulated document 23, is computed (step S42). A method of computing the feature amount is known in the electronic signature art, and a description thereof will be omitted. Subsequently, each of the document information 21 and the feature amount is encrypted with a private key (step S43). The document information 21 and the amount feature that are encrypted are encapsulated together with a public key (making a pair with the private key used for the decryption), which was encrypted to a third part (step S44). Then, the encrypted, encapsulated document is distributed to accessers (persons or parties who will access the encapsulated document)(step S45). The encrypted, encapsulated document 23 can be produced by an encapsulated document producing and editing apparatus performing the above-mentioned process.

At the time of accessing, as shown in FIG. 17, the file of the encrypted encapsulated document 23 is acquired first (step S51). Next, the attached public key is decrypted by a public key of a third part (step S52), and the encrypted document information and the encrypted feature amount are decrypted with the decrypted public key (step S53). Then, a feature amount is computed from the decrypted document information (step S54). Thereafter, an inspection is performed to determine whether or not the encrypted, encapsulated document 23 is tampered by comparing the decrypted feature amount with the computed feature amount (step S55).

However, since the public key for decrypting in this case is attached to the encapsulated document, it is necessary to encrypt the public key by a third party for authentication. If such a method is taken, a document producer is request to merely attach the public key that was encrypted by the authentication, and the accesser is not required to acquire a key for decrypting the document if the accesser has the public key of the third party for authentication.

Although the examples mentioned thus far are related to encryption of an entire document, it is preferred in practice to encrypt the operating program 22. Because, although the above-mentioned examples are on the assumption that the document producer has good intent and the electronic document is tampered during distribution, it is better for more reliability that the document producer causes the electronic document to reject a malicious operating program.

A description will now be given of a method, as an example, in which a document producer prevents a malicious program from being included. For that purpose, fundamentally, a provider of a document producing and editing application produces the operating program 22 beforehand, and a producer of the application put a signature, and a document producer may produce the encapsulated document 23 provided with the encrypted operating program 22.

First, the provider of an encapsulated document producing and editing application prepares a pair of a private key and a public key that is signed by authentication party, which is a bona fide third part. Then, the provider provides the encrypted operating program encrypted by the above-mentioned private key and the encrypted public key together with a program (encapsulated document producing and editing means) for producing and editing the document information of the encapsulated document.

Here, when a file is encrypted by the public key method, information to be encrypted and the feature amount of the information are encrypted, and an encrypted file to which the encrypted authentication information of the encrypting party is added is produced.

Thus, the document producer encapsulates, after producing the information of the document, the necessary encrypted operating program and the encrypted public key. That is, since the producer simply encapsulates the document information, the encrypted operating program for displaying the document information and the encrypted public key, a malicious operating program cannot be mixed. If one produces a malicious operating program and attempts to add to the encapsulated document, the malicious operating program cannot be encrypted since there is no private key available. Additionally, if a malicious producer produces a private key and a public key, the malicious producer cannot pass off as the provider of the application since the authentication party, which is a bona fide third party, must discloses the location of the producer when encrypting the public key of the document producer.

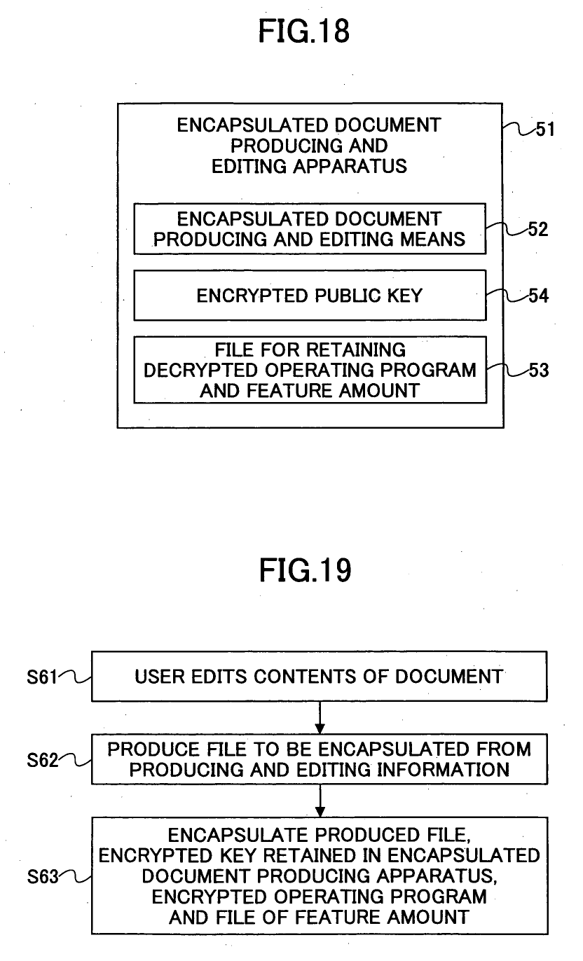

In order to achieve the above-mentioned method, as one example, an encapsulated document producing and editing apparatus 51 illustrated in FIG. 18 may be used. That is, the encapsulated document producing and editing apparatus 51 comprises: an encapsulated document producing and editing means 52; an encrypted operating program 53 which is signature-encrypted by a provider of the encapsulated document producing and editing apparatus 51 using its own private key; and an encrypted public key 54 which is produced by encrypting a public key of the provider of the encapsulated document producing and editing apparatus 51 that decrypts the encrypted operating program by the authentication party which is a third party. The encapsulated document producing and editing means 52 includes user-interface means for producing and editing the encapsulated document 23 and encapsulating means for encapsulating the produced information, the signed encrypted public key 54 and the signed encrypted operating program 53.

As shown in FIG. 19, in order that a user can produce and edit a document, the contents and arrangement of the documents are determined (step S61). Next, the encapsulated document producing and editing means 52 produces a file to be encapsulated based on the produced and edited information (step S62). The step S62 is performed as a function of the user-interface means. Subsequently, the produced file, the file of the encrypted public key 54, which is provided by the provider of the encapsulated document producing and editing apparatus 51, and the signed encrypted operating program 53, which is encrypted with the private key which makes a pair with the public key (step S63). The process of step S63 is performed as a function of the encapsulating means. In this case, the file of a feature is also encapsulated together.

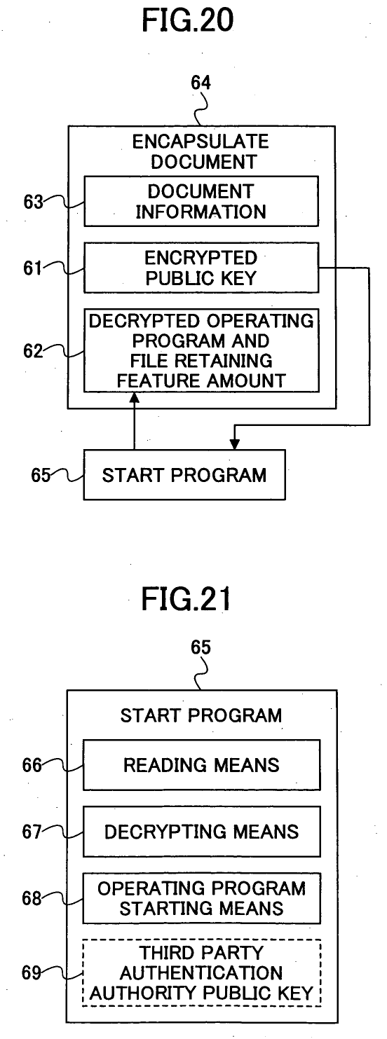

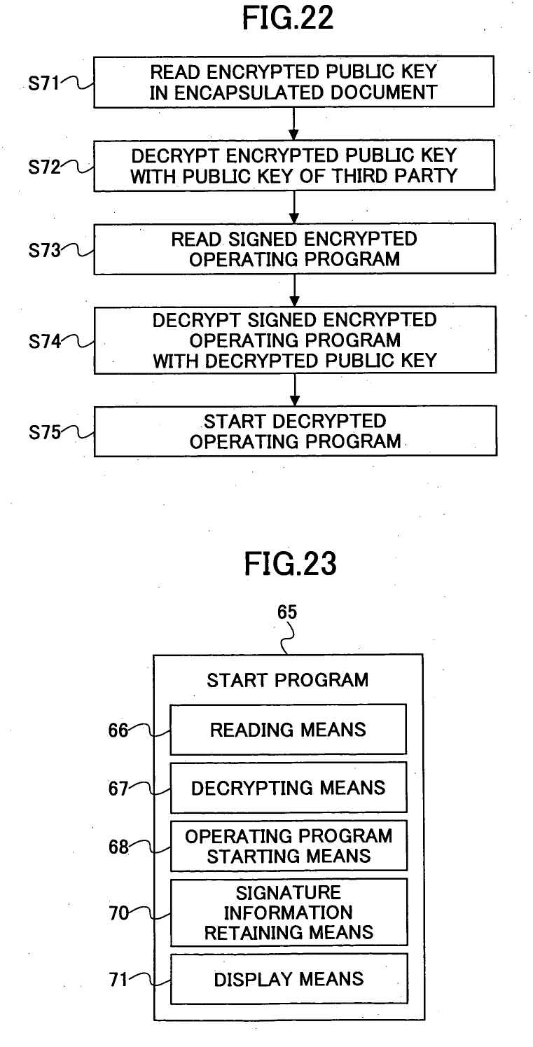

Thus, as shown in FIG. 20, the file of the encapsulated document 64, as an example of a single file, can be produced which has the encrypted public key (decryption key information) 61, the file 62 of a signed encrypted operating program and the document information 63. In FIG. 20, the reference numeral 65 indicates a start program. The start program 65 comprises, as shown in FIG. 21, reading means for reading a specific file from the files of the encapsulated document 64, decrypting means 67 for decrypting the file by using the public key; operating program starting means 68 for starting the decrypted operating program and a public key that has been authenticated by a third party authentication authority.

It should be noted that the above-mentioned method will be described further in detail later.

Next, a description will be given, with reference to FIG. 21, of an example of an operation of the start program 65 to start the encapsulated document 64 when an accesser accesses the encapsulated document 64. FIG. 21 is a flowchart of such an operation of the start program 65 to start the encapsulated document 64 when an accesser accesses the encapsulated document 64.

First, the reading means 66 reads the encrypted public key 61 encrypted by a third party authentication authority in the encapsulated document 64 (step S71). Next, the read encrypted public key is decrypted by the decryption means 67 using the public key 69 of the third party authentication authority (step S72). Subsequently, the signed encrypted operating program 62 in the encapsulated document 64 is read by the reading means 66 (step S73). Then, the signed encrypted operating program 62 is decrypted by the decrypting means 67 using the decrypted public key of the provider of the encapsulated document producing and editing apparatus (step S74). Finally, the decrypted operating program is started by the operating program starting means 68 (step S75).

The above-mentioned encapsulated document producing and editing apparatus 51 can be easily realizable by the encapsulated document producing and editing program in the computer 1. Moreover, although the public key 69 of the third party authentication authority is retained in the start program 65 in example shown in the figure, the public key 69 may be retained by the memory means of the computer 1.

Moreover, although it has been explained that the start program is started by the Shell program of the operating system as shown in FIG. 3, the Shell program itself may have such a function.

That is, if the Shell program of the operating system determines that it is a file of an encapsulated document structure by checking an extension, etc., the encrypted public key 61 in the encapsulated document 64 is decrypted with the public key of the third party authentication authority incorporated in the operating system and the encrypted operating program 62 is decrypted by the decrypted public key. If the decryption ends normally, the operating program concerned is caused to start so that the file of the encapsulated document 64 produced by a plurality of kinds of application programs of the provider of a plurality of kinds of encapsulated document producing and editing apparatus can be started by providing a single public key in the computer 1.

That is, the encapsulated document 64 with a security function is applicable to all the files handled by the computer 1. Since the file to which the present invention is applied retains an operating program with a security function, it becomes possible to operate safely in computers of different environments.

By the way, when signed by a new provider, the encapsulated document may be displayed by a structure provided with signature information retaining means 70 which can retain and offer a plurality of sets of signature information and display means 71 which displays information on the display 10.

Additionally, although the decrypted public key 61 is produced for each provider of the encapsulated document producing and editing application and is encrypted by a third party authentication authority, a public key common to the operating system may be used in a more simplified method. In this case, there is no need to retain the public key in the encapsulated document. However, the private key common to the operating system must be distributed to the provider of the application for producing the encrypted operating program 62, which may arise a problem if there is a malicious application provider.

Moreover, although it has been explained that the encrypted public key 61 is actually retained in the encapsulated document 64, URL retaining the public key may be described in the encapsulated document 64. In this case, computer 1 must be connected to the Internet. Moreover, in this case, the won computer may be caused to retain the public key when connecting to the Internet. That is, when the public key is not actually retained in the encapsulated document 64, a corresponding public key in the computer 1 may be used.

In any case, fundamentally, it is important for the public key which decrypts an operating program to be decrypted by an authentication party which is a reliable third party agency so that, if one attempts to mix a malicious operating program into the encapsulated document, a private key for encryption cannot be obtained without going through an official channel.

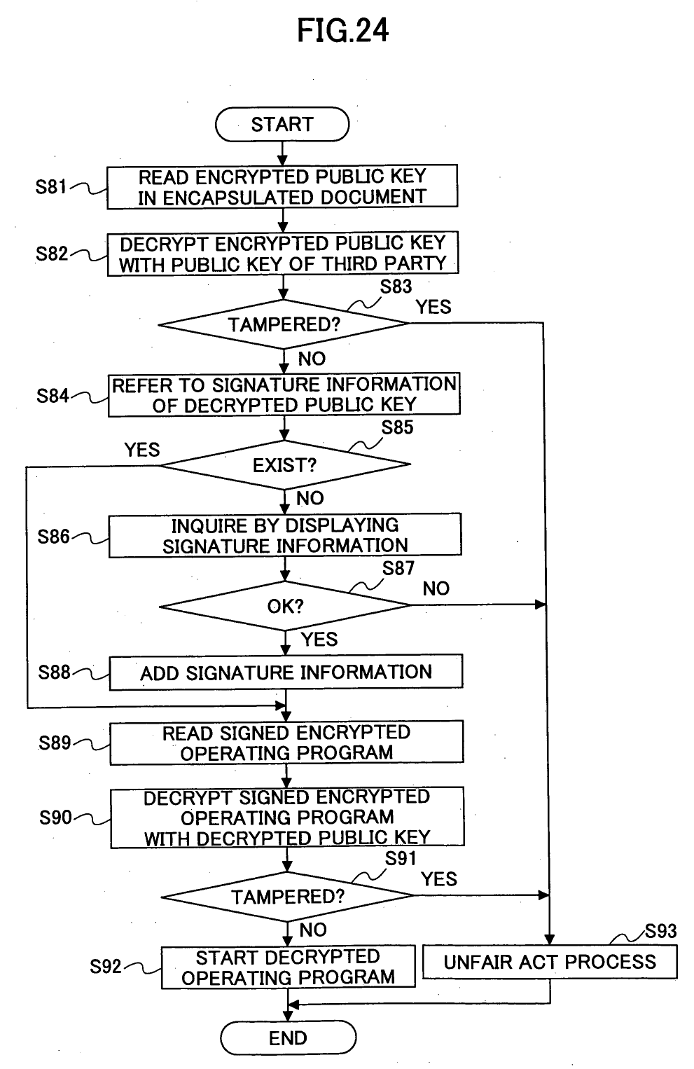

Next, a description will be given, with reference to FIG. 24, of a process performed by the start program 65 including a display process of an unfair when there is a tamper or alteration. First, the encrypted public key 61 in the encapsulated document 64 is read by the reading means 66 (step S81). Next, the encrypted public key 61 is decrypted with the public key 69 of the third party authentication authority that is installed in the computer 1 (step S82). Here, if there is found a tamper or alteration when performing the decryption (Y of step S83), the fact that there was an unfair act is displayed as an unfair act detection process (step S93), and the routine is ended. If there is no tamper (N of step S83), the signature information in the signature information retaining means 70 is compared with the signature information of the decrypted public key (step S84). If the signature information in the signature information retaining means 70 does not match the signature information of the decrypted public key (N of step S85), the signature information is displayed by the display means 71 so as to send inquiry to the user (step S86). The process of step S85 is performed as a function of the signature determining means to determine the authenticity of the signature information.

If it is determined by the user that the signature is made by an unfair signatory judging from the signature information displayed on the display 10 (N of step S87), the display of an unfair act is performed on the display 10 as the unfair act detection process (step S93). If it is determined that there was no unfair act (N of step S87), the signature information is added and retained by the signature information retaining means (step S88). Thereafter, the encrypted operating program with signature is read (step S89), and the encrypted operating program is decrypted using the decrypted public key (step S90). If there is a tamper found in the decrypted operating program (Y of step S91), the display of an unfair act is performed as an unfair act detection process (step S93), and the routine is ended. On the other hand, if there is no tamper (N of step S91), the operating program is started normally by the operating program starting means 68 (step S92).

According to the above-mentioned process, the operating program can be automatically started when the user judged that the signature information is correct.

It should be noted that although in this example the unfair act detection process in the case of an unfair file is a process to display the fact that the file is an unfair file, an inquiry as to whether to delete (cancel) the started file itself may be made to the user.

Moreover, the operating program may be constituted by a plurality of operating programs such as the basic operating program 22a and the auxiliary operating programs 22b as shown in FIG. 12. In this case, when starting the auxiliary operating program 22b, the auxiliary operating program 22b concerned may be decrypted by the decrypting means 67 of the start program 65, and the start program 65 alternatively starts the auxiliary operating program 22b.

Moreover, as an example, the operating program 22 is preferably described in an intermediate-language cord. That is, if the operating program 22 is described by intermediate language and if a compiler or an interpreter program that can interpret and execute the intermediate language is installed in the computer 1, type-dependence of the computer 1 can be eliminated.

Moreover, an interpreter program, which can directly decrypt the code of the operating programs 22b, may be used.

At present, as such an intermediate language, there is JAVA language. If the technique of JAVA is used, a program, which can directly decrypt the code of the encrypted operating program, can be produced.

However, the present JAVA language develops an application which operates on a computer, and does not define the document data structure to be produced and accessed such as one according to the present invention. That is, if an operating program having a security function according to the JAVA technology, a provider of an encapsulated document producing and editing application program can provide the encapsulated document producing and editing means 52 the operating program having a security function and the user interface for editing and producing a document and the decrypted public key 54 for decrypting the operating program such as shown in FIG. 18. Thereby, a document producer can easily provide a high-security document, which is not dependent on a platform and does not permit an unfair process such a computer virus, to an encapsulated document producing and editing program.

Moreover, although the case where the encryption is performed using the private key with the signature of an application provider, there may be a different method. That is, there is a method in which a plurality of keys for encrypting the operating program are prepared so as to change the key to be encrypted in response to the right of operation of the operating program.

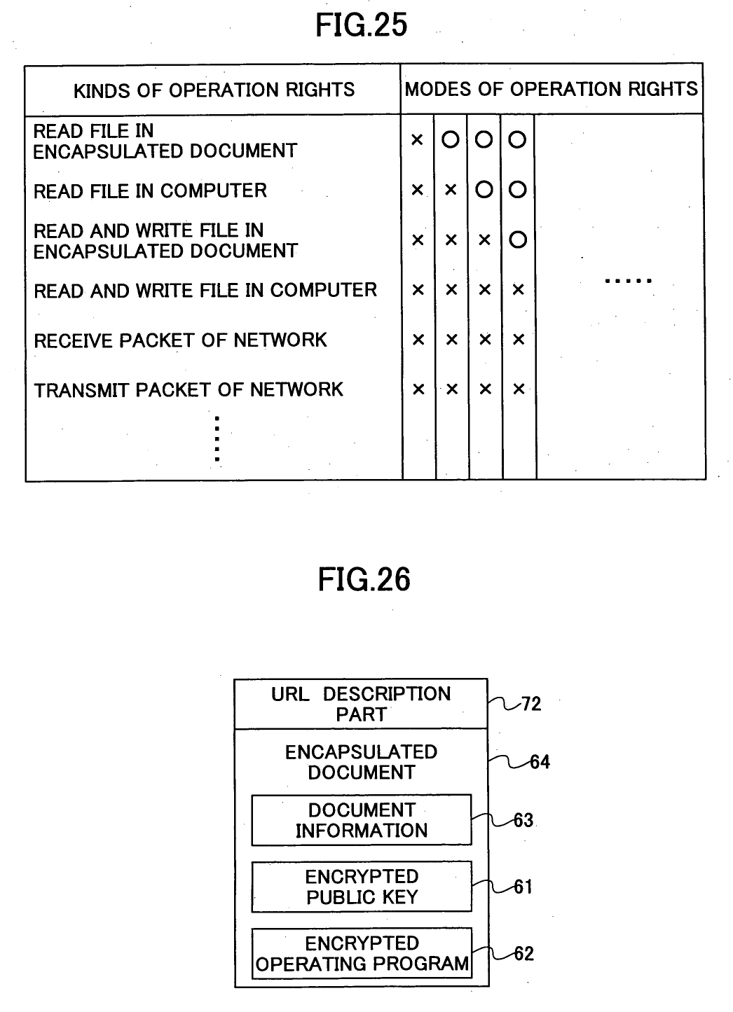

For example, as shown in FIG. 25, a plurality of keys to be encrypted are prepared in response to modes of operation rights such as permission (indicated by ∘) or non-permission (indicated by X) of reading or writing operation of files, transmission and reception through a network, etc., and the operation rights of the key used for decrypting the operating program is displayed so as to obtain a permission from the user and start the operating program according to the operation rights in the given mode. Moreover, the above-mentioned method may be used together with the previously mentioned method of the provider's key.

In the above description was given on the assumption that the start program is a part of a function of the Shell program of the operating system or on the assumption that the start program is previously installed in a computer which accesses documents. In any cases, the start program is always needed when an accesser accesses the above-mentioned encapsulated document.

A description will now be given of a method of distributing the start program. The Internet is developed now, and the start program may be downloaded through the Internet. However, when downloading through the Internet, a user has to know the URL of the site from which the start program is downloaded.

As an example, the URL may be described as property information of the file of the encapsulated document, or a user may recognize the URL by describing the URL in a URL description part 72 at a head of the file of the encapsulate document 64 as shown in FIG. 26 so as to display the file using a general-purpose text editor.

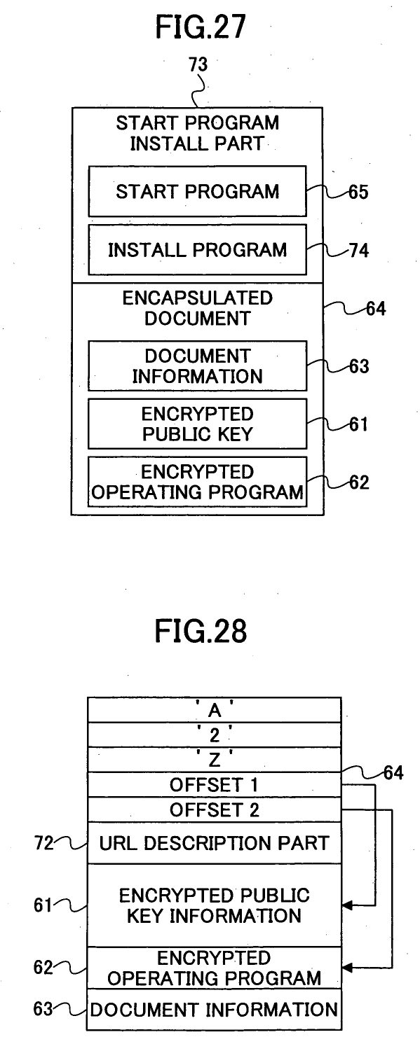

Moreover, as an example shown in FIG. 27, the start program 65 may be retained in a start program installation part 73 provided in the file of the encapsulated document 64, and the start program may be installed in the computer 1 according to an install program 74 after changing the extension of the file of the encapsulated document 62 to one for an execution program filed.

However, since this approach may permit an unfair program being mixed into the start program installation part 73. Thus, when sending the file of the encapsulated document 64, it is necessary to encrypt the file so that the file is not tampered.

Using the method according to the present invention which is a general-purpose method in which the start program 65 cause the operating program 62 of the encapsulated document 64 by merely a high-security method, different kinds of document file formats provided by different application makers can be handled by merely making the retaining format of the encrypted public key 61 in the document file and the retaining format of the operating program 62 called first common to each other.

For example, a file format shown in FIG. 28 may be used. The first three bytes correspond to a file header representing a file with a security function. First, the computer 1 determines that, when there is a train of bytes shown in the figure such as “A”, “2”, “Z”, the file belongs to the encapsulated document 64 having the data structure according to the present invention. OFFSET1 represents a location of retaining the encrypted public key 61 used for decryption, and OFFSET2 represents a location of retaining the decrypted operating program 62. The URL description part 72 is used so as to investigate the above-mentioned URL.

According to the above-mentioned structure, the start program can decrypts and starts the operating program using the public key.

Moreover, a format used for file compression of the usual ZIP, etc. may be used so as to define the name of the decrypted public key and the name of the operating program started first. In this case, the start program decompresses the encrypted public key having the defined name and the operating program having the defined name, and, then, performs the aforementioned operations.

As mentioned above, the present invention is applicable to all files used by a user through the computer 1. Additionally, by applying the present invention, all files used by a user are provided with a new function and can be operated safely in different computer environments.

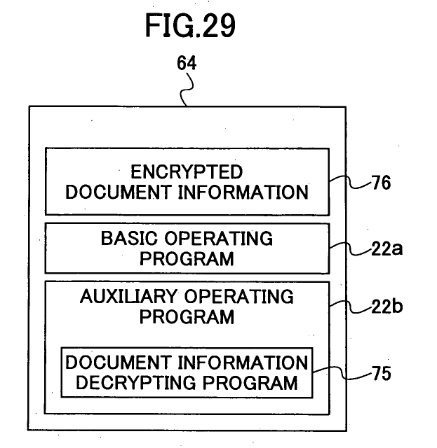

Moreover, by decrypting not only the operating program but also the document information to be displayed and adding a decrypting function to the operating program, a function of protecting a privacy of a document. That is, as an example shown in FIG. 29, the auxiliary operating programs 22b are prepared other than the basic program 22a, which is called first by the start program, and also a document information decryption program 75 is provided in one of the auxiliary operating programs 22b. It should be noted that the reference numeral 76 indicates encrypted document information.

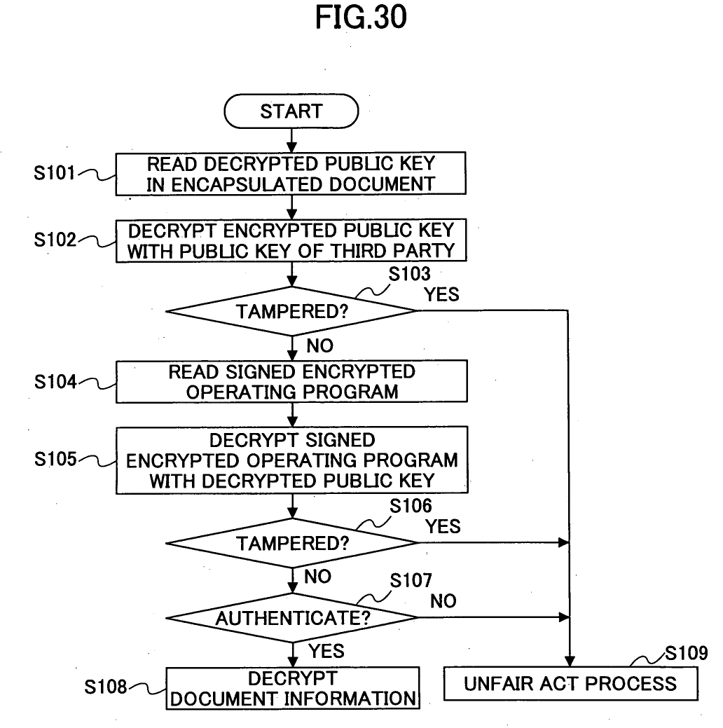

A description will be given, with reference to FIG. 30, of an example of a start operation control. First, similar to the above-mentioned example, the start program reads the encrypted public key in the encapsulated document 64 (step S101), and decrypts the encrypted public key by a public key of a third party authentication authority installed in the computer 1 (step S102). Here, if there is found a tamper when the decryption is performed (Y of step S103), the fact that there was an unfair act is displayed as the unfair act detecting process (step S109), and the routine is ended. If there is found no tamper (N of step S103), encrypted operating-program 22a with signature is read with the decrypted public key (step S104), and the encrypted operating program is decrypted with the decrypted public key (step S105). When the decrypted operating program is tampered, an unfair act display is performed as an unfair act detecting process (step S109), and the routine is ended. On the other hand, if not tampered (N of step S106), a user authentication is performed by the decrypted operating program (step S107). The user authentication may be performed using personal authentication information stored in the computer 1, or a user name and a password may be used. When the authentication succeeds (Y of step S107), the document information decryption program 75 in the auxiliary operating program 22b is started so as to decrypt the encrypted document information 76 (step S108). When the authentication fails (N of step S107), the fact that there was an unfair act is displayed as an unfair act detecting process (step S109), and the routine is ended.

The key used for decrypting the encrypted document information 76 is decrypted according to the above-mentioned authentication information, and is retained previously in the document information decryption program 75.

A description will now be given of an example of an accessing process by the operating program provided with the above-mentioned security function and an example of an extended operating program applicable as an operating program.

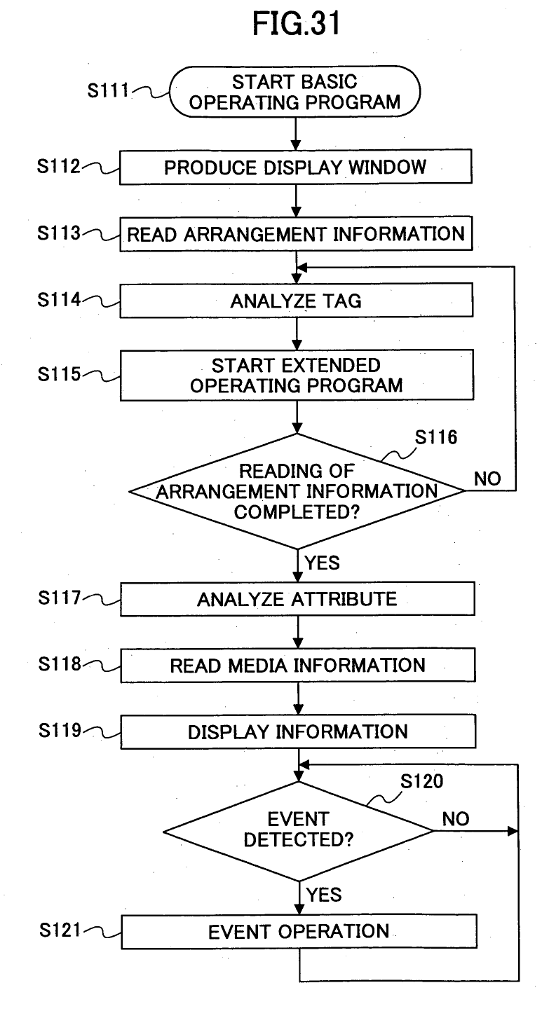

FIG. 31 is a flowchart showing a flow of a document accessing process using the personal computer 1 for accessing the encapsulated document 23. Here, the personal computer 1 and the encapsulated document 23 (or 64) together constitute an information processing apparatus.

The encapsulated document 23 includes an icon file (not illustrated in the figure) regarding icons for displaying icons corresponding to the substantial data of the text information 21b1 and the media information 21b2 on the personal computer 1. Then, since the icons according to the icon file are displayed on the personal computer 1, when a user selectively start an icon corresponding to the substantial data of the encapsulated document 23 by a mouse 12, etc. (double click), the basic operating program 22a stored in the encapsulated document 23 as a library file 31 in a library format is started (step S111). The basic operating program 22a produces a display window for displaying documents after the start (step S112). Then, the basic operating program 22a reads the document arrangement information 21a in the library file 31 described by XML, etc., (step S113).

After reading the document arrangement information 21a, the basic operating program 22a analyzes a tag structure (step S114), and starts the extended operating program 22b corresponding to a tag name such as illustrated in FIG. 9 in another thread, and passes the attribute described in the document arrangement information 21a to each extended operating program 22b (step S115). The basic operating program 22a performs such a process on all tags in the document arrangement information 21a stored in the encapsulated document 23 (step S116), and, thereby, the extended operating program 22b described in the document arrangement information 21a is started in another thread (step S115).

Each extended operating program 22b analyzes the attribute received from the basic operating program 22a (step S117), and reads the required text information 21b1 and media information 21b2 from the library file 31 in the encapsulated document 23 according to the contents of the attribute (step S118). Then, each extended program 22b displays the text information 21b1 and the media information 21b2 in an area having a size corresponding to the attribute in the window produced by the basic operating program 22a (step S119). By performing such a process, the encapsulated document 23 can display a plurality of sets of text information 21b1 and the media information 21b2 on the window acquired by the basic operating program 22a.

After the display, if generation of various events is recognized, the extended operating program 22b performs a process corresponding to the recognized event (step S121). Thus, the document in the encapsulated document 23 can be displayed with a structure fundamentally different from a conventional document.

As mentioned above, according to the encapsulated document 23 of the present embodiment, the basic operating program 22a is started first, and, then, the start program reads various kinds of information from the document arrangement information 21a and starts the extended operating program 22b.

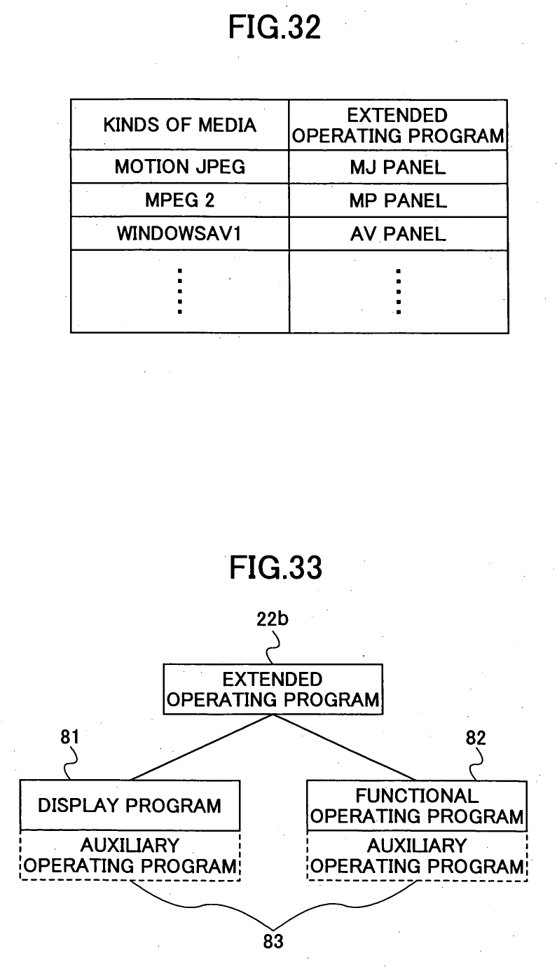

Moreover, as mentioned above, the extended operating program 22b may be started by previously preparing a program corresponding to a kind of the tag of the document arrangement information 21a described by XML, etc., or the extended operating program 22b may be started in response to kinds of various contents files (the text information 21b1, the media information 21b2) from which the attribute information of a tag is read. For example, as shown in FIG. 32, since there are a plurality of typical formats for dynamic images when reproducing and displaying the dynamic images, the extended operating program 22b becomes a large program if only one extended operating program 22b is produced for displaying all of the plurality of dynamic images. Thus, as shown in FIG. 32, a plurality of extended operating programs 22b are prepared in response to file formats so that one of the extended operating programs 22b, which matches a specific kind of file format in the encapsulated document 23, is encapsulated.

FIG. 33 is an illustration showing the kinds of the extended operating program 22b. As shown in FIG. 33, the extended operating program 22b can be not only a digital information display program 81 fro reproducing and displaying file contents information but also a functional operating program 82 which provides a specific function without reading digital information. Or the digital information display program 81 and the functional operating program 82 in the extended operating program 22b may have auxiliary programs 83 which assist them.

A description will now be given of functions achieved by the functional operating program 82 and the auxiliary program 83.

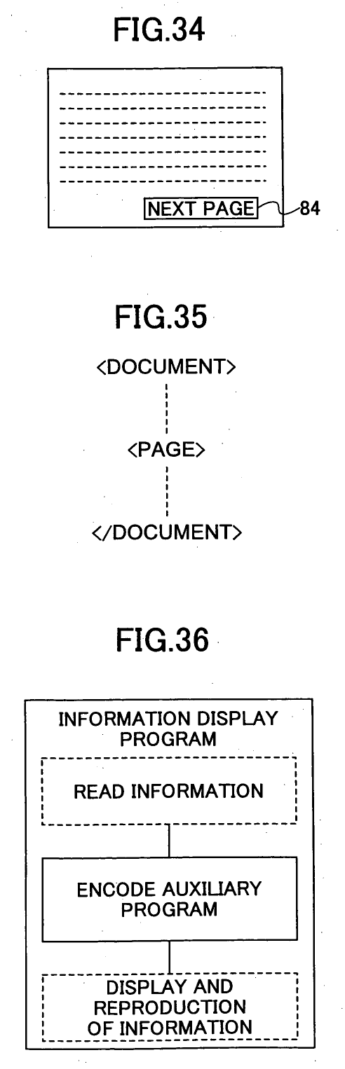

As an example, it is assumed that there is a document, which is longer than a display size of the display 10 of the personal computer 1 and has a plurality of pages. In this case, as shown in FIG. 34 as an example, a page turn-over button 84 is displayed as a functional panel on the display 10. This can be realized, a shown in FIG. 35, by describing a tag <page> in the document arrangement information 21a and providing to the functional operating program 82 a function of the extended operating program 22b, which is a PAGEButton corresponding to the tag. Accordingly, the page turn-over button 84 appears as shown in FIG. 34 due to operation of the functional operating program 82, which is the PAGEButton, and, thus, a function to turn over a page when a user presses the button by means of, for example, clicking the mouse 12 is provided.

Here, when a user presses the button, as shown in the flowchart of FIG. 31, the extended operating program 22b determines a detection of an event (Y of step S120) and performs a corresponding event operation (step S121). The event operation here is the page turn-over function performed by the functional operating program 82 and the auxiliary program 83.

As another example, the functional operating program 82 may have a function, for example, to display a function to display a number of pages, a date of production, a total number of words, etc.

Next, a description will be given of an example of a dynamic image reproduction function as an example of a function performed by the functional operating program 82 and the auxiliary program 83, which assists the functional operating program 82. There is an example of the dynamic image reproduction function in which the same basic functional operating program 82 is used for any dynamic image formats since a basic display part can be commonly used for any dynamic image file formats, but a part depending on the dynamic image file formats is provided to the auxiliary program 83. For example, as shown in FIG. 36, an encoding part of a file may be achieved by the auxiliary program 83.

Next, a description will be given of a specific example of the extended operating program 22b.

First, a description will be given of the function of the extended operating program 22b on the assumption that a plurality of contents files (the text information 21b1, the media information 21b2) are included in the encapsulated document 23.

The extended operating program 22b displays a file specifying panel (not shown in the figure) on the display 10. The file specifying panel is a panel that lists a plurality of contents files (the text information 21b1, the media information 21b2) included in the encapsulated document 23 in a selectively designating manner. Thus, if any one of the contents files (the text information 21b1, the media information 21b2) is selectively designated by a means such as clicking by the mouse 12, the extended operating program 22b determines a detection of an event (Y of step S120) and performs a corresponding event operation (step S121) as shown in the flowchart of FIG. 30.

As the event operation here, the extended operating program 22b performs an operation to display the selectively designated contents file (the text information 22b1 or the media information 21b2).

Next, a description will be given of a function of the extended operating program 22b on the assumption that a dynamic image is included as the as media information 21b2 in the encapsulated document 23.

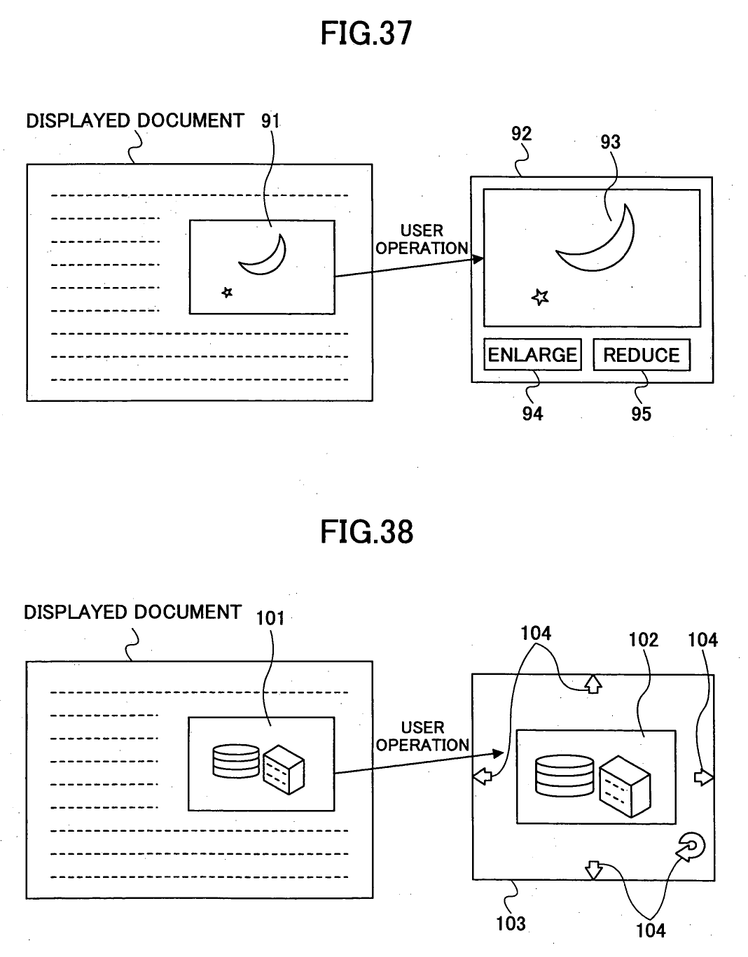

As shown in FIG. 37, the extended operating program 22b displays a dynamic image 91 in the document displayed on the display 10. Then, if a display of the dynamic image 91 contained in the document on the display 10 is selectively designated by mean of clicking by the mouse 12, the extended program 22b determines a detection of an event (Y of step S120) and performs a corresponding event operation (step S121).

As the event operation here, the extended operating program 22b produces and displays a functional panel 92, which is a separated frame for scaling as shown in FIG. 37. The functional panel 92 provides an enlarge button 94 and a reduce button 95 with an enlarged or reduced image 93 of the dynamic image 91. Then, if one of the buttons 94 and 95 is selectively designated, the extended operating program 22b performs a process of changing an enlargement ratio or a reduction ratio in response to the designation.

By adding such a new function to the extended operating program 22b, which displays a dynamic image, a user visibility can be remarkably improved as compared to the dynamic image 91 merely being attached to a document.

The scaling function by the extended operating program 22b can be achieved by any known scaling functions.

Next, a description will be given of a function of the extended operating program 22b on the assumption that a three-dimensional (3D) image file is contained in the encapsulated document 23 as the media information 21b2.

As shown in FIG. 38, the extended operating program 22b displays a 3D image 101 in a document displayed on the display 10. Then, if a display area of the 3D image 101 contained in the document on the display 10 is selectively designated by mean of clicking by the mouse 12, the extended program 22b determines a detection of an event (Y of step S120) and performs a corresponding event operation (step S121).

As the event operation here, the extended operating program 22b displays a pop-up frame 103, which includes an image 102 to display the 3D image 101 in enlarged or reduced scale or as it is, and arranges viewpoint change buttons 104 for changing the viewpoint to the pop-up frame 103. Then, if one of the viewpoint change button is selectively designated, the extended operating program 22b changes the viewpoint according to the selectively designated viewpoint change button 104. Thereby, a user's visibility can be improved.

Next, a description will be given of a function of the extended operating program 22b on the assumption that a dynamic image file is contained the encapsulated document 23 as the media information 21b2.

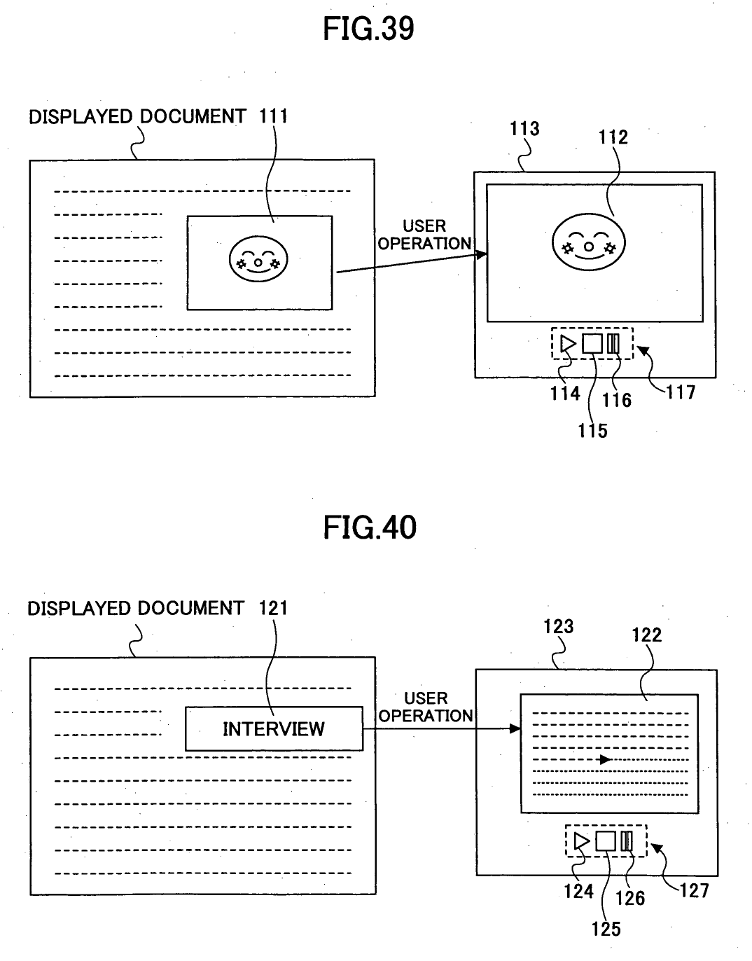

As shown in FIG. 39, the extended operating program 22b displays a static image 111 specified by one frame of a dynamic image in a document displayed on the display 10. Then, if a display area of the static image 111 contained in the document on the display 10 is selectively designated by mean of clicking by the mouse 12, the extended program 22b determines a detection of an event (Y of step S120) and performs a corresponding event operation (step S121) as shown in the flowchart of FIG. 31.

As the event operation here, the extended operating program 22b displays a pop-up frame 103, which includes an image 112 to display the static image 111 in enlarged or reduced scale or as it is, and causes operational buttons 117 including a play button 114, a stop button 115 and a pause button 116 to appear on the display 10. Then, if one of the buttons 114, 115 and 116 included in the operational buttons 117 is selectively designated by means of clicking the mouse 12, the extended program 22b determines a detection of an event (Y of step S120) and performs a corresponding event operation (step S121) as shown in the flowchart of FIG. 31.

As the event operation here, the extended operating program 22b reproduces the image 112, which is being displayed as a static image, as an original dynamic image when the play button 114 is selectively designated. Additionally, the extended operating program 22b stops the image 112, which is being displayed as a static image, when the play stop button 115 is selectively designated. Further, the extended operating program 22b displays the reproduced dynamic image at a moment as a static image at the present time when the pause button 116 is selectively designated.

A description will be given of a function of the extended operating program 22b on the assumption that an audio information file is contained in the encapsulated document 23 as the media information 21b2.

As shown in FIG. 40, the extended operating program 22b displays an audio play button 121 as a functional panel and a reproduction panel in a document displayed on the display 10. Then, if a display area of the audio play button 121 contained in the document on the display 10 is selectively designated by mean of clicking by the mouse 12, the extended program 22b determines a detection of an event (Y of step S120) and performs a corresponding event operation (step S121) as shown in the flowchart of FIG. 31.

As the event operation here, the extended operating program 22b displays a pop-up frame 123, which includes an audio reading information display area 112 mentioned later, and causes operational buttons 127 including a play button 124, a stop button 125 and a pause button 116 to appear on the display 10. Then, if one of the buttons 124, 125 and 126 included in the operational buttons 127 is selectively designated by means of clicking the mouse 12, the extended program 22b determines a detection of an event (Y of step S120) and performs a corresponding event operation (step S121) as shown in the flowchart of FIG. 31. As the event operation here, the extended operating program 22b reproduces the sound of the audio information file contained in the encapsulated document 23 when the play button 124 is selectively designated. Additionally, the extended operating program 22b stops the sound reproduction of the audio information file currently being performed when the play stop button 125 is selectively designated. Further, the extended operating program 22b temporarily stops the sound reproduction of the audio information file when the pause button 126 is selectively designated.

As a further function, the extended operating program 22b causes the personal computer 1 to perform a function to display visible information, which is obtained by converting sound to be reproduced into text information, in an information display area 122 when the replay button 124 is selectively designated and the sound of the audio information file is reproduced. Such an operation is effective when a speaker for sound reproducing in the document accessing apparatus (normally, the personal computer 1) is turned off or when an auditory handicapped person accesses the document. Moreover, the display of such a reading function may be automatically popped up based on the setting of a speaker of the personal computer 1 or a handicapped person assisting function.

Here, the audio information file may be text data or one having a data structure as audio data obtained by sampling a voice sound. If the audio information file is text data, the audio information file can be reproduced by a method in which a voice synthesizing LSI is used for reproducing the audio information file and the text data if converted into audio data defined by a feature amount of a voice sound. Moreover, when the audio information file consists of text data, the text data is used as it is. On the other hand, when the audio information file consists of audio data, it is necessary to convert it into text data by analyzing the audio data.

As explained above with some examples, it is considered to prepare various kinds of the extended operating programs 22b in response to various kinds of digital information to be displayed or reproduced. Then, if the extended operating programs 22b are prepared as parts of a multimedia document, the extended operating programs 22b can correspond flexibly to various kinds of media. In such a case, only the necessary extended operating program 22b may be stored in the encapsulated document 23, which results in an extremely simple structure of the encapsulated document 23.

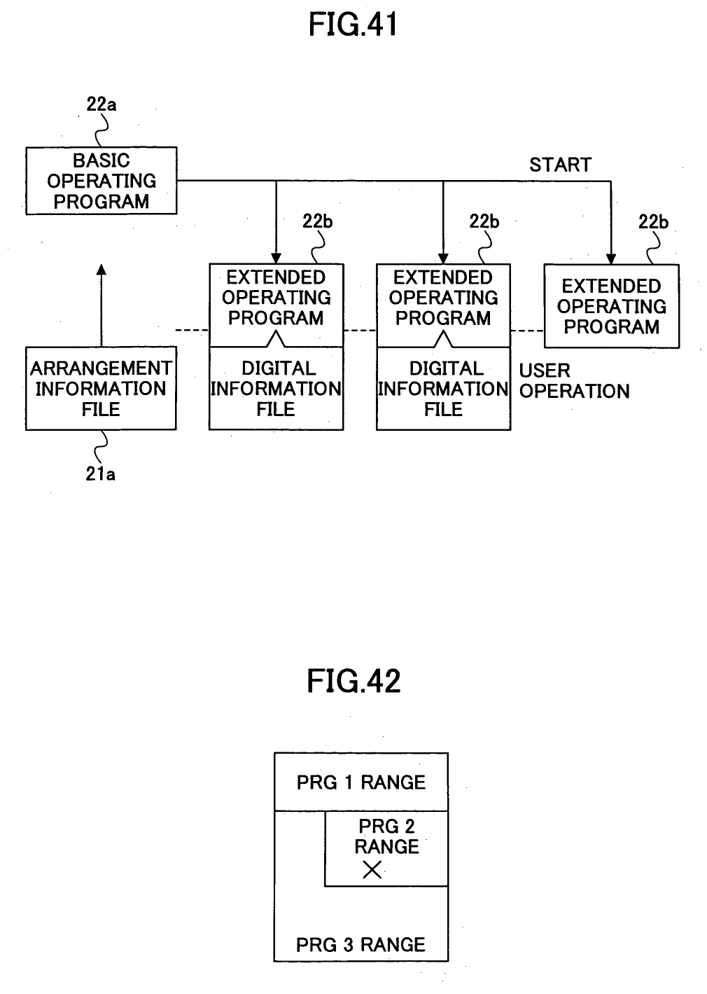

FIG. 41 shows a structure of the extended operating program 22b included in the encapsulated document 23. According to the structure of the encapsulated document 23, the basic operating program 22a reads the document arrangement information 21a, the extended operating program 22b causes to start the extended operating program 22b corresponding the contents file (the text information 21b1, the media information 21b2) which the document arrangement information 21a refers to, and the started extended operating program 22b displays and reproduces the contents file (the text information 21b1, media information 21b2). Moreover, each extended operating program 22b detects a user operation so as to perform a corresponding operation when there is detected a user operation. In this case, in a case of the extended operating program 22b, which does not refer to the contents file (the text information 21b1, media information 21b2), the extended operating program 22b merely receives the user operation and performs an operation corresponding to the user operation.

As the user operation, there may be a click operation by the mouse 12 and an input operation through the keyboard. When the click operation by the mouse 12 is performed, it is determined whether or not the location of the click by the mouse 12 is within a display area of the extended operating program 22c so as to perform a corresponding operation when the click is performed within its own display range. When the input operation is performed through the keyboard 11, it is determined whether or not a cursor position (not shown), which is movable through the keyboard 11, is within a display range of each of the extended operating programs 22b so as to perform a corresponding operation when selectively designated within its own display range. For example, as shown in FIG. 42, in a case where three sets of digital information (PRG1, PRG2, PRG3) are displayed, as one example, when a user clicks the mouse 12 at a position indicated by X, the extended operating program 22b of PRG2 detects the click of the mouse 12 and performs a corresponding operation.

As mentioned above, the encapsulated document 23 according to the present embodiment comprises a group of the extended operating programs 22b relate to the kinds of media and kinds of the tags of display information file, or comprises, as a minimum structure, the basic program 22a and the document arrangement information 21a. Then, the encapsulated document 23 is realized by preparing contents file (the text information 21b1, the media information 21b2) according to the information which a user wants to store in the encapsulated document 23 and adding the extended operating program 22b that can reproduce and display the information. The encapsulated document 23 according to the present embodiment stores various files as a single file using an archive format.

As mentioned thus far, in the case of providing a document accessible by a multiplatform, it is required to encapsulate the document information and the operating program for displaying and processing the document information into a single file. However, if an operating program is included in a document file, this may cause a problem relating to a computer virus.

Thus, the present invention suggests two approaches as mentioned above. The first approach is to start the operating program with a limitation in operation rights, and a second approach is to encrypt the operating program. The first approach may limit the function of the operating program since the operation rights are limited. Thus, in the second approach as mentioned above, the operation rights is expanded by preventing a tamper by using signature for an entire document. Moreover, the method in which a provider of a document producing and editing application produces and encrypts the operating program was mentioned although there is a possibility that a document producer mixes a malicious program into the document since the signature is applied to the entire document. It is also considered that the two methods are combined with each other.

That is, in the combined method, the operating program, which operates with limited operation rights, is operated without encryption, and the operating program is encrypted when performing an operation without limitation. For example, at a default, the start program starts the operating program in a mode of limited operation, and starts the encrypted operating program when a further operation rights are needed. That is, the operational mode is changed based on the signature information of the operating program to be started.

Moreover, there are some approaches of limiting the operation rights of the operating program. For example, when an intermediate code is used for the operating program, the operating rights can be easily limited since an input and output operation of the computer is performed through an interpreter, which interprets and executes the operating program. On the other hand, if the operating program is a native code, operations beyond the operation rights can be limited by detecting an execution code prior to an execution. Moreover, the above-mentioned limitation in the operation rights is provided in a standard operating system, and such an operating system may be used.

Accordingly, the above description discloses the following inventions.

1) An encapsulated document structure comprising: a document information file storing document information that is a substance of expression of a document; and an operating program file storing an operating program that materializes the document information, a limitation being given to the operating program by a security function when the operating program is interpreted and executed by a computer, wherein the document information file and the operating program file are encapsulated as a single document.

Accordingly, since the operating program file, which materializes the document information file, is encapsulated into a single file together with the document information file concerned, the document can be accessed under a computer environment different from a computer environment of the document producer. Additionally, since a limitation is applied to the operating program by the security function when interpreted and executed by a computer, a malicious program is prevented from mixing into the operating program, which achieves a safe access to the document.

2) In the above-mentioned encapsulated document structure, the security function of the operating program file may be controlled based on specific decryption key information for decrypting encrypted digital information.

3) The above-mentioned encapsulated document structure may further comprise encapsulating means for encapsulating the decryption key information, the operating program file and the document information file into a single document.

Accordingly, since the operating program file, which materializes the document information file, is encapsulated into a single file together with the document information file concerned, the document can be accessed under a computer environment different from a computer environment of the document producer. Additionally, since the encapsulated document structure contains decryption key information for decrypting the encrypted digital information and a limitation by the security function is imposed to the operating program so as to decrypt the operating program file in accordance with the decryption key information, a malicious program is prevented from mixing into the operating program, which achieves a safe access to the document.

4) In the encapsulated document structure, the encapsulating means encapsulates the decryption information, the operating program file and the document information file into a single file.

Accordingly, since the decryption key information, the operating program file and the document information file are incorporated into a single file, they can be easily handled and managed.

5) In the encapsulated document structure, the decryption key information may be signed and encrypted by a third party authority.

Accordingly, since signature encryption is applied to the decryption key information used for decrypting the operating program by a third party authentication authority, false decryption key information is prevented from mixing into the encapsulated document file, which improves the security.

6) In the encapsulated document structure, the operating program may be started by an external start program that is interpreted and executed by the computer.

Accordingly, since the operating program in the encapsulated document is started by the external start program, the operating program in the encapsulated document can be easily started by merely designating the encapsulated document on the computer to perform a predetermined operation.

7) In the encapsulated document structure, the operating program file may be described by an intermediate language code, and is executed by interpreting and executing the intermediate language code.

Accordingly, since the operating program can be executed by merely interpreting the intermediate language cord by reading by a start program, the operating program can be executed in computers based on different native codes.

8) In the encapsulated document structure, the operating program may be decrypted and started by the start program in accordance with the decryption key information.

Accordingly, the operating program in the encapsulated document can be safely started by decrypting the operating program by the external start program based on the decryption key information.

9) In the encapsulated document structure, the operating program started by the start program may operate within predetermined operation rights.

Accordingly, only safe operations can be performed by causing the operating program started by the starting program to operate within specified operation rights.

10) In the encapsulated document structure, the decryption key information may include link information of URL.

Accordingly, a function necessary for maintaining security can be achieved by setting the decryption key information to link information of URL without actually providing the decryption information in the encapsulated document.

11) In the encapsulated document structure, a storage area of the operating program may be described therein. Accordingly, the location of the operating program can be easily obtained by reading the information in the storage area of the encapsulated document.

12) The encapsulated document structure may further comprise a start program file storing a start program that is interpreted and executed by the computer to start the encapsulated document file, wherein, when a file identifier of the encapsulated document file is changed, the operating program file is started by the start program.

Accordingly, it is not necessary to install a start program in the computer beforehand and the operating program can be self-started since the start program for starting the encapsulated document is provided in the encapsulated document itself and the operating program is started by the start program in the encapsulated document itself when a file identifier of the extension of the encapsulated document is changed.

13) The encapsulated document structure may further comprise signature determining means for determining whether the signature information in the encapsulated document is true or false, wherein, when the signature information is false, an unfair act process for performing a predetermined operation to avoid a problem caused by an unfair act performed with respect to the encapsulated document.

Accordingly, an unfair act process such as an issue of warning or a deletion of a file can be appropriately performed by determining by the start program as to whether the signature information in the encapsulated document if true or false.

14) In the encapsulated document structure, the start program may display the signature information of the operating program to be started or the encapsulated document so as to cause a user to check the start.

Accordingly, the start program can display the signature information on the operating program to start or the encapsulated document so as to request the user to check the start, and, thereby, the use can recognize a false file beforehand and prevent the operating program from being unnecessarily started.

15) In the encapsulated document structure, the start program file may include signature retaining means for retaining signature information, and the start program may compare the signature information retained by the signature retaining means with the signature information in the encapsulated document so as to eliminate a signature display to the user when the signature information retained by the signature retaining means matches the signature information in the encapsulated document.

Accordingly, the start program has the signature information retaining means for retaining the signature information, and the retained signature information and another signature information provided in the encapsulated document are compared with each other so as to eliminate display of the signature when both match with each other. Thus, time and effort of the user for checking the signature information can be omitted with respect to a kind of encapsulated document, which is previously determined as true.

16) The encapsulated document structure may further comprise: a start program file storing a start program that is interpreted and executed by the computer; and an installation program file storing an installation program that installs the start program in the computer when a file identifier of the encapsulated document file is changed.

Accordingly, the start program can be easily installed in the computer since the start program for starting the encapsulated document is provided in the encapsulated document itself and also the installation program for installing the start program in the computer is provided in the encapsulated document when a file identifier of the extension of the encapsulated document is changed.

17) The encapsulated document structure may further comprise signature determining means for determining whether the signature information in the encapsulated document is true or false, wherein, when the signature information is false, an unfair act process for performing a predetermined operation to avoid a problem caused by an unfair act performed with respect to the encapsulated document.

Accordingly, an unfair act process such as an issue of warning or a deletion of a file can be appropriately performed by determining by the start program as to whether the signature information in the encapsulated document if true or false.

18) In the encapsulated document structure, the start program may display the signature information of the operating program to be started or the encapsulated document so as to cause a user to check the start.

Accordingly, the start program can display the signature information on the operating program to start or the encapsulated document so as to request the user to check the start, and, thereby, the use can recognize a false file beforehand and prevent the operating program from being unnecessarily started.

19) In the encapsulated document structure, the start program file may include signature retaining means for retaining signature information, and the start program compare the signature information retained by the signature retaining means with the signature information in the encapsulated document so as to eliminate a signature display to the user when the signature information retained by the signature retaining means matches the signature information in the encapsulated document.

Accordingly, the start program has the signature information retaining means for retaining the signature information, and the retained signature information and another signature information provided in the encapsulated document are compared with each other so as to eliminate display of the signature when both match with each other. Thus, time and effort of the user for checking the signature information can be omitted with respect to a kind of encapsulated document, which is previously determined as true.

20) The encapsulated document structure may further comprise encapsulating means for encapsulating the document information file and the operating program file into a single file, wherein the operating program is started by an external start program and is limited in operation rights thereof.

Accordingly, since the operating program file, which materializes the document information file, is encapsulated into a single file together with the document information file concerned, the document is accessible under a computer environment different from a computer environment of the document producer. Additionally, since a limitation by a security function is imposed onto the operating program so that the operating program is restricted in its operation rights and is started by an external start program, the encapsulated document can be started in safe.

21) In the above-mentioned encapsulated document structure, the single file may be signed and encrypted. Accordingly, a tamper or alteration of the document can be prevented.

22) In the encapsulated document structure, the operating program may be limited in operation rights thereof based on signature information regarding the operating program. Accordingly, an appropriate restriction in the operation rights can be applied since the restriction in the operation rights of the operating program is based on the signature information on the operating program.

23) In the encapsulated document structure, an input and output of the operating program started by the start program may be performed through an input and output library provided in the operating program.

Accordingly, the limitation in the operation rights of the operating program can be easily imposed by performing an input and output of the operating program started by the start program through the input and output library in the start program.

24) In the encapsulated document structure, the encapsulated document may include signature information, and the operating program may start the operating program in accordance with the signature information.

Accordingly, the encapsulated document has the signature information, and the start program starts the operating program in accordance with the signature information, and, thereby, the document can be prevented from being falsely started.

25) In the encapsulated document structure, the contents information file may includes: at least one contents file that serves as a substance of expression on a document; and a document structure file specifying a structure of the contents file and a display status on the document. Accordingly, a multimedia document, which can be easily edited, is achieved with a simple structure.

26) The encapsulated document structure according to the present invention may further comprise an icon file regarding an icon displayed on a display of the computer in accordance with substantive data of the document, wherein a selective designation of the icon is determined as an accessing operation to the document by the computer.

Accordingly, an access to the document, of which security is maintained, can be performed by merely designating the icon, and, thereby, the operating program file is interpreted and executed by the computer by being started by the start program in response to the designation of the icon. Thus, the contents files can be displayed on the display of the computer in accordance with a display state specified by the display information file.

27) The encapsulated document structure may further comprise a library file storing the contents file with an index indicating a storing location thereof, wherein the operating program file specifies the contents file according to the index.

Accordingly, the contents files can be specified by the index provided in the library file with respect to the encapsulated document having a maintained security.

28) The encapsulated document structure may further comprise a library file storing the contents file provided with a specific header, wherein the operating program file specifies the contents file according to the header.

Accordingly, the contents files can be specified by the header of the contents file with respect to the encapsulated document having a maintained security.

29) In the encapsulated document, the document contents file may be described by a general-purpose data description language.

Accordingly, the location information of the contents file can be produced in a general purpose manner with respect to the encapsulated document having a maintained security, thereby improving compatibility with various changes such as variation in the file format.

30) In the encapsulated document structure, the data description language may use a tag to describe a structure of the contents file and an element specifying the display status on the document.

Accordingly, the structure of the contents file and the display status of the contents file on the document can be described in the tag with respect to the encapsulated document having a maintained security. Thereby, the display information file is structured and can be easily restructured.

31) In the encapsulated document structure, the operating program file may be provided in accordance with a file format specified by the contents file described using the tag.

Accordingly, the file format of the display information file can be specified by the tag with respect to the encapsulated document having a maintained security. Thereby, the display information file is structured and can be easily restructured.

32) In the encapsulated document structure, the operating program file may be provided with a part as minimum unit necessary for processing the contents file.

Accordingly, a volume required for the operating program file can be reduced with respect to the encapsulated document having a maintained security.

33) The encapsulated document structure according to the present invention may further comprise: a file of a digital information display program for causing the contents file accessible on a display of the computer; and a file of a functional operation program for performing a specific function without referring to digital information of the contents file.

Accordingly, a specific function can be performed by the functional operation program file with respect to the encapsulated document having a maintained security, which enables more variety of expressions of information.

34) In the encapsulated document structure, the digital information display program has a function to display a file specifying panel for displaying file specifying information that specifies the contents file in a selectable state, and a function to causing the contents file, which corresponds to a case where the file specifying information is selected, accessible on the display of the computer.

Accordingly, if the file specifying information displayed on the file specifying panel is selected with respect to the encapsulated document having a maintained security, the contents file specified by the file specifying information is selected and accessible on the display of the file information.

35) In the encapsulated document structure, the functional operation program may have a function to display a function panel for function specifying information that specifies a predetermined function in a selectable state, and a function to perform the predetermined function that corresponds to a case where the function specifying information is selected.

Accordingly, a fact that a specific function is contained in the document can be indicated by the display of the functional panel with respect to the encapsulated document having a maintained security. Thus, when the function specifying information is selected by an operation on the functional panel, the function specified by the function specifying information is performed.

36) In the encapsulated document structure, the digital information display program may have a scaling function to enlarge or reduce a displayed image based on the contents file.

Accordingly, it becomes possible to enlarge or reduce the displayed image base on the contents file with respect to the encapsulated document having a maintained security.

37) In the encapsulated document structure, the digital information display program may have a view changing function to change a viewpoint when a displayed image based on the contents file is a three-dimensional image.

Accordingly, it becomes possible to change the view point of the three-dimensional image which is a displayed image based on the contents file with respect to the encapsulated document having a maintained security.

38) In the encapsulated document structure, the digital information display program has a function, when a displayed image based on the contents file is a dynamic image, to display a static image extracted from the dynamic in the document in a selectable state, and a function to reproduce the dynamic image when the static image is selected.

Accordingly, a dynamic image, which is a displayed image based on the contents file, can be displayed as a static image with respect the encapsulated document having a maintained security, and the original dynamic image can be reproduced by selecting the static image.

39) In the encapsulated document structure, the digital information display program may have a function to display, when the contents file includes audio information, a reproduction panel for causing the audio information designatable, and a function to reproduce the audio information when a reproduction of the audio information is designated through the reproduction panel.

Accordingly, the audio information contained in the contents file can be reproduced in accordance with the operation on the reproduction panel with respect to the encapsulated document having a maintained security.

40) In the encapsulated document structure, the digital information display program may have a function to display, when a reproduction of the audio information is designated through the reproduction panel, text information corresponding to the audio information.

Accordingly, the text information corresponding to the audio information can be displayed in response to the reproduction of the audio information contained in the contents file with respect to the encapsulated document having a maintained security.

41) An encapsulated document producing and editing apparatus comprising: decryption key information provided beforehand; an operating program file that is decrypted from the decryption key information; and encapsulated document producing and-editing means having user interface means for producing and editing a document information file in accordance with a user operation and encapsulating means for encapsulating the produced document information file, the decryption key information and the operating program file into a single file. Accordingly, the above-mentioned encapsulating document having a high security can be easily provided.

42) An encapsulated document producing and editing apparatus comprising: an operating program file provided beforehand; encapsulated document producing and editing means having user interface means for producing and editing a document information file in accordance with a user operation and encapsulating means for encapsulating the produced document information file and the operating program file into a single file; and decryption means for decrypting the encapsulated single file. Accordingly, the above-mentioned encapsulating document having a high security can be easily provided.

43) An encapsulated document producing and editing apparatus comprising: encapsulated document producing and editing means having user interface means for producing and editing a document information file in accordance with a user operation; an operating program file provided beforehand; and decryption means for decrypting the produced document information file and the operating program file, wherein the encapsulated document producing and editing means has encapsulating means for encapsulating the encrypted document information file and the operating program file into a single file. Accordingly, the above-mentioned encapsulating document having a high security can be easily provided.

44) A start program for starting an operating program file provided in an encapsulated document comprising: decryption key information for decrypting encrypted digital information; the operating program file that is decrypted in accordance with the decryption key information; document information file that is materialized on a computer by the decrypted operating program; and encapsulating means for encapsulating the decryption key information, the operating program file and the document information file into a single file, the start program comprising: reading means for reading the encrypted decryption key information and the operating program file from the encapsulated document file; decryption means for decrypting the decryption key information using a public key provided by a third party authentication authority, and decrypting the operating program using the decrypted decryption key information; and operating program starting means for starting the decrypted operating program.

Accordingly, the encapsulated document having a security function can be reproduced with a high security by merely starting the start program.

45) The above-mentioned start program may further comprise public key information provided by the third party authentication authority. Accordingly, since the start program has the public key information by the third party authentication authority, the encapsulated document can be reproduced with a high security by merely starting the start program.

46) The above-mentioned start program may further comprise signature determining means for determining whether signature information in the encapsulated document is true or false so as to perform a process for preventing a problem caused by an unfair act that has been applied on the encapsulated document file.

Accordingly, the start program itself has the signature determining means for determining whether the signature information in the encapsulated document is true or false, and an unfair act process such as an issue of warning or a deletion of a file can be appropriately performed when the signature information is determined as false.

47) The above-mentioned start program may further comprise means for displaying the signature information of the operating program or the encapsulated document to be started on a display of a computer so as to request a user to check a start of the operating program.

Accordingly, the start program can display the signature information on the operating program to start or the encapsulated document so as to request the user to check the start, and, thereby, the use can recognize a false file beforehand and prevent the operating program from being unnecessarily started.

48) The above-mentioned start program may further comprise signature information retaining means for retaining signature information so as to compare the signature information retained by the signature information retaining means with signature information provided in the encapsulated document so that a display of signature is omitted when the signature information retained by the signature information retaining means matches the signature information provided in the encapsulated document.

Accordingly, the start program has the signature information retaining means for retaining the signature information, and the retained signature information and another signature information provided in the encapsulated document are compared with each other so as to eliminate display of the signature when both match with each other. Thus, time and effort of the user for checking the signature information can be omitted with respect to a kind of encapsulated document, which is previously determined as true.

A description will now be given of another mode of carrying out the present invention.

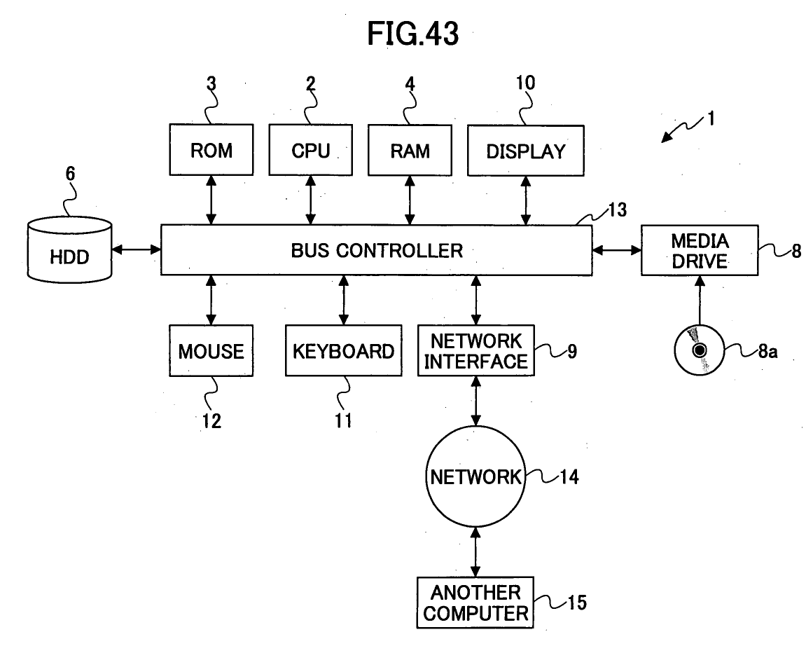

The present invention relates to a data structure of a document (an encapsulated document structure) operated in various information processing apparatuses such as a personal computer as a typical example. Thus, a description will be given first, with reference to FIG. 43, of a personal computer which can operates the encapsulated document according to the present invention. It should be noted that the personal computer shown in FIG. 43 has basically the same structure as the personal computer 1 shown in FIG. 1, and parts that are the same as the parts shown in FIG. 1 are given the same reference numerals.

FIG. 43 is a block diagram of the personal computer 1 which operates the encapsulated document according to the present invention. The personal computer 1 (hereinafter, may be referred to as a computer) comprises: a CPU (Central Processing Unit) 2 which is an information-processing part fro processing information; a ROM (Read Only Memory) 3 which stores programs including a BIOS (Basic Input Output System); a RAM (random Access Memory) 4 which is a primary memory device for temporarily storing information during processing; an HDD (Hard Disk Drive) 6 which is a secondary memory device for storing application programs and results of processing; a medium drive 8 of a removable medium 8a such as a CD-ROM as a recording medium for storing information or acquiring information (such as an encapsulated document according to the present invention) from outside; a network interface 9 connected to a network 14 for communicating with another computer 15 connected to the network 1; a display 10 for displaying information regarding operations and results of operations; a keyboard 11 and a mouse 12 for inputting instructions and information to the computer 1. The aforementioned parts communicate with each other by being arbitrated by a bus controller 13.

It should be noted that the removable medium 6 can be a magnetically recordable medium such as a flexible disk, a hard disk or a magnetic tape, a magneto-optically recordable medium such as MO, an optically recordable medium such as CD, CD-ROM, CD-R, CD-RW, DVD-ROM, DVD-R, DVD-RAM, DVD−RW or DVD+RW and a semiconductor memory.

When transmitting data to another computer 15, the data is supplied to the network interface 9 of the computer 1, and, then, the network interface 9 sends the data to another computer 15 through the network 14. Data received by the network interface 9 is determined by the network interface 9 as to whether or not it is necessary for the computer 1. If the received data is necessary for the computer 1, the data is taken by the computer 1, but if the data is not necessary, the data is discarded. Thus, data exchange of all data is performed through the network interface.

Generally, when the computer 1 is turned on, the CPU2 starts a program referred to as a loader contained in the BIOS stored in the ROM 3 so as to read an operating system (OS) from the HDD 5 and store the OS in the RAM 4. After the OS is started, the OS supports a start of an application program, reading of information, saving of information, etc., in accordance with an operation made by a user. As a typical OS, Windows (trademark of Microsoft Corporation), UNIX (trademark of X/Open, Inc.), etc., are known. A program that runs on the OS is referred to as an application program. A user normally operates to start an application program which the user desires, and operates digital information recorded in a memory device in a unit of file so as to edit, save and delete the information as required. That is, when a user performs various kinds of operations to a computer, all of application programs or data are treated in the unit of “file”, and the filed are stored in the memory device.

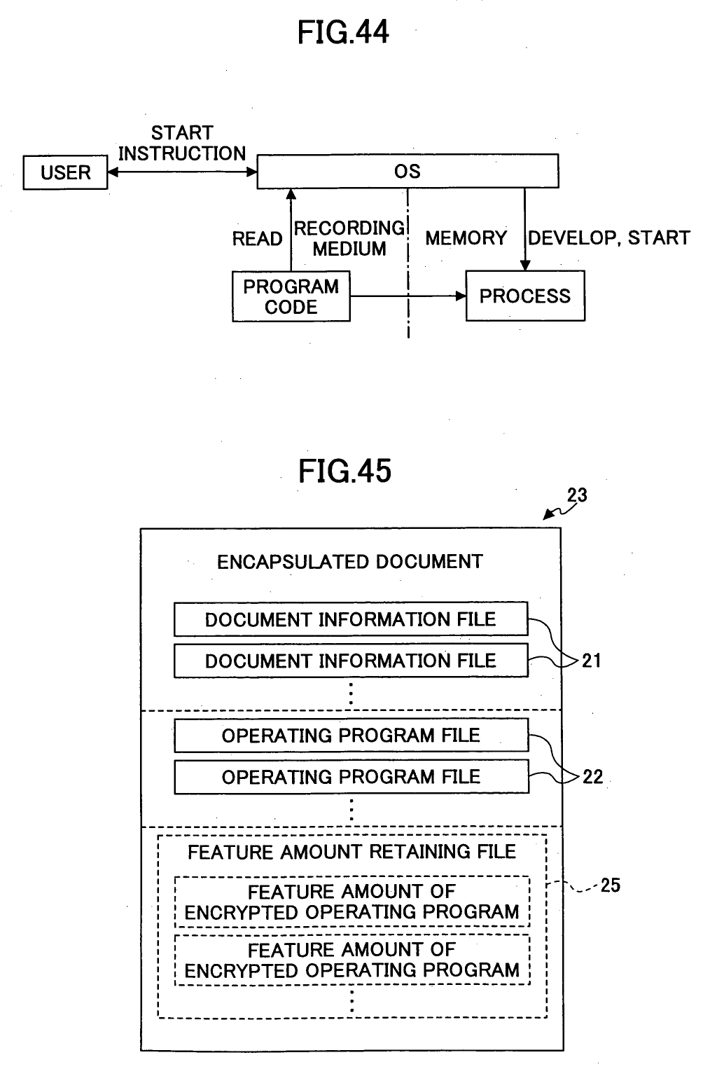

Next, a description will be given, with reference to FIG. 44, of a where the OS starts an application program stored in a memory medium of a secondary memory device in accordance with an instruction of a user. If a user send an instruction to the OS to start a specific program, the OS reads the program cord from the memory medium using the hardware of the memory device, and develops the program code on the RAM 4, which is a primary memory device (memory) of the computer 1 so that the CPU 2 executes the program by referring to the specific address developed. Usually, such a program independently executed is referred to as a “process” or a “task” so as to distinguish from a “program code” stored in a memory medium.

At present, many operating systems generally have a multi-task function to run a plurality of processes or tasks simultaneously. Moreover, the present operating systems assigns a memory individually to each of the processes so as to run the plurality of processes simultaneously.

Moreover, a meta-file, which is a virtual file, is formed on a memory for communications between the processes to exchange data, and transmission and reception of information are performed through file access.

Next, a description will be given, with reference to FIG. 45, of an outline of a data structure of a document (encapsulated document) according to the present invention. The encapsulated document file 23 is stored in the HDD5 of the computer 1. The encapsulated document file 23 of the present embodiment is produced by encapsulating document information files 21, operating program files 22 and feature amount retaining files 25 into a single file. The document information files 21 contain various contents, which are substances of expression in a document, and a document structure. The operating program files 22 are programs for realizing the contents of the document information files 21. Such information has a structure of a unit of file so that the information can be managed by a general computer 1. More specifically, the contents information of the document information file 21 can be a static image file, a dynamic image file, a sound file or a text file that have file formats which the computer 1 can handle and operate.

Moreover, the encapsulating means uses a known multi-file compression method such as ZIP or LHA so as to automatically decode a file, which has been encoded with the multi-file compression format, when displaying the document information file 21. Moreover, the operating program of the operating program file 22 is preferably described in an intermediate language code. If the operating program is described in the intermediate language, the type dependency of the computer can be eliminated if a compiler or an interpreter program, which can interpret and execute the intermediate language, is installed in the computer. JAVA (trademark of Sun Microsystems) language is such an intermediate language.

Further, as shown in FIG. 45, an encrypted information regarding a feature amount of each operating program file 22 is stored in the feature amount retaining file 25.

That is, the encapsulated document file 23 according to the present embodiment differs from a conventional technique in that the feature amount retaining file 25, in which the feature amount of each operating program file 22 is stored by being encrypted, is retained in the encapsulated document file 23.

Therefore, since the operating program file 22, which materializes the substance of expression of the document information file 21, is encapsulated together with the document information file 21 concerned, it becomes possible to access the document concerned even in an environment different from that of a computer of a document producer. Under such circumstances, it becomes possible to check a tamper or alteration of the operating program file 22 during a distribution of the encapsulated document file 23 by decrypting the encrypted feature amount of the operating program file 22 retained in the feature amount retaining file 25 and computing the feature amount of the distributed operating program file 22 so as to compare the decrypted feature amount and the computed feature amount. Thus, a malicious program is prevented from being mixed into the encapsulated document, which permits a user to safely access the distributed document.

Next, a description will be given of an important feature of the computer 1.

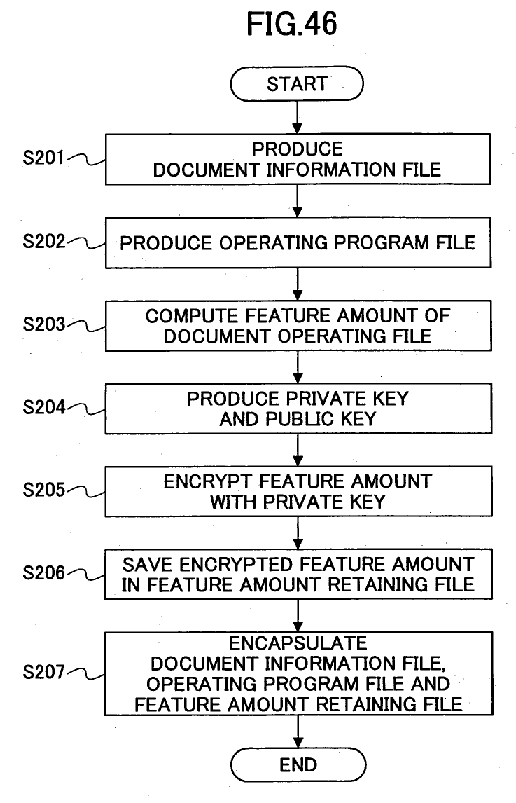

The computer 1 serves as an encapsulated document producing apparatus that performs an encapsulated document producing process to produce the encapsulated document file 23 due to the CUP 2 incorporated therein executing an application program that runs on the operating system. FIG. 46 is a flowchart which shows a flow of the encapsulated document producing process realized by the CPU 2 following the application program that runs on the operating system.

As shown in FIG. 46, first, the document information file 21, which is the contents to be a substance of expression on a document, is produced in response to a user operation (step S201: document information file acquisition means). Such a creation of the document information file 21 is realizable by general word-processing software. Then, the operating program file 21, which materializes (display, operate, access, etc.) the contents of the document information file 21, is produced (step S202: operating program file acquisition means).

In the subsequent step S203, a feature amount of the operating program file 22 produced in step S202 is computed. The function of feature computation means is performed in step S203. One example of achieving the feature amount of the operating program file 22 is an electronic fingerprint applied to the operating program file 22. SHA1 (Secure-Hash-Algorithm) is used as a computation method of such a feature amount. SHA1 compresses a data block of an arbitrary length corresponding to the operating program by a 20-byte sequence. Although, similar to actual fingerprints, the feature amounts of two different operating programs are expected to be always different from each other, it is possible that the same feature amount is computed for different operating programs since the kinds of values of the feature amount are finite. However, since the feature amount can be converted into an extremely large number such as 2,160 kinds, a probability that the same feature amount is derived from different operating program can be ignored probabilistically. As a fundamental characteristic of SHA1, there are two points, one is that the feature amount of the operating program is changed when the operating program is changed only by one bit and the other is that a falsified message having a feature amount the same as the original feature amount cannot be produced even if one attempts falsification. According to the above-mentioned features, it can be proved that an operating program and a feature amount of the operating program concerned becomes one-to-one relationship. As the computing method of a feature amount other than SHA1, MD5 invented by Mr. Ronald Rivest of Massachusetts Institute of Technology can be used. It should be noted that a method other than SHA1 and MD5 may be used for computing an feature amount of the operating program file 22. Additionally, as an example of a realizing means of the computation of a feature amount, a program contained in a security package of JAVA provided by Sun Microsystems can be used when the operating program is described in JAVA language.

Subsequently, a private key and a public key are produced (step S204), and the feature amount of the operation program file 22 is encrypted with the produced private key (step S205). RSA, DSA (Digital Signature Algorithm), etc., may be used for the encryption when using the private key. The encryption algorithm of RSA depends on the fact that it is difficult to perform factorization into prime factors for a large number, and it is generally known that a key having a factor of more than 2,000 bits is safe. Since RSA, DSA, etc., are provided by various companies, they can be used simply. It should be noted that, instead of producing the private key and the public key used for encryption, a private key and a public key previously stored in the computer of the document producer may be used.

That is, in the present embodiment, the feature amount of the operation program file 22 is encrypted by the public key encryption method. Thereby, if the private key, which is owned by the producer of the encapsulated document file 23 and is not open to public, is set as an encrypted key and if a public key, which is different from the private key, is open to accessing persons as a decryption key, only persons having the public key is capable of decrypting the feature amount of the operation program file 22.

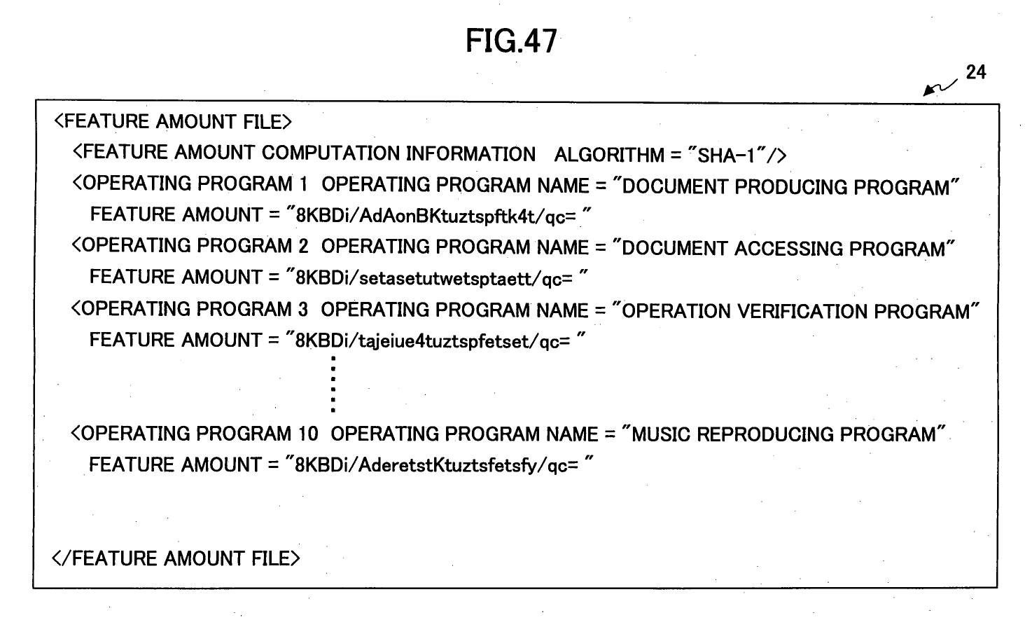

Then, after storing the feature amount of the operating program file 22 encrypted with the private key in the feature amount retaining file 25 (step S206), the encapsulated document file 23 is produced as a single document by encapsulating the encapsulating means the document information file 21, the operating program file 22 and feature amount retaining file 25 (step S207). It should be noted that when storing the encrypted feature amount of the operating program file 22 in the feature amount retaining file 25, the operating program file 22 and the encrypted feature amount of the operating program file 22 should be related to each other. FIG. 47 shows an example in which the operating program file 22 and the encrypted feature amount of the operating program file 22 are described by XML by being related to each other. As shown in FIG. 47, the encrypted feature amount of the operating program file is stored, as attribute information in the operation program tag, in the feature amount retaining file 25. Moreover, as shown in FIG. 47, an algorithm used by the document producer for computing a feature amount when computing the feature amount of the operating program file 22 is described in an algorithm, which is attribute information in the feature amount tag of the feature amount retaining file 25.

The thus-produced encapsulated document file 23 is sent and distributed to a predetermined computer 1 together with the public key making a pair with the private key used for encrypting the feature amount of the operating program file 22.

The computer 1 serves as a tamper verification apparatus, which performs a tamper verification process for the operating program file 22, by the CPU 2 operating in accordance with an encapsulated document start program (hereinafter, referred to as a start program) to which the Shell program in the operating system is related. Hereinafter, a description will be given on the assumption that the encapsulated document file 23, as shown in FIG. 45 is distributed together with the public key from another computer 15.

The start program starts when an accesser selects the encapsulated document file 23 using the inputting device such as the keyboard 11 or the mouse 12 and when the Shell program in the operating system determines that the encapsulated document file 23 is selected based on an extension, etc. The start program reads the selected encapsulated document file 23, and carries out the tamper verification process on the operating program file 22 in the encapsulated document file 23.

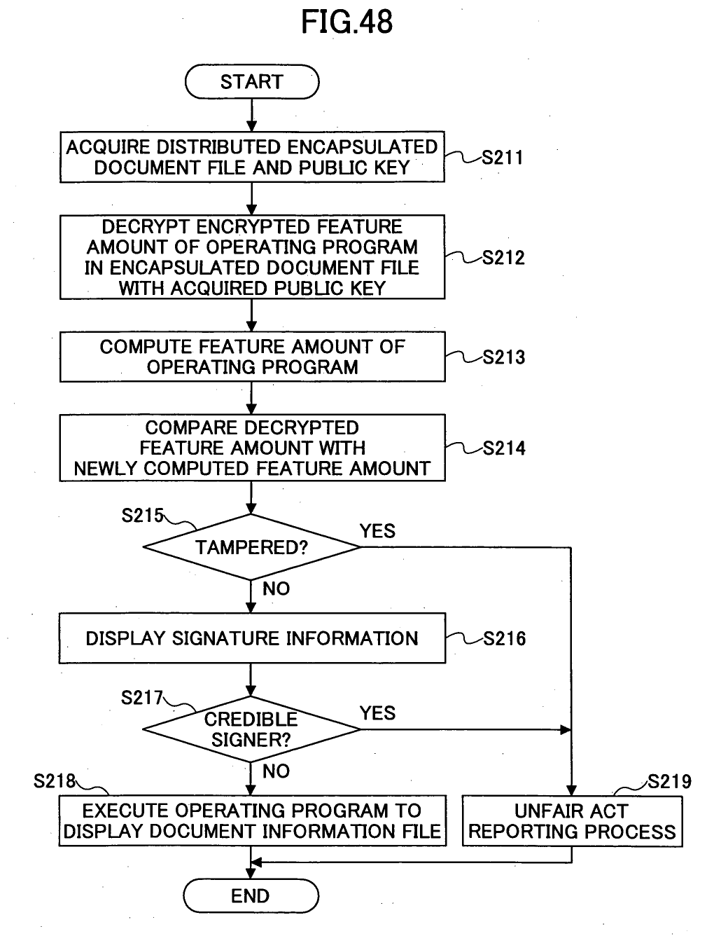

FIG. 48 is a flowchart showing a flow of the tamper verification process performed by the start program. As shown in FIG. 48, first the distributed encapsulated document file 23 and public key are acquired and decompressed (step S211: reading means), and the encrypted feature amount of the operating program file 22, which exists in the encapsulated document file 23, is decrypted using the acquired public key (step S212: decryption means).

Subsequently, the feature amount of the operating program file 22 in the encapsulated document file 23 acquired in step S211 is computed (step S213: feature amount computing means). Similar to the process in the encapsulated document producing apparatus, the computation of the feature amount of the operating program file 22 may be performed using the technique of SHA1 or MD5, or using the program in the security package of JAVA. Basically, it is necessary to match the feature amount computation algorithms of the document produce and the accesser with each other. As mentioned above, the feature amount computation algorithm which the document producer used when computing the feature amount of the operating program file 22 is described in the algorithm stored as attribute information in the feature amount computation information tag of the feature amount retaining file 25 (refer to FIG. 47). Thus, the feature amount of the operating program file 22 can be computed based on the feature amount computation algorithm information. It should be noted that if the feature amount computation algorithms of the document producer side and the accesser side match with each other, there is no need to compute the feature amount of the operating program file 22 using the same feature amount computation algorithm.

Subsequently, proceeding to step S214, the decrypted value of the encrypted feature amount of the operating program file 22 in the distributed encapsulated document file 23 is compared with the value of the computed feature amount of the operating program file 22 on the accesser side so as to perform the tamper verification process on the operating program file 22. Thus, the function of the tamper verification execution means is achieved. If there is no tamper found in the operating program file 22 of the encapsulated document file 23 by computing the feature amount of the same operating program file 22 using the same feature amount computation algorithm, the decrypted value of the encrypted feature amount of the operating program file 22 in the distributed encapsulated document file 23 is equal to the value of the computed feature amount of the operating program file 22 on the accesser side. Therefore, it can be checked whether or not the operating program file 22 was tampered or altered by comparing the two feature amounts.

That is, the function of the tamper verification means is performed in steps S212-S214.

If the two feature amounts are equal to each other, that is, if it is determined that the operating program file 22 is not tampered or altered (N of step S215) as a result of the tamer verification on the operating program file 22, the signature information described in the operating program file 22 is displayed on the display 10 (step S216) so as to let the accesser to judge whether the displayed signer is credible.

If an input is made by the accesser through the inputting device such as the keyboard 11 or the mouse 12 that the signer is credible (Y of step S217), the operating program of the operating program file 22 is executed so as to display the document information file 21 contained in the encapsulated document file 23 on the display 10 (step S218).

On the other hand, if it is determined that the two feature amounts are not equal to each other as a result of execution of the tamper verification on the operating program file 22, that is, if the operating program file 22 has been tampered or altered (Y of step S215), and if an input is made by the accesser through the inputting device such as the keyboard 11 or the mouse 12 that the signer is not credible (N of step S217), the operating program of the operating program file 22 is not executed and an unfair act reporting process is performed to report that the operating program is an unfair program file (step S219). As for the unfair act reporting process, it is considered that a dialog box is displayed on the display 10 that indicates the fact that the operating program file 22 in the encapsulated document file 23 was tampered or altered during the distribution. Moreover, in addition to the display of an unfair program file, a request is made to the user to determine whether to delete the operating program file 22 of the encapsulated document file 23.

Although the feature amount information is generated usually with an information amount of 20 bytes, the information amount may be changed according to a level of risk of the operating program file 22 to which the tamper verification is applied. Although a smaller information amount of the feature amount information of the operating program file 22 to which the tamper verification is applied achieves the tamper verification of the operating program at a higher speed, if the information amount of the feature amount information is too small, the variation in the feature amount becomes small, which increases a risk of tamper. Therefore, the operating program file 22 having a low risk may be computed to become a small information amount, and the operating program file 22 having a high risk may be computed to become a large information amount. Under that circumstances, in order to notify the accesser of how much the tamper verification of the operating program file 22 safely functions, it is necessary to display a size of the information amount of the feature amount information used for the tamper verification. Then, the value obtained by decrypting the encrypted feature amount of the operating program file 22 retained in the feature amount retaining file 25 or the value obtained on the accesser side by computation of the feature amount of the operating program file 22 may be displayed on the display 10. Thus, by incorporating the feature amount information display program file for displaying the feature amount information on the display 10 of the computer 1 on the accesser side into the encapsulated document file 23, the encapsulated document file, which can notifies the accesser of the safety of the tamper verification function, can be provided.

Thus, according to this embodiment provided with the encapsulated document producing apparatus and the tamper verification apparatus, the verification of a tamper of the operating program file 22 during distribution can be performed by merely encrypting the feature amount of the operating program file 22 which is data as small as about 20 bytes, without encrypting the entire operating program file 22. Thus, the encapsulated document file 23 can perform a tamper verification of the operating program file 22 in the encapsulated document file at a high speed, thereby providing a useful encapsulated document.

It should be noted that the start program is not limited to one, which is started by the Shell program in the operating system, and the Shell program itself may have such as function.

Additionally, a plurality of private keys for encrypting the operating program file 22 may be prepared so as to change the public key for encryption in accordance with the operation rights of the operating program file 22. It is considered that the risk of the operating program file 22 changes depending on the contents of execution of the operating program. For example, there is little risk if the operating program file 22 merely displays the document information file 21, but the risk of the operating program file 22 increases when the operating program file 22 adds a function to edit the document information file 21. Then, it becomes possible not to execute the operating program file 22 having a high risk by previously setting operation limiting information, which limits the process of the operating program file 22, so as to change the public key for decryption in accordance with the operation limiting information.

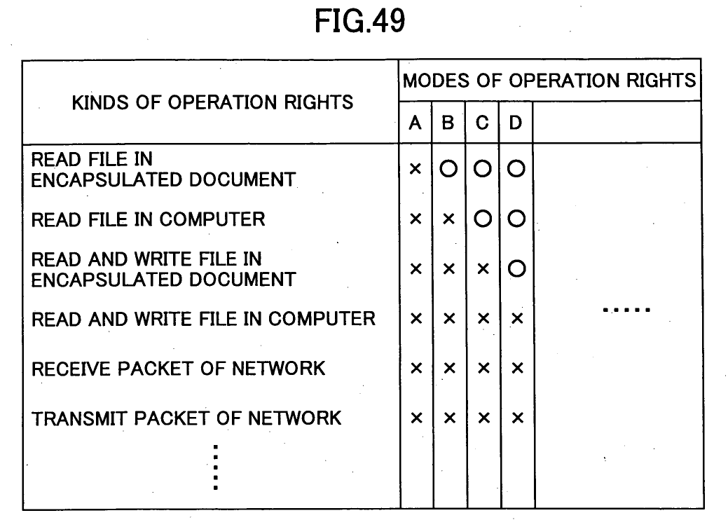

More specifically, as shown in FIG. 49, the public key for decryption is prepared in accordance with the modes of operating rights such as permission (indicated by ∘) and non-permission (indicated by X) of reading and writing of files, transmission and reception through a network, etc., and the operation rights information needed when executing the operating program file 22 is displayed to the accesser through the display 10 so as to obtain a permission from the accesser to start the operating program file 22 within the mode of the operation rights. For example, if the operation rights mode B shown in FIG. 49 is selected, only a program for reading files in the encapsulated document file 23 is executed. Similarly, if the operation rights mode C shown in FIG. 49 is selected, only a program for reading files in the encapsulated document file 23 and a program for reading files in the computer 1 are executed.

It should be noted that the method of limiting the operation rights of the operating program is not limited to the above-mentioned method. For example, if an intermediate code is used for the operating program, an interpreter is needed for interpreting and executing the operating program, and, thus, the operation rights can be easily limited since the input and output operation of the computer is performed through the interpreter. Moreover, if the operating program is described by a native code, an execution code can be detected prior to the execution of the operating program so as to prohibit an operation other than the permitted operation rights. Moreover, the above-mentioned limiting function of operation rights is provided in a standard operating system, and such a function of the operating system may be used.

As mentioned above, the encapsulated document file 23, which executes the operating program file 22 in accordance with the operation limiting information on the accesser side, can be provided.

Moreover, an operation rights information notification program may be added as one of the operating program files 23 so as to notify the document producer of the operation rights information on the acesser side. The operation rights information notification program displays a dialog box on the display 10 of the computer 1 on the accesser side for determining whether to permit sending notification of the operation rights information to the document producer. If the accesser permits sending the notification of the operation rights information, the operation rights information notification program is executed so as to send the notification of operation rights information set in the computer 1 to the document producer. Upon reviewing the operation rights information notified by the accesser, if the document producer determines that the document information file 21 in the previously distributed encapsulated document file 23 is not displayed, the document producer may distribute again to the accesser the encapsulated document file 23 of which operating program file 22 is changed in accordance with the operation rights information on the accesser side.

Thereby, the encapsulated document file 23 which notify the document producer of that fact that the operating program file 22 of the encapsulated document file 23 is not started, when the operating program file 22 is limited by the operation rights information of the accesser side.

It should be noted that although, in the present embodiment, the tamper verification for the operating program file 22 is performed by comparing the decrypted one of the encrypted feature amount of the operating program file 22 with the computed one of the feature amount of the operating program file 22, the tamper verification for the operating program file 22 may be performed by comparing encrypted feature amount of the operating program file 22 with the decrypted one of the encrypted feature amount of the operating program file 22 that was computed on the accesser side.

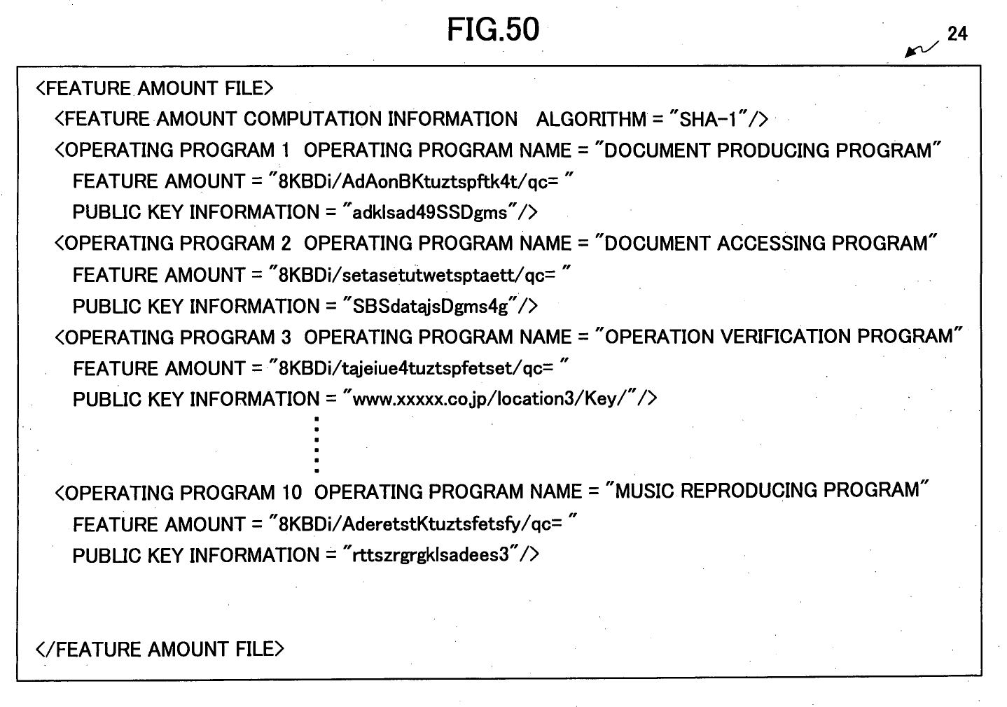

Although the encapsulated document file 23 is distributed with the public key in this embodiment, the public key may be encapsulated in the encapsulated document file 23 in a first variation. FIG. 50 shows an example of the feature amount retaining file 25 described by XML, in which the feature amount of the operating program file 22 encrypted with the private key is related to the public key information, which is information regarding the public key making a pair with the private key. As shown in FIG. 50, stored in the feature amount retaining file 25 as attribute information in the operation program tag are the feature amount of the operating program file 22 encrypted with the private key and the public key information, which is information regarding the public key making a pair with the private key.

It should be noted that the public key information of the feature amount retaining file 25 is not limited to the public key itself, and the public key information may be location information of the public key. For example, the location information may describe information regarding location (URL: Uniform Resource Locator) on the Internet where the public key is retained (the public key information of the “operating program 3” shown in FIG. 50). In this case, the computer 1 must be connected to the Internet. Moreover, the public key information exhibited on the Internet may be saved in the memory medium (RAM 4 or HDD 6) of the accesser's computer 1, when the accesser connects to the Internet. By doing in this way, when the public key information is not saved in the encapsulated document file 23, the public key information saved in the memory medium (RAM 4 or HDD 6) of the accesser's computer can be used instead.

By incorporating the public key (location information of the public key) into the encapsulated document file 23 and distributing the encapsulated document file 23 to the accesser, the accesser can perform the tamper verification of the operating program file 22 by merely acquiring the encapsulated document file 23 using the tamper verification apparatus.

As an example of the first variation of the above-mentioned embodiment, it is considered that a feature amount of the operating program file 22 produced by each vendor is encrypted with the private key and the public key information for decryption is saved in the feature amount retaining file 25. As shown in FIG. 50, for example, it is a case where the operating program 1 is produced by a vendor, A company, and the operating program 2 is produced by a vendor, B company. The above-mentioned situation happens when a plurality of operating program files are produced by a plurality of vendors so as to produce a large scale program since it is rare to produce all programs by one person and it is general to produce one program with cooperation of many persons. That is, it is expected that the operating program file 22 encapsulated into the encapsulated document file 23 is also produced by a plurality of vendors.

The accesser performs the tamper verification of the operating program file 22 using the public key information of each vendor saved in the feature amount retaining filed 25, and if there is no tamper or alteration found in the operating program file 22, the signature information of the vendor who produced the operating program file 22 is displayed and the program file 22 is executed.

As mentioned above, by relating different public key information to each operating program file 22, the encapsulated document file 23, which is capable of causing the operating program file 22 produced by each vendor to bear a responsibility, can be provided.

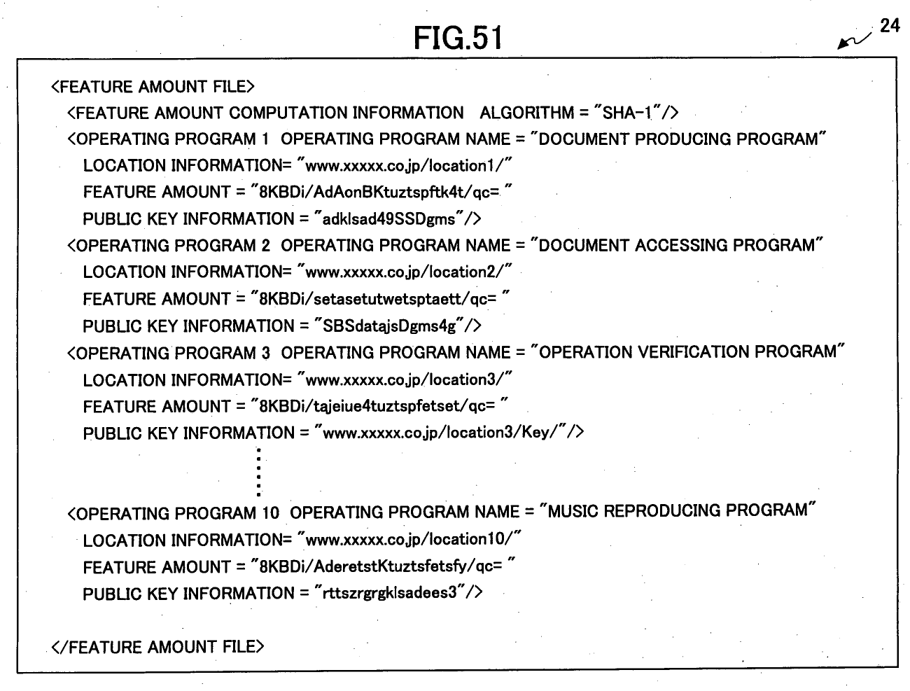

Although, in the present embodiment, the encapsulated document file 23, which is produced by encapsulating the document information file 21, the operating program file 22 and the feature amount retaining file 25 by using the encapsulation means as a single document, is distributed, the operating program file 22 is not always incorporated into the encapsulated document file 23 as a second variation. In such a case, it is necessary to take a device such as to add location information so that the operating program file and the encrypted feature amount of the operating program file are related to each other in the feature amount retaining file 25. FIG. 51 shows a file format of the feature amount retaining file 25 which stores the feature amount information of the operating program with the location information. As shown in FIG. 51, as the location information described as attribute information in the operating program tag, information regarding location on the Internet (URL: Uniform Resource Locator) may be described. In this case, the computer 1 must be connectable to the Internet. In the feature amount shown in FIG. 51, a result of encryption of the feature amount of the operating program file located at a location indicated by the location information described as attribute information in the operation program tag with the private key is described. Using the file format shown in FIG. 51, the tamper verification of the operating program file 22 can be performed even if the operating program file is not physically encapsulated into a single file.

Therefore, since the location information, which indicates the saved location of the operating program file 22 expressing and materializing the document information file 21, is encapsulated together with the document information file 21 concerned, it becomes possible to access the document concerned in an environment different from that of the computer of the document producer. Since the encrypted feature amount of the operating program 23 retained in the feature amount retaining file 24 is decrypted and also the feature amount of the operating program file 23 stored in the predetermined location is computed so as to compare the decrypted feature amount with the computed feature amount, the verification of a tamper of the operating program file 22 during distribution of the encapsulated document file 23 can be achieved, which prevents a malicious program from being mixed into the operating program. Thus, the accesser can access the document safely.

It should be noted that only a part of the operating program file may be encapsulated as the operating program file 22 together with the document information file 21 and the feature amount retaining file 25, and the remaining part of the operating program file 22 may be stored in a predetermined location on the Internet.

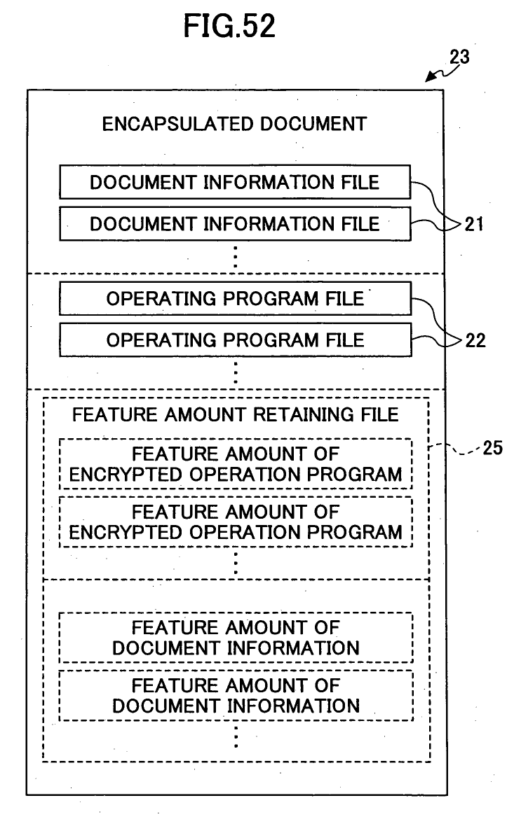

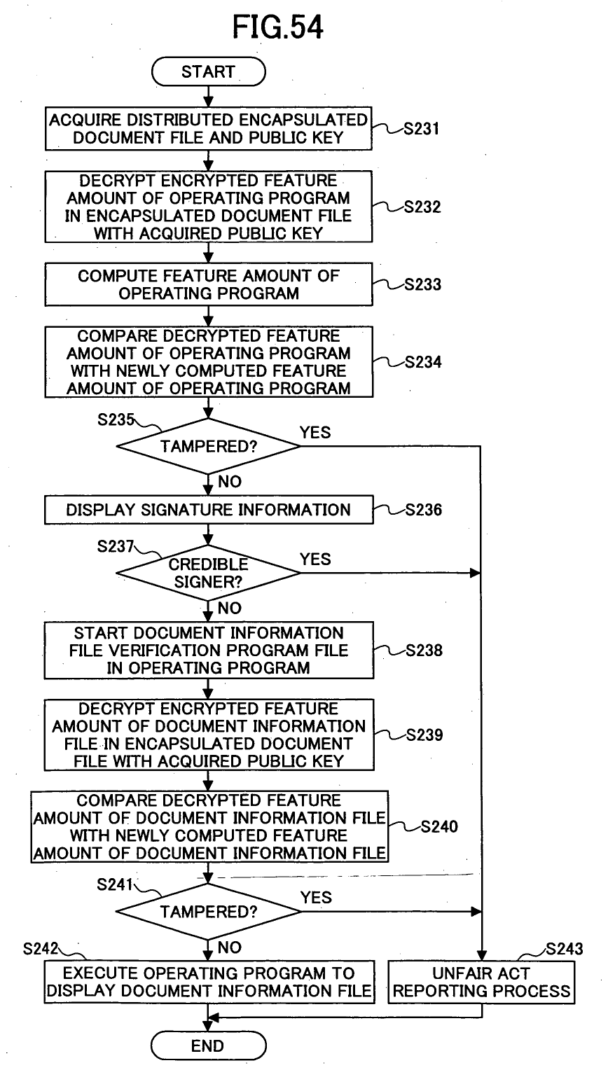

A description will now be given, with reference to FIG. 52 through FIG. 54, of another embodiment of the present invention. It should be noted that parts that are the same as the parts explained in the above-mentioned embodiments are given the same reference numerals, and descriptions thereof will be omitted.

First, a description will be given, with reference to FIG. 52, of an outline of a data structure of a document (encapsulated document structure). The encapsulated document file 23 according to the present embodiment is stored in the HDD 5 of the computer 1. The encapsulated document file 23 according to the present embodiment is produced by encapsulating by the encapsulating means the document information file 21, the operating program file 22 and the feature amount retaining file 25 into a single file. The document information files 22 contain various contents, which are substances of expression in a document, and a document structure. The program files 23 are programs for realizing the contents of the document information files 22. Such information has a structure of a unit of file so that the information can be managed by a general computer 1.

More specifically, the contents information of the document information file 21 can be a static image file, a dynamic image file, a sound file or a text file that have file formats which the computer 1 can handle and operate. Moreover, the encapsulating means uses a known multi-file compression method such as ZIP or LHA so as to automatically decode a file, which has been encoded with the multi-file compression format, when displaying the document information file 21. Moreover, the operating program of the operating program file 22 is preferably described in an intermediate language code. If the operating program is described in the intermediate language, the type dependency of the computer can be eliminated if a compiler or an interpreter program, which can interpret and execute the intermediate language, is installed in the computer. JAVA (trademark of Sun Microsystems) language is such an intermediate language.

Further, as shown in FIG. 52, an encrypted feature amount of each operating program file 22 and an encrypted feature amount of each document information file 21 are stored in the feature amount retaining file 25.

That is, the encapsulated document file 23 according to the present embodiment differs from a conventional technique in that the feature amount retaining file 25, in which the feature amount of each program file 22 and the feature amount of each document information file 21 are stored by being encrypted, is retained in the encapsulated document file 23.

Next, a description will be given of an important feature of the computer 1.

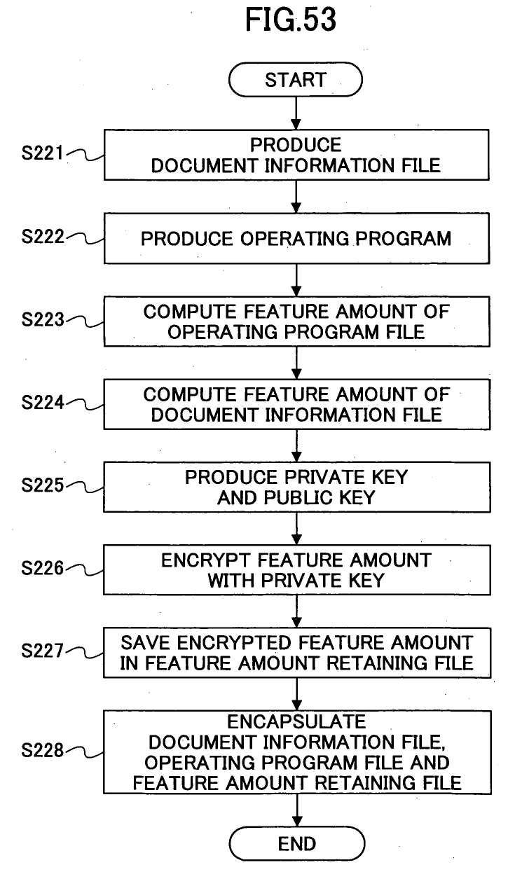

The computer 1 serves as an encapsulated document producing apparatus that performs an encapsulated document producing process to produce the encapsulated document file 23 due to the CUP 2 incorporated therein executing an application program that runs on the operating system. FIG. 53 is a flowchart which shows a flow of the encapsulated document producing process realized by the CPU 2 following the application program that runs on the operating system.

As shown in FIG. 53, first, the document information file 21, which is the contents to be a substance of expression on a document, is produced in response to a user operation (step S221: document information file acquisition means). Such a creation of the document information file 21 is realizable by general word-processing software. Then, the operating program file 22, which materializes (display, operate, access, etc.) the contents of the document information file 21, is produced (step S222: operating program file acquisition means).

In the subsequent step S223, a feature amount of the operating program file 22 produced in step S222 is computed. The function of feature computation means is performed in step S223. One example of achieving the feature amount of the operating program file 22 is an electronic fingerprint system applied to the operating program file 22. SHA1 (Secure-Hash-Algorithm) is used as a computation method of such a feature amount. SHA1 compresses a data block of an arbitrary length corresponding to the operating program by a 20-byte sequence. Although, similar to actual fingerprints, the feature amounts of two different operating programs are expected to be always different from each other, it is possible that the same feature amount is computed for different operating programs since the kinds of values of the feature amount are finite. However, since the feature amount can be converted into an extremely large number such as 2,160 kinds, a probability that the same feature amount is derived from different operating program can be ignored probabilistically. As a fundamental characteristic of SHA1, there are two points, one is that the feature amount of the operating program is changed when the operating program is changed only by one bit and the other is that a falsified message having a feature amount the same as the original feature amount cannot be produced even if one attempts falsification. According to the above-mentioned features, it can be proved that an operating program and a feature amount of the operating program concerned becomes one-to-one relationship. As the computing method of a feature amount other than SHA1, MD5 invented by Mr. Ronald Rivest of Massachusetts Institute of Technology can be used. It should be noted that a method other than SHA1 and MD5 may be used for computing an feature amount of the operating program file 22. Additionally, as an example of a realizing means of the computation of a feature amount, a program contained in a security package of JAVA provided by Sun Microsystems can be used when the operating program is described in JAVA language.

Additionally, a feature amount is computed with respect to the document information file 21 produced in step S221 (step S224: document information feature amount computing means). The feature amount of the document information file 21 can be computed in the same manner as the method of computing the feature amount of the operating program file 22.

Subsequently, a private key and a public key are produced (step S225), and the feature amount of the operation program file 22 and the feature amount of the document information file 21 are encrypted with the produced private key (step S226). RSA, DSA (Digital Signature Algorithm), etc., may be used for the encryption when using the private key. The encryption algorithm of RSA depends on the fact that it is difficult to perform factorization into prime factors for a large number, and it is generally known that a key having a factor of more than 2,000 bits is safe. Since RSA, DSA, etc., are provided by various companies, they can be used simply. It should be noted that, instead of producing the private key and the public key used for encryption, a private key and a public key previously stored in the computer of the document producer may be used. That is, in the present embodiment, the feature amount of the operating program file 22 and the feature amount of the document information file 21 are encrypted with the public key encryption system.

Then, after storing the feature amount of the operating program file 22 and the feature amount of the document information file 21 encrypted with the private key in the feature amount retaining file 25 (step S227), the encapsulated document file 23 is produced as a single document by encapsulating the encapsulating means the document information file 21, the operating program file 22 and feature amount retaining file 25 (step S228). It should be noted that when storing the encrypted feature amount of the operating program file 22 and encrypted feature amount of the document information file 21 in the feature amount retaining file 25, the operating program file 22 and the encrypted feature amount of the operating program file 22 and the document information file 21 and the encrypted feature amount of the document information file 21 should be related to each other.

The thus-produced encapsulated document file 23 is sent and distributed through the network 14 to a predetermined computer 1 together with the public key making a pair with the private key used for encrypting the feature amount of the operating program file 22.

The computer 1 serves as a tamper verification apparatus, which performs a tamper verification process for the operating program file 22, by the CPU 2 operating in accordance with the start program to which the Shell program in the operating system is related. Hereinafter, a description will be given on the assumption that the encapsulated document file 23 as shown in FIG. 52 is distributed together with the public key from another computer 15 (an encapsulated document producing apparatus).

The start program starts when an accesser selects the encapsulated document file 23 using the inputting device such as the keyboard 11 or the mouse 12 and when the Shell program in the operating system determines that the encapsulated document file 23 is selected based on an extension, etc. The start program reads the selected encapsulated document file 23, and carries out the tamper verification process on the operating program file 22 in the encapsulated document file 23.

FIG. 53 is a flowchart showing a flow of the tamper verification process performed by the start program. As shown in FIG. 53, first the distributed encapsulated document file 23 and public key are acquired and decompressed (step S231: reading means), and the encrypted feature amount of the operating program file 22, which exists in the encapsulated document file 23, is decrypted using the acquired public key (step S232: decryption means).

Subsequently, the feature amount of the operating program file 22 in the encapsulated document file 23 acquired in step S231 is computed (step S233: feature amount computing means). Similar to the process in the encapsulated document producing apparatus, the computation of the feature amount of the operating program file 22 may be performed using the technique of SHA1 or MD5, or using the program in the security package of JAVA. Basically, it is necessary to match the feature amount computation algorithms of the document produce and the accesser with each other. As mentioned above, the feature amount computation algorithm which the document producer used when computing the feature amount of the operating program file 22 is described in the algorithm stored as attribute information in the feature amount computation information tag of the feature amount retaining file 25 (refer to FIG. 47). Thus, the feature amount of the operating program file 22 can be computed based on the feature amount computation algorithm information. It should be noted that if the feature amount computation algorithms of the document producer side and the accesser side match with each other, there is no need to compute the feature amount of the operating program file 22 using the same feature amount computation algorithm.

Subsequently, proceeding to step S234, the decrypted value of the encrypted feature amount of the operating program file 22 in the distributed encapsulated document file 23 is compared with the value of the computed feature amount of the operating program file 22 on the accesser side so as to perform the tamper verification process on the operating program file 22. Thus, the function of the tamper verification execution means is achieved. If there is no tamper found in the operating program file 22 of the encapsulated document file 23 by computing the feature amount of the same operating program file 22 using the same feature amount computation algorithm, the decrypted value of the encrypted feature amount of the operating program file 22 in the distributed encapsulated document file 23 is equal to the value of the computed feature amount of the operating program file 22 on the accesser side. Therefore, it can be checked whether or not the operating program file 22 was tampered or altered by comparing the two feature amounts.

That is, the function of the tamper verification means is performed in steps S232-S234.

If the two feature amounts are equal to each other, that is, if it is determined that the operating program file 22 is not tampered or altered (N of step S235) as a result of the tamer verification on the operating program file 22, the signature information described in the operating program file 22 is displayed on the display 10 (step S236) so as to let the accesser to judge whether the displayed signer is credible.

If an input is made by the accesser through the inputting device such as the keyboard 11 or the mouse 12 that the signer is credible (Y of step S237), the operating program of the operating program file 22 is executed so as to display the document information file 21 contained in the encapsulated document file 23 on the display 10 (step S238).

A document information file verification program compares the encrypted feature amount of the document information file 21 with the acquired public key (step S239: decryption means), and compares the decrypted value of the feature amount of the document information file 21 with the computed value of the feature amount of the document information file 21 on the accesser side so as to perform the tamper verification of the document information file 21 (step S240). That is, the function of the tamper verification means is performed in steps S238-S240.

If the two values of the feature amount are equal to each other as a result of the tamper verification of the document information file 21, that is, if the document information file 21 is not tampered or altered (N of step S241), the operating program (document access program) of the operating program file 22 is started so as to display the document information file 21 on the display 10 (step S242).

On the other hand, if the operating program file 22 has been tampered or altered (Y of step S235), if an input is made by the acesser through the inputting device such as the keyboard 11 or the mouse 12 that the signer is not credible (N of step S237), or if the document information file 21 is tampered or altered (Y of step S241), an unfair act reporting process is performed to report that the operating program is an unfair program file (step S243). As for the unfair act reporting process, it is considered that a dialog box is displayed on the display 10 that indicates the fact that the operating program file 22 in the encapsulated document file 23 was tampered or altered during the distribution. Moreover, the document producer may be notified of the fact that the encapsulated document file 23 was tampered or altered, and a distribution of the new encapsulated document file 23 may be requested.

Thus, according to this embodiment provided with the encapsulated document producing apparatus and the tamper verification apparatus, the verification of a tamper of the operating program file 22 during distribution can be performed by merely encrypting the feature amount of the operating program file 22 and feature amount of the document information file 21 which are data as small as about 20 bytes, without encrypting the entire operating program file 22 and the entire document information file 21. Thus, with the encapsulated document file 23, a tamper verification of the operating program file 22 and the document information file 21 in the encapsulated document file 23 can be performed at a high speed, thereby providing a useful encapsulated document. That is, it becomes possible to perform a tamper verification of the document information file 21 as well as the tamper verification of the operating program file 22, which achieves further safe access to the document.

It should be noted that the start program is not limited to one, which is started by the Shell program in the operating system, and the Shell program itself may have such as function.

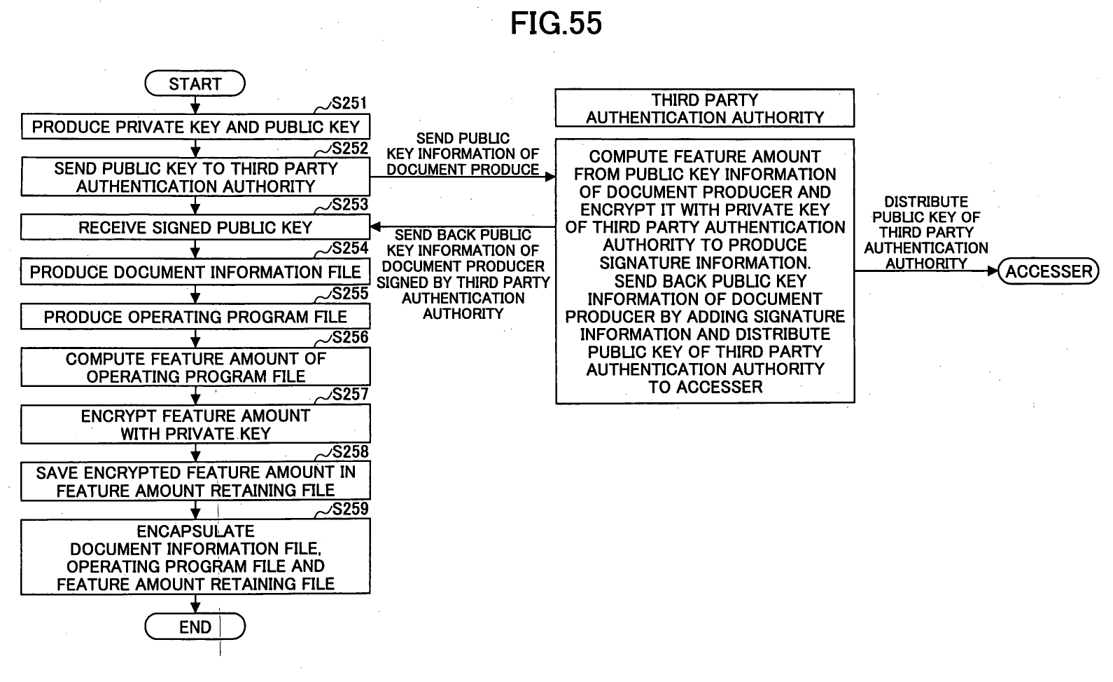

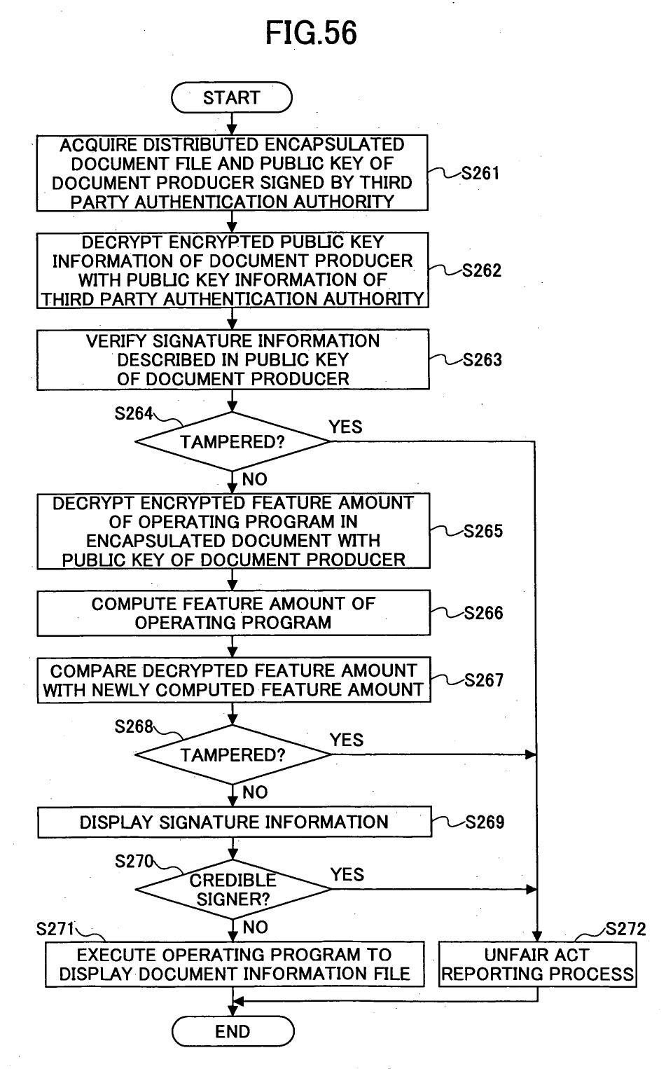

A description will now be give, with reference to FIG. 55 and FIG. 56, of another embodiment of the present invention. It should be noted that parts that are the same as the parts explained in the above-mentioned embodiments are given the same reference numerals, and descriptions thereof will be omitted.

According to the above-mentioned embodiments, a tamper verification can be performed for the operating program file 22 in the encapsulated document file 23. However, the determination as to whether the signature information provided in the operating program file 22 is credible is performed by an accesser. If the accesser knows the document producer, the accesser can determine whether there is a risk in the document producer described in the signature information, and, thus, the security of the encapsulated document file 23 is maintained. On the other hand, if the accesser does not know the document producer, the accesser cannot determine whether there is a risk in the document producer, and, thus, the security of the encapsulated document file 23 cannot be maintained. Thus, in this embodiment, the security of the encapsulated document file 23 is maintained even when the accesser does not know the document producer, by preparing a third party authentication authority who is credible for both the accesser and the document producer.

A description will now be given of a function performed by the computer 1 to achieve the present embodiment.

First, a description will be given of an encapsulated document producing process performed by the computer 1. The computer 1 serves as an encapsulated document producing apparatus, which performs an encapsulated document producing process for producing the encapsulated document file 23 by the CPU 2 executing the application program operated on the operating system. FIG. 55 is a flowchart which shows a flow of the encapsulated document producing process performed by the CPU 2 executing the application program that runs on the operating system of the computer 1.

As shown in FIG. 55, a private key and a public key of the document producer is produced first (step S251), and, then, identity information of the document producer is described in the public key information of the document producer and the public key information is sent to a third party authentication authority (step S252).

Here, the third party authentication authority is a neutral organization which checks the justification of the public key and issues a public key certificate. The third party authentication authority describes signature information in the public key information of the document producer so as to acquire the public key of the document producer and secure the identity information of the document producer. As for the signature method for a public information, there is a method in which a feature amount is computed from the acquired public key information of the document producer so as to encrypt the feature amount with a private key of a third party authentication authority. However any signature method can be used as long as the signature method can prove credibility of the signature method.

Moreover, the third party authentication authority sends back to the document producer the public key information provided with signature by private key information of the third party authentication authority, and distributes the public key information of the third party authentication authority to the accesser through a safe communication channel. The safe communication channel is a channel which is safeguarded so that the public key is prevented from being tampered or altered during a distribution from a third party authentication authority to an accesser. As a mode of distribution of the public key information of the third party authentication authority, the public key information may be exhibited on a homepage of the third party authentication authority so as to be freely downloaded, or the public key information may be recorded on a CD-ROM, DVD-ROM, etc., so as to be distributed to an accesser. Moreover, since the public key information of the third party authentication authority is stored in a computer on the accesser side in many cases, the public key information stored in a computer may be used instead of distributing the public key information. As a format of the public key information, a standardized certificate format (X509 format, etc.) may be used. Thereby, the third party authentication authority can warrant a credibility of the encapsulated document file 23 by providing signature to the public key information of the document producer.

Next, the public key information signed by the third party authentication authority is acquired (step S253).

The process of the subsequent steps S254-S259 is the same as the process of steps S201-S203 and steps S205-S207 shown in FIG. 46, and a description thereof will be omitted.

The thus-produced encapsulated document file 23 will be sent and distributed to a predetermined computer 1 with the public key of the document producer signed by the third party authentication authority through the network 14.

A description will now be given of a tamer verification process. The computer 1 serves as a tamper verification apparatus, which performs a tamper verification process for the encapsulated document file 23 by the CPU 2 executing the start program related to the Shell program in the operating system of the computer 1. Here, a description will be given on the assumption that encapsulated document file 23 as shown in FIG. 45 is distributed from another computer 15 (encapsulated document producing apparatus) together with a public key of a document producer signed by a third party authentication authority. Moreover, it is assumed that the public key information of the third party authentication authority is distributed to an accesser through a safe communication channel.

When the accesser selects the encapsulated document file 23 through an inputting device such as the keyboard 11 or the mouse 12, and if the Shell program in the operating system judges that the selected file is the encapsulated document file 23 in accordance with an extension of the file, a start program is started. The start program reads the selected encapsulated document file 23, and carries out a tamper verification on the operating program file 22 provided in the encapsulated document file 23.

FIG. 56 is a flowchart which shows a flow of the tamper verification process performed by the start program. As shown in FIG. 56, the distributed encapsulated document file 23 and the public key of the document producer signed by the third party authentication authority are acquired and decompressed (step S261), and the encrypted public key information of the document producer is decrypted using the public key of the third party authentication authority (step S262). Then, the signature information described in the public key of the document producer is verified (step S263).

If it is certificated by the third party authentication authority, that is, if no tamper or alteration is found (N of step S264), the decrypted feature amount of the operating program file 22 in the encapsulated document file 23 is decrypted by using the decrypted public key of the document producer (step S265). Then, the feature amount of the operating program file 22 is computed (step S266).

Subsequently, proceeding to step S267, the decrypted value of the encrypted feature amount of the operating program file 22 in the distributed encapsulated document file 23 is compared with the value of the computed feature amount of the operating program file 22 on the accesser side so as to perform the tamper verification process on the operating program file 22.

If the two feature amounts are equal to each other, that is, if it is determined that the operating program file 22 is not tampered or altered (N of step S268) as a result of the tamer verification on the operating program file 22, the signature information described in the operating program file 22 is displayed on the display 10 (step S269) so as to let the accesser to judge whether the displayed signer is credible.

If an input is made by the accesser through the inputting device such as the keyboard 11 or the mouse 12 that the signer is credible (Y of step S270), the operating program of the operating program file 22 is executed so as to display the document information file 21 contained in the encapsulated document file 23 on the display 10 (step S271).

On the other hand, if it is not certificated by the third party authentication authority (Y of step S264), if the operating program file 22 has been tampered or altered (Y of step S268), or if an input is made by the accesser through the inputting device such as the keyboard 11 or the mouse 12 that the signer is not credible (N of step S270), the operating program of the operating program file 22 is not executed and an unfair act reporting process is performed to report that the operating program is an unfair program file (step S272). As for the unfair act reporting process, it is considered that a dialog box is displayed on the display 10 that indicates the fact that the operating program file 22 in the encapsulated document file 23 was tampered or altered during the distribution.

Thus, according to this embodiment provided with the encapsulated document producing apparatus and the tamper verification apparatus, the verification of a tamper of the operating program file 22 during distribution can be performed by merely encrypting the feature amount of the operating program file 22 which is data as small as about 20 bytes, without encrypting the entire operating program file 22. Thus, the encapsulated document file 23 can perform a tamper verification of the operating program file 22 in the encapsulated document file at a high speed, thereby providing a useful encapsulated document. Additionally, since the public key information on the document producer side is signed by the third party authentication authority so as to warrant the credibility of the encapsulated document file 23, a risk of the document producer can be judged even if the accesser does not know the document producer so that the security function for the encapsulated document file 23 is maintained.

It should be noted that the start program is not limited to one, which is started by the Shell program in the operating system, and the Shell program itself may have such as function.

It should be noted that although the safety of the encapsulated document file 23 is warranted by encrypting the feature amount of the public key information of the document producer in the present embodiment, the encapsulated document file 23 can be warranted by encrypting the public key information of the document producer itself.

An example is mentioned below where a provider of an operating system (OS) encrypts the public key information of the document producer.

First, the provider of the operating system produces a private key and a public key, and encrypts the public key information of the document producer with the private key of the provider of the operating system. Then, the provider of the operating system sends the encrypted public key information back to the document producer. It should be noted that the public key information of the provider of the operating system is previously stored in the operating system.

The document producer sends to the accesser the produced encapsulated document file 23 and the encrypted public key information.

Thus, the accesser can use the encapsulated document file 23 safely by verifying the operating program file 22 of the encapsulated document file 23 in the same manner as in the above-mentioned embodiment by decrypting the encrypted public key information using the public key information of the provider of the operating system previously stored in the operating system.

According to the method in which the public key information of the document producer is encrypted, the accesser cannot use the encapsulated document until the accesser acquires the public key information of a third party since the public key information is encrypted with a private key of the third party. For this reason, in the method of encrypting the public key information of the document producer, it becomes possible for the document producer to apply a billing process to the accesser through the third party.

On the other hand, in the method of encrypting the feature amount of the public key information of the document producer, since public key information is not decrypted with the private key of the third party, the accesser can use the encapsulated document file 23 without certification of the signature information of the public key information of the document producer by selecting whether to use the public key information of the document producer.

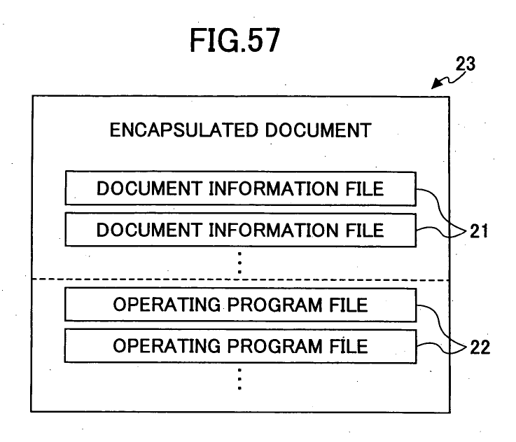

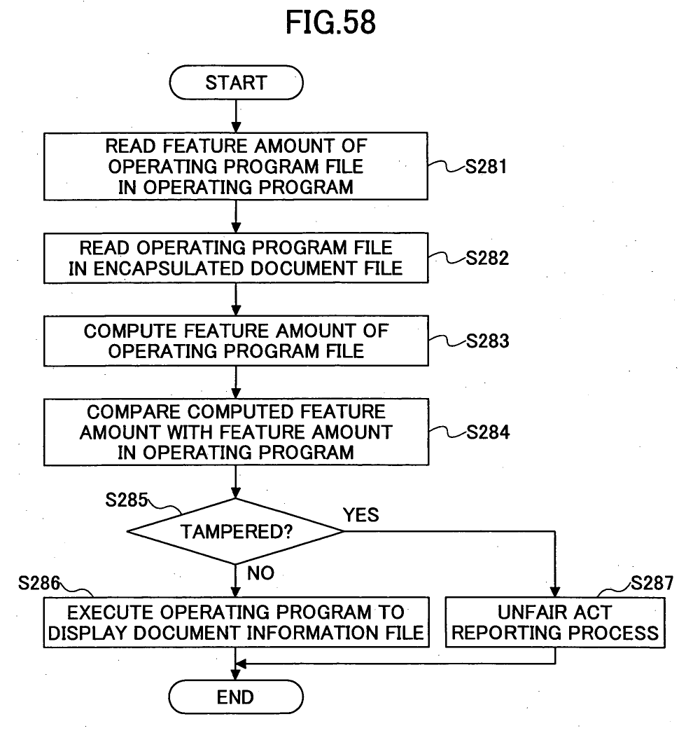

A description will now be given, with reference to FIG. 57 and FIG. 58, of another embodiment of the present invention. It should be noted that parts that are the same as the parts explained in the above-mentioned embodiments are given the same reference numerals, and descriptions thereof will be omitted.

According to the above-mentioned embodiments, the feature amount retaining file 25, which stores encrypted feature amount of each operating program file 22, is retained in the encapsulated document file 23. On the other hand, according to the present invention, the feature amount retaining file 25 is not retained in the encapsulated document file 23 but retained in a start program related to the Shell program of the operating system.

A description will be given, with reference to FIG. 57, of an outline of a data structure of a document (encapsulated document structure) according to the present embodiment. The encapsulated document file 23 according to the present embodiment is stored in the HDD 5 of the computer 1. The encapsulated document file 23 according to the present embodiment is produced by encapsulating by the encapsulating means the document information file 21, the operating program file 22 and the feature amount retaining file 25 into a single file. The document information files 22 contain various contents, which are substances of expression in a document, and a document structure. The program files 23 are programs for realizing the contents of the document information files 22. Such information has a structure of a unit of file so that the information can be managed by a general computer 1.

More specifically, the contents information of the document information file 21 can be a static image file, a dynamic image file, a sound file or a text file that have file formats which the computer 1 can handle and operate. Moreover, the encapsulating means uses a known multi-file compression method such as ZIP or LHA so as to automatically decode a file, which has been encoded with the multi-file compression format, when displaying the document information file 21.

Moreover, the operating program of the operating program file 22 is preferably described in an intermediate language code. If the operating program is described in the intermediate language, the type dependency of the computer can be eliminated if a compiler or an interpreter program, which can interpret and execute the intermediate language, is installed in the computer. JAVA (trademark of Sun Microsystems) language is such an intermediate language. The encrypted feature amount of the operating program file 22 is stored in the start program.

That is, the encapsulated document file 23 according to the present embodiment differs from that of the above-mentioned embodiment in that the feature amount retaining file 25 is not retained in the encapsulated document file 23.

Therefore, since the operating program file 22, which expressed and materializes the document information file 21, and the document information file concerned are encapsulated into a single file, the document concerned can be accessed under a computer environment different from the computer of the document producer. In this case, by computing the feature amount of the distributed operating program file 22 and comparing the computed feature amount with the feature amount of the operating program file retained outside, it becomes possible to verify a tamper or alteration of the operating program file 22 during the distribution of the encapsulated document file 23. Thus, a malicious program is prevented from being mixed into the operating program file 22.

Next, a description will be given of an important function of the computer 1 to achieve the present embodiment.

The computer 1 serves as an encapsulated document producing apparatus that, performs an encapsulated document producing process to produce the encapsulated document file 23 due to the CUP 2 incorporated therein executing an application program that runs on the operating system. A description will be given below on the assumption that the encapsulated document file 23 as shown in FIG. 57 is distributed from another computer 15 (encapsulated document producing apparatus) together with a public key.

When an accesser selects, the encapsulated document file 23 through an inputting device such as the keyboard 11 or the mouse 12, and if the Shell program judges that the selected file is the encapsulated document file 23 in accordance with the extension of the file, a start program is started. The start program reads the selected encapsulated document file 23, and perform a tamper verification on the operating program file 22 provided in the encapsulated document file 23.

FIG. 58 is a flowchart which shows a flow of the tamper verification process performed by the start program. As shown in FIG. 58, the feature amount of the operating program file 22 in the start program is read first (step S281).

Next, the operating program file 22 existing in the encapsulated document file 23 selected by the accesser using an inputting device such as the keyboard 11 or the mouse 12 is read (step S282), and a feature amount of the thus-acquired operating program file 22 is computed (step S283).

Subsequently, proceeding to step S284, the tamper verification process is performed by comparing the feature amount of the operating program file 22 in the start program with the feature amount of the operating program file 22 computed on the accesser side.

As a result of the tamper verification process, if the two feature amounts are equal to each other, that is, if the operating program file 22 is not tampered or altered (N of step S285), the operating program (document accessing program) of the operating program file 22 is started so as to display the document information file 21 on the display 10 (step S286).

On the other hand, as a result of the tamper verification process, if the two feature amounts are not equal to each other, that is, if the operating program file 22 is tampered or altered (Y of step S285), an unfair act reporting process is performed so as to report the fact that the feature amount verification program file was tampered or altered (step S287). As the unfair act reporting process, it is considered, for example, to display a dialog, which reports the fact that the feature amount verification program file was tampered or altered, on the display 10.

As mentioned above, according to the present embodiment provided with the encapsulated document producing apparatus and the tamper verification apparatus, it is possible to verify a tamper of the operating program file 22 during the distribution of the encapsulated document file 23 without encrypting the entire operating program file 22. Accordingly, the useful encapsulated document file 23, of which operating program file 22 is verified whether there was a tamper or alteration at a high speed, can be provided.

It should be noted that the start program is not limited to one, which is started by the Shell program provided in the operating system, and the Shell program itself may have such a function.

Moreover, when there is no start program as a function of the Shell program of the operating system, it is necessary for the accesser to acquire the start program for starting the encapsulated document file 23. As the acquisition method of the start program, there is a method of downloading the start program from the Internet. However, when downloading the start program from the Internet, a user has to know the URL of the site from which the start program can be downloaded. Thus, the URL may be described as property information of the file, or the URL of the download site may be easily recognized by a general-purpose text editor by describing the URL at the head of the file.

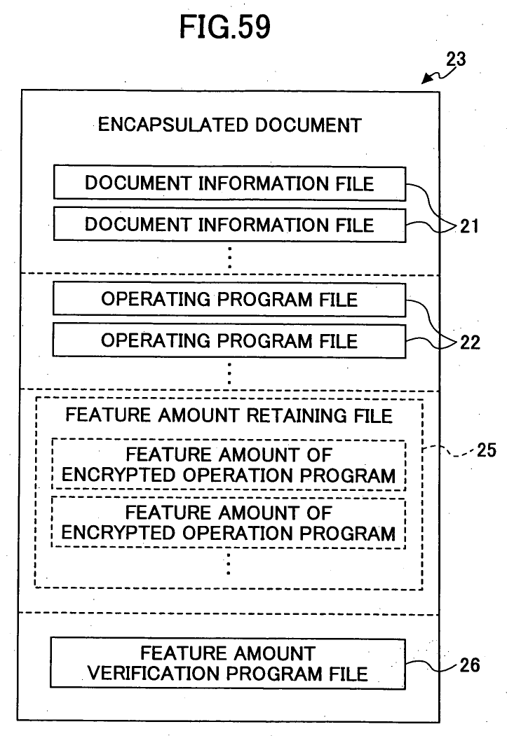

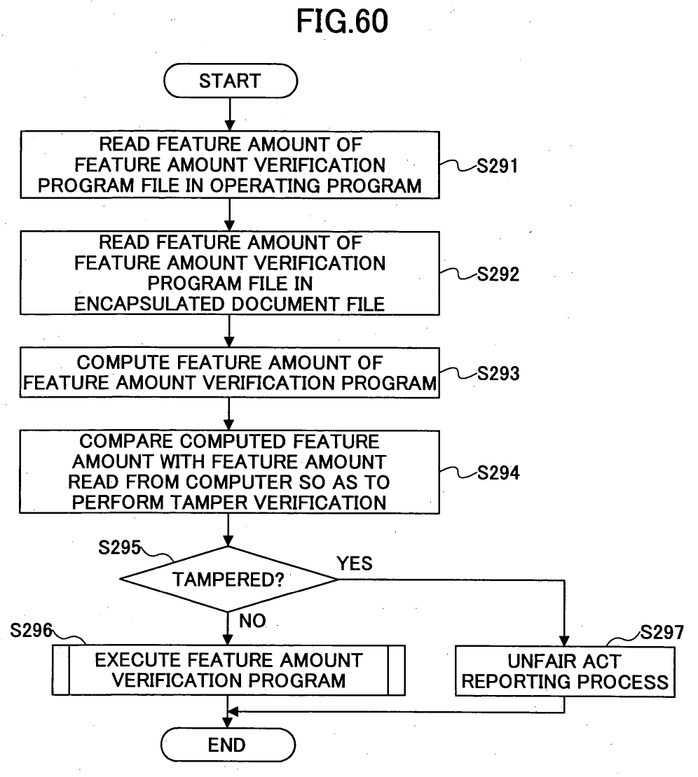

A description will now be given, with reference to FIG. 59 and FIG. 60, of another embodiment of the present invention. It should be noted that parts that are the same as the parts explained in the above-mentioned embodiments are given the same reference numerals, and descriptions thereof will be omitted.

A description will be given, with reference to FIG. 59, of an outline of a data structure of a document (encapsulated document structure) according to the present embodiment. The encapsulated document file 23 according to the present embodiment is stored in the HDD 5 of the computer 1. The encapsulated document file 23 according to the present embodiment is produced by encapsulating by the encapsulating means the document information file 21, the operating program file 22, the feature amount retaining file 25 and a feature amount verification program file 26 into a single file. The document information files 22 contain various contents, which are substances of expression in a document, and a document structure. The program files 23 are programs for realizing the contents of the document information files 22. Such information has a structure of a unit of file so that the information can be managed by a general computer 1.

More specifically, the contents information of the document information file 21 can be a static image file, a dynamic image file, a sound file or a text file that have file formats which the computer 1 can handle and operate. Moreover, the encapsulating means uses a known multi-file compression method such as ZIP or LHA so as to automatically decode a file, which has been encoded with the multi-file compression format, when displaying the document information file 21.

Moreover, the operating program of the operating program file 22 is preferably described in an intermediate language code. If the operating program is described in the intermediate language, the type dependency of the computer can be eliminated if a compiler or an interpreter program, which can interpret and execute the intermediate language, is installed in the computer. JAVA (trademark of Sun Microsystems) language is such an intermediate language. The encrypted feature amount of the operating program file 22 is stored in the start program.

The feature amount verification program file 26 is provided for verifying a tamper or alteration of the operating program file 22. The feature amount of the feature amount verification program file is retained in the start program.

That is, the encapsulated document file 23 according to the present embodiment differs from that of the above-mentioned embodiments in that the feature amount verification program file 26 is retained in the encapsulated document file 23.

Next, a description will be given of an important function of the computer 1 to achieve the present embodiment.

The computer 1 serves as an encapsulated document producing apparatus that performs an encapsulated document producing process to produce the encapsulated document file 23 due to the CUP 2 incorporated therein executing an application program that runs on the operating system. A description will be given below on the assumption that the encapsulated document file 23 as shown in FIG. 59 is distributed from another computer 15 (encapsulated document producing apparatus) together with a public key.

When an accesser selects the encapsulated document file 23 through an inputting device such as the keyboard 11 or the mouse 12, and if the Shell program judges that the selected file is the encapsulated document file 23 in accordance with the extension of the file, a start program is started. The start program reads the selected encapsulated document file 23, and perform a tamper verification on the operating program file 22 provided in the encapsulated document file 23.

FIG. 59 is a flowchart which shows a flow of the tamper verification process performed by the start program. As shown in FIG. 59, the feature amount of the operating program file 22 in the start program is read first (step S291).

Next, the feature amount verification program file 22 existing in the encapsulated document file 23 selected by the accesser using an inputting device such as the keyboard 11 or the mouse 12 is read (step S292), and a feature amount of the thus-acquired feature amount verification program file 26 is computed (step S293).

Subsequently, proceeding to step S294, the tamper verification process is performed by comparing the feature amount of the feature amount verification program file 26 in the start program with the feature amount of the feature amount verification program file 26 computed on the accesser side.

As a result of the tamper verification process, if the two feature amounts are equal to each other, that is, if the feature amount verification program file 26 is not tampered or altered (N of step S295), a feature amount verification program is executed (step S296: tamper verification means).

On the other hand, as a result of the tamper verification process, if the two feature amounts are not equal to each other, that is, if the feature amount verification program file 26 is tampered or altered (Y of step S295: determination means), an unfair act reporting process is performed so as to report the fact that the feature amount verification program file 26 was tampered or altered (step S297). As the unfair act reporting process, it is considered, for example, to display a dialog, which reports the fact that the feature amount verification program file was tampered or altered, on the display 10.

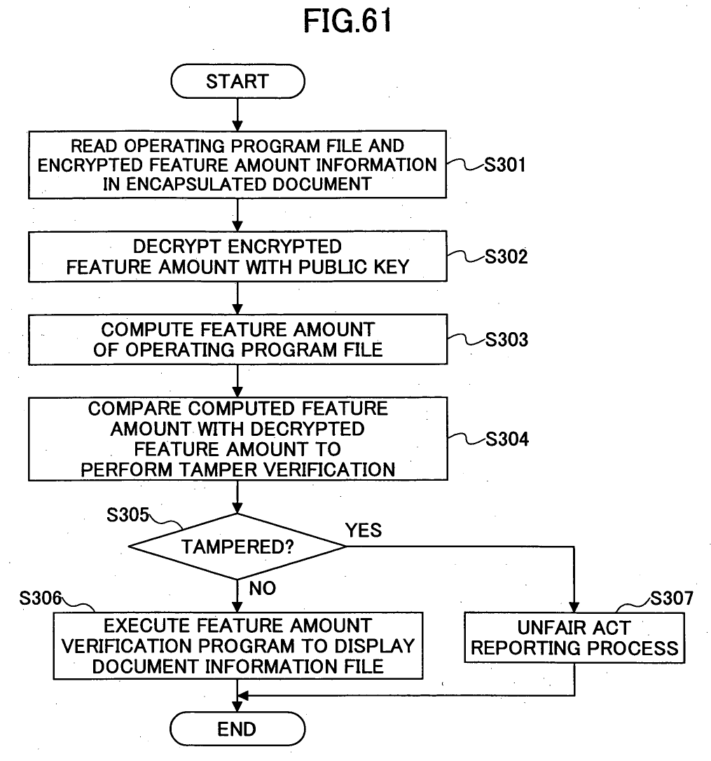

A description will now be given of the feature amount verification process which is achieved by executing the feature amount verification program in step S296. FIG. 61 is a flowchart showing a flow of the feature amount verification process. As shown in FIG. 61, first, all of the operating program files 22 and the feature amount retaining files 25 in the same encapsulated document file 23 are read (step S301), and the encrypted feature amount is decrypted using the acquired public key (step S102), and the feature amount of each operating program file 22 is computed (step S303).

Subsequently, proceeding to step S304, the decrypted feature amount of each operating program file 22 is compared with the feature amount of the operating program file 22 computed on the accesser side so as to perform the tamper verification of the operating program file 22.

As a result of the tamper verification of the operating program file 22, if the two feature amounts are equal to each other, that is, if the operating program file 22 is not tampered or altered (N of Step S305), the start program (document accessing program) of the operating program file 22 is started so as to display the document information file 21 on the display 10 (step S306).

On the other hand, as a result of the tamper verification of the operating program file 23, if the two feature amounts are not equal to each other, that is, if the operating program file 22 has been tampered or altered, an unfair act reporting process is performed to report the fact that the operating program file 22 was tampered or altered (step S307). As the unfair act reporting process, it is considered to display a dialog, which reports that the operating program file 22 was tampered or altered, on the display 10 of the computer 1.

As mentioned above, according to the present embodiment, it is possible to verify a tamper of all the operating program files 22 in encapsulated document file 23 by incorporating the feature amount verification program file 26 into the encapsulated document file 23 and performing the tamper verification of the feature amount verification program file 26 and a start of the feature amount verification program by the start program.

It should be noted that the start program is not limited to one, which is started by the Shell program provided in the operating system, and the Shell program itself may have such a function.

Moreover, when there is no start program as a function of the Shell program of the operating system, it is necessary for the accesser to acquire the start program for starting the encapsulated document file 23. As the acquisition method of the start program, there is a method of downloading the start program from the Internet. However, when downloading the start program from the Internet, a user has to know the URL of the site from which the start program can be downloaded. Thus, the URL may be described as property information of the file, or the URL of the download site may be easily recognized by a general-purpose text editor by describing the URL at the head of the file.

It should be noted that, in the above mentioned embodiments, although the feature amount of the operating program file 22 is encrypted using the public key encryption method in which the key information for encryption is different from the key information for decryption, the present invention is not limited to such a public key encryption method, and the feature amount of the operating program file 22 may be decrypted using a private key encryption method in which the key information for encryption is the same as the key information for decryption. That is, the key information which encrypted the feature amount of the operating program file 22 etc. is retained in the computer of an accesser who accesses the encapsulated document file 23. Therefore, the computer 1 of the accesser requires different sets of key information. It should be noted that the key information cannot be distributed by being provided in the encapsulated document file 23 since the key information must be kept confidential. When the encryption key and the decryption key are the same key, it becomes possible to perform encryption and decryption at high speed.

As mentioned above, the above description discloses the following invention.

1) A program tamper verification method performed by an information processing unit for verifying a tamper on an operating program file that materializes a document information file that is a substance of expression regarding a document, the operating program file and the document information file are encapsulated into an encapsulated document file, the program tamper verification method comprising the steps of: computing a feature amount of the operating program file in the encapsulated document file when materializing the document information file; decrypting an encrypted feature amount of the operating program file that was been retained; comparing the decrypted feature amount of the operating program file with the computed feature amount of the operating program file; limiting materialization of the document information file performed by the operating program file when the decrypted feature amount of the operating program file does not match the computed feature amount of the operating program file.

Accordingly, the verification of a tamper or alteration on the operation program file in the middle of distribution of the encapsulated document file can be achieved by merely decrypting a small amount of data (about 20 bytes) such as the feature amount of the operating program without decrypting the entire operating program file. Thereby, is becomes possible to provide a conveniently usable encapsulated document file that can perform verification of a tamper or alteration on the operating program file in the encapsulated document file at a high speed.

2) A program tamper verification method performed by an information processing unit for verifying a tamper on an operating program file that materializes a document information file that is a substance of expression regarding a document, the operating program file and the document information file are encapsulated into an encapsulated document file, the program tamper verification method comprising the steps of: computing a feature amount of the operating program file stored at a location indicated by location information retained in the encapsulated document file when materializing the document information file; decrypting a decrypted feature amount of the operating program previously retained; comparing the decrypted feature amount of the operating program file with the computed feature amount of the operating program file; limiting materialization of the document information file performed by the operating program file when the decrypted feature amount of the operating program file does not match the computed feature amount of the operating program file.

Accordingly, the verification of a tamper or alteration on the operation program file in the middle of distribution of the encapsulated document file can be achieved by merely decrypting a small amount of data (about 20 bytes) such as the feature amount of the operating program without decrypting the entire operating program file. Thereby, is becomes possible to provide a conveniently usable encapsulated document file that can perform verification of a tamper or alteration on the operating program file in the encapsulated document file at a high speed.

3) An encapsulated document structure comprising: a document information file storing document information that is a substance of expression of a document; an operating program file storing an operating program that materializes the document information, a limitation being given to the operating program by a security function when the operating program is interpreted and executed by a computer; and a feature amount retaining file retaining an encrypted feature amount regarding the program file, wherein the document information file, the operating program file and the feature amount retaining file are encapsulated as a single document.

Accordingly, since the operating program file that materializes the document information file is encapsulated together with the document information file, the document is accessible under a computer environment different from a computer environment of the document producer. The encrypted feature amount of the operating program file retained in the feature amount retaining file is decrypted so as to obtain the decrypted feature amount, and the feature amount of the distributed operating program file is computed so as to obtain the computed feature amount. Thus, it becomes possible to verify a tamper or alteration on the operating program in the middle of distribution of the encapsulated document file by comparing the decrypted feature amount with the computed feature amount. Therefore, a malicious program is prevented from being mixed into the operating program, which achieves a safe access to the encapsulated document file.

4) An encapsulated document structure comprising: a document information file storing contents information that is a substance of expression on a document; location information indicating a location where an operating program file is stored, the operating program file storing an operating program for materializing the document information file; and a feature amount retaining file retaining an encrypted feature amount regarding the operating program file, wherein the document information file, the location information and the feature amount retaining file are encapsulated into a single file.

Accordingly, since the location information, which indicates the location where the operating program for materializing the document information file is saved, is encapsulated together with the document information file, it becomes possible to access the document information file under a computer environment different from a computer environment of the document producer. The encrypted feature amount of the operating program file retained in the feature amount retaining file is decrypted so as to obtain the decrypted feature amount, and the feature amount of the distributed operating program file is computed so as to obtain the computed feature amount. Thus, it becomes possible to verify a tamper or alteration on the operating program in the middle of distribution of the encapsulated document file by comparing the decrypted feature amount with the computed feature amount. Therefore, a malicious program is prevented from being mixed into the operating program, which achieves a safe access to the encapsulated document file.

5) An encapsulated document structure comprising: a document information file storing document information that is a substance of expression of a document; and an operating program file storing an operating program that materializes the document information, a limitation being given to the operating program by a security function when the operating program is interpreted and executed by a computer, wherein the document information file and the operating program file are encapsulated as a single document, and a feature amount of the operating program in the operating program file is stored outside the single document.

Accordingly, since the operating program file for materializing the document information file is encapsulated together with the document information file concerned, the document information file is accessible under a computer environment different from a computer environment of the document producer. The feature amount of the distributed operating program file is computed so as to obtain the computed feature amount so as to compare the computed feature amount with the feature amount retained outside the encapsulated document file. Thereby, it becomes possible to verify a tamper or alteration on the operating program in the middle of distribution of the encapsulated document file, and a malicious program is prevented from being mixed into the operating program, which achieves a safe access to the encapsulated document file.

6) An encapsulated document structure comprising: document information file storing contents information that is a substance of expression on a document; and location information indicating a location where an operating program file containing an operating program for materializing the document information file is stored, wherein the document information file and the location information are encapsulated into a single file, and a feature amount regarding the operating program file is stored outside the single file.

Accordingly, since the location information, which indicates the location where the operating program for materializing the document information file is saved, is encapsulated together with the document information file, it becomes possible to access the document information file under a computer environment different from a computer environment of the document producer. The feature amount of the operating program file stored in the location indicated by the location information is computed so as to obtain the computed feature amount and the computed feature amount is compared with the feature amount of the operating program stored outside the encapsulated document file. Thereby, it becomes possible to verify a tamper or alteration on the operating program in the middle of distribution of the encapsulated document file, and a malicious program is prevented from being mixed into the operating program, which achieves a safe access to the encapsulated document file.

7) In the encapsulated document structure, the feature amount retaining file may also retain an encrypted feature amount regarding the document information file.

Accordingly, since it becomes possible to perform not only a verification of a tamper or alteration on the operating program file but also a verification of a tamper or alteration on the document information file, the document can be accessed still more safely.

8) In the encapsulated document structure, the feature amount retaining file may retain decryption key information used for decrypting the encrypted feature amount regarding the operating program file.

Accordingly, it becomes possible for the document accesser to verify a tamper or alteration on the operating program file by merely acquiring the encapsulating document file, which is distributed with the decryption key information encapsulated therein.

9) In the encapsulated document structure, the feature amount retaining file may retain location information which indicates decryption key information used for decrypting the encrypted feature amount regarding the operating program file.

Accordingly, it becomes possible for the document accesser to verify a tamper or alteration on the operating program file by merely acquiring the encapsulating document file, which is distributed with the location information indicating a location of the decryption key information and encapsulated therein.

10) In the encapsulated document structure, a different set of the decryption key information may be related to each operating program file.

Accordingly, when an a plurality of operation program files are produced by not only one bender but also a plurality of benders, the document producer can perform a verification of a tamper or alteration on the operating program file by using the decryption key information of each bender.

11) In the encapsulated document structure, the feature amount regarding the operating program file may be encrypted by a public key encryption method.

Accordingly, by setting the private key, which is owned by the producer of the encapsulated document file and is not publicly open, as a decryption key and providing to the document accesser a public key, as a decryption key, different from the private key, only a person having the public key is capable of decrypting the feature amount regarding the operating program file.

12) In the encapsulated document structure, the decryption key information may be signed and encrypted by a third party authentication authority.

Accordingly, the third party authentication authority puts a signature on the decryption key information (public key information) of the document producer and guarantees safety of the encapsulated document file, and, thereby, the document accesser can determine a risk regarding the document producer, even if the document accesser does not know the document producer, so as to maintain the security of the encapsulated document file.

13) In the encapsulated document structure, the feature amount regarding the operating program file is encrypted by a private key encryption method.

Accordingly, it becomes possible to perform and encryption and decryption at a high speed since the encryption key and the decryption key are the same.

14) The encapsulated document structure may further comprise a feature amount verification program for performing a verification of a tamper on the operating program file, the feature amount verification program being encapsulated into the single file.

Accordingly, the feature amount verification program file is inserted into the encapsulated document file and the start program performs the tamper verification on the feature amount verification program file and the starting of the feature amount verification program, and, thus, it becomes possible to perform the tamper verification on all the operating program files in the encapsulated document file.

15) An encapsulated document producing apparatus comprising: document information file acquisition means for acquiring a document information file storing contents information that is a substance of expression regarding a document; operating program file acquisition means for acquiring an operation program file storing an operating program, which is interpreted and executed by a computer, for materializing the document information file acquired by the document information file acquisition means; feature amount computing means for computing a feature amount of the operating program file; feature amount retaining file producing means for encrypting the feature amount of the operating program file computed by the feature amount computing means, and saving the encrypted feature amount in a feature amount retaining file; and encapsulating means for encapsulating the document information file, the operating program file and the feature amount retaining file into a single document. Accordingly, it becomes possible to easily produce the encapsulated document file having a high-security.

16) The above-mentioned encapsulated document producing apparatus may further comprise document information feature amount computing means for computing a feature amount of the document information file so as to encrypt the computed feature amount of the document information file with encryption key information and save the encrypted feature amount in the feature amount retaining file. Accordingly, it becomes possible to easily produce the encapsulated document file having a high-security.

17) A tamper verification apparatus comprising: reading means for reading an encapsulated document file having an encapsulated document structure; and tamper verification means for performing verification of a tamper on an operating program stored in the encapsulated document file based on a feature amount of the operating program file that materializes a document information file stored in the encapsulated document file and read by the reading means, wherein the encapsulated document structure comprises the document information file, the operating program file and a feature amount retaining file that retains an encrypted feature amount of the operating program.

Accordingly, the tamper verification on the operating program file is performed based on the feature amount of the operating program file, which materializes the document information file retained in the encapsulated document file. Thereby, since the tamper verification on the operating program file can be performed in the middle of distribution of the encapsulated document file, it becomes possible to prevent mixing of a malicious program, which results in a safe access to the document.

18) In the tamper verification apparatus, the tamper verification means may include: decryption means for decrypting the encrypted feature amount of the operating program file retained by the feature amount retaining file stored in the encapsulated document file and read by the reading means; feature amount computation means for computing a feature amount of the operation program file stored in the encapsulated document file; and tamper verification execution means for performing the verification of a tamper on the operating program file based on the computed feature amount of the operating program file computed by the feature amount computation means and the decrypted feature amount of the operating program file decrypted by the decryption means.

Accordingly, the encrypted feature amount of the operating program file retained in the feature amount retaining file is decrypted, and also the feature amount of the distributed operating program file is computed so as to compare the decrypted feature amount with the computed feature amount. Thereby, it becomes possible to perform the tamper verification on the operating program file in the middle of distribution of the encapsulated document file.

19) In the tamper verification apparatus, the tamper verification means may include: feature amount computation means for computing a feature amount of the operating program file stored in the encapsulated document file read by the reading means; and tamper verification execution means for performing the verification of a tamper on the operating program file based on the computed feature amount of the operating program file computed by the feature amount computation means and a feature amount of the operating program file stored in a start program.

Accordingly, the feature amount of the distributed operating program file is computed so as to compare the computed feature amount with the feature amount of the start program. Thereby, it becomes possible to perform the tamper verification on the operating program file in the middle of distribution of the encapsulated document file.

20) In the tamper verification apparatus, the tamper verification means may include: feature amount computation means for computing a feature amount of the operating program file stored in the encapsulated document file read by the reading means; encryption means for encrypting the computed feature amount of the operating program file computed by the feature amount computation means; and tamper verification execution means for performing the verification of a tamper on the operating program file based on the encrypted feature amount of the operating program file encrypted by the encryption means and a decrypted feature amount of the operating program file retained in a feature amount retaining file stored in the encapsulated document file.

Accordingly, the feature amount of the distributed operating program is computed, and the computed feature amount of the operating program file is decrypted so as to compare the decrypted feature amount with the encrypted feature amount retained in the feature amount retaining file. Thereby, it becomes possible to perform the tamper verification on the operating program file in the middle of distribution of the encapsulated document file.

21) In the tamper verification apparatus, the tamper verification means may include: feature amount computation means for computing a feature amount of a feature amount verification program file stored in the encapsulated document file and read by the reading means; determining means for determining whether or not to execute the feature amount verification program file based on the computed feature amount of the feature amount verification program file computed by the feature amount computation means and a feature amount of the feature amount verification program file stored in a start program; and tamper verification execution means for performing verification of a tamper on the operating program file when the feature amount verification program file is determined by the determining means to be executed.

Thereby, it becomes possible to perform the verification of a tamper or alteration on the feature amount verification program in the middle of distribution of the encapsulated document. Thus, it becomes possible to perform the tamper verification on all the operating program files in the encapsulated document file by starting the feature amount verification program when a tamper or alteration is not found.

22) An encapsulated document producing process program causing a computer to perform the functions of: acquiring a document information file installed in the computer, the document information file containing contents information that is a substance of expression regarding a document; acquiring an operating program file that is interpreted and executed by the computer so as to materialize the document information file acquired by the function of acquiring the document information file; computing a feature amount of the operating program file; encrypting the feature amount of the operating program file computed by the function of computing the feature amount by using decryption key information; saving the decrypted feature amount of the operating program file in a feature amount retaining file; and encapsulating the document information file, the operating program file and the feature amount retaining file into a single document file. Accordingly, it becomes possible to easily produce the encapsulated document file having the file structure providing a high security.

23) The encapsulated document producing process program may further comprise the functions of: causing the computer to perform a function of computing the feature amount of the document information file; decrypting the computed feature amount of the document information file by using decryption key information; and saving the decrypted feature amount of the document information file in the feature amount retaining file. Accordingly, it becomes possible to easily produce the encapsulated document file having the file structure providing a high security. Accordingly, it becomes possible to easily produce the encapsulated document file having the file structure providing a high security.

Accordingly, it becomes possible to easily produce the encapsulated document file having a file structure providing a high security by causing a computer to read the encapsulated document producing process program stored in the processor readable storage medium.

24) A processor readable storage medium storing an encapsulated document producing process program causing a computer to perform the functions of: acquiring a document information file installed in the computer, the document information file containing contents information that is a substance of expression regarding a document; acquiring an operating program file that is interpreted and executed by the computer so as to materialize the document information file acquired by the function of acquiring the document information file; computing a feature amount of the operating program file; encrypting the feature amount of the operating program file computed by the function of computing the feature amount by using decryption key information; saving the decrypted feature amount of the operating program file in a feature amount retaining file; and encapsulating the document information file, the operating program file and the feature amount retaining file into a single document file. Accordingly, it becomes possible to easily produce the encapsulated document file having a file structure providing a high security by causing a computer to read the encapsulated document producing process program stored in the processor readable storage medium.

25) A start program causing a computer to perform the functions of: reading an encapsulated document file having an encapsulated document structure; and performing verification of a tamper on an operating program stored in the encapsulated document file based on a feature amount of the operating program file that materializes a document information file stored in the encapsulated document file and read by the reading means, wherein the encapsulated document structure comprises the document information file, the operating program file and a feature amount retaining file that retains an encrypted feature amount of the operating program.

Accordingly, the tamper verification on the operating program file is performed based on the feature amount of the operating program file that materializes the document information file stored in the encapsulated document file. Thereby, since it becomes possible to perform the verification of a tamper or alteration in the middle of distribution of the encapsulated document file. Thus, a malicious program is prevented from being mixed into the operating program file, which results in a safe access to the document.

26) In the start program, the function of performing the verification may include the function of: decrypting the encrypted feature amount of the operating program file retained by the feature amount retaining file stored in the encapsulated document file and read by the function of reading; computing a feature amount of the operation program file stored in the encapsulated document file; and performing the verification of a tamper on the operating program file based on the computed feature amount of the operating program file computed by the feature amount computation means and the decrypted feature amount of the operating program file decrypted by the decryption means.

Accordingly, the encrypted feature amount of the operating program file retained in the feature amount retaining file is decrypted, and also the feature amount of the distributed operating program file is computed so as to compare the computed feature amount with the decrypted feature amount. Thereby, it becomes possible to perform the verification of a tamper or alteration on the operating program file in the middle of distribution of the encapsulated document file.

27) In the start program, the function of performing verification may include the function of: computing a feature amount of the operating program file stored in the encapsulated document file read by the function of reading; and performing the verification of a tamper on the operating program file based on the computed feature amount of the operating program file computed by the function of computing the feature amount and a feature amount of the operating program file stored in the start program.

Accordingly, the feature amount of the distributed operation program file is computed so as to compare the computed feature amount with the feature amount stored in the start program. Thereby, it becomes possible to perform the verification of a tamper or alteration on the operating program file in the middle of distribution of the encapsulated document file.

28) In the start program, the function of performing verification may include the function of: computing a feature amount of the operating program file stored in the encapsulated document file read by the function of reading; encrypting the computed feature amount of the operating program file computed by the function of computing the feature amount; and performing the verification of a tamper on the operating program file based on the encrypted feature amount of the operating program file encrypted by the function of encrypting and a decrypted feature amount of the operating program file retained in a feature amount retaining file stored in the encapsulated document file.

Therefore, the feature amount of the distributed operating program file is computed and the computed feature amount is decrypted so as to compare the computed feature amount with the encrypted feature amount of the operating program file retained in the feature amount retaining file. Thereby, it becomes possible to perform the verification of a tamper or alteration on the operating program file in the middle of distribution of the encapsulated document file.

29) In the start program, the function of performing verification may include the function of: computing a feature amount of a feature amount verification program file stored in the encapsulated document file and read by the function of reading; determining whether or not to execute the feature amount verification program file based on the computed feature amount of the feature amount verification program file computed by the function of computing the feature amount and a feature amount of the feature amount verification program file stored in the start program; and performing verification of a tamper on the operating program file when the feature amount verification program file is determined by the determining means to be executed.

Accordingly, the feature amount of the feature amount verification program file retained in the distributed encapsulated document file is computed, and the computed feature amount is compared with the feature amount of the feature amount verification program file stored in the start program. Thereby, it becomes possible to perform the verification of a tamper or alteration on the feature amount verification program file in the middle of distribution of the encapsulated document file. Additionally, it becomes possible to perform the tamper verification on all the operating program files in the encapsulated document file by starting the feature amount verification program when a tamper or alteration is not found.

It should be noted that the above-mentioned start program may be stored in a processor readable storage medium so that the above-mentioned start program is read and executed by a computer.

A description will now be given of a third mode for carrying out the present invention.

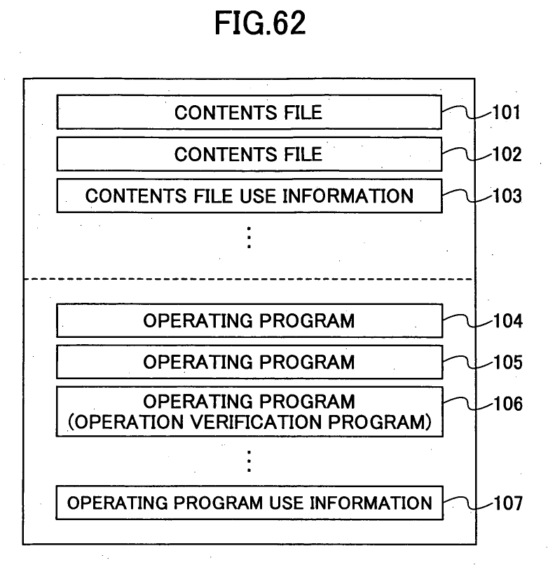

FIG. 62 is an illustration showing a structure of an electronic document file according to the present invention. The electronic document file shown in FIG. 62 corresponds to the encapsulated document file 23 explained in the above-mentioned embodiments of the first and second modes for carrying out the present invention. The electronic document file shown in FIG. 62 comprises contents files 101 and 102, contents file use information 103, operating programs 104, 105 and 106 and operating program information 107. Each of the contents files 101 and 102 corresponds to the previously mentioned document information file 21, which stores information regarding the contents of a document produced by a document producer. A template information may be inserted into the contents files 101 and 102 beforehand so that the document producer can easily describe the contents of a document. As examples of the template information, there are an icon image, which is needed to perform an operation process with respect to the contents files 101 and 102 with a graphic user interface format, and a background image at the time of producing the contents files 101 and 102.

The contents file use information 103 contains use information regarding the contents information stored in the contents files 101 and 102. The use information contains information regarding a limitation in use or a method of use of the contents and information regarding a feature amount of the contents files 101 and 102. If a tamper verification and a use limitation for the contents information in the contents files 101 and 102 are not necessary, there is no need to provide the contents file use information in the encapsulated document file.

Each of the operating programs 104, 105 and 106 corresponds to the previously mentioned operating program file 22, which is a program provided by a provider of an application (a provider of the operating program). The operating program includes a program for performing a data exchange, transmission, display, edit, save or print process with respect to the contents files 101 and 102. The operating program further includes a program for verifying the operating programs 104, 105 and 106 and the contents files 101 and 102. The document producer describes the contents of the document in the contents files 101 and 102 by using a document producing program contained in the operating programs 104, 105 and 106. As a specific function of each of the operating programs 104, 105 and 106, there are a word-processor function, an image editing function, a music editing function, a dynamic image editing function, etc. A document accesser, who accesses the electronic document, views the contents of the document described in the contents file by using a document access program contained in the operating programs 104, 105 and 106.

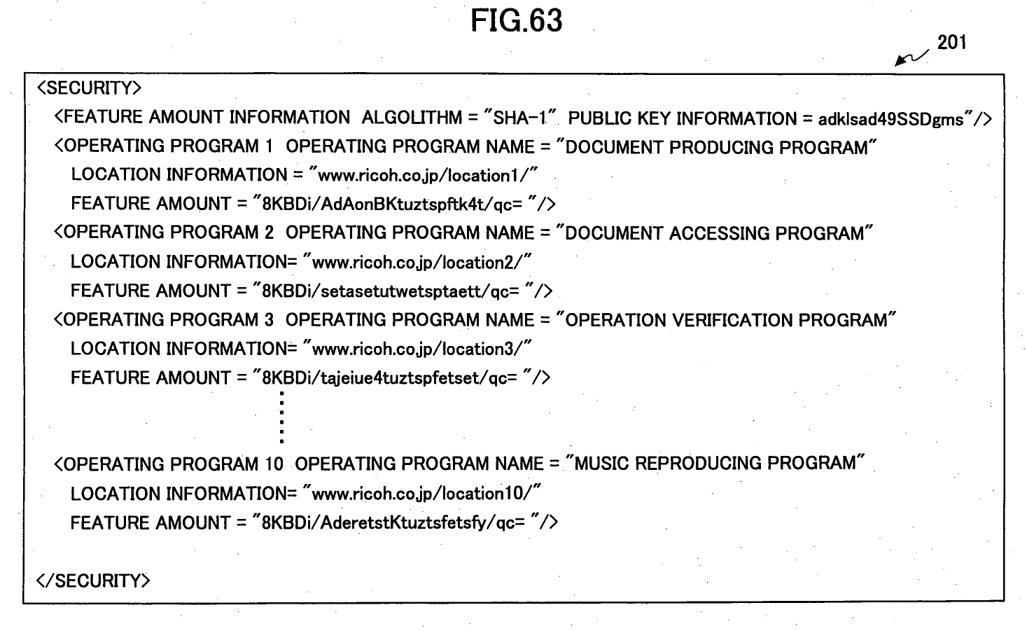

The operating program use information 107 includes information regarding the a limitation and a method of use of the operating programs 104, 105 and 106. The operating program use information 107 also contains information regarding a feature amount of the operating programs and decryption information used when performing a tamper verification. FIG. 63 shows an XML format for describing information contained in the operating program use information 107. The algorithm described in the format 201 as attribute information in a feature amount information tag indicates a method for computing a feature amount of the operating program. According to the format 201, a feature amount is computed by SHA described later. The public key information in the format 201 is information for decrypting an encrypted operating program. The location information described as attribute information in the operating program tag indicates a location where the operating program is stored in the encapsulated document. Moreover, the feature amount in the format 201 describes a result of computation of the feature amount of the operating programs. Here, if the feature amount information is not used when performing a verification of the operating programs, the attribute information such as the feature amount and algorithm may be omitted.

Security of the electronic document file having a structure shown in FIG. 62 is guaranteed by the operation verification program 106, which is one of the operating programs, performing a tamper verification of the operating programs based on the operating program use information 107. As an example of the execution of the operation verification program 106, the encrypted operating program in the electronic document file is decrypted and signature information of the operating program is verified. As an example of the method of encrypting the operating program, there is a method using a common key system or a method using a public key system. A description will be given below of the method using a public key system. In the public key system, a provider of an application (hereinafter, referred to as an application provider) procures a private key, and the operating program is encrypted with the private key. The public key making a pair with the private key is distributed so that both the document producer and the document accesser can acquire the public key. RSA, DSA (Digital Signature Algorithm), etc., may be used for the encryption when using the private key. The encryption algorithm of RSA depends on the fact that it is difficult to perform factorization into prime factors for a large number, and it is generally known that a key having a factor of more than 2,000 bits is safe. Since RSA, DSA, etc., are provided by various companies, they can be used simply.

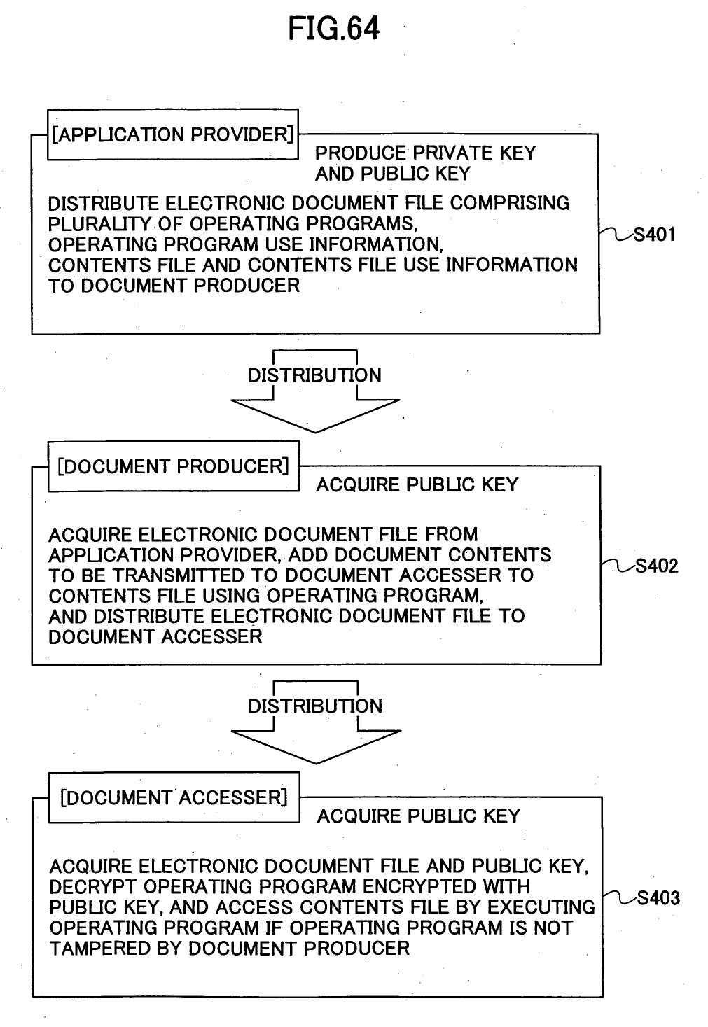

Next, A description will be given, with reference to FIG. 64, of an outline of an electronic document authentication using the above-mentioned electronic document file. In the electronic document authentication, there exist an application provider, a document producer and a document accesser, and the application provider produces an electronic document file and distributes the electronic document file to the document producer (step S401). The document producer describes the contents of a document to a contents file using the distributed electronic document file, and distributes the electronic document file to the document accesser (step S402). The document accesser causes the operating program to be executed after performing a tamper verification of the distributed electronic document file, and if there is no tamper found, the document accesser accesses the contents file (step S403).

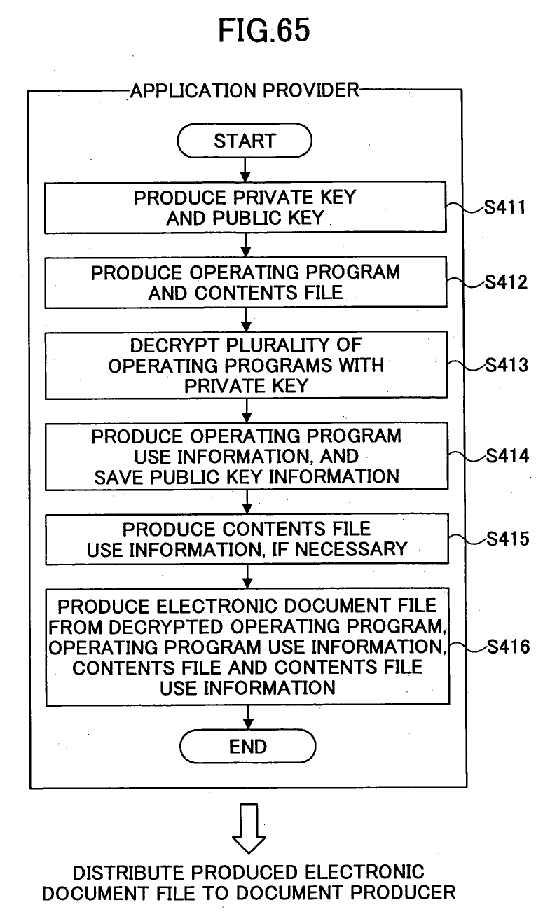

A description will be given in detail below of the electronic document authentication. First, a description will be given of a process, which the application provider performs. FIG. 65 is a flowchart showing a process procedure for the electronic document authentication performed the application provider. First, the application provider produces a private key and a public key (step S411). Next, the application provider produces a plurality of operating program and contents files (step S412). Subsequently, the application provider encrypts the operating programs with the private key, which the application provider produced (step S413). Then, the application provider produces the operating program use information, and saves the public key information (step S414). The application provider produces, if necessary, the contents file use information (step S415). Then, the application provider produces an electronic document file comprising the encrypted operating programs, the operating program user information, the contents files and the contents file use information (step S416). Then, the application producer distributes the thus-produced electronic document file to the document producer.

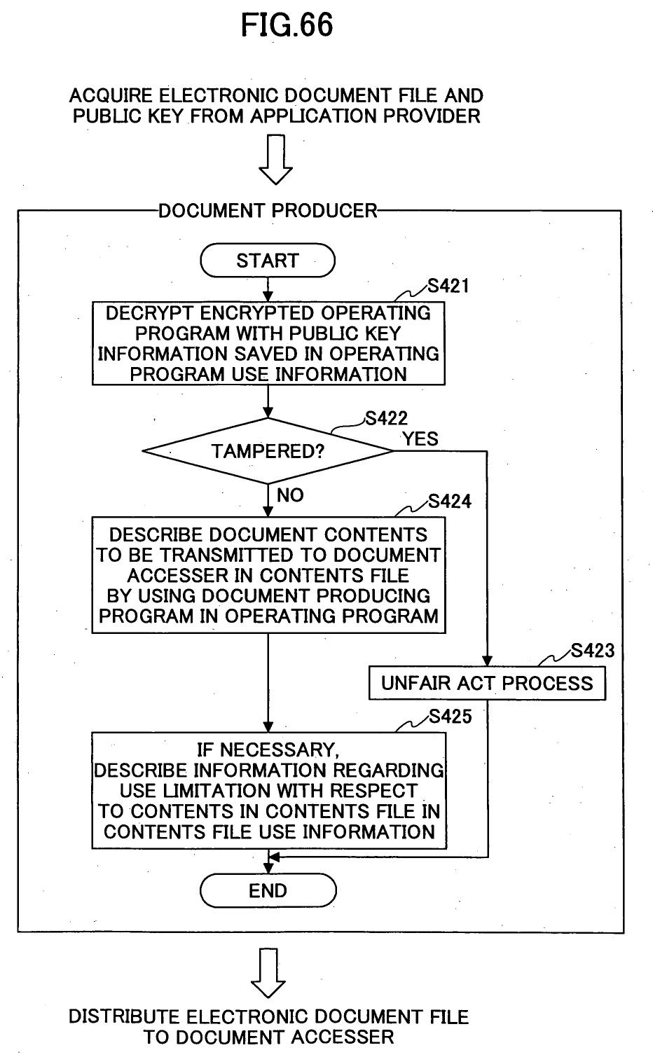

Next, a description will be given of a process performed by the document producer. FIG. 66 is a flowchart showing a process procedure for the electronic document authentication by the document producer. First, the document producer acquires the electronic document file distributed by the application provider, and decrypts the document producing program which is one of the operating programs encrypted with the public key information stored in the use information of the plurality of operating programs in the electronic document file (step S421). Next, the document producer performs an authentication based on the signature information of the operating programs so as to verify whether or not there was a tamper or alteration (step S422). When there was a tamper or alteration (Yes of step S42), it is determined that there was an unfair act performed (step S423), and the process is ended (that is, the document producing process is stopped). If there was no tamper or alteration (No of step S422), the document producer produces document contents which is to be sent to the document accesser by using the document producing program, and saves the document contents in the contents file (step S424).

Moreover, the document producer describes, if necessary, the limitation for the contents in the contents file in the contents file use information (step S425). Then, the document producer distributes the electronic document file, in which the document contents are described by the document producer, to the document accesser. It should be noted that the document producing program, which is one of the operating programs in the electronic document file to distribute, can be automatically erased when it is distributed or acquired by the document accesser. The erasure of the document producing program can be performed by mounting by the application provider an erasing program for the document producing program in the document producing program beforehand.

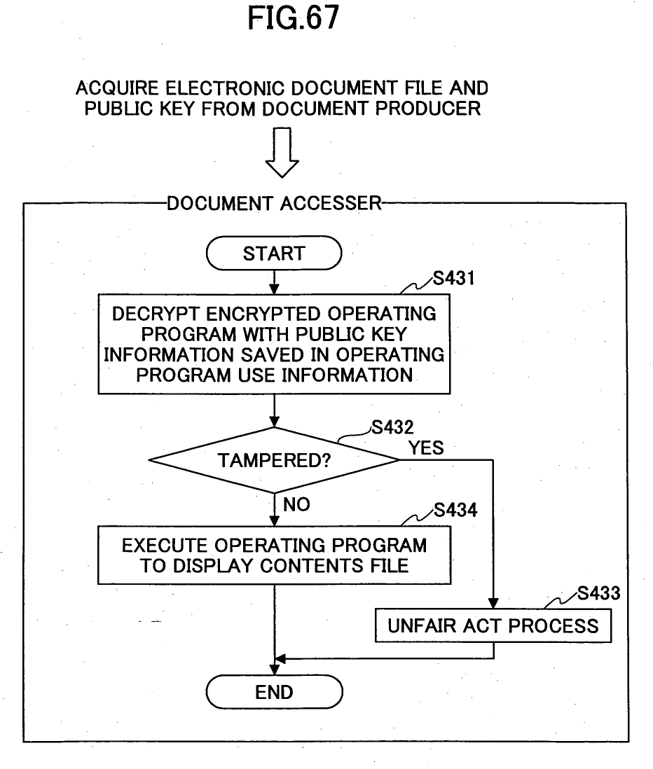

Next, a description will be given of a process performed by the document accesser. FIG. 67 is a flowchart showing a process procedure for the electronic document authentication performed by the document accesser. First, upon receipt of the electronic document file distributed by the document producer, the document accesser decrypts the operating programs using the public key information stored in the operating program use information in the electronic document file (step S431). Next, the document accesser authenticates the signature information provided by the application provider on the operating programs by using the operation verification program, which is one of the operating programs, so as to perform a tamper verification of the operating programs, which may be performed by a malicious document producer. When there was a tamper or alteration (Yes of step S432), it is determined that an unfair act was performed (step S4339, and the process is ended (that is, the access to the electronic document file is stopped).

If there was no tamper or alteration (No of step S432), the document accesser causes to execute the document accessing program, which is one of the operating programs for displaying the contents files, so as to display the file contents (step S434). Since there is no possibility of executing a tampered or altered operating program, the document accesser can access the electronic document file by executing only the operating programs provided by the application provider. Even if the document producer adds harmful information to the document, the document accesser can avoid an bad influence by going through the above-mentioned process.

It should be noted that the above-mentioned electronic document file can be distributed in a state where the operating programs, the operating program use information, the contents files and the contents file use information are divided, or in a state where they are encapsulated into a single file. However, if the electronic document file is distributed in the divided state, it is required to add link information so as to clarify a correspondence between the operating programs and the operating program use information, a correspondence between the contents files and the contents file use information and a correspondence between the operating programs and the contents files. If the programs and information are encapsulated into a single file, an electronic document file, which can be conveniently used, is provided. However, in a case where the public key information is stored as the operating program use information mentioned above, there is a risk in that the document accesser performs the tamper verification on the operating programs with the public key information which was tampered or altered since a malicious document producer may tamper or alter both the operating programs and the public key information stored in the operating program use information.

Accordingly, it is important to prevent the public key information from being tampered or altered. As one of methods to solve this problem, there is a distribution of the public key information to a document accesser through a channel different from a channel through which the electronic document file is distributed. As a mode of distribution of the public key information, the public key information may be exhibited on a homepage of the third party authentication authority so as to be freely downloaded, or the public key information may be recorded on a CD-ROM, DVD-ROM, etc., so as to be distributed to a document accesser. As another method of solving the problem, a tamper verification may be performed on the public key information in the electronic document file by using public key information of a third party authentication authority stored in a computer on the document accesser side. As a format of the public key information, a standardized certificate format (X509 format, etc.) may be used.

Additionally, in order to achieve a high speed operation of the operating program by reducing an amount of data to be encrypted and decrypted, a feature amount of the operating program may be computed and the computed feature amount may be encrypted and decrypted as mentioned in the previous embodiments. When using such as feature amount, a feature amount of the operating program encrypted with a private key of the application provider may be stored in the operating program use information. One example of the feature amount of the operating program file is an electronic fingerprint system applied to the operating program. SHA1 (Secure-Hash-Algorithm) is used as a computation method of such a feature amount. As a fundamental characteristic of SHA1, there are two points, one is that the feature amount of the operating program is changed when the operating program is changed only by one bit and the other is that a falsified message having a feature amount the same as the original feature amount cannot be produced even if one attempts falsification. According to the above-mentioned features, it can be proved that an operating program and a feature amount of the operating program concerned becomes one-to-one relationship.

A description will be given below of an authentication of the electronic document file in this case. First, an application provider encrypts only the feature amount of the operating program with a private key, and distributes it to a document producer. The document producer describes the document contents in the contents file using the document producing program in the operating program, and distributes the contents file to a document accesser. The document accesser performs a tamper verification on the operating program by comparing a result of decryption of the feature amount of th operating program encrypted with the public key information with a result of computation of the feature amount of the operating program. Here, if there was no tamper or alteration by the document producer and the same feature amount of the operating program is obtained with the same algorithm, the decrypted value of the encrypted feature amount of the operating program distributed by the application provider must be equal to the value of the feature amount of the operating program computed on the document accesser side. Since the computation method of the feature amount is publicly known, the feature amount can be easily computed by using the same algorithm. As mentioned above, a tamper or alteration of an operating program can be verifiable by comparing two feature amounts.

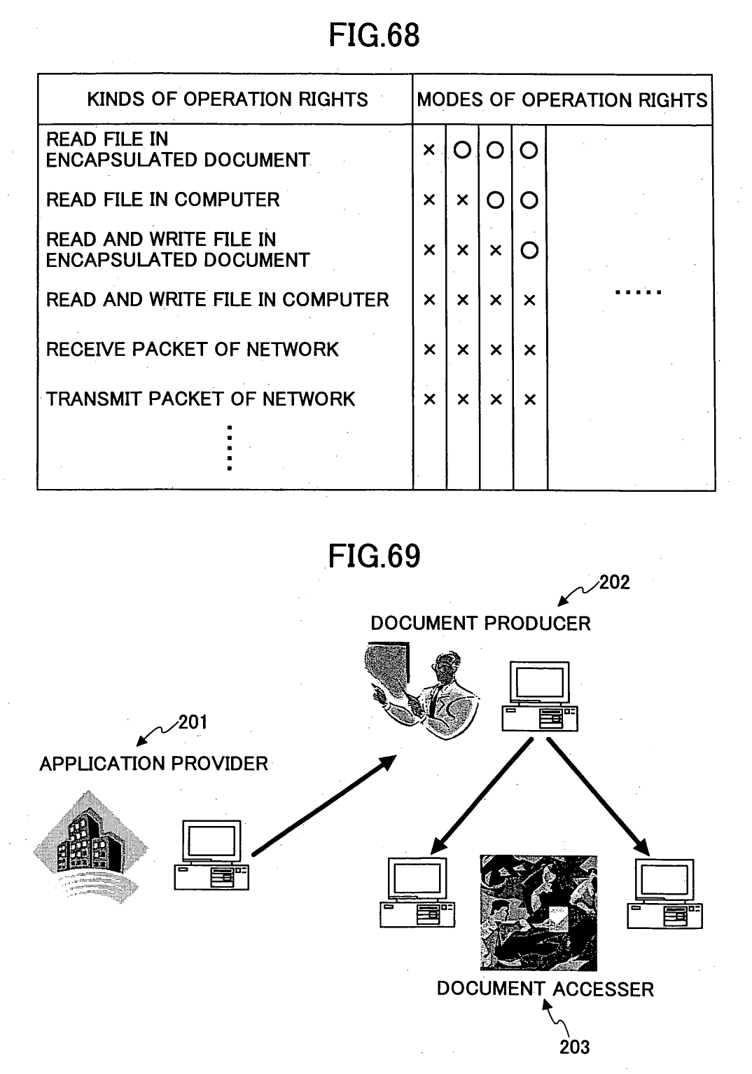

Moreover, the operating program limitation information that limits execution of an operating program in response to safeness of a plurality of operating programs may be stored in the operating program use information. This can be achieved by preparing a plurality of keys for encrypting the operating program so as to change the key for encryption and decryption in response to the operation rights of the operating program. As an example, as shown in a table shown in FIG. 68, the key for encryption is prepared in accordance with the modes of operating rights such as permission and non-permission of reading and writing of files, transmission and reception through a network, etc., and the operation rights information needed when executing the operating program may be displayed to the document accesser so as to obtain a permission from the document accesser to start the operating program within the mode of the operation rights.

Additionally, the above-mentioned operating program is preferably described in an intermediate language code. If the operating program is described in the intermediate language, the type dependency of the computer can be eliminated if a compiler or an interpreter program, which can interpret and execute the intermediate language, is installed in the computer. JAVA (trademark of Sun Microsystems) language is such an intermediate language. Using JAVA language, the computation process of the operating program can be simplified. However, the present JAVA language is for developing an application that runs on a computer, and does not define the electronic document file such as mentioned above.

Next, a description will be given of a system structure for performing an electronic document authentication using the above-mentioned electronic document file. FIG. 69 is an illustration showing an entire structure of an electronic document authentication system using the electronic document file according to the present invention. The electronic document authentication system comprises an application provider 201, a document producer 202 and a document accesser 203. Arrows in the figure indicate directions of sending the electronic document file.

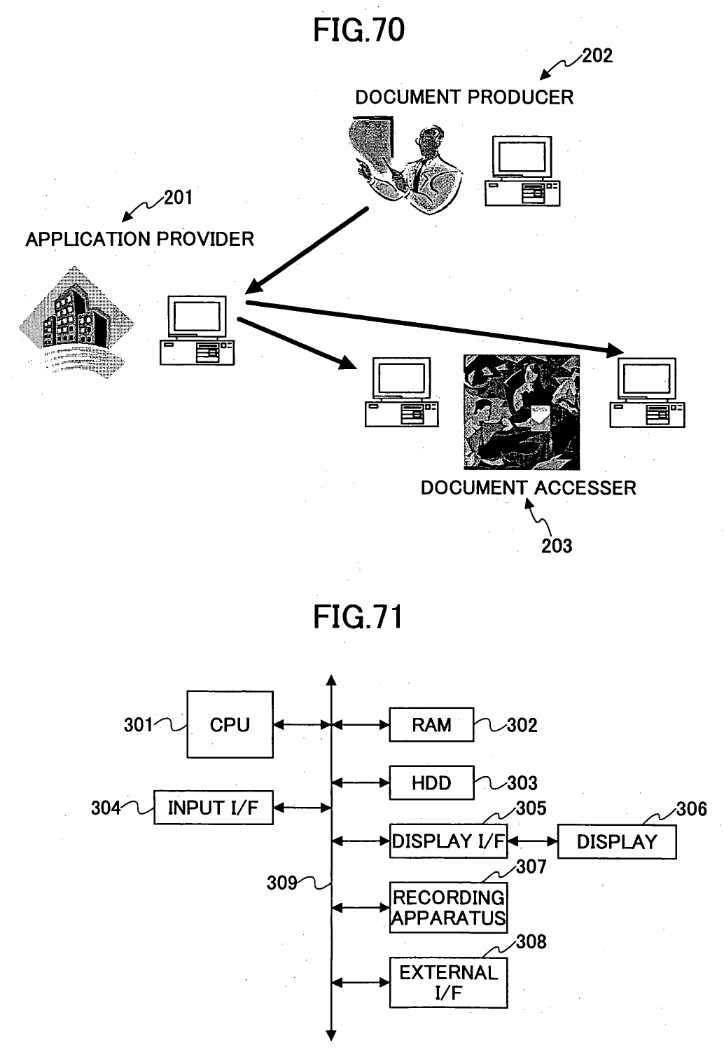

The electronic document authentication system can also be constituted as shown in FIG. 70. In the electronic document authentication system shown in FIG. 70, the document producer 202 produces first a contents file and contents file use information according to a format of the contents file and contents file use information determined by the application provider 201. The produced contents file and contents file utilization information are sent to the application provider 201. Under that circumstances, address information of the document accesser 203 to whom the electronic document file is distributed may be sent to the application provider 201. The application provider 901 selects operating programs and operating program use information required for operating the contents (a static image, a dynamic image, a 3D image, a music, etc) described in the received contents file. The application provider 201 produces the electronic document file having the structure shown in FIG. 62 by using the selected electronic document file and operating program use information and the contents file and the contents file use information produced by the document producer 202.

Then, the application provider 201 distributes the produced electronic document file to the document accesser 203 according to the address information of the document accesser 203 which was sent from the document producer 202. The document accesser 203 performs a tamper verification on the operating program in the electronic document file, and if there is no tamper found, the document accesser 203 executes the operating program so as to access the contents file in the electronic document file. Although the application provider 201 distributes the electronic document file to the document accesser 203 in the above example, the application provider 201 may send back the produced electronic document file to the document producer 202 so that the document producer 202 distributes the electronic document file to the document accesser 903.

Next, a description will be given, with reference to FIG. 71, of a typical hardware structure of a computer used by the application provider, the document provider and the document accesser in the electronic document authentication system. The hardware shown in FIG. 71 comprises a central processing unit (CPU) 301 performing various controls and processes in the electronic document authentication system, a random access memory (RAM) 302, a hard disk drive (HDD) 303, an input interface (I/F) 304 including a pointing device such as a mouse, a keyboard, a button, etc, a display 306 such as a cathode ray tube (CRT), a recording apparatus 307 such as a compact-disk-rewritable (CD-R), and an external I/F 308 for wired or wireless connection with an external apparatus such as an image inputting device or a printer or an electric communication line such as the Internet. The above-mentioned parts are connected to each other via a bus 309.

The RAM 302 is used as a work area of the CPU 301, and also used as a recording area for a plurality of operating programs for performing the processes in the electronic document authentication system and fixed information such as other control programs. The operating programs are loaded to the RAM 302 through the recording apparatus 307, for example, or leaded to the RAM 302, if necessary, after temporarily stored in the HDD 303, or loaded to the RAM 302 through the electric communication line connected to the external I/F 308.

The document producer reads the electronic document file of the structure shown in FIG. 62 using the hardware as shown in FIG. 71, and describes the document contents to be sent to the document accesser in the contents file. Under that circumstances, three programs are recorded in the recording apparatus 307, that are, a program for reading the operating progams and the operating program use information in the electronic document file, a document producing program, and an electronic document file producing program for producing an electronic document file from the read operating program and operating program use information and the produced contents file and contents file use information.

A description will be given of another embodiment.

The electronic document file according to the embodiment described below can prevent a tamper of the contents file produced by the document producer or prevent a use of contents which may infringe copy rights or against public order in the contents file by adding a contents verification program to one of a plurality of operating programs. A specific configuration of the electronic document file is the same as that shown in FIG. 62. The contents verification program performs limitation of use of contents in the contents tamper verification contents filed based on the contents file use information.

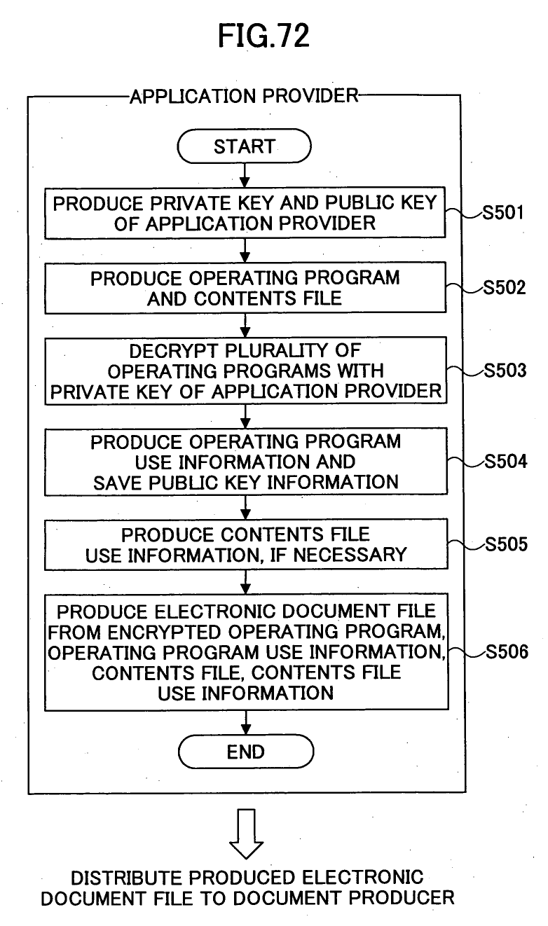

A description will be given of a tamper verification of the contents file. First, a description will be given of a process performed by an application provider. FIG. 72 is a flowchart showing a process procedure for tamper verification on the contents file performed by the application provider. First, the application provider produces a private key and a public key (step S501). Next, the application provider produces operating program contents file (step S502). Then, the application provider encrypts an operating program with the private key of the application provider (step S503). The application provider produces operating program use information, and stores the public key information (step S504). The application provider produces, if necessary, the contents file use information (step S505). The application provider produces an electronic document file constituted by the encrypted operating program, the operating program use information, the contents file and the contents file use information (step S506). Then, the thus-produced electronic document file is distributed to a document producer.

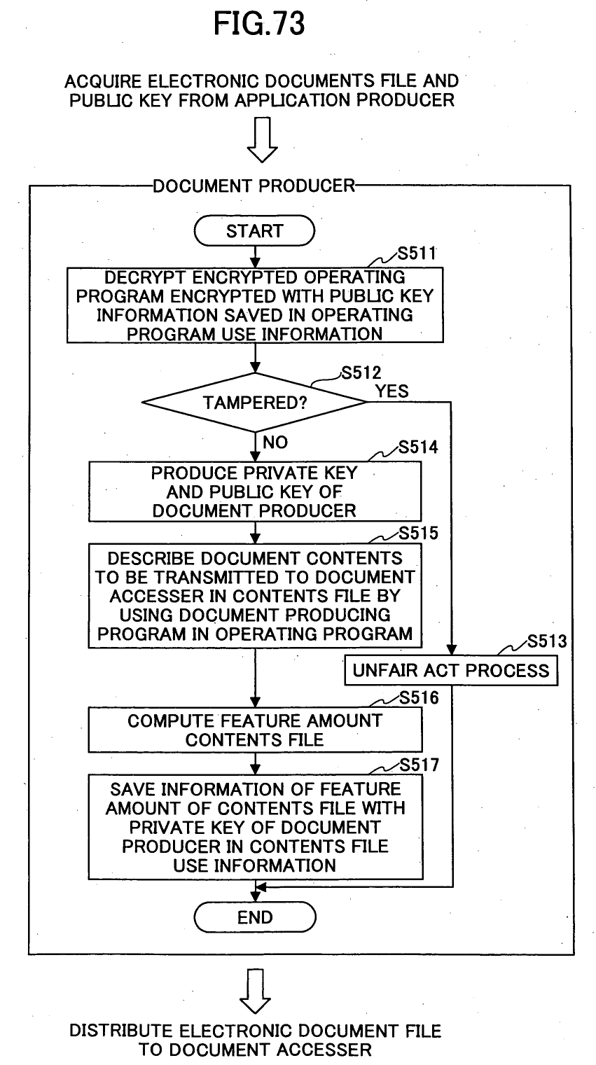

Next, a description will be given of a process performed by a document producer. FIG. 73 is a flowchart showing a process procedure for tamper verification of the contents file performed by the document producer. First, the document producer acquires the electronic document file distributed by the application provider, and decrypts the encrypted operating program with the public key information stored in the operating program use information in the electronic document file (step S511). Next, the document producer performs authentication based on the signature information of the operating program so as to check an existence of a tamper (step S512). If there is a tamper or alteration found (Yes of step S512, it is determined that there was an unfair act (step S513), and the process is ended (that is, the producing process of a document is ended). On the other hand, if there is no tamper or alteration found (No of step S512), the document producer produces a private key and a public key that are peculiar to the document producer, in the same manner as the application provider (step S514). Then, the document producer describes the document contents to be sent to the document accesser in the contents file by using the document producing program in the operating program (step S515). Then, the document producer computes an amount of the contents file from the contents file in the same manner as the above-mentioned embodiment (step S516). Thereafter, the document producer decrypts the computed feature amount with the private key retained by the document producer, and stores the encrypted feature amount of the contents file as the contents file use information (step S517) Thereafter, the electronic document file produced by using the operating program and operating program use information provided by the application provider and the contents file and contents file use information produced by the document producer is distributed to a document accesser.

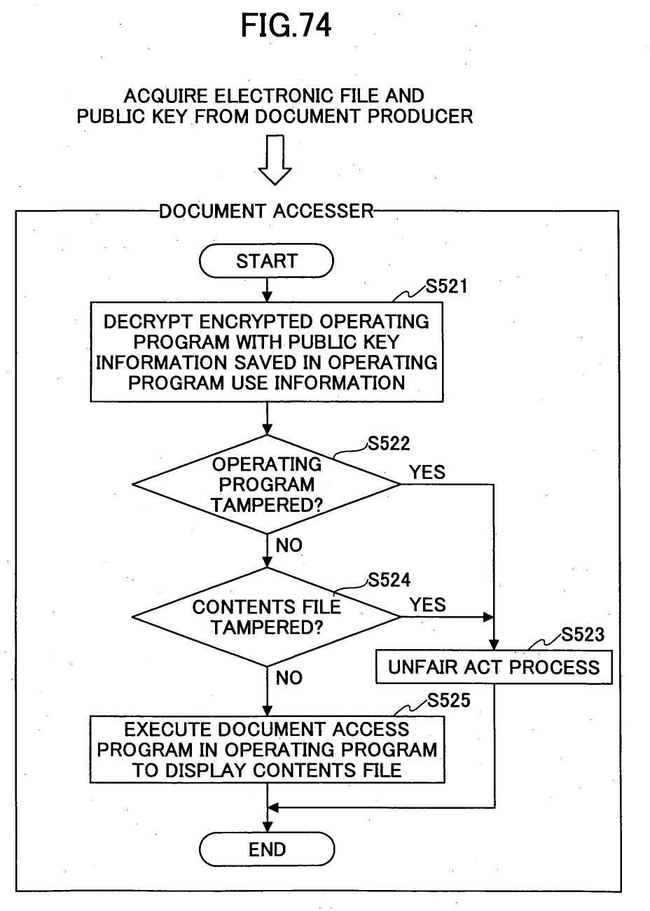

Next, a description will be given of a process performed by the document accesser. FIG. 74 is a flowchart showing a process procedure for tamper verification on the contents file performed by the document accesser. First, after acquiring the electronic document file distributed by the document producer, the document accesser decrypts operating programs using the public key information stored in the operating program use information in the electronic document file (step S521). Next, the document accesser authenticates the signature information, which the application provider signed the operating program, using an operation verification program which is one of the operating programs so as to perform a tamper verification (step S522). When there is found a tamper or alteration (Yes of S522), it is determined that there was an unfair act (step S523), and the process is ended (that is, the access to the document file is stopped). On the other hand, if there is no tamper or alteration found (No of step S522), the contents verification program, which is one of the operating programs, is executed so as to decrypt the encrypted feature amount of the contents file stored in the contents file use information.

Then, the document accesser performs a tamper verification by comparing a result of decryption with a newly computed result of the feature amount of the contents file (step S524). If there is an tamper or alteration found (Yes of step S521), it is determined that there was an unfair act (step S523), and the process is ended (that is, the access to the document file is stopped). If there is no tamper or alteration found (No of step S524), a document access program, which is one of the operating programs, is executed so as to display the contents file (step S525). By going through the above processes, the document accesser can confirm that the document contents in the distributed electronic file is one which was produced by the document producer who signed the contents file.

Moreover, in a case of limiting copy rights of the contents in the contents file, use limitation information of the contents is stored in the contents file use information. An infringement of the copy rights of the contents may occur when the document producer uses without permission the contents provided by the application provider or the contents provider when the document producer produces an electronic document file or when the document accesser uses the contents in the electronic document file without permission. A description will be given below of a process for protecting copy rights of the contents in the electronic document file.

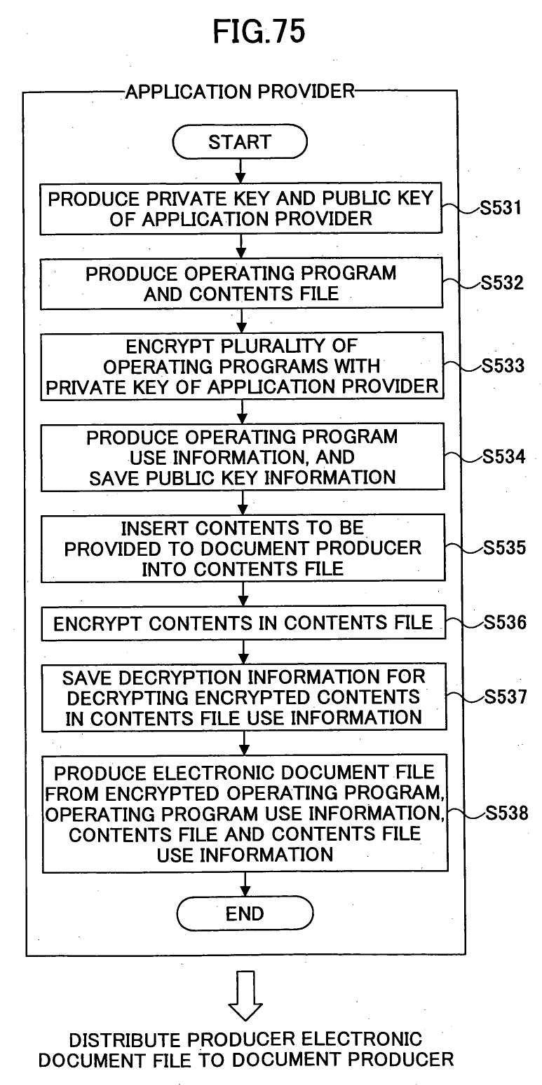

A description will be given first of a process performed by an application provider. FIG. 75 is a flowchart showing a process procedure for protecting copy rights of contents performed by the application provider. First, the application provider produces a private key and a public key (step S531). Next, the application provider produces an operating program contents file (step S532). Subsequently, the application provider encrypts a plurality of operating programs with the private key of the application provider (step S533). Then, the application provider produces the operating program use information, and stores public key information in the information (step S534). Then, the application provider inserts the contents provided to the document producer into the contents file (step S535). The application provider encrypts the contents (contents which the copy rights are claimed) in the contents file (step S536). Then, the application provider stores decryption information for decrypting the encrypted contents in the contents file use information (step S537).

Here, a limitation can be given to the contents available to the document producer by adjusting decryption information to be stored in the contents file use information. For example, if music information is stored in the contents information, the contents information may be decrypted while changing sound quality of the music information in response to the decryption information in the contents file use information. Then, the application provider produces an electronic document file which comprises the encrypted operating program, the operating program use information, the contents file and the contents file use information (step S538). Thereafter, the thus-produced electronic document file is distributed to a document producer.

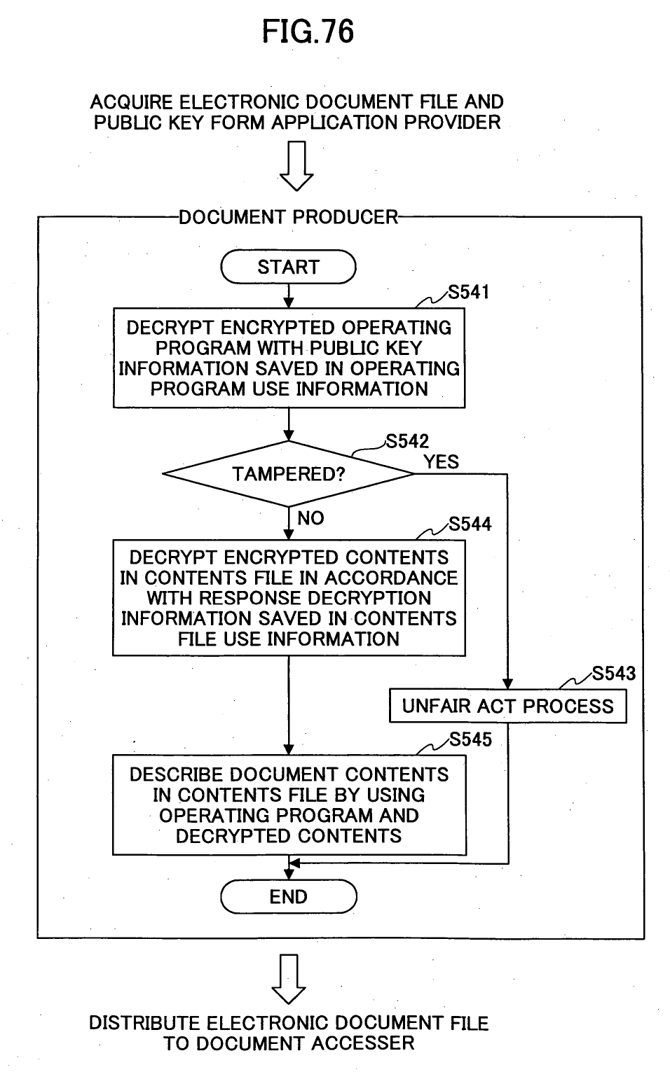

Next, a description will be given of a process performed by the document producer. FIG. 76 is a flowchart showing a process procedure for protecting copy rights of the contents performed by the document producer. First, the document producer acquires the electronic document file distributed by the application provider, and decrypts the encrypted operating program with the public key information stored in the operating program use information in the electronic document file (step S541). Next, the document producer performs an authentication based on the signature information on the operating program so as to check existence of a tamper (step S542). If there is found a tamper or alteration (Yes of step S542), it is determined that there was an unfair act (step S543), and the process is ended (that is, the production of a document is stopped). When there is no tamper or alteration found (No of step S542), the document producer decrypts the encrypted contents in the contents file in response to the decryption information stored in the contents file use information (step S544).

It should be noted that, a program for requesting the decryption information to the application provider may be added if the decryption information stored in the contents file use information is insufficient when decrypting the contents, by adding a contents decryption information request program as one of the operating programs. Then, the document producer describes the document contents to be sent to the document accesser in the contents file by using the operating program and the decrypted contents (step S150). Then, the electronic document file is distributed to a document accesser.

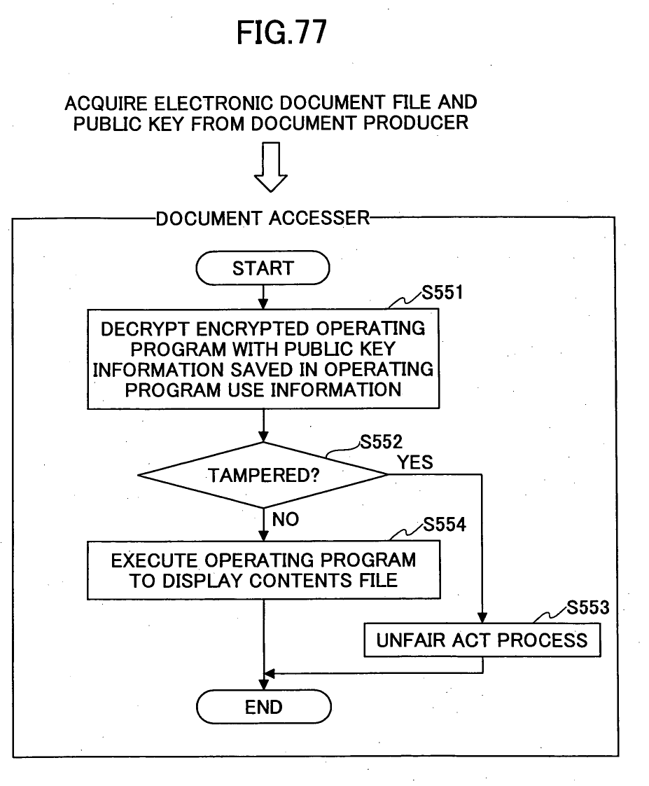

A description will now be given of a process performed be the document accesser. FIG. 77 is a flowchart showing a process procedure for protecting copyright of the contents performed by the document accesser. First, after acquiring the electronic document file distributed by the document producer, the document accesser decrypts an operating program using the public key information stored in the operating program use information in the electronic document file (step S551). Next, the document accesser authenticates the signature information, which was signed on the operating program by the application provider, and performs a verification of a tamper or alteration on the operating program, which may be performed by a malicious document producer (step S552). If there is found a tamper or alteration (Yes of step S552), it is determined that there was an unfair act (step S553), and the process is ended (that is, the access to the document is stopped).

On the other hand, if there is no tamper or alteration found (No of step S552), the document access program, which is one of the operating programs for displaying the contents file, so as to display the contents file (step S554). By going through the above-mentioned process, the limitation in use of the contents by the application provider can be applied so as to claim the copyright of the contents. When protecting the copyright of the contents produced by the document producer, the contents produced by the document producer is encrypted and decryption information for decrypting the encrypted contents is stored in the contents use information. A limitation can be given to the contents available to the document accesser by adjusting the decryption information stored in the contents use information.

Further, by adding a use permission request program to one of the operating programs, when the document producer or the document accesser uses the contents which infringe the copyright in the electronic document file, the owner or the copyright association of the copyright of the contents may be announced to the document producer or the document accesser so as to facilitate communications with the owner of the copyright so that the use permission request can be easily performed.

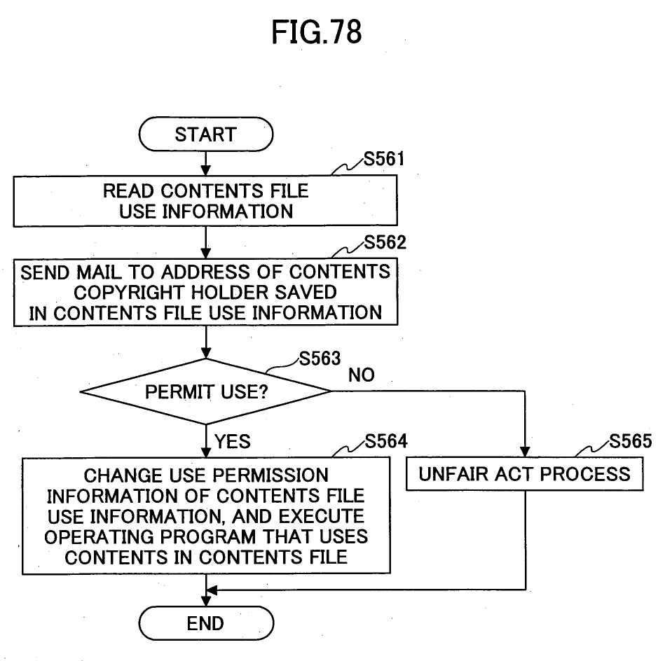

FIG. 78 is a flowchart showing a process procedure for sending the copyright use permission request. First, after execution of the operating program, which uses the contents, on the document accesser side, the address information of the copyright holder described in the contents file use information is automatically read (step S561). Next, an electronic mail is sent to the read address (the copyright holder of the contents) so as to confirm a permission of use of the contents in the electronic document file (step S562). The copyright holder who received the acknowledgement mail determines whether or not to permit use of the contents concerned (step S563). When permitting use of the contents concerned (Yes of step S563), use permission information of the contents file use information is changed so as to execute the operating program which uses the contents in the contents file (step S564). When not permitting use of the contents concerned (No of step S563), it is determined that an unfair act occurred (step S565), and the process is ended. It should be noted that the use permission request program may perform a process of payment of contents use fees simultaneously in addition to the sending the use acknowledgement. Moreover, in order to prevent an unfair use of the contents, the computer address and the user name of the document asseccer who is accessing the electronic document file may be sent to the copyright holder of the contents.

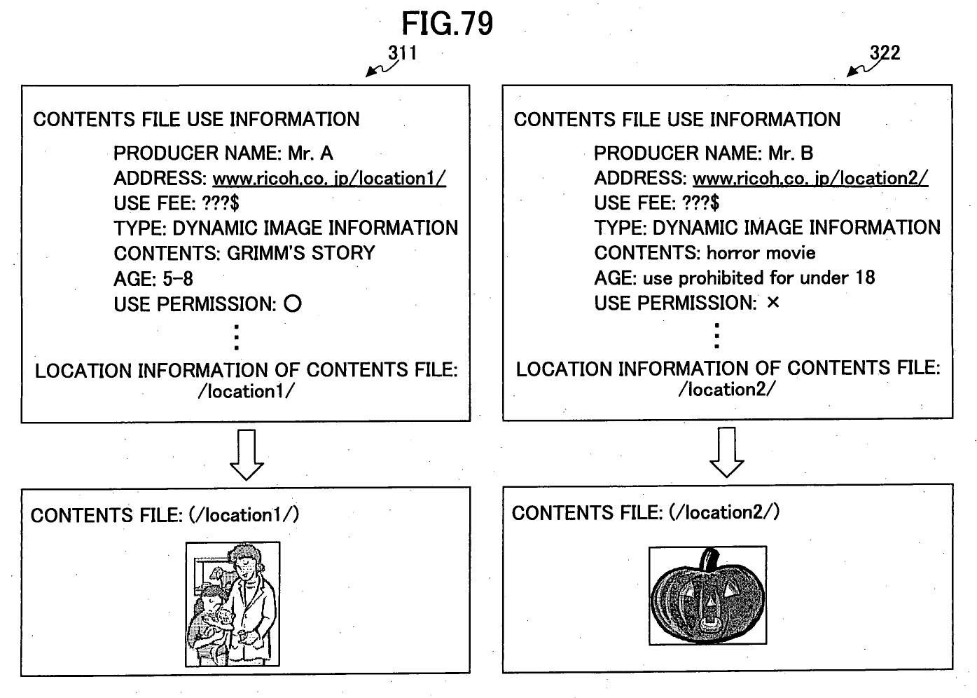

FIG. 79 is an illustration showing a format of the contents file use information that is displayed when sending the use permission request. It should be noted that the formats 301 and 322 shown in FIG. 79 can be described by XML format similar to the operating program use information.

Moreover, when the document producer is permitted to insert external contents into the contents file, the insertion of the external contents may be limited by causing the insertion to always go through the document producing program provided by the application provider. In the document producing program, header information of external contents to be insert is read, and if contents that against public order such as a violent uprising scene are described in the external contents, the insertion of the external contents into the contents file is limited. Moreover, when the document producer wants to insert external contents in a contents file, the external contents to be inserted is sent to the application provider so that the application provider produces contents file use information with respect to the external contents and inserts the external contents into the contents file. The limitation in use of contents may be applied on the document accesser side. Personal information regarding the document accesser may be registered in the document access program so as to apply a limitation in display of contents in the contents file.

A description will now be given of another embodiment of the electronic document authentication system according to the present invention.

In the electronic document authentication system, a document producer and a document accesser are provided with two kinds of electronic document files by the application provider, one if an electronic document file which guarantees that the operating programs contained therein are safe and the other is an electronic document file which does not guarantee that the operating programs contained therein are safe. The document accesser cannot access contents files in an electronic document file without fear if the document file that was distributed from an unknown document producer is the electronic document of which safety is not guaranteed. Although operating programs in the electronic document file of which safety is guaranteed are encrypted by the application provider, operating programs in the electronic document file of which safety is not guaranteed are not encrypted by the application provider. For this reason, a verification of a tamper or alteration cannot be performed on the operating programs in such an electronic document file of which safety is not guaranteed. Thus, the present embodiment is to solve such a problem.

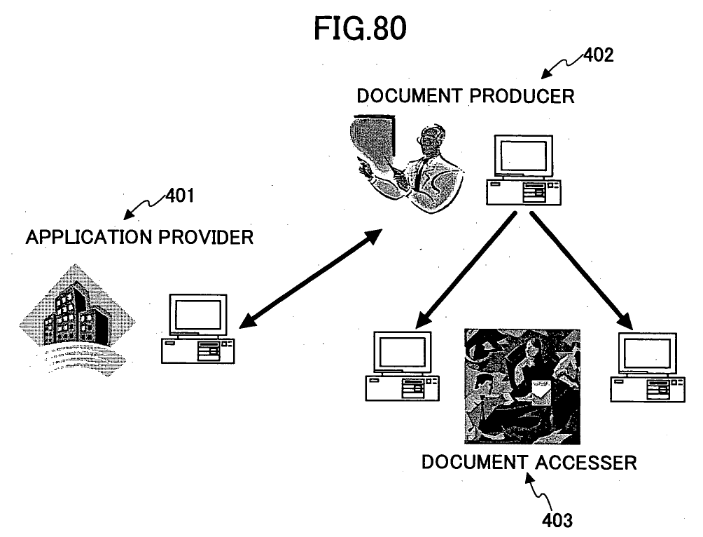

FIG. 80 is an illustration of an entire structure of the electronic document authentication system according to the present invention. The electronic document authentication system shown in FIG. 80 comprises an application provider 401, a document provider 402 and a document accesser 403. In FIG. 80, arrows indicate a direction of sending an electronic file.

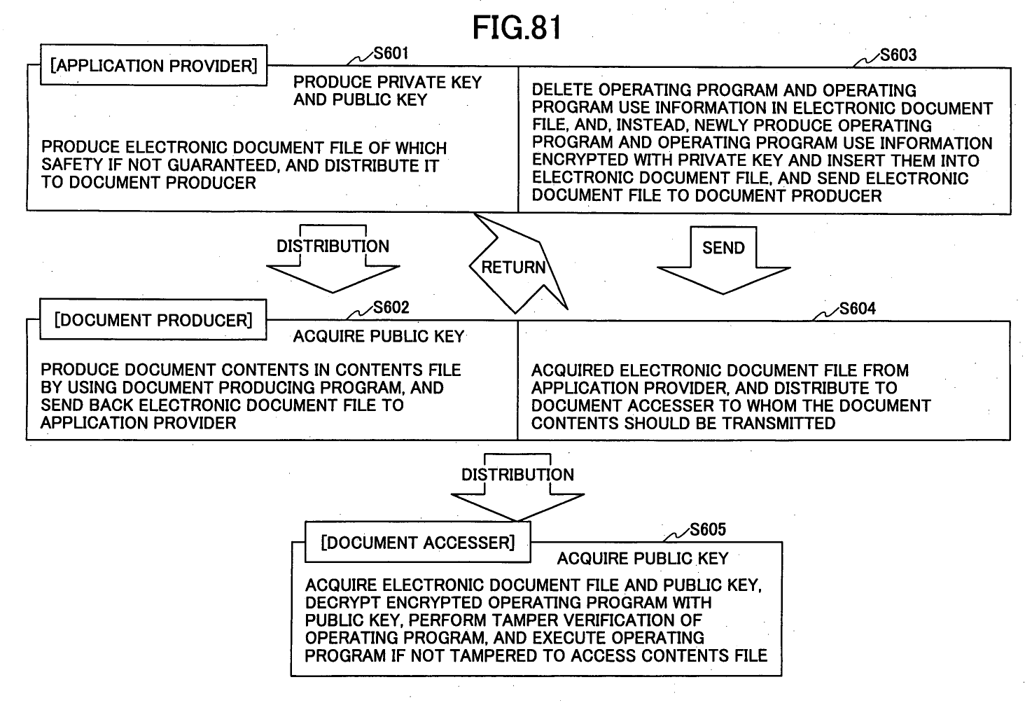

A description will now be given, with reference to FIG. 81, of an outline of the electronic document authentication performed using the above-mentioned electronic document file. In the electronic document authentication, there exist an application provider, a document producer and a document accesser, and the application provider produces an electronic document file (there is no guarantee of safety) and distributes it to the document producer (step S601). The document producer uses the document producing program, which is one of operating programs, so as to produce document contents to be sent to the document accesser, and sends back the electronic document file to the applicaion provider (step S602). Then, the application provider deletes the operating program and the operating program use information in the electronic document file received from the document producer; newly produces operating program and operating program use information encrypted by a private key; inserts them into the electronic document file; and sends the electronic document file to the document producer (step S603). The document producer describes contends to be sent to the document accesser in the contents file of the electronic document file acquired by the application provider, and distributes the electronic document file to the document accesser (step S604). The document accesser acquires the electronic document file and a public key; decrypts the encrypted operating program with the public key; verifies a tamper or alteration of the operating program; and if not altered, executes the operating program so as to access the contents file in the electronic document file (step S605).

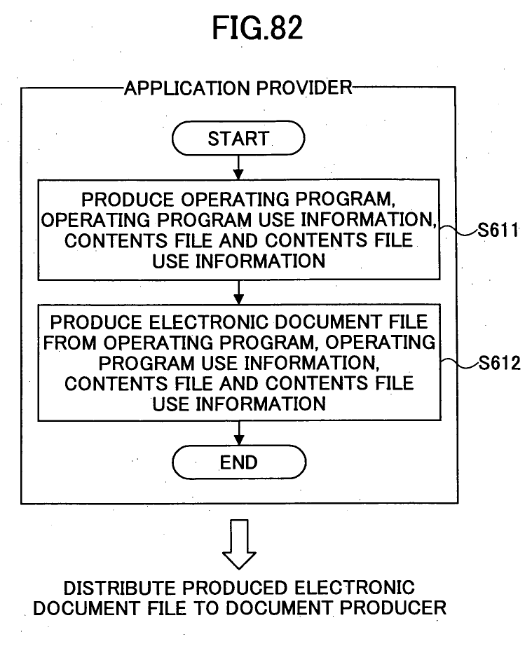

A description will be given in detail of the electronic document authentication. First, a description will be given of a first process performed by the application provider. FIG. 82 is a flowchart showing a process procedure of the first process for the electronic document authentication performed by the application provider. First, the application provider produces an operating program, operating program utilization information, a contents file and contents file use information (step S611). Then, the application provider produces an electronic document file using the operating program, the operating program utilization information, the contents file and the contents file use information produced in step S611 (step S612). Thereafter, the application provider distributes the produced electronic document file to the document producer.

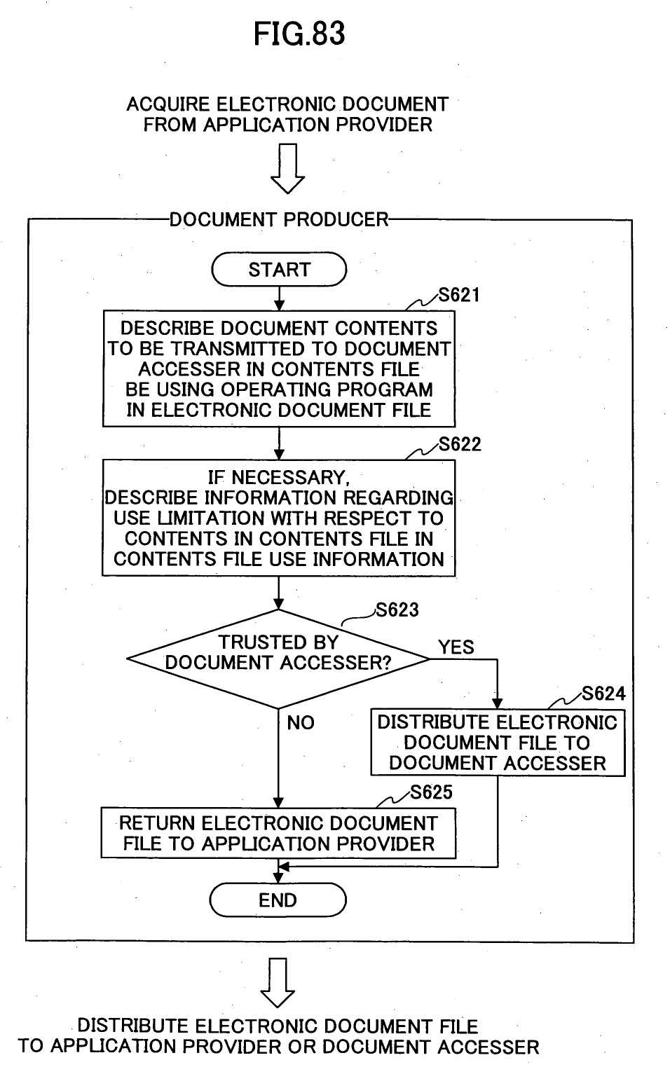

A description will be given of a first process performed by the document producer. FIG. 83 is a flowchart showing a process procedure of the first process for the electronic document authentication performed by the document producer. First, the document producer acquires the electronic document file distributed from the application provider, and describes the document contents to be sent to the document accesser in the contents file by using the document producing program, which is one of the operating programs (step S221). Under the circumstances, unlike the aforementioned embodiment, there is a possibility that the operating program is tampered or altered by the document producer since the operating program is not encrypted. Next, if necessary, the document producer describes information such as use limitation with respect to the contents in the contents file in the contents file use information (step S622). Then, the document producer determines whether or not the document producer is trusted by the document accesser (step S623). If trusted by the document accesser (Yes of step S623), the document producer distributes the produced electronic document file to the document accesser as it is (step S624). If not trusted by the document accesser (No of S623: No), the document producer sends back the produced electronic document file to the application provider (step S625). It should be noted that if there is a function to be added to the operating program, the document producer may inform the application provider of such a function when sending the electronic document file back to the application provider.

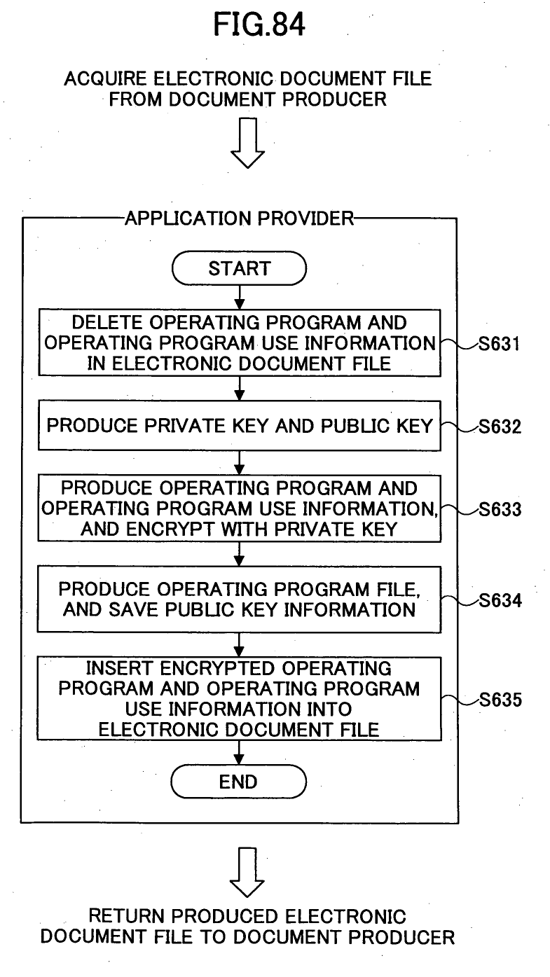

A description will be given of a second process performed by the application provider. FIG. 84 is a flowchart showing a process procedure of the second process for the electronic document authentication performed by the application provider. The application provider acquires the electronic document file sent back from the document producer, and deletes the operating program and the operating program use information in the electronic document file (step S631). Next, the application provider produces a private key and a public key (step S632). Then, the application provider newly produces an operating program and operating program use information, and decrypts the operating program with the private key retained by the application provider (step S633). The application provider stores the public key making a pair with the private key in the operating program use file (step S634). The encrypted operating program and operating program use information are inserted into the electronic document file (step S635). Thereafter, the application provider sends the electronic document file to the document producer.

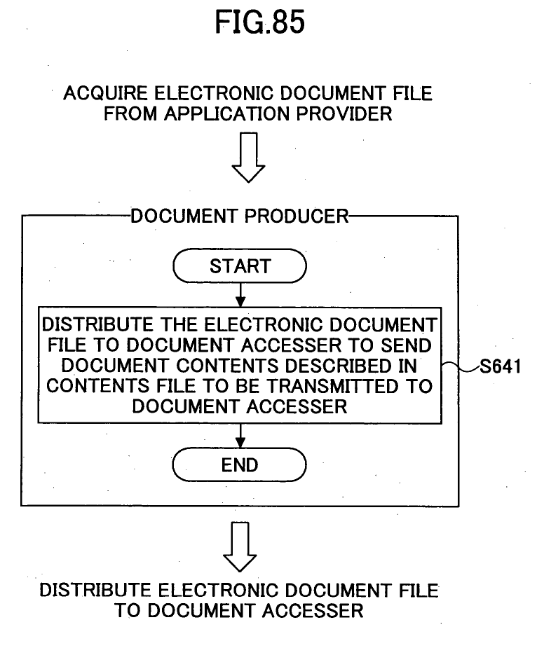

A description will be given of a second process performed by the document producer. FIG. 85 is a flowchart showing a process procedure of the second process for the electronic document authentication performed by the document producer. The document producer acquires the electronic document file from the application provider, and distributes the electronic document file to the document accesser to send the document contents to be transmitted to the document accesser (step S641). Here, since the operating program in the electronic document has been encrypted, the document producer cannot perform a tamper or alteration of the operating program.

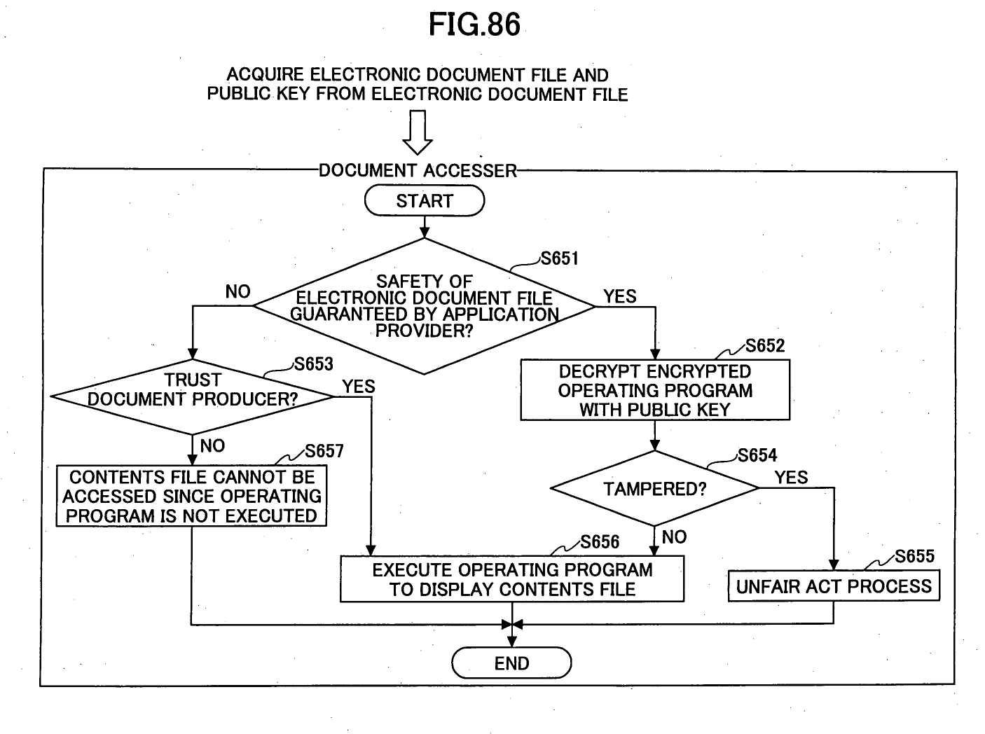

A description will now be given of a process performed by the document accesser. FIG. 86 is a flowchart showing a process procedure for the electronic document authentication performed by the document accesser. First, safety of the document accesser judges whether the acquired electronic document file is guaranteed by the application provider (step S651). Here, the signature information on the operating program may be verified by decrypting the operating program in the electronic document file by using decryption information stored in the operating program use information, or if the operating program is not encrypted when the electronic document file is started, a dialog box may be displayed so as to inform that the application provider does no guarantee safety of the electronic document file. If the safety of the electronic document file is guaranteed by the application provider (Yes of step S651), the process proceeds to step S652. On the other hand, if the safety of the electronic document file is not guaranteed by the application provider (No of step S651), the process proceeds to step S653. If the safety of the electronic document file is guaranteed by the application provider (Yes of step S651), the operating program is decrypted with the public key information stored in the operating program use information in the electronic document file (step S652). Then, the signature information which the application provider signed on the operating program is authenticated by using the operation verification program, which is one of the operating programs, so as to perform a verification of a tamper or alteration of the operating program performed by a malicious document producer (step S654)

If there is found a tamper or alteration found (Yes of step S654), it is determined that there was an unfair act performed (step S655), and process is ended (that is, the access to the document is stopped). If there is found no tamper or alteration (No of step S654), the document access program, which is one of operating programs for displaying the contents file, is executed so as to display the contents file (step S656). On the other hand, if the safety of the electronic document file is not guaranteed by the application provider. (No of step S250), a dialog box is displayed for determination of start of the operating program so as to request a judgment as to whether the document accesser trusts the document producer of the electronic document file (step S653). If the document accesser trusts the document producer (Yes of step S653), the document access program, which is one of the operating programs, is executed so as to display the contents file (step S656). On the other hand, if the document accesser does not trust the document producer (No of step S657), the operating program is not executed so that the contents file is not accessed (step S657).

By going through the above-mentioned processes, the document accesser can judge easily whether the application provider has guaranteed safety by indicating the safety of the electronic document file to the document accesser. Consequently, the document accesser is prevented from erroneously accessing a harmful electronic document file distributed by an unknown document producer.

As explained above, according to the electronic document file and electronic document file producing apparatus according to the present invention, by causing the document producing application to guarantee safety of an electronic document, a harmful electronic document is prevented from been accessed even when the document accesser does not check the document producer, thereby maintaining the security and safety in accessing an electronic document.

As interpreted from the above-mentioned embodiments of the present invention, the description discloses the following invention.

1) An electronic document file comprising: a plurality of operating programs and operating program use information provided by an operating program provider; and a contents file and contents use information produced by the operating program provider or a document producer. Accordingly, the application provider guarantees safety of the electronic document file, and, thereby, the document accesser can access the electronic document file with security even if the document accesser does not know the document producer.

2) In the electronic document file, at least one of the operating programs may be an operation verification program that operates other operating programs based on the operating program use information. Accordingly, the application provider guarantees safety of the electronic document file, and, thereby, the document accesser can access the electronic document file with security even if the document accesser does not know the document producer.

3) In the electronic document file, at least one of the operating programs may be a contents verification program that limits a use of the contents file based on the contents file use information. Accordingly, the application provider guarantees safety of the electronic document file, and, thereby, the document accesser can access the electronic document file with security even if the document accesser does not know the document producer.

4) In the electronic document file, at least one of the operating programs may be an operation verification program that operates other operating programs based on the operating program use information, and at least one of the operating programs is a contents verification program that limits a use of the contents file based on the contents file use information. Accordingly, the application provider guarantees safety of the electronic document file, and, thereby, the document accesser can access the electronic document file with security even if the document accesser does not know the document producer.

5) In the electronic document file, the operation verification program may verify a tamper on the operating programs and the operating program use information. Accordingly, the application provider guarantees safety of the electronic document file, and, thereby, the document accesser can access the electronic document file with security even if the document accesser does not know the document producer.

6) In the electronic document file, the contents verification program may verify a tamper on the contents file and the contents file use information. Accordingly, the decryption information and the use limitation information of the contents file are saved in the contents file use information. Thus, verification of a tamper on the contents file produced by the document producer can be performed. Additionally, use of contents which may infringe copyrights or contents which may against the public order contained in the contents file can be prohibited.

7) In the electronic document file, when safety of the operating programs is not guaranteed by the operation verification program, a user of the electronic document file may be notified of the fact that safety of the operating programs is not guaranteed. Accordingly, when there is a risk in the electronic document, such as risk is announced to the document accesser so as to suggest to the document acceeser not accessing the harmful electronic document file.

8) In the electronic document file, the operating programs, the operating program use information, the contents file and the contents file use information may be encapsulated into a single file. Accordingly, while maintaining security of the electronic document file, mutual exchange, transmission, display, edit, save, print of the electronic document without depending on a computer device and a network environment can be realized, and an electronic document file which can maintain legibility semipermanently can be provided.

9) An electronic document file producing apparatus comprising: reading means for reading a plurality of operating programs and operating program use information; contents file producing means for producing a contents file and contents file use information; and information producing means for producing information to be stored in an electronic document file, wherein the electronic document file comprises: a plurality of operating programs and operating program use information provided by an operating program provider; and a contents file and contents use information produced by the operating program provider or a document producer. Accordingly, the electronic document file producing apparatus can produce the electronic document file mentioned above.

10) In the above-mentioned electronic document file producing apparatus, the contents file producing means may cause one of the operating programs of the electronic document file to be executed. Accordingly, the electronic document file producing apparatus, which produced the above-mentioned electronic document file, can be provided.

11) The electronic document file producing apparatus may further comprise operating program adding means for adding the plurality of operating programs and the operating program use information provided by the operating program provider to the electronic document file based on the contents file and the contents file use information produced by the contents file producing means. Accordingly, the electronic document file producing apparatus, which can add an operating program according to the contents file produced by the document producer, can be provided.

A description will be given below of specific applications in which the encapsulated document file or electronic document file according to the present invention is used.

A description will be given first of an application of the encapsulated document file structure according to the present invention in which a user can pay use fees in accordance with an amount of electronic document produced or an amount of use of application programs.

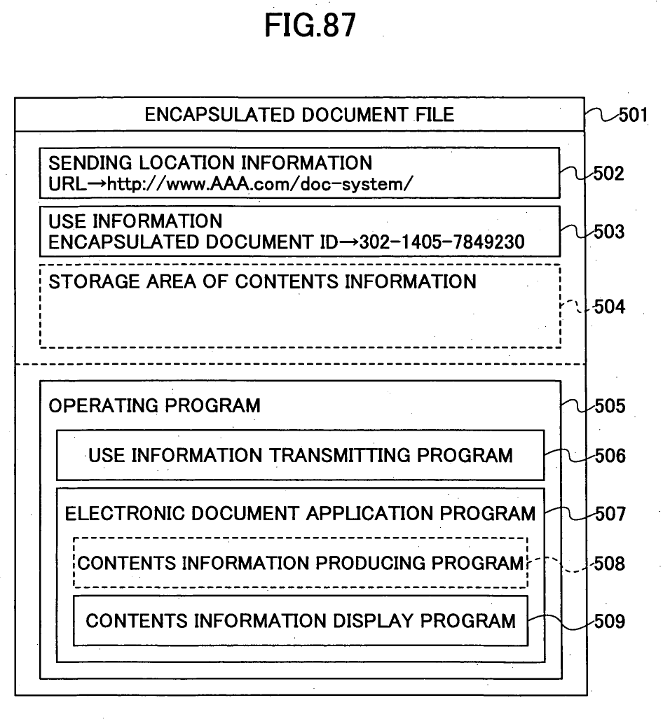

A description will be give of a structure of the encapsulated document file used in the present application. FIG. 87 is an illustration showing a structure o the encapsulated document file used in the present application.

As shown in FIG. 87, the encapsulated document file 501 is constituted by encapsulating sending location information 502, use information 503, a storage area 504 of contents information, which is a substance of expression on a document, and an operating program 505 by encapsulating means. Each of the above-mentioned sets of information has an individual file structure so as to be managed by an operation system of a general-purpose computer.

The sending location information 502 is an address to which the use information 503 is transmitted when the encapsulated document is used. The URL (Uniform Resource Locator) information which, for example, is owned by the provider of the encapsulated document file is described in the address of the sending location information.

The use information 503 is information regarding encapsulated document file 501. As the use information, there are ID number information given to the encapsulated document file 501, log information of a document producer who produces, edits and adds contents information using the encapsulated document file 501, information regarding a feature amount of the contents information produced by the document producer.

The storage area 504 of the contents information is a memory area where the contents information produced, edited or added by the document producer who is a user of the encapsulated document file 501 is stored. The storage area 504 of the contents information may be provided with predetermined amount of information which the provider of the encapsulated document file can store. Or, The storage area 504 of the contents information may be expanded or reduced in response to an amount of information of the contents information, which the document producer stores. Moreover, template information may be stored in the storage area 504 of the contents information beforehand so that the document producer can easily describe the document contents. As examples of the template information, there are information regarding an icon image necessary for executing an operation process with respect to the contents information in a graphic user interface manner and information regarding a background image used when producing the contents information.

The operating program 505 contains an information transmitting program 506, an electronic document application program 507, etc. The use information transmitting program 506 is for transmitting the use information 503 when using the encapsulated document file 501. The electronic document application program 507 includes contents information producing program 508, a contents information display program 509, etc.

The contents information producing program 508 is a program for the document producer producing, editing and adding the contents information in the encapsulated document file 501. As a specific function of the contents information producing program 508, there are a word-processor function, an image edit function, a music edit function, a dynamic image edit function, etc. When the document accesser does not produce, edit or add the contents information by using the contents information producing program 508 in the encapsulated document file 501, the contents information producing program 508 may be deleted from the electronic document application program 507. The contents information display program 509 is a program for displaying the contents information stored in the encapsulated document file 501. As a specific function of the contents information display program 509, there are an image display function, a music reproducing function, a dynamic image reproducing function, etc. Moreover, a print program for printing specific contents information or edit history saving program for saving history information of edition of the contents information, etc., may be inserted into the electronic document application program 507 in addition to the above-mentioned programs.

The encapsulated document 501 having the above-mentioned structure can be stores in various recording media including magnetic recording media such as a flexible disk, a hard disk or a magnetic tape, magneto-optical recording media such as a magneto-optical disk (MO), optical recording media such as CD, CD-ROM, CD-R, CD-RW, DVD-ROM, DVD-R, DVD-RAM, DVD−RW or DVD+RW, and a semiconductor memory, and can be easily carried depending on its kind.

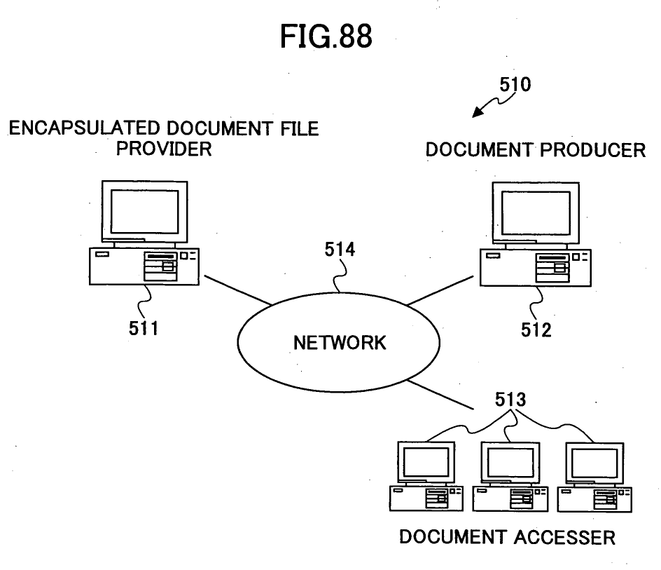

FIG. 88 is an illustration showing an outline of a structure of an electronic document system, which performs a service process for providing the encapsulated document file 501.

As shown in FIG. 88, in the electronic document system 510, a computer 511, which the encapsulated document file provider uses, a computer 511, which the document producer uses and a computer 512, which the document accesser uses, are connected through a network 513. These computers 511, 512 and 513 function as an encapsulated document processing apparatus. It should be noted that the encapsulated document file 501 can be transmitted through the network 513 which is constituted by a wired or wireless communication line such as a local area network (LAN) or the Internet.

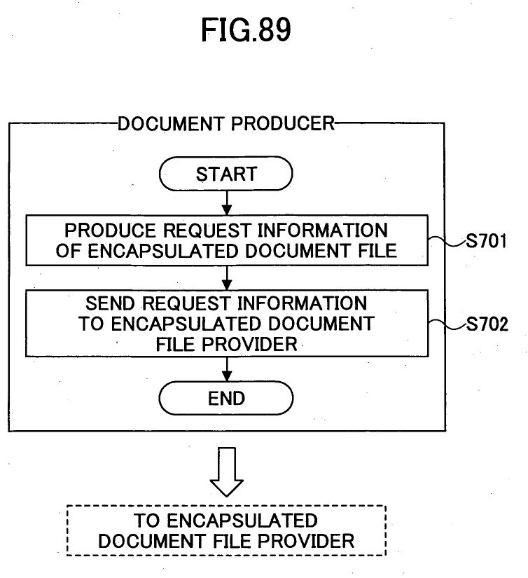

A description will now be given, with reference to FIG. 89 through FIG. 92, of an encapsulated document file offer service process in the encapsulated document system 501. It should be noted that various processes for achieving the encapsulated document file offer service process are performed by CPUs in the computers 510, 511 and 512 based on programs stored in memory devices of each computer and the operating program 505 provided in the encapsulated document file 501.

FIG. 89 is a flowchart showing a flow of a request process of requesting the encapsulated document file 501.

As shown in FIG. 89, in order to acquire the encapsulated document file 501 required to create, edit and add the contents information to be transmitted to the document accesser, the computer 512 produces request information for the encapsulated document file 501 (step S701), and sends the request information for the encapsulated document file 501 to the computer 511 of the encapsulated document file provider through the network 514 (step S702).

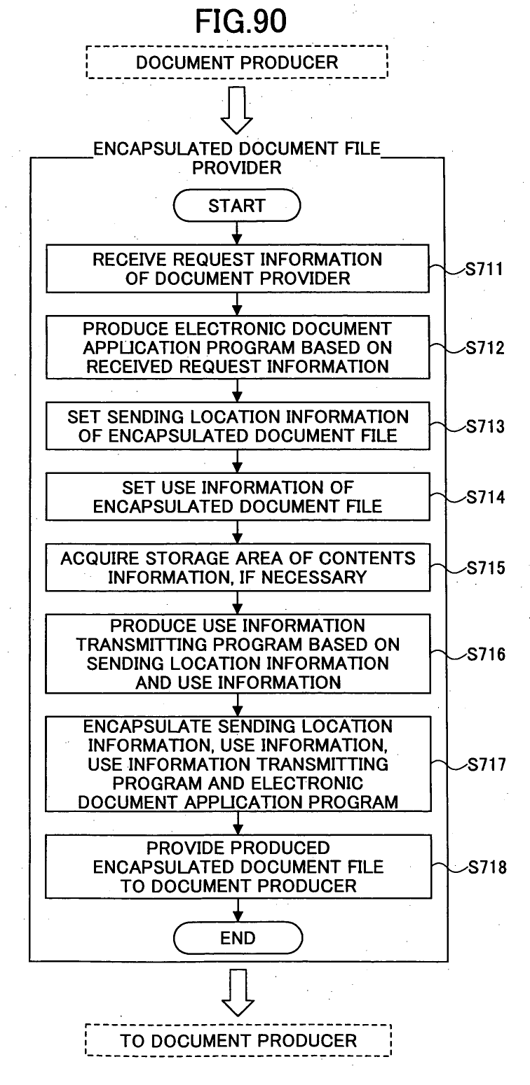

FIG. 90 is a flowchart showing a flow of an offer process of the encapsulated document file 501.

As shown in FIG. 90, the computer 511 of the encapsulated document file provider receives the request information sent from the computer 512 of the document producer (step S711: request information receiving means). In response to the received request information, the contents information producing program 508 and the contents information display program 509 of the electronic document application program 507 are produced (S712: operating program producing means). For example, for a document producer who wants to produce only contents information of music, the contents information producing program 508 having only a music edit function may be produced, or for a document producer who wants to produce only contents information of character document information, the contents information producing program 508 having only a word-processor function may be produced. Next, the sending location information 502 of the encapsulated document file 501 is set (S713: sending location information setting means). Usually, the URL information on the electronic document system 501 which the encapsulated document file provider possesses is set to the sending location information 502. However, when performing fee-charging process of use fees of the electronic document application program 507 by a party other than the encapsulated document file provider, the URL information on the system, which performs the fee-charging process, may be set.

Subsequently, the use information 503 of the encapsulated document file 501 is set (step S714: use information setting means). As the use information 503, there are ID number information of the encapsulated document file 501, user information of the encapsulated document file 501 and information regarding a feature amount of the contents information. The ID number information is information regarding an ID number corresponding to one encapsulated document file 501. Accordingly, it can be managed so that different contents information is not attached to the encapsulated document file 501 of the same ID number, or the contents information is not produced by a different document producer. The user information of the encapsulated document file 501 is log information for checking the identity of the document producer of the encapsulated document file 501. The log information may be produced base on the request information sent from the computer 512 of the document producer. The feature amounts of the contents information is, for example, an electronic fingerprint applied to the contents information produced, edited or added by the document producer. SHA1 (Secure-Hash-Algorithm) is one of methods of computing the feature amount. The fundamental characteristics of SHA1 were described in the aforementioned embodiments. It should be noted that, when the encapsulated document file provider provides the encapsulated document file 501 to the document producer, a feature amount computation program, which computes the feature amount of the contents information, is provided in the operating program 505 since the contents information is not stored, and the feature amount computation program is started automatically when the document producer stores the contents information so as to compute the feature amount of the stored contents information.

Then, the storage area 504 of the contents information is acquired (step S715: storage area acquiring means). The storage area 504 of the contents information is acquired with a limitation in an amount of information, which can be stored therein, based on the request information of the document producer. When performing a fee-charging process of the electronic document application program 507, the charge fee may be set according to an amount of information of the contents information. Moreover, the storage area 504 of the contents information may be expanded or reduced in response to the amount of information of the contents information, which the document producer wants to store in the storage area 504. If an expansion of the storage area 504 is not limited, an information amount detection program, which detects an amount of information of the contents information, may be provided in the operating program 505 so as to automatically start the information amount detection program when the document producer stores the contents information, calculate an amount of information of the stored contents information, and add the result of the calculation to the use information 503. Next, the use information transmitting program 506 is produced (step S716: operating program producing means). The use information transmitting program 506 sends the use information 503 in the encapsulated document file 501 based on the sending location information 502 when the computer 512 of the document producer saves contents information in the encapsulated document file 501. Moreover, the use information transmitting program 506 may send the use information 503 when the electronic document application program 507 is used. Finally, the sending location information 502, the use information 503, use information transmitting program 506 and the electronic document application program 507 are encapsulated into the encapsulated document file 501 (step S717: encapsulating means), and the encapsulated document file 501 is sent to the computer 512, that is, the encapsulated document file 501 is provided to the document producer (step S718: encapsulated document transmitting means). It should be noted that the process of steps S712 through S 717 serves as encapsulated document producing means.

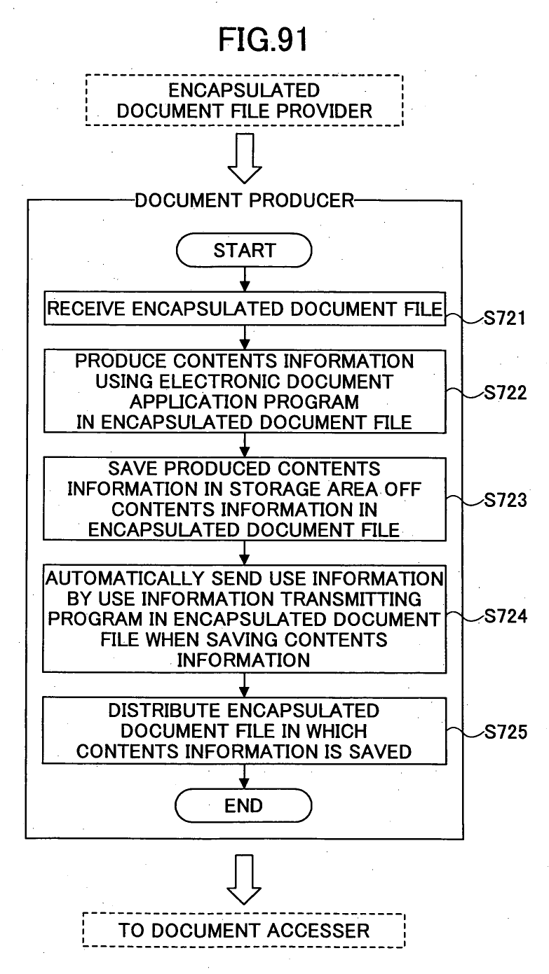

FIG. 91 is a flowchart showing a flow of a distribution process of the encapsulated document file 501.

As shown in FIG. 91, the computer 512 of the document producer receives the encapsulated document file 501 that was provided from the encapsulated document file provider, that is, sent from the computer 511 of the encapsulated document file provider (step S721: encapsulated document receiving means). Next, the computer 512 of the document producer produces, edits or adds the contents information to be transmitted to the document accesser by using the contents information producing program 508, which is one of the electronic document application programs 507 in the encapsulated document file 501 (step S722: contents information producing means). If the contents information producing program 508 is installed in the computer 512 of the document producer, the contents information may be produced, edited or added by using the contents information producing program 508 in the computer 512. The contents information produced, edited or added is saved in the storage area 504 of the contents information (S723: contents information saving means). The use information transmitting program 506 in the encapsulated document file 501 is started automatically when saving the contents information, and the use information 503 in the encapsulated document file 501 is sent to the sending location which is set in the sending location information 502 (step S724: use information transmitting means). The fee-charging process of use fees of the electronic document application program 507 may be performed when the use information 503 is sent by the use information transmitting program 506, or when the computer 511 of the encapsulated document file 501 is provided to the computer 512 of the document producer. The encapsulated document file 501 which retains the contents information is distributed to the document accessers, that is, sent to the computers 513 of the document accessers (step S725 encapsulated document transmitting means).

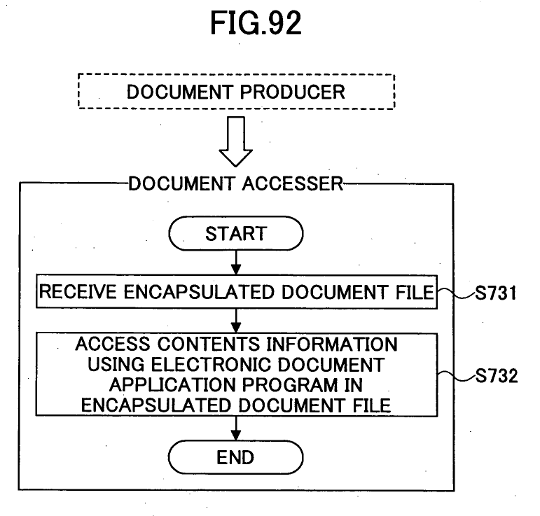

FIG. 92 is a flowchart showing a flow of an access process of the encapsulated document file 501.

As shown in FIG. 92, the computer 513 of the document accesser receives the encapsulated document file 501 that was distributed by the document producer, that is, sent from the computer 512 of the document producer (step S731). When the document accesser executes the encapsulated document file 501 by selecting by an inputting device such as a mouse, the contents information display program 509, which is one of the electronic document application programs 507 in the encapsulated document file 501, starts automatically so as to display the contents information (step S732). Therefore, the contents information can be displayed even when the electronic document application program 507 is not installed in the computer 513 of the document accesser since the contents information display program 509 is encapsulated in the encapsulated document file 501. Such a process is performed as an encapsulated document file offer service process.

As mentioned above, according to the present embodiment, the use information 503 of the encapsulated document file 501 is provided from the computer 512 of the document producer to the computer 511 of the encapsulated document file provider by using the use information transmitting program 506 in the encapsulated document file 501, and, thus, the computer 511 of the encapsulated document file provider is enabled to acquire the use information 503. Therefore, the electronic document application program 507 can be prevented from being falsely used, while the user can pay fees in accordance with a number of electronic documents produced or an amount of use of the electronic document application program.

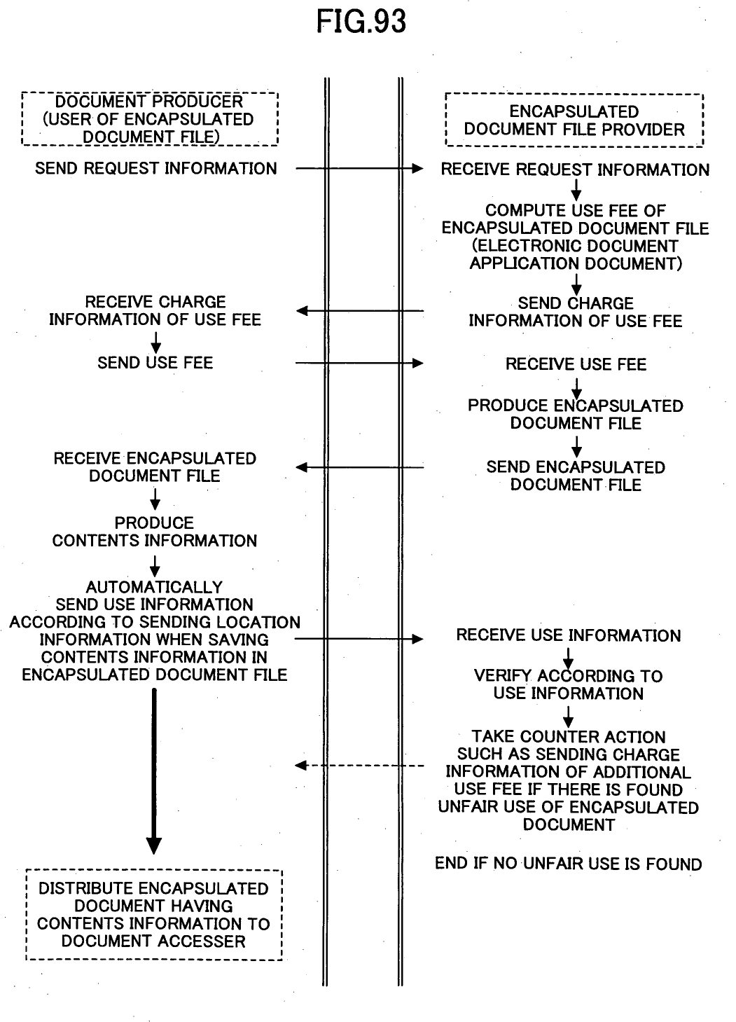

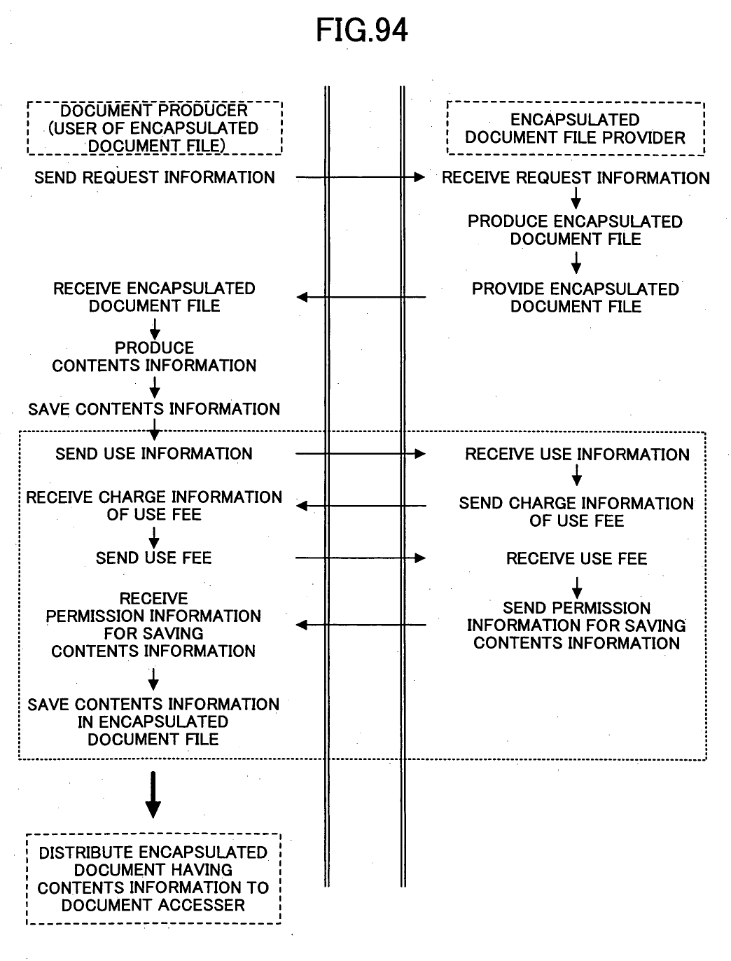

A description will now be given of a fee-charging process for the electronic document application program 507. FIG. 93 and FIG. 94 are illustrations for explaining flows of the fee-charging process (fee collection means) of the use fee of the electronic document application program 507. FIG. 93 shows an example of a process for charging the use fee of the electronic document application program 507 when the encapsulated document file provider provides the encapsulated document file 501 to the document producer. FIG. 94 shows an example of a process for charging the use fee of the electronic document application program 507 when the document producer saves the contents information in the encapsulated document file 501.

As shown in FIG. 93, the computer 512 of the document producer sends the request information of the encapsulated document file 501 to the computer 511 of the encapsulated document file provider.

The computer 511 of the encapsulated document file provider receives the request information sent from the computer 512 of the document producer (request information receiving means), computes the use fee of the encapsulated document file (the electronic document application program 507) 501 from the request information, and produces charge information of the use fee (charge information producing means). Here, the use fee may be computed according to an amount of information of the contents information stored in the encapsulated document file 501, or may be computed by the function of the electronic document application program 507 required for producing the contents information by the document producer. The charge information of the computed fee is sent to the computer 512 of the document producer (charge information transmitting means).

The computer 512 of the document producer receives the charge information of the fee, and sends the payment information of the fee to the computer 511 of the encapsulated document file provider.

The computer 511 of the encapsulated document file provider receives the payment information of the fee (payment information receiving means), produces the encapsulated document file 501 according to the request information of the document producer (encapsulated document producing means), and distributes the encapsulated document file 501 to the document producer, that is, sends the encapsulated document file 501 to the computer 512 of the document producer (encapsulated document transmitting means). Here, the fee-charging process of the use fee may be performed in cooperation with a credit card company or the like.

The computer 512 of the document producer receives the encapsulated document file 501, and produces the contents information using the electronic document application program 507 in the encapsulated document file 501. Then, the produced contents information is saved in the encapsulated document file 501. When saving the contents information, the use information 503 is automatically sent to the computer 511 of the encapsulated document file provider by the use information transmitting program 506.

The compute 511 of the encapsulated document file provider receives the use information 503, and performs a verification of an unfair use of the encapsulated document file 501. When an unfair use of the encapsulated document file 501 is detected as a result of the verification, charge information on an additional amount of use is sent to the document producer so as to charge the fees corresponding to the unfair use. If an unfair use is not performed, the received use information 503 is stored in a memory device, such as a hard disk drive (HDD), provided in the computer 511 of the encapsulated document file provider.

According to the above-mentioned process, the encapsulated document file 501 can be prevented from being falsely used, while the fee-charging process of the electronic document application program 507 is performed.

The fee-charging process of FIG. 94 is different from the fee-charging process of FIG. 93 in that the encapsulated document file 501 is provided at free of charge without performing the fee-charging process when providing the encapsulated document 501 and the fee-charging process is performed when the document producer saves the contents information in the encapsulated document file 501. A description will be given below of only the different point from the process of FIG. 94.

As shown in FIG. 94, when the computer 512 of the document producer performs a saving process of the contents information, the use information transmitting program 506 starts automatically so as to send the use information 503 to the computer 511 of the encapsulated document file provider. The computer 511 of the encapsulated document file provider receives the use information 503 (use information receiving means), computes the use fee based on the use information 503 and produces the charge information of the use fee (charge information producing means), and sends the produced charge information to the computer 512 of the document producer (charge information transmitting means).

The computer 512 of the document producer receives the charge information of the use fee, and sends the payment information of the use fee to the computer 511 of the encapsulated document file provider according to the received charge information.

After the computer 511 of the encapsulated document file provider receives the payment information of the use fee (payment information receiving means) and checks the received payment information of the use fee, the computer 511 sends permission information, which permits execution of the saving process of the contents information, to the computer 512 of the document producer (permission information transmitting means). The permission information may be stored in the use information 503 in the encapsulated document file 501.

Upon receipt of the permission information, the computer 512 of the document producer can save the contents information in the encapsulated document file 501. It is possible to set so that the permission information is automatically deleted once the contents information is saved in the encapsulated document file 501. If the use fee is not paid, as an unfair act preventing process, the permission information is not sent so as to prevent the contents information from being saved n the encapsulated document file 501.

According to the above-mentioned process, the encapsulated document file 501 can be prevented from being falsely used, while the fee-charging process of the electronic document application program 507 is performed.

A description will be given below of an example of a format of the use information 503.

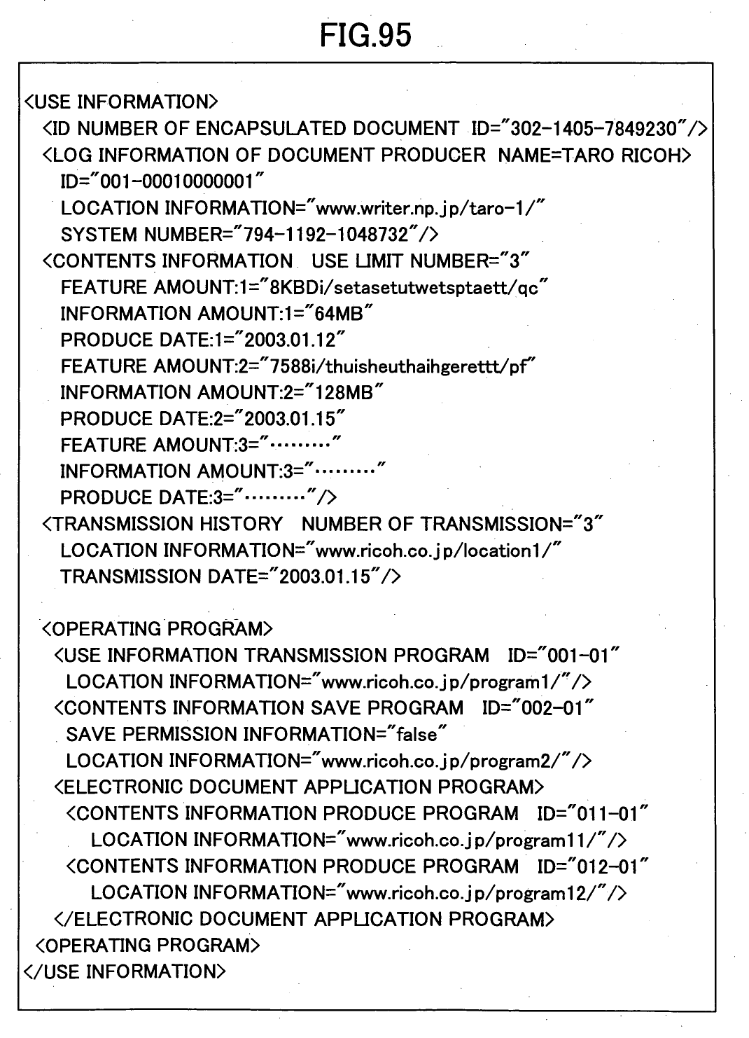

FIG. 95 is an illustration for explaining an example of a format of the use information 503, which is sent by the use information transmitting program 506.

As shown in FIG. 95, the identification number of the encapsulated document file 501 is a number attached to each encapsulated document file 501 so as to discriminate a provided encapsulated document file 501. The ID number is produced and attached by the encapsulated document file provider when the encapsulated document file 501 is provided to the document producer. Moreover, the log information of the document producer is information indicating the identity of the document producer. As an example, the log information includes name information, ID number information and location information of the document producer and system information. The identification number indicates identification number information assigned by the encapsulated document file provider when a document producer registers to the electronic document system 510. The location information indicates network address information of the document producer. The system number is information regarding the system currently used in the computer 512 of the document producer. As a specific example of the system number, there are a product number of a CPU in a computer, a product number of a network card, a user ID number of an operation system, etc. Here, although various examples are mentioned as the log information, any information may be used as long as the identity of the document producer can be checked. Moreover, in order to prevent the log information of the document producer from being accessed by the document accesser, encrypted log information, which is obtained by encrypting the log information of the document producer with encryption key information possessed by the encapsulated document file provider, may be stored n the use information 503.

The contents information indicates information, which the document provider produced, edited or added. As examples of the contents information, there are a number of times limitation, feature amount information, an information amount, produce date information, etc. The number of times limitation indicates a number of times which the electronic document application program 507 in the encapsulated document file 501 can be used. For example, if the value of the limitation in the number of times of use is 3, three encapsulated document files 501 each of which contains different sets of contents information can be produced with respect to one ID number of the encapsulated document file 501. The feature amount information indicates a feature amount of the contents information stored in the encapsulated document file 501. The information amount indicates an amount of information of the contents information. The produce dated indicates time information regarding a time when the contents information was produced. The transmission history indicates history of transmission of the use information 503 performed by the use information transmitting program 506. The transmission number indicates a number of times of transmission of the use information 503. The location information indicates address information of the sending location to which the use information 503 was sent. The sending date indicates information regarding a time when the use information 503 was transmitted.

The operating program 505 indicates a kind of the operating program 505 in the encapsulated document file 501. The use information transmitting program 506 is a program which sends the use information 503. The ID number indicates a kind of the program and version information. Moreover, the location information indicates, if there is no designated operating program 505 in the encapsulated document file 501, the address information storing the operating program 505 executable instead. The contents information save program is a program used when saving the contents information in the encapsulated document file 501. The contents information can be saved when save permission information indicates “true”, and cannot be saved when the save permission information indicates “false”. The save permission information turns to “true” when permission information, which is sent from the encapsulated document file provider, is received. The electronic document application program 507 indicates a kind of the operating program 505 regarding production or display of the electronic document. The contents information producing program 508 indicates a program used by the document producer to produce, edit or add the contents information. The contents information display program 509 indicates a program which is used by the document producer to display the contents information stored in the encapsulated document file 501.

A description will now be given of an unfair use detection process.

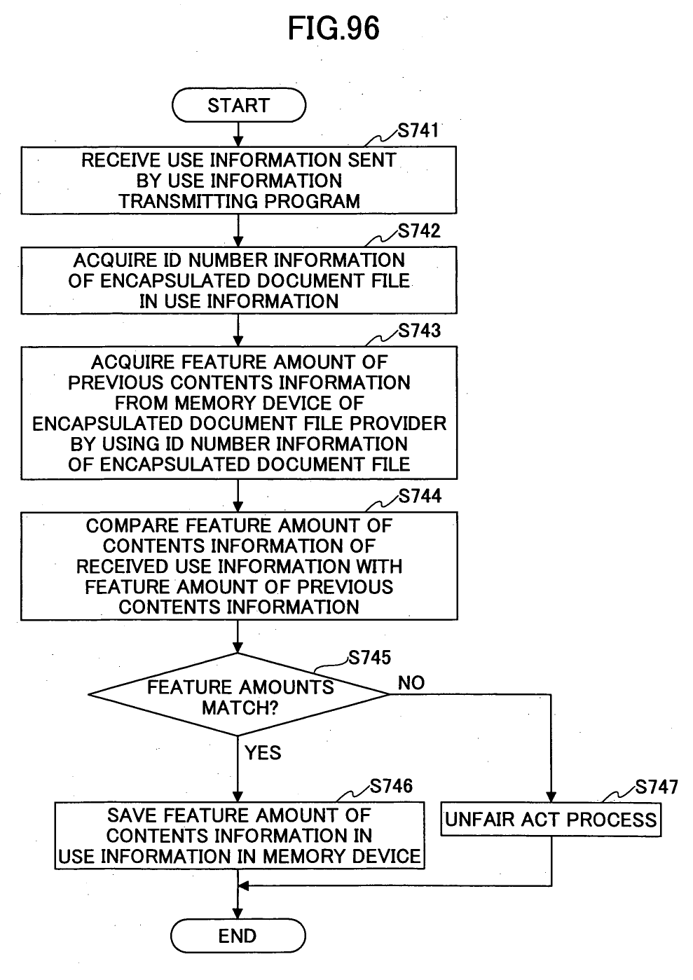

FIG. 96 is a flowchart showing a flow of the unfair use detection process for detecting unfair use of the encapsulated document file 501. The unfair use detection process is a process for detecting unfair use of the encapsulated document file 501 by using a feature amount of the contents information in the use information 503.

As shown in FIG. 96, the computer 511 of the encapsulated document file provider receives the use information 503, which is sent from the computer 512 of the document producer by the use information transmitting program 506 in the encapsulated document file 501 (step S741: use information receiving means). The ID number information of the encapsulated document file 501 in the received use information 503 is acquired (step S742: ID number information acquisition means). Here, the use information 503 has feature amount information and ID number information of the contents information. The feature amount information serves as unfair act discrimination information. Next, the feature amount of the contents information previously saved is acquired from a memory device such as a hard disk drive of the computer 511 of the encapsulated document file provider by using the ID number information of the acquired encapsulated document file 501 (step S743: unfair discrimination information acquisition means). If the feature amount information of the contents information was not saved in the past, the feature amount information of the contents information turns to “null”. When the feature amount information in the past is “null”, the feature amount of the contents information in the received encapsulated document file 501 is stored in the memory device such as a hard disk drive. Subsequently, the feature amount information of the received contents information is compared with the feature amount information of the contents information in the past. (step S744: unfair discrimination information comparison means). If the two sets of feature amount information are equal to each other (Y of step S745), this indicates that the same contents information is stored in the encapsulated document file 501 having the same ID number information. Thus, the same ID number is not saved or overwritten (step S746), and the unfair act detection process is ended without performing the unfair preventing process. On the other hand, if the two sets of feature amount information are not equal to each other (N of step S745), this indicates that different contents information is stored in the encapsulated document file 501 having the same ID number information, and, thus, the unfair preventing process is performed (S747: unfair act prevention execution means). If the use limitation number of the encapsulated document file 501 is set grater than 1, the unfair act preventing process (counter action) is performed in the encapsulated document file 501 having the same ID number when different feature amounts of the contents information that exceeds the use limitation number are detected. As the unfair act preventing process, there are processes of requesting payment of use fee by sending charge information of the additional amount of use to the computer 512 of the document producer so as to charge the use fee for the unfair use, or saving the log information of the document producer who conducted the unfair use in a memory device such as a hard disk drive (HDD) of the computer 511 of the encapsulated document file provider comprises. According to the above-mentioned process, an unfair use of the encapsulated document file 501 can be detected. The log information of the document producer may be used for detection of an unfair use instead of using the feature-amount information of the contents information as unfair act discrimination information, or both sets of information may be used.

Here, the computer 511 of an encapsulated document file provider may limit the time of use of the electronic document application program 507 in the encapsulated document file 501 by acquiring a time when the use information 503 sent by the use information transmitting program 506 in the encapsulated document file 501 is received. Generally, in the electronic document application program 507 having a limitation in its time of use distributed for the purpose of performance evaluation, the time of use is limited in accordance with time information acquired from the operation system of the computer 512 of the user who uses the application program 507 concerned. Thus, if the user changes the time information of the operation system, the limitation for the time of use of the electronic document application program 507 cannot be applied. However, in the encapsulated document file 501 of the present embodiment, since the use information 503 is sent to the computer 511 of the encapsulated document file provider when the encapsulated document file 501 is used, the computer 511 of the encapsulated document file provider can apply a limitation in the time of use of the electronic document application program 507 without depending on the time information of the operation system of the user side by acquiring the time information from the operation system of the computer 511 of the encapsulated document file provider.

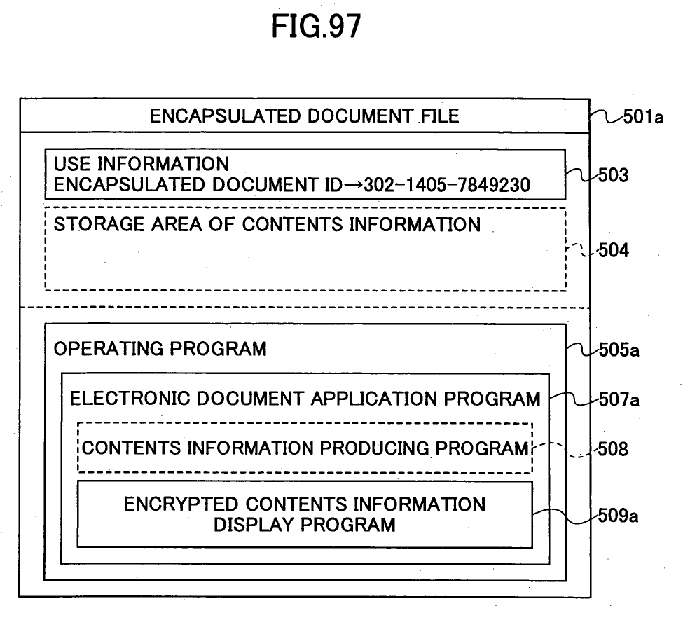

A description will be given below, with reference to FIG. 97, of an example of the file structure of the encapsulated document file according to another embodiment of the present invention.

The encapsulated document file 501a shown in FIG. 97 has a file structure basically the same as the above-mentioned encapsulated document file 501 except that the encapsulated document file 501a does not have the transmission place information 502, and an operating program 505a does not have the use information transmitting program 506. Furthermore, an electronic document application program 507a has an encrypted contents information display program 509a instead of the contents information display information 509. It should be noted that in FIG. 97, parts that are the same as the parts shown in FIG. 87 are given the same reference numerals, and descriptions thereof will be omitted.

As shown in FIG. 97, the electronic document application program 507a includes the contents information producing program 508 and the contents information display program 509a encrypted by the encapsulated document file provider.

The encrypted contents information display program 509a is a program in the state where the program for displaying the contents information in the encapsulated document file 501a is encrypted by the encapsulated document file provider. Moreover, similar to the previously mentioned embodiment, an application program other than the above-mentioned programs may be provided in the electronic document application program 507a if needed.

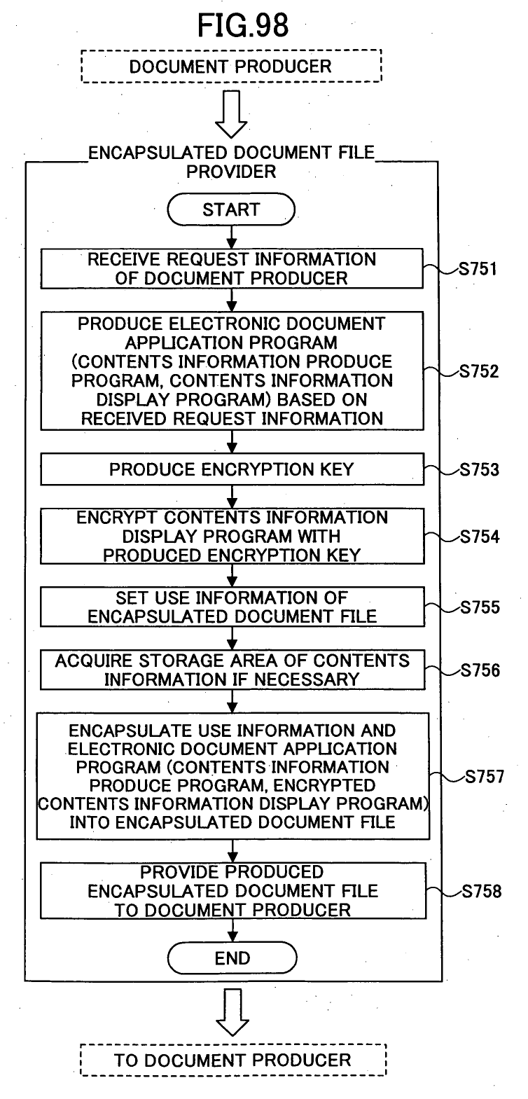

FIG. 98 is a flowchart showing a flow of an offer process of the encapsulated document file 501a.

As shown in FIG. 98, the computer 511 of the encapsulated document file provider receives the request information sent from the computer 512 of the document producer (step S751: request information receiving means). In response to the received request information, the computer 511 of the encapsulated document file provider produces the contents information producing program 508 and the contents information display program 509 of the electronic document application program 507a (step S752: operating program producing means). Next, an encryption key which is possessed by the computer 511 of the encapsulated document file provider is produced (step S753: encryption key producing means). Then, the contents information display program 509a is encrypted with the produced encryption key (S754: operating program encryption means). Subsequently, the use information 503 of the encapsulated document file 501a is set up (S755: use information setting means). As the use information 503, there are an ID number of the encapsulated document file 501a, user information of the encapsulated document file 501a, a feature amount of the contents information, etc. Then the storage area 504 of the contents information is acquired (S756: storage area acquisition means). The storage area 504 of the contents information may be acquired by limiting an amount of information that can be stored therein based on the request information of the document producer, or the storage area 504 may be expandable or reduceable in accordance with an amount of information of the contents information, which the document producer wants to save. Finally, the computer 511 of the encapsulated document file provider encapsulates the sending location information 502, the use information 503, and the electronic document application program 507a into the encapsulated document file 501a (S757: encapsulation means), and provides the encapsulated document file 501a to the document producer, that is, sends the encapsulated document file 501a to the computer 512 of the document producer (S758: encapsulated document transmitting means). It should be noted that the process of step S752 through step S757 serves as encapsulated document producing means.

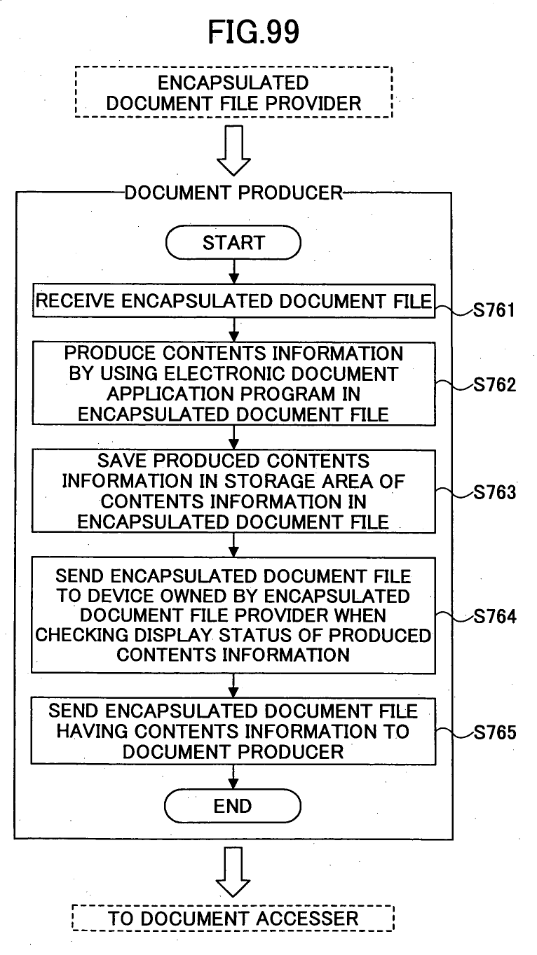

FIG. 99 is a flowchart showing a flow of a distribution process of the encapsulated document file 501a.

As shown in FIG. 99, the computer 512 of the document producer receives the encapsulated document file 501a, which was provided from the encapsulated document file provider, that is, sent from the computer 511 of the encapsulated document file provider (step S761). Next, the computer 512 of the document producer produces, edits or adds the contents information to be transmitted to the document accesser by using the contents information producing program 508, which is one of the electronic document application programs 507a in the encapsulated document file 501a (step S762), and saves the contents information in the storage area 504 of the contents information (S83). If the contents information producing program 508 is installed in the computer 512 of the document producer, the contents information may be produced, edited or added using the contents information producing program 508 in the computer 512. Moreover, in order to check the display state of the contents information when producing the contents information, the encapsulated document file 501a is sent to a specific decryption apparatus (not shown in the figure: decryption means), which the computer 511 of the encapsulated document file provider holds (step S764), and the display information of the contents information is sent to the computer 512 of the document producer. By receiving the display information of the contents information, the computer 512 of the document producer can check the display state. The fee-charging process of the use fee of the electronic document application program 507a may be performed when sending the display information of the contents information to the computer 512 of the document producer, or may be performed when the computer 511 of the encapsulated document file provider provides the encapsulated document file 501a to the computer 512 of the document producer. Finally, the computer 511 of the encapsulated document file provider distributes the encapsulated document file 501a, which retains the contents information, to the document accesser, that is sends the encapsulated document file 501a to the computer 513 of the document accesser (S765).

Thus, in the present embodiment, the contents information display program 509a to be provided can be prevented from being falsely used by providing the encrypted contents information display program 509a in the encapsulated document file 501a, and even if, for example, the document producer produces, edits or adds the contents information, the document producer is prevented from distributing the encapsulated document file 501a to the document accesser's computer 513 without going through the encryption apparatus provided to the computer 511 of the encapsulated document file provider since the contents information in the encapsulated document file 501a is not displayed unless the encapsulated document file 501a is sent to the specific decryption apparatus (decryption means) of the encapsulated document file provide. Moreover, the document producer who is a user can conduct a payment in accordance with a number of electronic documents produced or an amount of use of the electronic document application-program 507a.

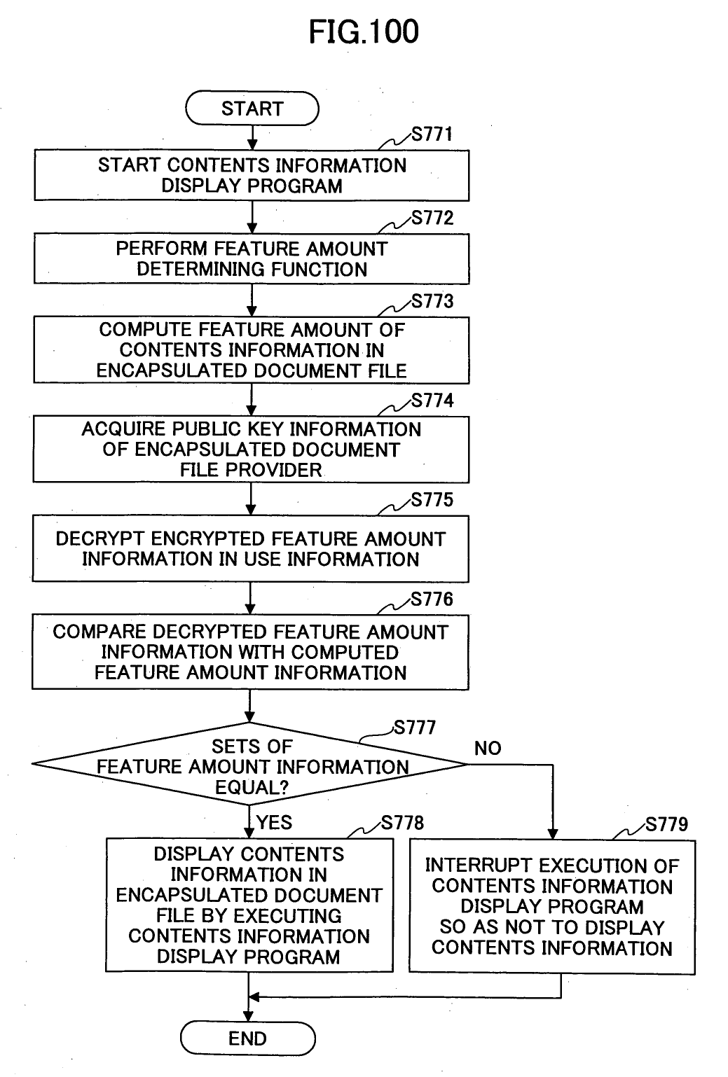

A description will be given bellow, with reference to FIG. 100 of a feature amount determining process performed by the contents display program 509 having a feature amount determining function. FIG. 100 is a flowchart showing a flow of the feature amount determining process of the encapsulated document file 501.

As shown in FIG. 100, when the contents information display program 509 is started (step S771), the feature amount determining function is performed (step S772). The contents information display program 509 computes the feature amount of the contents information in the encapsulated document file 501 (S773). The feature amount determining function acquires the public key information, which is exhibited by the encapsulated document file provider (S774). The public key information distributed by the encapsulated document file provider may be acquired. Or the public key information may be acquired using URL information of a Web page in which the public key information is exhibited, the URL information being previously stored in the use information. Next, using the acquired public key information, the encrypted feature amount information in the use information 503 is decrypted (step S775). Then the decrypted feature amount information is compared with the computed feature amount information (S776). As a result of the comparison, if both sets of the feature amount information are equal to each other (Y of step S778), it is determined that the contents information corresponds to the specific document and the contents information display program 509 is executed to display the contents information (S778). On the other hand, if the two sets of feature amount information are not equal to each other (N of step S777), it is determined that the contents information does not correspond to the specific document and interrupts the execution of the contents display program 509 so as not to display the contents information (step S779). By performing the above-mentioned process, the contents information display program which displays only a specific document can be provided.

In the present embodiment, if the document producer uses the contents information display program 509, which is developed solely by the document produce, instead of using the contents information display program 509 provided by the encapsulated document file provider, the document producer can use the encapsulated document file 501 without sending the use information 503 to the encapsulated document file provider. However, since there is a possibility that a document producer adds a computer virus, etc. to the contents information display program 509 if there is no mutual trust between the document producer and the document accesser, there may be a risk for the document accesser to use the contents information display program 509 produced by the document producer. Therefore, when the document information is distributed in a situation in which there is no mutual trust between the document producer and the document accesser, it is desirable to have the document producer to use the contents information display program 509 provided by the encapsulated document file provider. Since the document producer cannot acquire the private key information produced by the encapsulated document file provider, the document producer cannot produce the encrypted feature amount information, which is to be stored in the use information 503. Therefore, in order to make the document accesser to use the contents information display program 509 provided by the encapsulated document file provider in the present embodiment, the document producer must send the feature amount information of the contents information to the encapsulated document file provider so as to ask the encapsulated document file provider to produce the encrypted feature amount information. Therefore, since it is assured that the encapsulated document file provider acquires the use information 503 from the document producer, the fee-charging process of the use fee of the electronic document application program 507 can be practically achieved.

As interpreted from the above-mentioned embodiment, the description discloses the following invention.

1) An encapsulated document structure comprising: an operating program read by a provided-side computer connected to a network so as to cause the provided-side computer to perform various functions; use information regarding an encapsulated document provided to the provided-side computer through the network; and sending location information for sending the use information to a providing-side computer connected to the network, wherein the operating program, the use information and the sending location information are encapsulated into a single document, and the operating program includes use information transmitting program for transmitting the use information according to the sending location information at a predetermined timing.

Accordingly, the providing-side computer (the encapsulated document provider) acquires use information of the encapsulated document by sending the use information based on the sending location information at a predetermined timing. Thereby, the application program, which is the operating program to be provided, is prevented from being falsely used. Moreover, it becomes possible for the user to make a payment in accordance with a number of use of the encapsulated documents or an amount of use of the application program.

2) In the above-mentioned encapsulated document structure, the operating program may include: a contents information display program for displaying contents information that is a substance of expression on a document; a permission information reception program for receiving permission information regarding permission of display of the contents information form the provided-side computer through the network; and a contents information display program for displaying the contents information in accordance with the permission information.

Accordingly, by encapsulating the contents information display program for displaying the contents information in accordance with the permission information from the providing-side computer into the encapsulated document file, the display process of the contents information can be applied to only a specific document, and the contents information can be prevented from being falsely used.

3) In the encapsulated document structure, the permission information may be encrypted feature amount information of the contents information; the operating program further may include a feature amount determination program for determining whether or not the encrypted feature amount information is equal to predetermined feature amount; and the contents information display program may display the contents information in accordance with a result of determination of the feature amount determination program. Accordingly, the encapsulated document structure having the above-mentioned effects can be achieved with a simple structure

4) In the encapsulated document structure, wherein the feature amount determination program may determine whether or not the encrypted feature amount information of the contents information is equal to computed feature amount information computed from the contents information existing in the encapsulated document, and the contents information display program may display the contents information when the encrypted feature amount information of the contents information is determined by the feature amount determination program equal to the computed feature amount information computed from the contents information existing in the encapsulated document. Accordingly, the encapsulated document structure having the above-mentioned effect can be achieved easily.

5) An encapsulated document structure comprising: a storage area where contents information, which is a substance of expression on a document, is stored; an operating program read by a provided-side computer connected to a network so as to cause the provided-side computer to perform various functions; and use information regarding an encapsulated document provided to the provided-side computer through the network, wherein the storage area, the operating program and the use information are encapsulated into a single document, and the operating program includes an encrypted contents information display program for displaying the contents information stored in the storage area.

Accordingly, an unfair use of the contents information display program can be prevented by encrypting the contents information display program. For example, the contents information cannot be displayed unless the encapsulated document is sent to a specific decrypting apparatus. Thereby, the provided-side computer (document producer) is prevented from distributing the encapsulated document to an accessing side (document accesser) without going through the providing-side computer (encapsulated document provider).

6) An encapsulated document processing apparatus, comprising: request information receiving means for receiving request information from a provided-side computer through a network; encapsulated document producing means for producing an encapsulated document having a predetermined encapsulated document structure in accordance with the request information received by the request information receiving means; and encapsulated document transmitting means for sending the encapsulated document produced by the encapsulated document producing means to the provided-side computer through the network, wherein the predetermined encapsulated document structure comprises: an operating program read by the provided-side computer connected to a network so as to cause the provided-side computer to perform various functions; use information regarding an encapsulated document provided to the provided-side computer through the network; and sending location information for sending the use information to a providing-side computer connected to the network, wherein the operating program, the use information and the sending location information are encapsulated into a single document, and the operating program includes use information transmitting program for transmitting the use information according to the sending location information at a predetermined timing. Accordingly, the contents information display program can be prevented from being falsely used.

7) The encapsulated document processing apparatus may further comprise: charge information producing means for producing charge information of use fee of the encapsulated document by computing the use fee in accordance with the request information received by the request information receiving means; charge information transmitting means for transmitting the charge information of the use fee produced by the charge information producing means to the provided-side computer through the network; and payment information receiving means for receiving payment information on the use fee from the provided-side computer through the network, wherein the encapsulated document transmitting means sends the encapsulated document produced by the encapsulated document producing means to the provided-side computer through network when the payment information on the use fee is received by the payment information receiving means.

Accordingly, by producing the charge information on the use fee according to the request information and sending to the provided-side computer, the use can make a payment in accordance with a number of encapsulated documents produced or an amount of use of the application programs. Therefore, by sending the encapsulated document to the provided-side computer after receiving the payment information on the use fee from the provided-side computer, the contents information display program can be prevented from being falsely used.

8) In the encapsulated document processing apparatus, the encapsulated document producing means may include: operating program producing means for producing an operating program in accordance with the request information received by the request information receiving means, the operating program being read by the provided-side computer and causing provided-side computer to perform various functions; use information setting means for setting use information regarding the encapsulated document provided to the provided-side computer through the network; and encapsulating means for encapsulating the operating program produced by the operating program producing means and the use information set by the use information setting means into a single document.

Accordingly, by encapsulating the operating program and the use information, the providing-side computer, which received the encapsulated document, becomes capable of performing various functions, and the use information can be used further.

9) In the encapsulated document processing apparatus, the encapsulated document producing means may include: operating program producing means for producing an operating program in accordance with the request information received by the request information receiving means, the operating program being read by the provided-side computer and causing provided-side computer to perform various functions; encryption key producing means for producing an encryption key owned by the providing-side; operating program encryption means fro encrypting the operating program with the encryption key produced by the encryption key producing means; use information setting means for setting use information regarding the encapsulated document provided to the provided-side computer through the network; and encapsulating means for encapsulating the operating program encrypted by the operating program encrypting means and the use information set by the use information setting means into a single file.

Accordingly, by encapsulating the encrypted operating program and the use information, the provided-side computer, which received the encapsulated document, can be prevented from falsely using the operating program.

10) An encapsulated document processing apparatus, comprising: use information receiving means for receiving use information from a provided-side computer through a network; charge information producing means for producing charge information of use fee of the encapsulated document by computing the use fee in accordance with the request information received by the use information receiving means; charge information transmitting means for transmitting the charge information of the use fee produced by the charge information producing means to the provided-side computer through the network; payment information receiving means for receiving payment information on the use fee from the provided-side computer through the network; and permission information transmitting means for transmitting permission information to the provided-side computer through the network when the charge information on the use fee is received by the payment information receiving means, the permission information for permitting and execution of a saving process of contents information that is a substance of expression on a document.

Accordingly, by producing the charge information on the use fee according to the use information and sending to the provided-side computer, a user can make a payment in accordance with a number of the encapsulating documents (electronic documents) or an amount of use of the application programs. Moreover, by sending the encapsulated document to the provided-side computer after receiving the payment information on the use fee from the provided-side computer, the contents information display program can be prevented from being falsely used.

A description will now be given of an application of the encapsulated document file structure according to the present invention in which copyrights of contents information described in an electronic document can be protected.

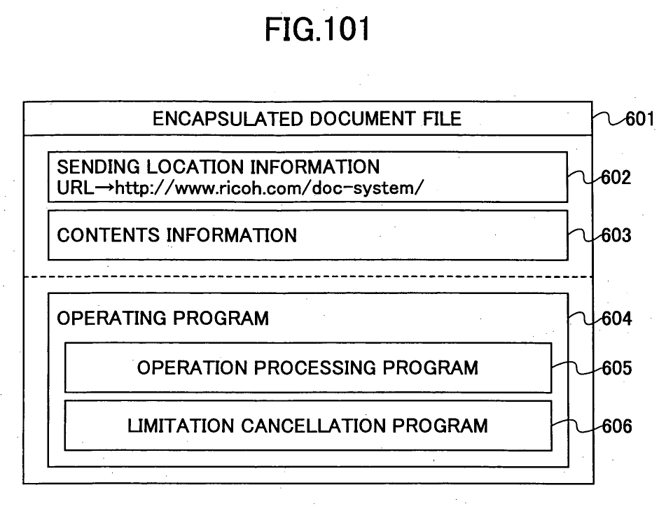

A description will be give of a structure of the encapsulated document file used in the present application. FIG. 101 is an illustration showing a structure o the encapsulated document file used in the present application.

As shown in FIG. 101, the encapsulated document file 601 is constituted by encapsulating sending location information 602, contents information 503, which is a substance of expression on a document, and an operating program 604 by encapsulating means. Each of the above-mentioned sets of information has an individual file structure so as to be managed by an operation system of a general-purpose computer.

The sending location information 602 is an address to which request information of limitation cancellation information is sent when the encapsulated document file 601 is used. The limitation cancellation information is for canceling a use limitation of the contents information 603, that is, for canceling a limitation in an operation process of the operating program 604. The URL (Uniform Resource Locator) information which, for example, is owned by the provider of the encapsulated document file is described in the address of the sending location information. The contents information 603 indicates contents information produced, edited or added by the document producer.

The operating program 604 comprises an operation processing program 605 and a limitation cancellation program 606. The operation processing program 605 is a program which performs an operation process with respect to the contents information 603 in the encapsulated document file 601. Here, the operation processing program 605 is limited in its operation process with respect to the contents information 603 in accordance with right information determined by the encapsulated document file provider. The limitation cancellation program 606 is a program which requests limitation cancellation information for canceling a limitation in the operation process of the operation processing program 605 based on the sending location information 602, and cancels the operation process of the operation processing program 605.

As one of the limitation means of the operation process with respect to the contents information 603 in the encapsulated document file 601, the operation process of the operation processing program 605 may be limited by storing encrypted contents information in the encapsulated document file 601.

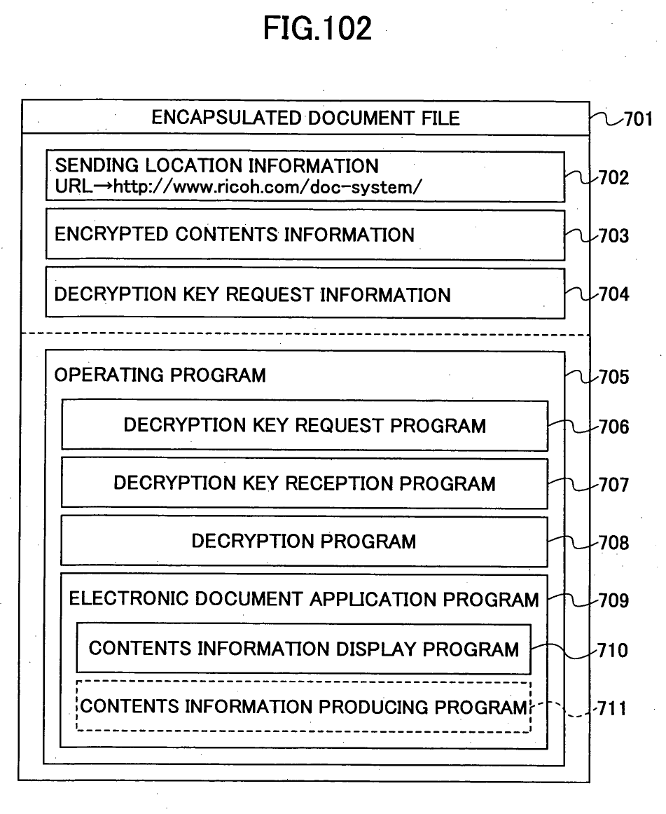

FIG. 102 is an illustration of an example of a file structure of the encapsulated document file containing the encrypted contents information. As shown in FIG. 102, the encapsulated document file 701 is constituted by encapsulating sending location information 702, the encrypted contents information 703, decryption key request information 704 and an operating program 705 by encapsulating means. The above-mentioned each information has a file structure so as to be managed by an operation system of a general-purpose computer.

The sending location information 702 is an address to which decryption key request information for requesting encryption key information is sent when the encapsulated document file 701 is used. The encryption key information is for decrypting the decrypted contents information 703. Here, the decryption key information serves as limitation cancellation information. Usually, URL information of the encapsulated document file provider is described in the address of the sending location. The encrypted contents information 703 is information obtained by encrypting the contents information produced, edited or added by the document producer by using the encryption key information, which is authority information owned by the encapsulated document file provider. The decryption key request information 704 is request information by which a document accesser makes a request to the encapsulated document file provider the decryption key information for decrypting the encrypted contents information 703.

The operating program 705 comprises a decryption key request program 706, a decryption key reception program 707, a decryption program 708 and an electronic document application program 709. The decryption key request program 706, the decryption key reception program 707 and the decryption program 708 together constitute the limitation cancellation program 706. The electronic document application program 709 constitutes the operation processing program 705. The decryption key request program 706 is a program for requesting the decryption key information which decrypts the encrypted contents information 703, when displaying the contents information 703 of the encapsulated document file 701. The decryption key reception program 707 is a program for receiving the decryption key information offered by the encapsulated document file provider in accordance with the decryption key request information 704 requested by the decryption key request program 706. The decryption program 708 is a program for decrypting the encrypted contents information 703 by using the decryption key information received by the decryption key reception program 707.

The electronic document application program 709 comprises a contents information display program 710 and a contents information producing program 711. The contents information display program 710 is a program for displaying the contents information 703 stored in the encapsulated document file 701. As a specific function of the contents information display program 710, there are an image display function, a music reproduction function, a dynamic image reproduction function, etc. The contents information producing program 711 is a program for enabling a document producer to produce, edit or add the contents information 703 in the encapsulated document file 701. As a specific function of the contents information producing program 711, a word processor function, a picture editing function, a music editing function, a dynamic image editing function, etc. If the document producer does not produce, edit or add the contents information by using the contents information producing program 711 in the encapsulated document file 701, the contents information producing program 711 may be deleted from the electronic document application program 709. Moreover, in addition to the above-mentioned programs 710 and 711, a print program for printing the specific contents information 703 or an edit history save program for saving edit history of the contents information 703 may be provided into the electronic document application program 709.

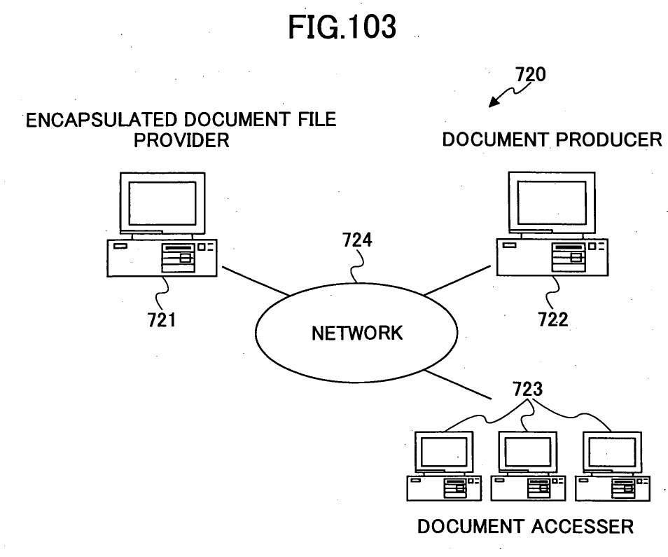

FIG. 103 is an illustration showing an outline of a structure of the electronic document system as a contents information distribution system.

As shown in FIG. 103, in the electronic document system 301, a computer 721 used by h an encapsulated document file provider who provides the encapsulated document file, a computer 722 which is use by a document producer who produces the encapsulated document file, and computers 723 which are used by document accessers who access the encapsulated document file are connected through a network 724. These computers 721, 722 and 723 serve as an encapsulated document processing apparatus. It should be noted that the encapsulated document files 601 and 701 can be transmitted through the network 724, which consists of a wired or wireless communication line such as a LAN (Local Area Network) or the Internet.

Here, the document producer represents a person or party who produces, edits or adds contents information 703 in the encapsulated document file 701. The document accesser represents person or party who accesses and uses the contents information 703 produced, edited or added in the encapsulated-document file 701. The encapsulated document file provider represents a person or party who provides the encapsulated document file 701 to the document producer and the document accesser. The encapsulated document file provider serves as an intermediary to collect use fees of the contents information from the document accesser instead of the document producer, and send the collected use fee to the document producer. Additionally, the encapsulated document file provider protects copyrights of the contents information 703 produced, edited or added by the document producer.

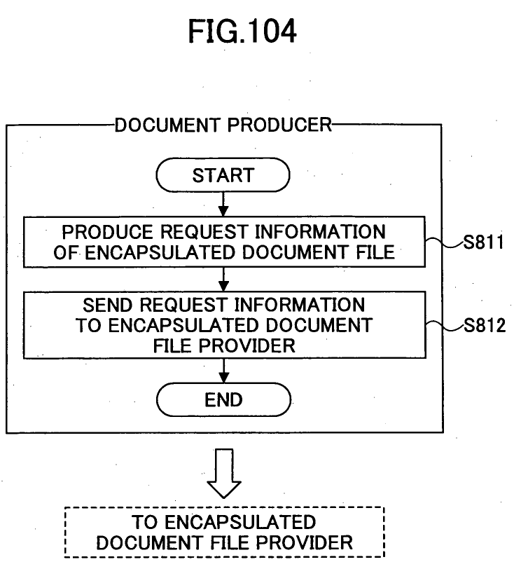

A description will now be given of a contents information distribution system according to the present invention. A description will be given first, with reference to FIG. 104 through FIG. 111, of an encapsulated document file offer service process in the electronic document system 720. It should be noted that various processes for achieving the contents information offer service process are performed by a CPU of the computers 712, 722 and 723 based on programs stored in a ROM, RAM or HDD and the operating program 705 provided in the encapsulated document file 701.

FIG. 104 is a flowchart showing a flow of a request process of the encapsulated document file 701.

As shown in FIG. 104, the computer 722 of a document producer produces request information for the encapsulated document file 701, which is needed to produce, edit or add the contents information 703 to be transmitted to the document accesser (step S811), and sends the produced request information to the computer 721 of the encapsulated document file provider through the network 724 (step S812).

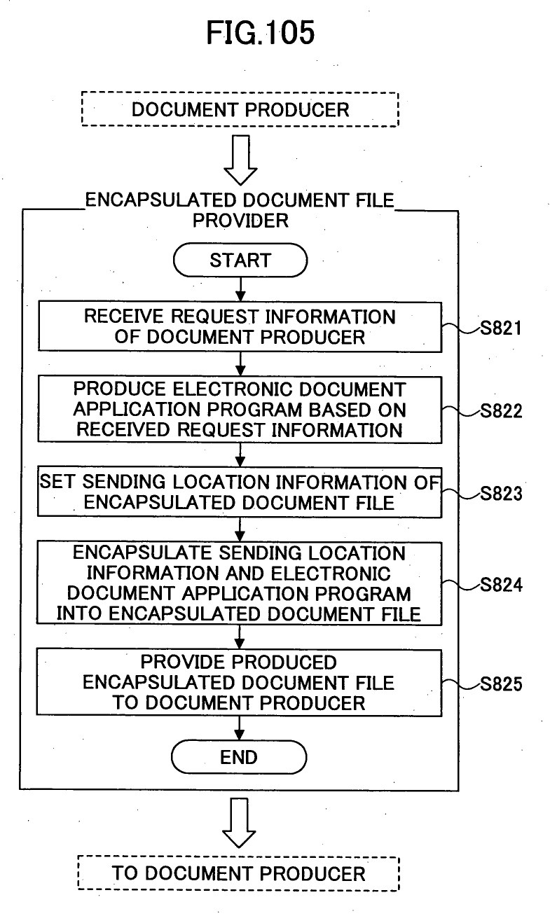

FIG. 105 is a flowchart which showing a part of a flow of an offer process of the encapsulated document file 701.

As shown in FIG. 105, the computer 721 of the encapsulated document file provider receives the request information sent from the computer 722 of the document producer (step S821: request information receiving means). Corresponding to the received request information, encapsulated document file provider produces the contents information display program 710 and the contents information producing program 711 of the electronic document application program 709 (step S822: operating program producing means). For example, the contents information producing program 711, which provides only a music edit function, may be produced for the document producer who wants to produce only contents information of music, or the contents information producing program 711, which provides only a word-processor function, may be produced for the document producer who wants to produce only contents information of character and document. Additionally, if the contents information producing program 711 is installed in the computer 722 of the document producer, the contents information producing program 711 in the electronic document application program 709 of the encapsulated document file 701 may be deleted.

Next, the sending location information 702 of the encapsulated document file 701 is set up (step S823: sending location information setting means). Although URL information on the electronic document system 720, which is possessed by the encapsulated document file provider, is set usually in the sending location information 702, when a person or party other than the encapsulated document file provider performs a fee-charging process of use fee of the contents information 703, URL information on a system performing the fee-charging process may be set in the sending location information 702. Subsequently, a storage area of the contents information 703 is acquired (storage area acquisition means). The storage area of the contents information 703 is acquired with a limitation in an amount of information, which can be stored based on the request information of the document producer. Moreover, the storage area of the contents information 703 may be made to be expandable or reduceable in accordance with an amount of information of the contents information 703 which the document producer wants to save. Finally, the sending location information 702, the electronic document application program 709 and the storage area of the contents information 703 are encapsulated into the encapsulated document file 701 (step S824: encapsulation means), and the encapsulated document file 701 is sent to the document producer, that is, the computer 722 of the document producer (S825: encapsulated document transmitting means). It should be noted that the process of step S822 through step S824 (including the storage area acquisition means) serves as encapsulated document producing means.

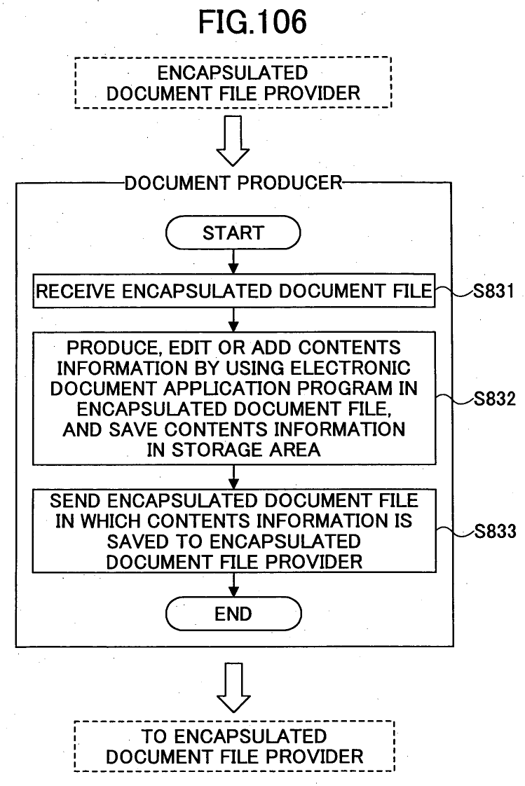

FIG. 106 is a flowchart showing a part of the flow of the offer process of the encapsulated document file 701.

As shown in FIG. 106, the computer 722 of the document producer receives the encapsulated document file 701 provided from the computer 721 of the encapsulated document file provider (step S831: encapsulated document receiving means). Next, the computer 722 of the document producer produces, edits or adds the contents information 703 to be transmitted to the document accesser by using the contents information producing program 711, which is one of the electronic document application programs 709 in the encapsulated document file 701 (contents information producing means). The contents information 703 produced, edited or added is saved in the storage area of the contents information 703 (step S832: contents information saving means). It should be noted that if the electronic document application program 709 which produces, edits and adds contents information in the encapsulated document file 701 is installed in the computer 722 of the document producer, it is not necessary to use the contents information producing program 711 in the encapsulated document file 701. In this case, the contents information producing program 711 in the encapsulated document file 701 may be deleted. Subsequently, the encapsulated document file 701, which retains the contents information 703, is sent to the computer 721 of the encapsulated document file provider (S833: encapsulated document transmitting means).

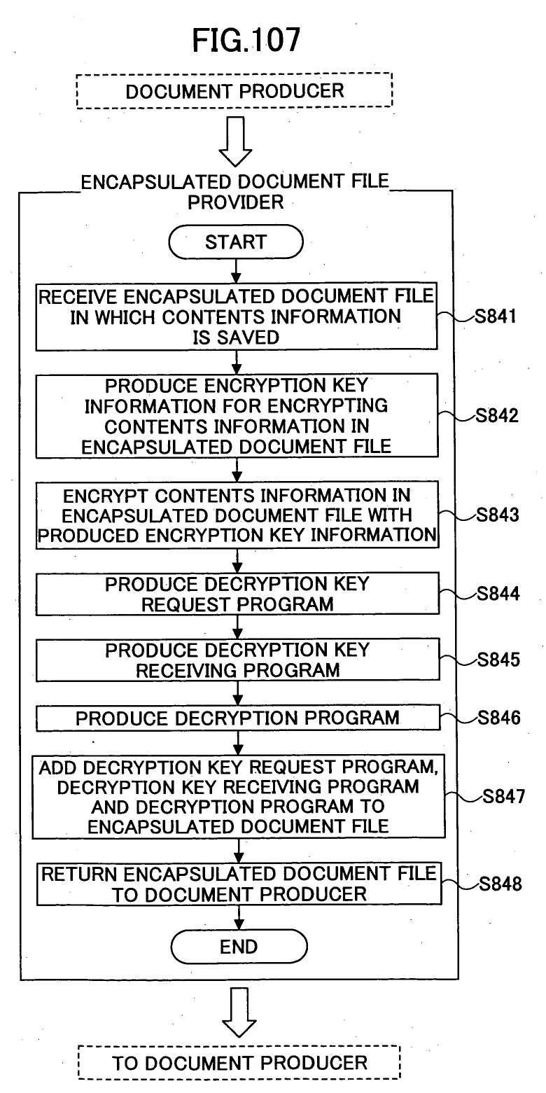

FIG. 107 is a flowchart showing a part of the flow of the offer process of the encapsulated document file 701.

As shown in FIG. 107, the computer 721 of the encapsulated document file provider receives the encapsulated document file 701 in which the contents information 703 is saved (step S841). Next, encryption key information for encrypting the contents information 703 is produced (S842: contents information encryption means). The contents information 703, which exists in the encapsulated document file 701, is encrypted using the produced encryption key information (S843: contents information encryption means). Subsequently, the decryption key request program 706, the decryption key reception program 707 and the decryption program 708 are produced (S844, S845, S846: operating program producing means). The produced decryption key request program 706, the produced decryption key reception program 707 and the produced decryption program 708 are encapsulated into the encapsulated document file 701 (S847: encapsulation means), and the encapsulated document file 701 is sent back to the computer 722 of the document producer (S848: encapsulated document transmitting means).

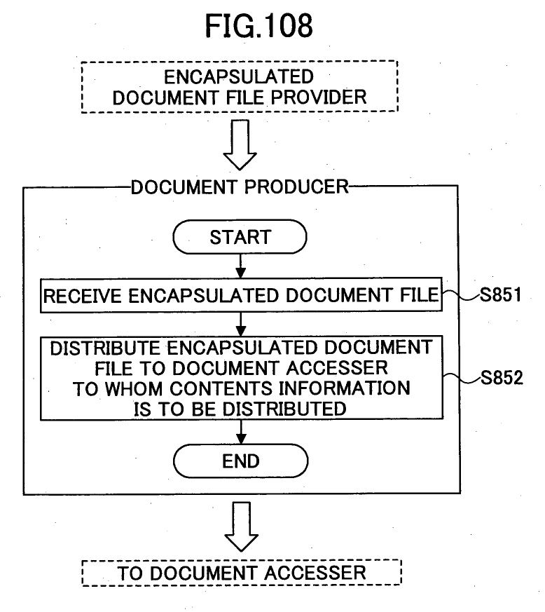

FIG. 108 is a flowchart showing a flow of a distribution process of the encapsulated document file 701.

As shown in FIG. 108, the computer 722 of the document producer receives the encapsulated document file 701 having the encrypted contents information 703 (step S851), and distributes the encapsulated document file 701 to a document accesser to whom the contents information 703 is to be distributed, that is sent to the computer 723 of the document accesser (step S852).

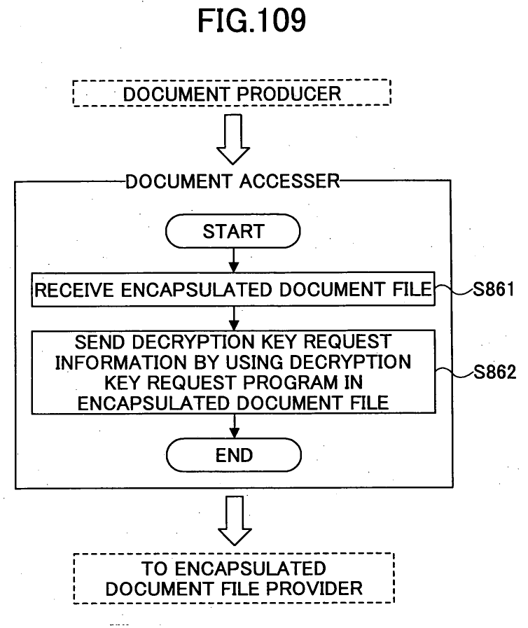

FIG. 109 is a flowchart showing a part of a flow of an access process of the encapsulated document file 701.

As shown in FIG. 109, the computer 723 of the document accesser receives the encapsulated document file 701 sent from the computer 722 of the document producer (step S61: encapsulated document receiving means). When the document accesser chooses and accesses the encapsulated document file 701 by an input device such as a mouse, the decryption key request program 706 in the encapsulated document file 701 starts automatically, and the decryption key request information 704 for requesting the decryption key information for decrypting the encrypted contents information 703 is sent to the computer 721 of the encapsulated document file provider (S862: decryption key request information transmitting means).

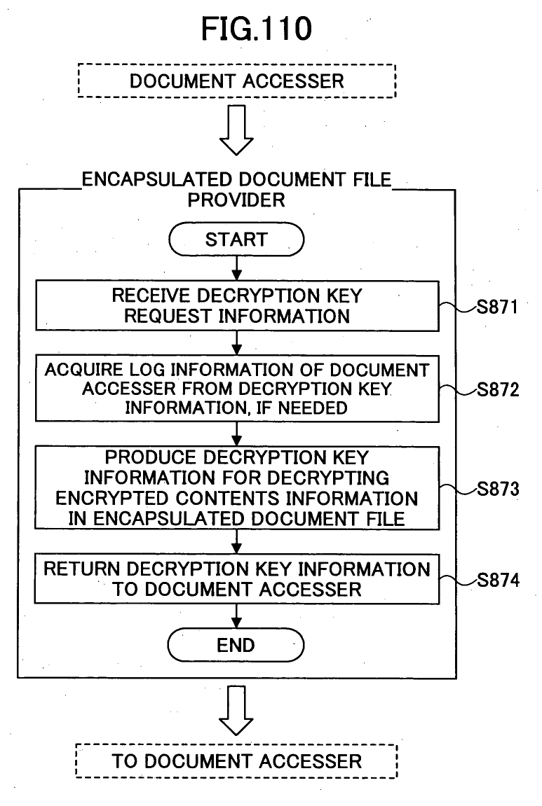

FIG. 110 is a flowchart showing a part of a flow of the access process of the encapsulated document file 701.

As shown in FIG. 110, the computer 721 of the encapsulated document file provider receives the decryption key request information 704 from the computer 723 of the document accesser (step S871: decryption key request information receiving means). Here, the computer 721 of the encapsulated document file provider may acquire the log information of the document accesser from the received decryption key request information 704 if needed, and may perform a fee-charging process, which collects the use fee of the contents information from the document accesser, as an intermediary of the document producer (step S872). Subsequently, the decryption key information for decrypting the encrypted contents information 703 is produced based on the received decryption key request information 704 (S873: decryption key producing information producing means). The encapsulated document file provider sends back the produced decryption key information to the computer 723 of the document accesser (S874: decryption key producing information transmitting means).

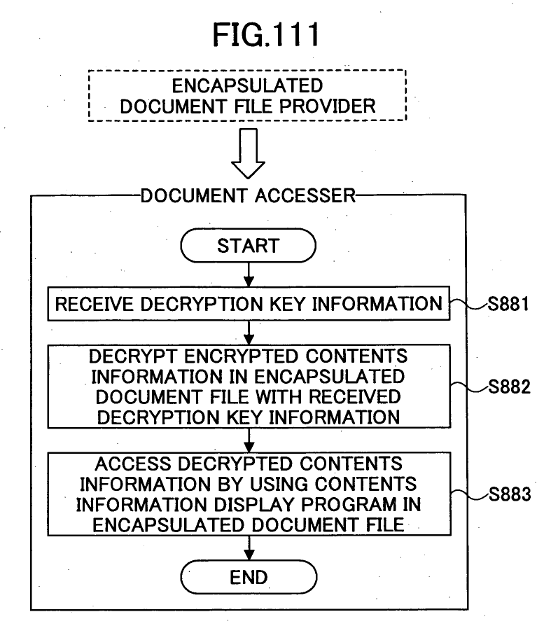

FIG. 111 is a flowchart showing a part of the flow of the access process of the encapsulated document file 701.

As shown in FIG. 111, the computer 723 of the document accesser receives the decryption key information sent back from the computer 721 of the encapsulated document file provider (step S881: decryption key information receiving means). The encrypted contents information 703 is decrypted with the received decryption key information by using the decryption program 708 in the encapsulated document file 701 (S882: contents information decryption means). The decrypted contents information 703 is displayed by the contents information display program 710, which is one of the electronic document application programs 709 in the encapsulated document file 701 (step S883). Therefore, even if the electronic document application program 709, which displays contents information 703 on the computer 723 of the document accesser, is not installed, the contents information 703 can be displayed. The above-mentioned process is performed as the contents information distribution service process.

As mentioned above, according to the present embodiment, the operation process with respect to the contents information 703 is limited by limiting the operation process with respect to the contents information 703 in the encapsulated document file 701 based on the authority information, that is, by encrypting the contents information 703 based on the decryption key information. Thereby, the contents information in then encapsulated document file 701 is prevented from being falsely used, and copyrights of the contents information 703 can be protected.

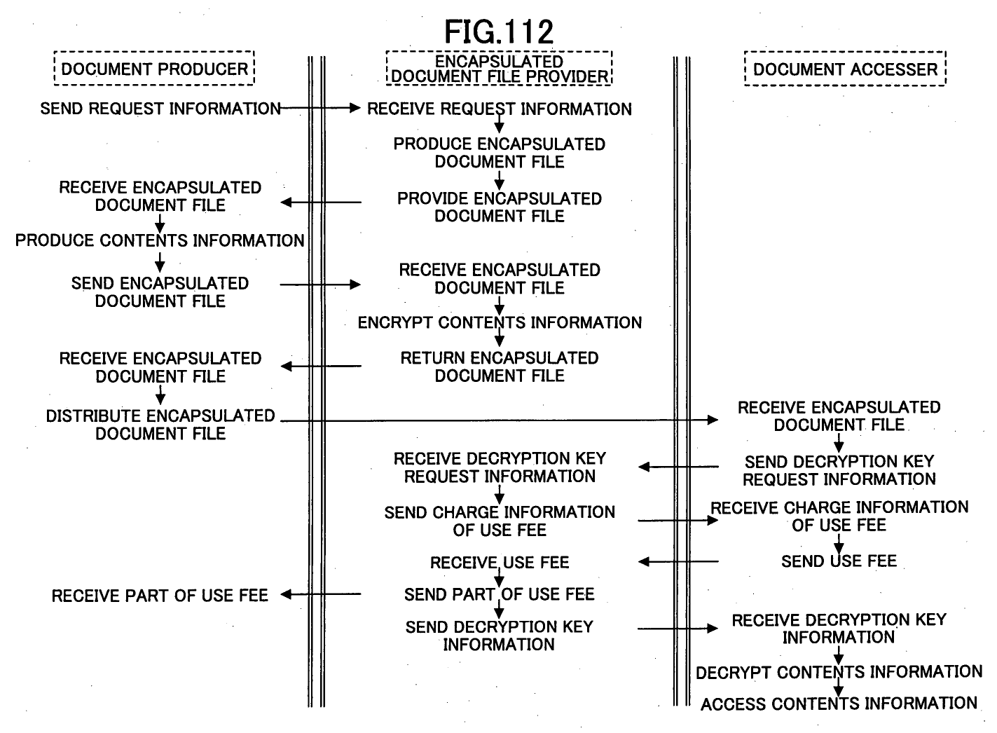

A description will be given, with reference to FIG. 112, of the fee-charging process for charging use fee of the contents information 703. FIG. 112 shows an example of a process for charging the use fee of the contents information 703 when the encapsulated document file provider sends the decryption key information to the document accesser.

As shown in FIG. 112, the computer 722 of the document producer sends the request information of the encapsulated document file 701 to the computer 721 of the encapsulated document file provider.

The computer 721 of the encapsulated document file provider receives the sent request information, produces the encapsulated document file 701 according to the request information of the document producer, and sends the produced encapsulated document file 701 to the document producer, that is, the computer 722 of the document producer.

The computer 722 of the document producer receives the encapsulated document file 701, and saves in the encapsulated document file 701 the contents information 703, which is produced, edited or added using the electronic document application program 709, which is the operation processing program 705 in the encapsulated document file 701. Then, the document producer sends the encapsulated document file 701 in which the contents information 703 is stored to the computer 721 of the encapsulated document file provider.

The computer 721 of the encapsulated document-file provider receives the encapsulated document file 701, and encrypts the contents information 703 in the encapsulated document file 701 with the encryption key information owned by the computer 721 of the encapsulated document file provider. The encapsulated document file 701 having the encrypted contents information 703 is sent to the computer 722 of the document producer.

The computer 722 of the document producer receives the encapsulated document file 701, and distributes the encapsulated document file 701 to a document accesser to whom the contents information 703 is to be transmitted, that is, the computer of the file accesser. Here, the distribution work of the encapsulated document file 701 may be performed by computer 721 of the encapsulated document file provider by storing by the document producer the address information of a document accesser to which the encapsulated document file 701 is to be distributed. Moreover, instead of distributing the encapsulated document file 701, the encapsulated document file 701 may be open to a serve owned by the encapsulated document file provider.

The computer 723 of the document accesser receives the distributed encapsulated document file 701, and accesses the encapsulated document file 701 by selecting it with an input device such as a mouse. When the encapsulated document file 701 is accessed, the decryption key request program 706, which exists in the encapsulated document file 701, automatically starts, and the decryption key request information 704 for decrypting the encrypted contents information 703 to the computer 721 of the encapsulated document file provider.

The computer 721 of the encapsulated document file provider receives the decryption key request information 704, and acquires ID number information attached to the encapsulated document file 701 and the log information of the document accesser from the received decryption key request information 704. Then the computer 721 produces charge information of the use fee of the contents information 703 from the ID number information of the encapsulated document file (charge information producing means), and sends the produced charge information of the use fee to the computer 723 of the document accesser (charge information transmitting means).

The computer 723 of the document accesser receives the charge information of the use fee, and sends payment information of the use fee of the contents information 703 to the computer 721 of the encapsulated document file provider in accordance with the charge information.

The computer 721 of the encapsulated document file provider receives the payment information of the use fee (payment information receiving means), and sends a part of the payment information of the use fee to the computer 722 of the document producer. Next, The computer 721 of the encapsulated document file provider produces decryption key information for decrypting the encrypted contents information 703 in the encapsulated document file 701 by referring to the ID number of the encapsulated document file 701, and sends it to the computer 723 of the document accesser.

The computer 723 of the document accesser receives decryption key information, and decrypts the contents information 703 in the encapsulated document file 701. Next, the decrypted contents information 703 is displayed by executing the contents information display program 710 in the encapsulated document file 701.

According to the above-mentioned process, the contents information 703 can be prevented from being falsely used by acquiring the log information of the document accesser by using the contents information 703 in the encapsulated document file 701, and use fee of the contents information can be collected from the document accesser as an intermediary between the document producer and the document accesser.

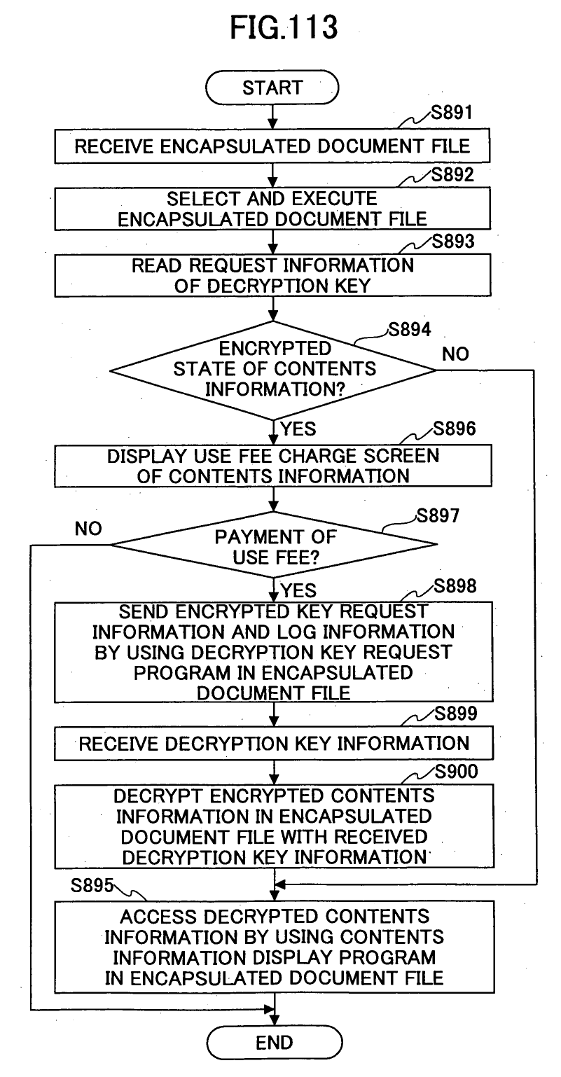

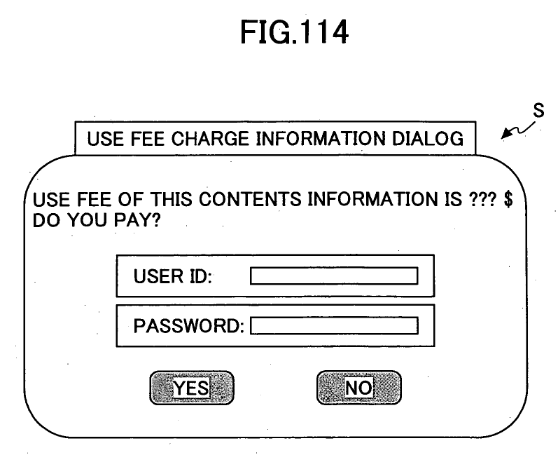

Next, a description will be given, with reference to FIG. 113 and FIG. 114, of an operation process of the encapsulated document file 701 performed by the computer 723 of the document accesser for charging for and displaying the contents information 703 in the encapsulated document file 701. FIG. 113 is a flowchart showing the operation process of the encapsulated document file 701 performed by the computer 723 of the document accesser for charging for and displaying the contents information 703 in the encapsulated document file 701. FIG. 114 is an illustration showing a screen S fro charging the use fee of the contents information 703.

As shown in FIG. 112, the computer 723 of the document accesser receives the encapsulated document file 701 sent from the computer 722 of the document producer (step S891). When the document accesser access the encapsulated document file 701 by selecting it by an input device such as a mouse (step S892), the decryption key request information 704, which exists in the encapsulated document file 701, automatically is read (step S893), and the encryption information for the contents information 703 in the read decryption key request information 704 is judged (step S894). If the value of the encryption information for the contents information 703 in the decryption key request information 704 is false (N of step S894), this means that the contents information has already been decrypted. Thus, the contents information display program 710 in the encapsulated document file 701 is started so as to display the contents information 703 (step S895). On the other hand, if the value of the encryption information for contents information 703 is true (Y of step S94), the screen S for charging the use fee of the contents information 703 to the document accesser (refer to FIG. 114) is displayed on a display of the computer 723 (step S896). Then the document accesser determines whether to pay the user fee (step S897).

As shown in FIG. 114, a user ID box in the screen S is a place where the user ID number of the document accesser is input. Moreover, a password fox in the screen S is a place where a specific password owned by the document accesser is input. The user ID number and the password of the document accesser are given when the document accesser made a user registration in the electronic document system 720, which is a contents information distribution system of the encapsulated document file provider. After inputting the user ID number and the password using the input device such as a keyboard, the document accesser presses a selection button (a selection button of Yes in FIG. 1113, or a selection button of No) so as to input whether to pay the use fee. When the selection button of No is pressed (N of step S897), the encrypted contents information 703 is not decrypted, and the operation process is ended. When the selection button of Yes is pressed (Y of S897), the decryption key request information 704, the payment information of the use fee of the contents information 703, and the log information of the document accesser are sent to the computer 721 of the encapsulated document file provider by using the decryption key request program 706 in encapsulated document file 701 (step S898).

When the computer 721 of the encapsulated document file provider receives the decryption key request information 704, the payment information of the use fee of the contents information 703, and the log information of the document accesser, the computer 721 of the encapsulated document file provider sends back the decryption key information. At this time, the computer 721 of the encapsulated document file provider sends a part of the payment information of the use fee of the contents information 703 to the computer 722 of the document producer. Moreover, the ID number of the encapsulated document file 701 described in the decryption key request information and the log information of the document accesser may be stored in a memory device such as a hard disk drive (HDD) owned by the encapsulated document file provider in relation to each other. By saving the log information of the document accesser who received the decryption key information for the contents information 703 in the memory device such as a hard disk drive (HDD), the contents information 703 can be prevented from being falsely used and copyrights of the contents information 703 can be protected.

The computer 723 of the document accesser receives the decryption key information returned from the computer 721 of the encapsulated document file provider by an operation of the decryption key reception program 707 in the encapsulated document file 701 of the document accesser (step S899). Upon receipt of the encryption key information, the decryption key reception program 707 cause the decryption program 708 in the encapsulated document file 701 to start automatically. After decrypting the encrypted contents information 703 (step S900), the decryption program 708 decrypts causes the contents information display program 710 in the encapsulated document file 701 to start automatically so as to display the decrypted contents information 703 on the display 314 of the computer 723 of the document accesser (step S895). By performing the above-mentioned operation process, the encapsulated document file provider can charge the use fee of the contents information produced, edited or added by the document producer to the document accesser as an intermediary between the document producer and the document accesser.

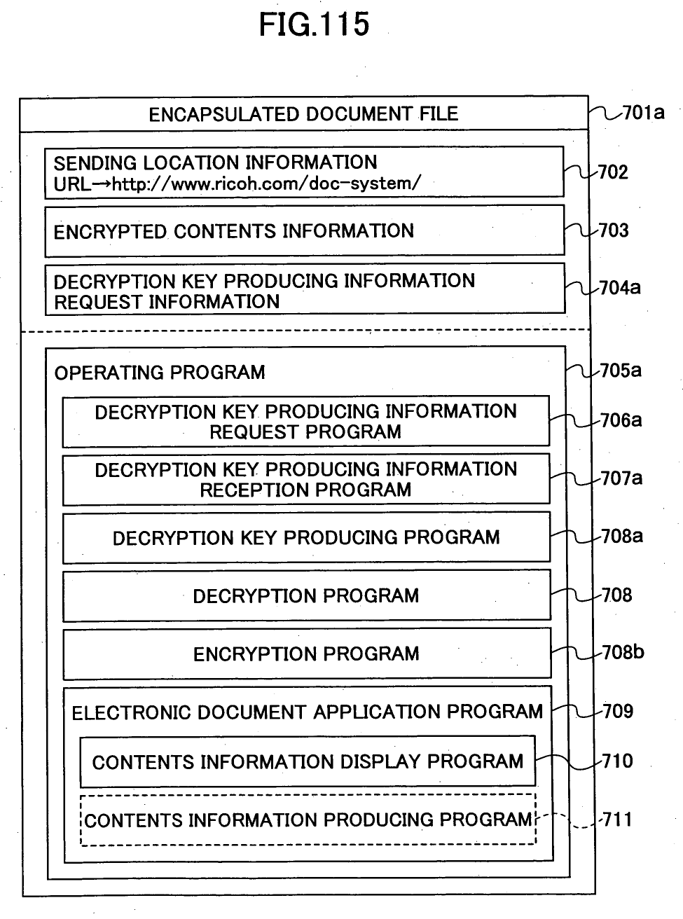

FIG. 115 is an illustration showing an example of a file structure of the encapsulated document according to the present invention.

The capsulated document file 701a shown in FIG. 115 has the same structure as the encapsulated document file 701 shown in FIG. 102 except for the differences mentioned below. It should be noted that in FIG. 114, parts that area the same as the parts shown in FIG. 102 are given the same reference numerals, and descriptions thereof will be omitted.

As shown in FIG. 115, the encapsulated document file 701a comprises the sending location information 702, the encrypted contents information 703, decryption key producing information request information 704a and an operating program 705a, which are encapsulated by encapsulation means into one document. Each of the above-mentioned sets of information has an individual file structure so as to be managed by an operation system of a general-purpose computer.

The decryption key producing information request information 704a is the request information of a document accesser to make a request to the encapsulated document file provider for sending the decryption key producing information for decrypting the decrypted contents information 703.

The operating program 705a comprises decryption key producing information request program 706a, decryption key producing information reception program 707a, a decryption key producing program 708a, a decryption program 708, an encryption program 708b and the electronic document application program 709.

The decryption key producing information request program 706a is a program for requesting the decryption key producing information, which is needed when producing decryption key information for decrypting the encrypted contents information 703. The decryption key producing information reception program 707a is a program for receiving the decryption key producing information provided by the encapsulated document file provider based on the decryption key producing information request information 704a requested by the decryption key producing information request program 706a. The decryption key producing program 708a is a program for producing the decryption key information for decrypting the encrypted contents information 703 from the log information of the document accesser acquired from the document accesser and the decryption key producing information received by the decryption key producing information reception program 707a. The decryption program 708 is a program for decrypting the encrypted contents information 703 by using the decryption key information produced by the decryption key producing program 708a. The encryption program 708b is a program for encrypting again the decrypted contents information 703 in the encapsulated document file 701a. The electronic document application program 709 is the same as that shown in FIG. 102, which is constituted by the contents information display program 710 and the contents information producing program 711.

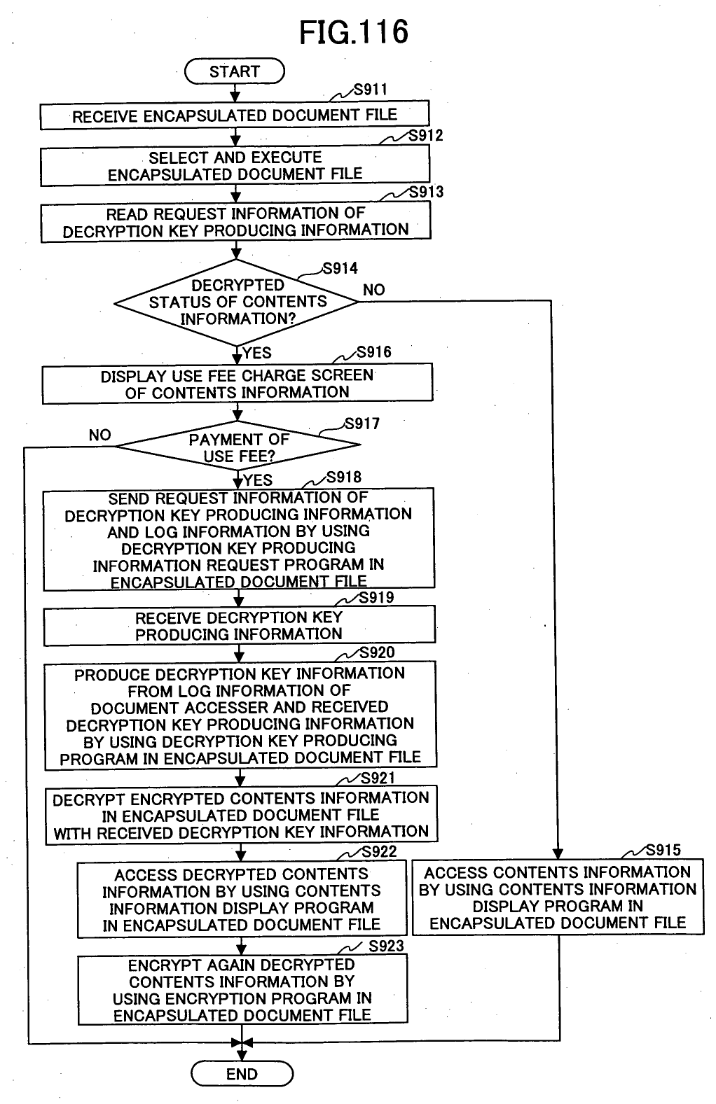

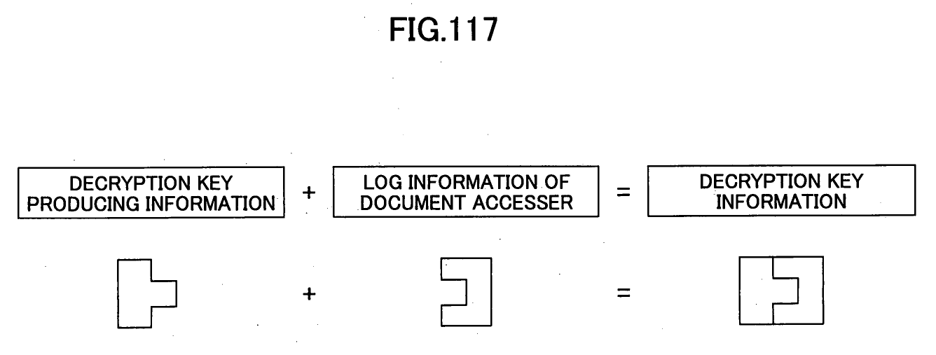

A description will now be given, with reference to FIG. 116 and FIG. 117, of an operation process of the encapsulated document file 701a performed on the computer 723 of the document accesser for charging for the contents file 703 in the encapsulated document file 701a and displaying the contents file 703. FIG. 116 is a flowchart showing a flow of the operation process of the encapsulated document file 701a performed on the computer 723 of the document accesser for charging for the contents file 703 in the encapsulated document file 701a and displaying the contents file 703.

As shown in FIG. 115, the computer 723 of the document accesser receives the encapsulated document file 701a distributed from the computer 722 of the document producer (step S911). When the document accesser accesses the encapsulated document file 701a by selecting by an input device such as a mouse (step S912), the decryption key producing information request information 704a, which exists in the encapsulated document file 701a is read automatically (step S913), and a value of the encryption information of the contents information 703 in the read decryption key producing information request information 704a is judged (step S914). If the value of the encryption information of contents information 703 is false (N of step S914), this means that the contents information 703 has not been encrypted. Thus, the contents information display program 710 in the encapsulated document file 701a is started so as to display the contents information 703 (step S915). On the other hand, if the value of the encryption information of the contents information 703 is true (Y of step S914), the screen S (refer to FIG. 113) for charging the use fee of the contents information 703 to the document accesser is displayed on a display of the computer 723 (step S916). Then, it is judged whether to pay the use fee (step S917). When the selection button of No shown in FIG. 114 is pressed (N of step S917), the operation process of the encapsulated document file 701 is ended without displaying the contents information 703. When the selection button of Yes is pressed (Y of step S917), using the decryption key producing information request program 706a in the encapsulated document file 701a, the decryption key producing information request information 704a, the payment information of use fee of the contents information 703 and the log information of the document accesser are sent to the computer 721 of the encapsulated document file provider (step S918).

The computer 721 of the encapsulated document file provider receives the decryption key producing information request information 704a, the payment information of use fee of the contents information 703 and the log information of the document accesser, and sends back the decryption key producing information. Here, the decryption key generation information is information needed when the decryption key producing program 708a in the encapsulated document file 701a produces the decryption key information by using the log information of the document accesser. FIG. 117 is an illustration showing an outline of a relationship between the decryption key producing information and the log information of the document accesser. As shown in FIG. 116, the decryption key information is produced by decryption key producing information and the log information of the document accesser. It should be noted that the computer 721 of the encapsulated document file provider sends a part of the payment information for the use fee of the contents information 703 to the computer 722 of the document producer. Moreover, the ID number of the encapsulated document file 701a described in the decryption key producing information request information 704a and the log information of the document accesser may be stored in a memory device such as a hard disk drive (HDD) owned by the encapsulated document file provider in relation to each other. By saving the log information of the document accesser who received the decryption key information for the contents information 703 in the memory device such as a hard disk drive (HDD), the contents information 703 can be prevented from being falsely used and copyrights of the contents information 703 can be protected.

The computer 723 of the document accesser receives the decryption key producing information returned from the computer 721 of the encapsulated document file provider by using the decryption key producing information reception program 707a in the encapsulated document file 701 of the document accesser (step S919). Upon receipt of the decryption key producing information, the decryption key producing information reception program 707a caused the decryption key producing program 708a in the encapsulated document file 701 to start automatically. The decryption key producing program 708a reads the log information of the document accesser from the computer 723 of the document accesser, produces the decryption key information for decrypting the encrypted contents information 703 in the encapsulated document file 701a from the log information of the document accesser and the received decryption key producing information (step S920), and starts the decryption program 708 in the encapsulated document file 701a. The decryption program 708 decrypts the encrypted contents information 703 (step S921). After decrypting the contents information 703, the decryption program 708 deletes the decryption key information used for decryption and causes the contents information display program 710 in the encapsulated document file 701a to start automatically. The contents information display program 710 displays the decrypted contents information 703 on a display of the computer 723 of the document accesser (step S922). When the user performs the ending process of the encapsulated document file 701a after displaying the contents information 703 in encapsulated document file 701a, the encryption program 708b in the encapsulated document file 701 is automatically started to encrypt again the decrypted contents information 703, and the operation process of the encapsulated document file 701a is ended.

By performing the above-mentioned operation process, the use fee of the contents information 703 produced, edited or added by the document producer can be caused to the document accesser as an intermediary between the document producer and the document accesser. Moreover, since the decryption key generation information provided from the computer 721 of the encapsulated document file provider and the log information of the document accesser acquired from the computer 723 of the document accesser, etc. are needed when decrypting the encrypted contents information 703, even if the document accesser transfers the decryption key producing information provided from the encapsulated document file provider to other document accessers, other document accessers cannot decrypt the contents information 703. Therefore, the encapsulated document file 701a can be accessed by a specific document accesser, and copyrights of the contents information 703 can be protected.

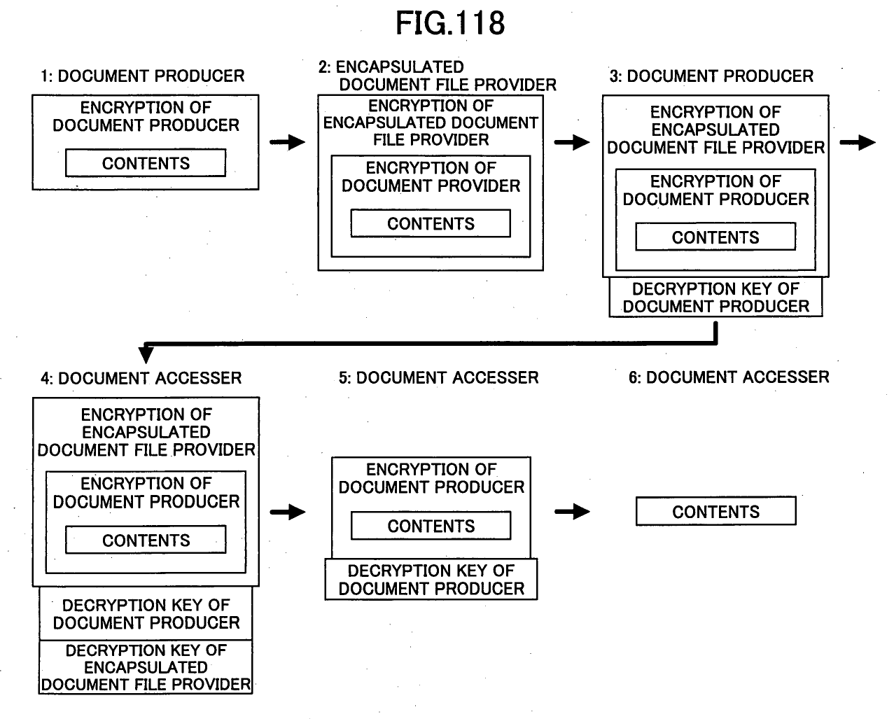

A description will now be given, with reference to FIG. 118, of another embodiment of the encapsulated document file according to the present invention.

The encapsulated document file of the present embodiment has the same structure as that shown in FIG. 102 except for the following differences. That is, the contents information 703 is encrypted with the encryption key information owned by the document producer before the contents information, which was produced, edited or added on the document producer side, is decrypted with the decryption key owned by the encapsulated document file provider; after decrypting the contents information using the decryption key information provided by the encapsulated document file provider, the decryption program 708 further decrypts the contents information with the decryption key information provided by the document accesser; and the operating program 705 has the encryption program 708b. It should be noted that parts that are the same as parts in the previous embodiments are given the same reference numerals, and descriptions thereof will be omitted.

FIG. 118 is an illustration for explaining a status of encryption of the contents information 703 in the contents information distribution service process.

As shown in FIG. 117, the document producer is in an operation processing state where the computer 722 of the document producer produces the contents information 703, and the contents information 703 is in a state 1) where it is encrypted with the encryption key information owned by the document producer.

The encapsulated document file provider is in an operation processing state where the computer 721 of the encapsulated document file provider adds decryption key request program 706 to the encapsulated document file 701, and the contents information 703 is in a state 2) where it is encrypted by the computer 722 of the document producer and further encrypted with the encryption key information owned by the encapsulated document file provider.

The document producer is in an operation processing state where the computer 722 of the document producer distributes the contents information 703 to the computer 723 of the document accesser, and the contents information 703 is in a state 3) where the decryption key information of the document producer is attached to the contents information 703 of the state 2).

The document accesser is in an operation processing state where the computer 723 of the document accesser sends the decryption key request information owned by the encapsulated document file provider for requesting the decryption key information to the computer 721 of the encapsulated document file provider, and the contents information 703 is in a state 4) where the decryption key information provided by the encapsulated document file provider is attached to the contents information 703 which is in the state 3).

The document accesser is in an operation processing state where the document accesser decrypts the contents information 703 with the decryption key information which owned by the encapsulated document file provider by using the decryption program 708 in the encapsulated document file 701, and the contents information 703 is in a state 5) where the decryption key information of the document producer is attached to the contents information 703 encrypted with the encryption key owned by the document producer.

The document accesser is in an operation processing state where the contents information 703 is decypted with the decryption key information owned by the document producer by using the decryption program 708 in the encapsulated document file 701, and the contents information 703 is decrypted completely so that the contents information 703 can be displayed by using the contents information display program 710 in the encapsulated document file 701.

Depending on the status of the encapsulated document file provider, when the computer 721 of the encapsulated document file provider receives the encapsulated document file 701, the contents information 703 in the encapsulated document file 701 has been encrypted with the encryption key information owned by the document producer as shown in FIG. 117. Thus, the encapsulated document file provider cannot access the contents information 703, which the document producer produced, edited or added. Therefore, the encapsulated document file provider is prevented from accessing the contents information 703 of the document producer.

As interpreted from the above-mentioned embodiment, the description discloses the following invention.

1) An encapsulated document structure, comprising: contents information that is a substance of expression on a document; an operating program read by an accessing-side computer connected to a network, the operating program causing the accessing-side computer to perform various functions; and sending location information for sending various kinds of information to a providing-side computer connected to the through the network, wherein the contents information, the operating program and the sending location information are encapsulated into a single document, and wherein the operating program includes: an operation processing program of which operation process on the contents information is limited based on authority information; and a limitation cancellation program for canceling a limitation in the operation process of the operation processing program by sending various kinds of information based on the sending location information.

Accordingly, by limiting the operation process applicable to the contents information in the encapsulated document file based on the authority information, the contents information in the encapsulated document can be prevented from being falsely used, and it becomes possible to protect copyrights of the contents information.

2) In the above-mentioned encapsulated document structure, the contents information may be encrypted, and the limitation cancellation program may acquire decryption key information for decrypting the encrypted contents document based on the sending location information through the network so as to decrypt the encrypted contents information based on the decryption key information acquired.

Accordingly, by encrypting the contents information and acquiring the decryption key information so as to decrypt the encrypting contents information, the contents information in the encapsulated document file can be prevented from being falsely used and it becomes possible to protect copyrights of the contents information.

3) In the encapsulated document structure, decryption key producing information request information may be encapsulated into the single document together with the contents information, the operating program and the sending location information, the decryption key producing information request information for requesting the providing-side computer to send decryption key producing information necessary for producing the decryption key information, and the limitation cancellation program may include: a decryption key producing information requesting program for requesting the decryption key producing information by sending the decryption key producing information request information to the providing-side computer through the network based on the sending location information; decryption key producing information reception program for receiving the decryption key producing information from the providing-side computer through the network; a decryption key producing program for producing the decryption key information based on the decryption key producing information received by the decryption key producing information reception program; and a decryption program for decrypting the encrypted contents information based on the decryption key information produced by the decryption key producing program.

Accordingly, the encrypted contents information in the encapsulated document file can be decrypted only with decryption key information that is produced based on the information, which specifies the document accesser, such as the log information of the document accesser and the decryption key producing information provided by the encapsulated document file provider. Thus, it becomes possible to provide the encapsulated document file having contents information which can be sued only by a specific document accesser.

4) An encapsulated document processing apparatus, comprising: storage area acquisition means for acquiring a storage area where contents information, which is a substance of expression on a document, is saved; request information receiving means for receiving request information through from a provided-side computer through a network; operating program producing means for producing and operating program in accordance with the request information received by the request information receiving means, the operating program being read by the an accessing-side computer and causing the accessing-side computer to perform various kinds of functions; sending location information setting means for setting sending location information for sending various kinds of information to a providing-side computer through the network; encapsulation means for encapsulating the storage area, the operating program produced by the operating program producing program and the sending location information set by the sending location information setting means into a single document; and encapsulated document transmitting means for transmitting the encapsulated document produced by the encapsulating means to the provided-side computer-through the network, wherein the operating program producing means includes: an operation processing program of which operation process on the contents information is limited based on authority information; and a limitation cancellation program for canceling the limitation in the operation process of the operating program by sending various kinds of information based on the sending location information.

Accordingly, by limiting the operation process applicable to the contents information in the encapsulated document file based on the authority information, the contents information in the encapsulated document can be prevented from being falsely used, and it becomes possible to protect copyrights of the contents information.

5) The encapsulated document processing apparatus may further comprise contents information encryption means for encrypting the contents information, which is stored in the storage area acquired by the storage area acquisition means, according to encryption key information as the authority information, wherein the encapsulated document transmitting means transmits the encapsulated document, which has the contents information encrypted by the contents information encryption means and stored in the storage area, to the provided-side computer or the accessing-side computer through the network.

Accordingly, by encrypting the contents information, the operation process applicable to the contents information in the encapsulated document file is limited. Thus, the contents information in the encapsulated document file can be prevented from being falsely used, and it becomes possible to protect copyrights of the contents information.

6) In the encapsulated document processing apparatus, the limitation cancellation program may include: a decryption key producing information request program for requesting decryption key producing information necessary for producing decryption key information for decrypting the contents information, a request being sent to the providing-side computer through the network based on the sending location information; a decryption key producing information reception program for receiving the decryption key producing information from the providing-side computer through the network; a decryption key producing program for producing the decryption key information based on the decryption key producing information received by the decryption key producing information reception program; and decryption program for decrypting the encrypted contents information based on the decryption key information produced by the decryption key producing program.

Accordingly, it is possible to provide the same effects as that of the above-mentioned encapsulated document processing apparatus with a simple structure.

7) An encapsulated document processing apparatus, comprising: decryption key request information receiving means for receiving decryption key request information from an accessing-side computer through a network, the decryption key request for requesting decryption key information for decrypting encrypted contents information, which is a substance of expression on a document; decryption key producing means for producing the decryption key information based on the decryption key request information received by the decryption key request information receiving means; and decryption key information transmitting means for transmitting the decryption key information, which is produced by the decryption key producing means, to the accessing-side computer through the network.

Accordingly, by sending the decryption key information to the accessing-side computer, the accessing-side computer becomes capable of decrypting the encrypted contents information. As a result, it becomes possible to display the contents information on a display apparatus.

8) The encapsulated document processing apparatus may further comprise fee-charging means for charging a use fee of the contents information to the accessing-side computer when the decryption key information is transmitted by the decryption key information transmitting means.

Accordingly, by charging the use fee of the contents information to the accessing-side computer when the decryption key information is transmitted, the providing-side computer is capable of charging, as an intermediary between the document producer and the document accesser, the use fee of the contents information, which is produced, edited or added by the document producer, to the document accesser.

9) An encapsulated document processing apparatus, comprising; decryption key production request information receiving means for receiving decryption key production information request information from a providing-side computer through a network, the decryption key production information request information for requesting decryption key producing information necessary for producing decryption key information for decrypting encrypted contents information, which is a substance of expression regarding a document; decryption key producing information producing means for producing the decryption key producing information based on the decryption key producing information request information received by the decryption key production request information receiving means; decryption key producing information transmitting means for transmitting the decryption key producing information, which is produced by the decryption key producing information producing on means, to an accessing-side computer through the network; and fee-charging means for charging a use fee of the contents information to the accessing-side computer when the decryption key producing information is transmitted by the decryption key producing information transmitting means.

Accordingly, by charging the use fee of the contents information to the accessing-side computer when the decryption key information is transmitted, the providing-side computer is capable of charging, as an intermediary between the document producer and the document accesser, the use fee of the contents information, which is produced, edited or added by the document producer, to the document accesser.

The present invention is not limited to the above mentioned various embodiments, and variations and modifications may be made without departing from the scope of the present invention.

The present application is based on Japanese priority applications, No. 2002-379748 filed Dec. 27, 2002, No. 2003-195626 filed Jul. 11, 2003, No. 2003-299135 filed Aug. 22, 2003, No. 2003-328753 filed Sep. 19, 2003 and No. 2003-327778 filed Sep. 19, 2003, the entire contents of which are hereby incorporated by reference.

What is claimed is:

1. An encapsulated document structure comprising:
a document information file storing document information that is a substance of expression of a document; and
an operating program file storing an operating program that materializes the document information, a limitation being given to the operating program by a security function when the operating program is interpreted and executed by a computer,
wherein the document information file and the operating program file are encapsulated as a single document.

2. The encapsulated document structure as claimed in claim 1, wherein the security function of said operating program file is controlled based on specific decryption key information for decrypting encrypted digital information.

3. The encapsulated document structure as claimed in claim 2, further comprising encapsulating means for encapsulating said decryption key information, said operating program file and said document information file into a single document.

4. The encapsulated document structure as claimed in claim 3, wherein encapsulating means encapsulates said decryption information, said operating program file and said document information file into a single file.

5. The encapsulated document structure as claimed in claim 3, wherein said decryption key information is signed and encrypted by a third party authority.

6. The encapsulated document structure as claimed in claim 3, wherein said operating program is started by an external start program that is interpreted and executed by said computer.

7. The encapsulated document structure as claimed in claim 6, wherein said operating program file is described by an intermediate language code, and runs by interpreting and executing the intermediate language code.

8. The encapsulated document structure as claimed in claim 6, wherein said operating program is decrypted and started by said start program in accordance with said decryption key information.

9. The encapsulated document structure as claimed in claim 6, wherein said operating program started by said start program operates within predetermined operation rights.

10. The encapsulated document structure as claimed in claim 3, wherein said decryption key information includes link information of URL.

11. The encapsulated document structure as claimed in claim 3, wherein a storage area of said operating program is described therein.

12. The encapsulated document structure as claimed in claim 3, further comprising a start program file storing a start program that is interpreted and executed by said computer to start said encapsulated document file, wherein, when a file identifier of said encapsulated document file is changed, said operating program file is started by said start program.

13. The encapsulated document structure as claimed in claim 12, further comprising signature determining means for determining whether the signature information in said encapsulated document is true or false, wherein, when said signature information is false, an unfair act process for performing a predetermined operation to avoid a problem caused by an unfair act performed with respect to the encapsulated document.

14. The encapsulated document structure as claimed in claim 12, wherein said start program displays the signature information of said operating program to be started or said encapsulated document so as to cause a user to check the start.

15. The encapsulated document structure as claimed in claim 14, wherein said start program file includes signature retaining means for retaining signature information, and said start program compare the signature information retained by said signature retaining means with the signature information in said encapsulated document so as to eliminate a signature display to the user when the signature information retained by said signature retaining means matches the signature information in said encapsulated document.

16. The encapsulated document structure as claimed in claim 3, further comprising: a start program file storing a start program that is interpreted and executed by said computer; and an installation program file storing an installation program that installs said start program in said computer when a file identifier of said encapsulated document file is changed.

17. The encapsulated document structure as claimed in claim 16, further comprising signature determining means for determining whether the signature information in said encapsulated document is true or false, wherein, when said signature information is false, an unfair act process for performing a predetermined operation to avoid a problem caused by an unfair act performed with respect to the encapsulated document.

18. The encapsulated document structure as claimed in claim 16, wherein said start program displays the signature information of said operating program to be started or said encapsulated document so as to cause a user to check the start.

19. The encapsulated document structure as claimed in claim 18, wherein said start program file includes signature retaining means for retaining signature information, and said start program compare the signature information retained by said signature retaining means with the signature information in said encapsulated document so as to eliminate a signature display to the user when the signature information retained by said signature retaining means matches the signature information in said encapsulated document.

20. The encapsulated document structure as claimed in claim 1, further comprising encapsulating means for encapsulating said document information file and said operating program file into a single file, wherein said operating program is started by an external start program and is limited in operation rights thereof.

21. The encapsulated document structure as claimed in claim 20, wherein said single file is signed and encrypted.

22. The encapsulated document structure as claimed in claim 20, wherein said operating program is limited in operation rights thereof based on signature information regarding said operating program.

23. The encapsulated document structure as claimed in claim 20, wherein an input and output of said operating program started by said start program is performed through an input and output library provided in said operating program.

24. The encapsulated document structure as claimed in claim 21, wherein said encapsulated document includes signature information, and said operating program starts said operating program in accordance with the signature information.

25. The encapsulated document structure as claimed in claim 1, wherein said contents information file includes:
at least one contents file that serves as a substance of expression on a document; and
a document structure file specifying a structure of the contents file and a display status on said document.

26. The encapsulated document structure as claimed in claim 6, further comprising an icon file regarding an icon displayed on a display of said computer in accordance with substantive data of said document, wherein a selective designation of said icon is determined as an accessing operation to said document by said computer.

27. The encapsulated document structure as claimed in claim 25, further comprising a library file storing said contents file with an index indicating a storing location thereof, wherein said operating program file specifies said contents file according to said index.

28. The encapsulated document structure as claimed in claim 25, further comprising a library file storing said contents file provided with a specific header, wherein said operating program file specifies said contents file according to said header.

29. The encapsulated document structure as claimed in claim 25, wherein said document contents file is described by a general-purpose data description language.

30. The encapsulated document structure as claimed in claim 29, wherein said data description language uses a tag to describe a structure of said contents file and an element specifying the display status on said document.

31. The encapsulated document structure as claimed in claim 30, wherein said operating program file is provided in accordance with a file format specified by said contents file described using said tag.

32. The encapsulated document structure as claimed in claim 25, wherein said operating program file is provided with a part as minimum unit necessary for processing said contents file.

33. The encapsulated document structure as claimed in claim 25, further comprising:
a file of a digital information display program for causing said contents file accessible on a display of said computer; and
a file of a functional operation program for performing a specific function without referring to digital information of said contents file.

34. The encapsulated document structure as claimed in claim 33, wherein said digital information display program has a function to display a file specifying panel for displaying file specifying information that specifies said contents file in a selectable state, and a function to causing said contents file, which corresponds to a case where said file specifying information is selected, accessible on said display of said computer.

35. The encapsulated document structure as claimed in claim 33, wherein said functional operation program has a function to display a function panel for function specifying information that specifies a predetermined function in a selectable state, and a function to perform said predetermined function that corresponds to a case where said function specifying information is selected.

36. The encapsulated document structure as claimed in claim 33, wherein said digital information display program has a scaling function to enlarge or reduce a displayed image based on said contents file.

37. The encapsulated document structure as claimed in claim 33, wherein said digital information display program has a view changing function to change a viewpoint when a displayed image based on said contents file is a three-dimensional image.

38. The encapsulated document structure as claimed in claim 33, wherein said digital information display program has a function, when a displayed image based on said contents file is a dynamic image, to display a static image extracted from the dynamic in said document in a selectable state, and a function to reproduce the dynamic image when the static image is selected.

39. The encapsulated document structure as claimed in claim 33, wherein said digital information display program has a function to display, when said contents file includes audio information, a reproduction panel for causing the audio information designatable, and a function to reproduce the audio information when a reproduction of said audio information is designated through said reproduction panel.

40. The encapsulated document structure as claimed in claim 39, wherein said digital information display program has a function to display, when a reproduction of said audio information is designated through said reproduction panel, text information corresponding to said audio information.

41. The encapsulated document structure as claimed in claim 1, further comprising a feature amount retaining file retaining an encrypted feature amount regarding said program file, the feature amount retaining file being encapsulated into said single file.

42. The encapsulated document structure as claimed in claim 41, wherein said feature amount retaining file also retains an encrypted feature amount regarding said document information file.

43. The encapsulated document structure as claimed in claim 41, wherein said feature amount retaining file retains decryption key information used for decrypting the encrypted feature amount regarding said operating program file.

44. The encapsulated document structure as claimed in claim 41, wherein said feature amount retaining file retains location information which indicates decryption key information used for decrypting the encrypted feature amount regarding said operating program file.

45. The encapsulated document structure as claimed in claim 43, wherein a different set of said decryption key information is related to each operating program file.

46. The encapsulated document structure as claimed in claim 44, wherein a different set of said decryption key information is related to each operating program file.

47. The encapsulated document structure as claimed in claim 41, wherein the feature amount regarding said operating program file is encrypted by a public key encryption method.

48. The encapsulated document structure as claimed in claim 43, wherein said decryption key information is signed and encrypted by a third party authentication authority.

49. The encapsulated document structure as claimed in claim 41, wherein the feature amount regarding said operating program file is encrypted by a private key encryption method.

50. The encapsulated document structure as claimed in claim 41, further comprising a feature amount verification program for performing a verification of a tamper on said operating program file, the feature amount verification program being encapsulated into said single file.

51. The encapsulated document structure as claimed in claim 1, wherein a feature amount of the operating program in said operating program file is stored outside said single document.

52. The encapsulated document structure as claimed in claim 51, wherein the feature amount regarding said operating program file is encrypted by a public key encryption method.

53. The encapsulated document structure as claimed in claim 51 wherein the feature amount regarding said operating program file is encrypted by a private key encryption system.

54. The encapsulated document structure as claimed in claim 51, further comprising a feature amount verification program for performing a verification of a tamper on said operating program file, the feature amount verification program being encapsulated into said single file.

55. An encapsulated document structure comprising:
a document information file storing contents information that is a substance of expression on a document;
location information indicating a location where an operating program file is stored, the operating program file storing an operating program for materializing the document information file; and
a feature amount retaining file retaining an encrypted feature amount regarding said operating program file,
wherein said document information file, said location information and said feature amount retaining file are encapsulated into a single file.

56. The encapsulated document structure as claimed in claim 55, wherein said feature amount retaining file also retains an encrypted feature amount regarding said document information file.

57. The encapsulated document structure as claimed in claim 55, wherein said feature amount retaining file retains decryption key information used for decrypting the encrypted feature amount regarding said operating program file.

58. The encapsulated document structure as claimed in claim 55, wherein said feature amount retaining file retains location information which indicates decryption key information used for decrypting the encrypted feature amount regarding said operating program file.

59. The encapsulated document structure as claimed in claim 57, wherein a different set of said decryption key information is related to each operating program file.

60. The encapsulated document structure as claimed in claim 58, wherein a different set of said decryption key information is related to each operating program file.

61. The encapsulated document structure as claimed in claim 55, wherein the feature amount regarding said operating program file is encrypted by a public key encryption method.

62. The encapsulated document structure as claimed in claim 57, wherein said decryption key information is signed and encrypted by a third party authentication authority.

63. The encapsulated document structure as claimed in claim 55, wherein the feature amount regarding said operating program file is encrypted by a private key encryption system.

64. The encapsulated document structure as claimed in claim 55, further comprising a feature amount verification program for performing a verification of a tamper on said operating program file, the feature amount verification program being encapsulated into said single file.

65. An encapsulated document structure comprising:
document information file storing contents information that is a substance of expression on a document; and
location information indicating a location where an operating program file containing an operating program for materializing the document information file is stored,
wherein the document information file and the location information are encapsulated into a single file, and a feature amount regarding the operating program file is stored outside said single file.

66. The encapsulated document structure as claimed in claim 65, wherein the feature amount regarding said operating program file is encrypted by a public key encryption method.

67. The encapsulated document structure as claimed in claim 66, wherein decryption key information used for decrypting the encrypted said operating program file is signed and encrypted by a third party authentication authority.

68. The encapsulated document structure as claimed in claim 65, wherein the feature amount regarding said operating program file is encrypted by a private key encryption system.

69. The encapsulated document structure as claimed in claim 65, further comprising a feature amount verification program for performing a verification of a tamper on said operating program file, the feature amount verification program being encapsulated into said single file.

70. A document file producing apparatus producing an electronic document file having an encapsulated document structure, said encapsulated document structure comprising:
a document information file storing document information that is a substance of expression of a document; and
an operating program file storing an operating program that materializes the document information, a limitation being given to the operating program by a security function when the operating program is interpreted and executed by a computer,
wherein the document information file and the operating program file are encapsulated as a single document.

71. The document file producing apparatus as claimed in claim 70, wherein said operating program file is produced and distributed by an operating program provider beforehand.

72. The document file producing apparatus as claimed in claim 70, wherein the security function of said operating program file is controlled based on specific decryption key information for decrypting encrypted digital information.

73. The document file producing apparatus as claimed in claim 72, wherein said specific decryption key information is produced and distributed by an operating program provider beforehand.

74. An encapsulated document producing and editing apparatus comprising:
decryption key information provided beforehand;
an operating program file that is decrypted from the decryption key information; and
encapsulated document producing and editing means having user interface means for producing and editing a document information file in accordance with a user operation and encapsulating means for encapsulating the produced document information file, said decryption key information and said operating program file into a single file.

75. An encapsulated document producing and editing apparatus comprising:
an operating program file provided beforehand;
encapsulated document producing and editing means having user interface means for producing and editing a document information file in accordance with a user operation and encapsulating means for encapsulating the produced document information file and said operating program file into a single file; and
decryption means for decrypting the encapsulated single file.

76. An encapsulated document producing and editing apparatus comprising:
encapsulated document producing and editing means having user interface means for producing and editing a document information file in accordance with a user operation;
an operating program file provided beforehand; and
decryption means for decrypting the produced document information file and said operating program file,
wherein said encapsulated document producing and editing means has encapsulating means for encapsulating the encrypted document information file and said operating program file into a single file.

77. A start program for starting an operating program file provided in an encapsulated document comprising: decryption key information for decrypting encrypted digital information; the operating program file that is decrypted in accordance with the decryption key information; document information file that is materialized on a computer by the decrypted operating program; and encapsulating means for encapsulating said decryption key information, said operating program file and said document information file into a single file, said start program comprising:
reading means for reading the encrypted decryption key information and said operating program file from said encapsulated document file;
decryption means for decrypting said decryption key information using a public key provided by a third party authentication authority, and decrypting said operating program using the decrypted decryption key information; and
operating program starting means for starting said decrypted operating program.

78. The start program as claimed in claim 77, further comprising public key information provided by said third party authentication authority.

79. The start program as claimed in claim 77, further comprising signature determining means for determining whether signature information in said encapsulated document is true or false so as to perform a process for preventing a problem caused by an unfair act that has been applied on said encapsulated document file.

80. The start program as claimed in claim 77, further comprising means for displaying the signature information of said operating program or said encapsulated document to be started on a display of a computer so as to request a user to check a start of said operating program.

81. The start program as claimed in claim 80, further comprising signature information retaining means for retaining signature information so as to compare the signature information retained by said signature information retaining means with signature information provided in said encapsulated document so that a display of signature is omitted when the signature information retained by said signature information retaining means matches the signature information provided in said encapsulated document.

82. An encapsulated document producing apparatus comprising:
document information file acquisition means for acquiring a document information file storing contents information that is a substance of expression regarding a document;
operating program file acquisition means for acquiring an operation program file storing an operating program, which is interpreted and executed by a computer, for materializing said document information file acquired by said document information file acquisition means;
feature amount computing means for computing a feature amount of said operating program file;
feature amount retaining file producing means for encrypting the feature amount of said operating program file computed by said feature amount computing means, and saving the encrypted feature amount in a feature amount retaining file; and
encapsulating means for encapsulating said document information file, said operating program file and said feature amount retaining file into a single document.

83. The encapsulated document producing apparatus as claimed in claim 82, further comprising document information feature amount computing means for computing a feature amount of said document information file so as to encrypt the computed feature amount of said document information file with encryption key information and save the encrypted feature amount in said feature amount retaining file.

84. A program tamper verification method performed by an information processing unit for verifying a tamper on an operating program file that materializes a document information file that is a substance of expression regarding a document, the operating program file and the document information file are encapsulated into an encapsulated document file, the program tamper verification method comprising the steps of:
computing a feature amount of said operating program file in said encapsulated document file when materializing said document information file;
decrypting an encrypted feature amount of said operating program file that was been retained;
comparing the decrypted feature amount of said operating program file with the computed feature amount of said operating program file;
limiting materialization of said document information file performed by said operating program file when the decrypted feature amount of said operating program file does not match the computed feature amount of said operating program file.

85. A program tamper verification method performed by an information processing unit for verifying a tamper on an operating program file that materializes a document information file that is a substance of expression regarding a document, the operating program file and the document information file are encapsulated into an encapsulated document file, the program tamper verification method comprising the steps of:
computing a feature amount of said operating program file stored at a location indicated by location information retained in said encapsulated document file when materializing said document information file;
decrypting a decrypted feature amount of said operating program previously retained;
comparing the decrypted feature amount of said operating program file with the computed feature amount of said operating program file;
limiting materialization of said document information file performed by said operating program file when the decrypted feature amount of said operating program file does not match the computed feature amount of said operating program file.

86. A tamper verification apparatus comprising:
reading means for reading an encapsulated document file having an encapsulated document structure; and
tamper verification means for performing verification of a tamper on an operating program stored in said encapsulated document file based on a feature amount of said operating program file that materializes a document information file stored in said encapsulated document file and read by said reading means,
wherein said encapsulated document structure comprises the document information file, the operating program file and a feature amount retaining file that retains an encrypted feature amount of said operating program.

87. The tamper verification apparatus as claimed in claim 86, wherein said tamper verification means includes:
decryption means for decrypting the encrypted feature amount of said operating program file retained by said feature amount retaining file stored in said encapsulated document file and read by said reading means;
feature amount computation means for computing a feature amount of said operation program file stored in said encapsulated document file; and
tamper verification execution means for performing the verification of a tamper on said operating program file based on the computed feature amount of said operating program file computed by said feature amount computation means and the decrypted feature amount of said operating program file decrypted by said decryption means.

88. The tamper verification apparatus as claimed in claim 86, wherein said tamper verification means includes:
feature amount computation means for computing a feature amount of said operating program file stored in said encapsulated document file read by said reading means; and
tamper verification execution means for performing the verification of a tamper on said operating program file based on the computed feature amount of said operating program file computed by said feature amount computation means and a feature amount of said operating program file stored in a start program.

89. The tamper verification apparatus as claimed in claim 86, wherein said tamper verification means includes:
feature amount computation means for computing a feature amount of said operating program file stored in said encapsulated document file read by said reading means;
encryption means for encrypting the computed feature amount of said operating program file computed by said feature amount computation means; and
tamper verification execution means for performing the verification of a tamper on said operating program file based on the encrypted feature amount of said operating program file encrypted by said encryption means and a decrypted feature amount of said operating program file retained in a feature amount retaining file stored in said encapsulated document file.

90. The tamper verification apparatus as claimed in claim 86, wherein said tamper verification means includes:
feature amount computation means for computing a feature amount of a feature amount verification program file stored in said encapsulated document file and read by said reading means;
determining means for determining whether or not to execute said feature amount verification program file based on the computed feature amount of said feature amount verification program file computed by said feature amount computation means and a feature amount of said feature amount verification program file stored in a start program; and
tamper verification execution means for performing verification of a tamper on said operating program file when said feature amount verification program file is determined by said determining means to be executed.

91. Am encapsulated document producing process program causing a computer to perform the functions of:
acquiring a document information file installed in said computer, the document information file containing contents information that is a substance of expression regarding a document;
acquiring an operating program file that is interpreted and executed by said computer so as to materialize said document information file acquired by said function of acquiring the document information file;
computing a feature amount of said operating program file;
encrypting the feature amount of said operating program file computed by said function of computing the feature amount by using decryption key information;
saving the decrypted feature amount of said operating program file in a feature amount retaining file; and
encapsulating said document information file, said operating program file and said feature amount retaining file into a single document file.

92. The encapsulated document producing process program as claimed in claim 91, further comprising the functions of:
causing said computer to perform a function of computing the feature amount of said document information file;
decrypting the computed feature amount of said document information file by using decryption key information; and
saving the decrypted feature amount of said document information file in said feature amount retaining file.

93. A processor readable storage medium storing an encapsulated document producing process program causing a computer to perform the functions of:
acquiring a document information file installed in said computer, the document information file containing contents information that is a substance of expression regarding a document;
acquiring an operating program file that is interpreted and executed by said computer so as to materialize said document information file acquired by said function of acquiring the document information file;
computing a feature amount of said operating program file;
encrypting the feature amount of said operating program file computed by said function of computing the feature amount by using decryption key information;
saving the decrypted feature amount of said operating program file in a feature amount retaining file; and
encapsulating said document information file, said operating program file and said feature amount retaining file into a single document file.

94. The processor readable storage medium as claimed in claim 93, wherein said encapsulated document producing process program further comprising the functions of:
causing said computer to perform a function of computing the feature amount of said document information file;
decrypting the computed feature amount of said document information file by using decryption key information; and
saving the decrypted feature amount of said document information file in said feature amount retaining file.

95. A start program causing a computer to perform the functions of:
reading an encapsulated document file having an encapsulated document structure; and
performing verification of a tamper on an operating program stored in said encapsulated document file based on a feature amount of said operating program file that materializes a document information file stored in said encapsulated document file and read by said reading means,
wherein said encapsulated document structure comprises the document information file, the operating program file and a feature amount retaining file that retains an encrypted feature amount of said operating program.

96. The start program as claimed in claim 95, wherein said function of performing the verification includes the function of:
decrypting the encrypted feature amount of said operating program file retained by said feature amount retaining file stored in said encapsulated document file and read by said function of reading;
computing a feature amount of said operation program file stored in said encapsulated document file; and
performing the verification of a tamper on said operating program file based on the computed feature amount of said operating program file computed by said feature amount computation means and the decrypted feature amount of said operating program file decrypted by said decryption means.

97. The start program as claimed in claim 95, wherein said function of performing verification includes the function of:
computing a feature amount of said operating program file stored in said encapsulated document file read by said function of reading; and
performing the verification of a tamper on said operating program file based on the computed feature amount of said operating program file computed by said function of computing the feature amount and a feature amount of said operating program file stored in said start program.

98. The start program as claimed in claim 95, wherein said function of performing verification includes the function of:
computing a feature amount of said operating program file stored in said encapsulated document file read by said function of reading;
encrypting the computed feature amount of said operating program file computed by said function of computing the feature amount; and
performing the verification of a tamper on said operating program file based on the encrypted feature amount of said operating program file encrypted by said function of encrypting and a decrypted feature amount of said operating program file retained in a feature amount retaining file stored in said encapsulated document file.

99. The start program as claimed in claim 95, wherein said function of performing verification includes the function of:
computing a feature amount of a feature amount verification program file stored in said encapsulated document file and read by said function of reading;
determining whether or not to execute said feature amount verification program file based on the computed feature amount of said feature amount verification program file computed by said function of computing the feature amount and a feature amount of said feature amount verification program file stored in said start program; and
performing verification of a tamper on said operating program file when said feature amount verification program file is determined by said determining means to be executed.

100. A processor readable storage medium storing a start program causing a computer to perform the functions of:
reading an encapsulated document file having an encapsulated document structure; and
performing verification of a tamper on an operating program stored in said encapsulated document file based on a feature amount of said operating program file that materializes a document information file stored in said encapsulated document file and read by said reading means,
wherein said encapsulated document structure comprises the document information file, the operating program file and a feature amount retaining file that retains an encrypted feature amount of said operating program.

101. The processor readable storage medium as claimed in claim 100, wherein said function of performing the verification includes the function of:
decrypting the encrypted feature amount of said operating program file retained by said feature amount retaining file stored in said encapsulated document file and read by said function of reading;
computing a feature amount of said operation program file stored in said encapsulated document file; and
performing the verification of a tamper on said operating program file based on the computed feature amount of said operating program file computed by said feature amount computation means and the decrypted feature amount of said operating program file decrypted by said decryption means.

102. The processor readable storage medium as claimed in claim 100, wherein said function of performing the verification includes the function of:
computing a feature amount of said operating program file stored in said encapsulated document file read by said function of reading; and
performing the verification of a tamper on said operating program file based on the computed feature amount of said operating program file computed by said function of computing the feature amount and a feature amount of said operating program file stored in said start program.

103. The processor readable storage medium as claimed in claim 100, wherein said function of performing the verification includes the function of:
computing a feature amount of said operating program file stored in said encapsulated document file read by said function of reading;
encrypting the computed feature amount of said operating program file computed by said function of computing the feature amount; and
performing the verification of a tamper on said operating program file based on the encrypted feature amount of said operating program file encrypted by said function of encrypting and a decrypted feature amount of said operating program file retained in a feature amount retaining file stored in said encapsulated document file.

104. The processor readable storage medium as claimed in claim 100, wherein said function of performing the verification includes the function of:
computing a feature amount of a feature amount verification program file stored in said encapsulated document file and read by said function of reading;
determining whether or not to execute said feature amount verification program file based on the computed feature amount of said feature amount verification program file computed by said function of computing the feature amount and a feature amount of said feature amount verification program file stored in said start program; and
performing verification of a tamper on said operating program file when said feature amount verification program file is determined by said determining means to be executed.

105. An electronic document file comprising:
a plurality of operating programs and operating program use information provided by an operating program provider; and
a contents file and contents use information produced by said operating program provider or a document producer.

106. The electronic document file as claimed in claim 105, wherein at least one of said operating programs is an operation verification program that operates other operating programs based on said operating program use information.

107. The electronic document file as claimed in claim 105, wherein at least one of said operating programs is a contents verification program that limits a use of said contents file based on said contents file use information.

108. The electronic document file as claimed in claim 105, wherein at least one of said operating programs is an operation verification program that operates other operating programs based on said operating program use information, and at least one of said operating programs is a contents verification program that limits a use of said contents file based on said contents file use information.

109. The electronic document file as claimed in claim 106, wherein said operation verification program verifies a tamper on said operating programs and said operating program use information.

110. The electronic document file as claimed in claim 106, wherein said operation verification program limits an operation of said operating programs.

111. The electronic document file as claimed in claim 107, wherein said contents verification program verifies a tamper on said contents file and said contents file use information.

112. The electronic document file as claimed in claim 107, wherein said contents verification program limits a use of said contents use file.

113. The electronic document file as claimed in claim 106, wherein, when safety of said operating programs is not guaranteed by said operation verification program, a user of said electronic document file is notified of the fact that safety of said operating programs is not guaranteed.

114. The electronic document file as claimed in claim 105, wherein said operating programs, said operating program use information, said contents file and said contents file use information are encapsulated into a single file.

115. An electronic document file producing apparatus comprising:
reading means for reading a plurality of operating programs and operating program use information;
contents file producing means for producing a contents file and contents file use information; and
information producing means for producing information to be stored in an electronic document file,
wherein said electronic document file comprises:
a plurality of operating programs and operating program use information provided by an operating program provider; and
a contents file and contents use information produced by said operating program provider or a document producer.

116. The electronic document file producing apparatus as claimed in claim 115, wherein said contents file producing means causes one of said operating programs of said electronic document file to be executed.

117. The electronic document file producing apparatus as claimed in claim 115, further comprises operating program adding means for adding said plurality of operating programs and said operating program use information provided by the operating program provider to said electronic document file based on said contents file and said contents file use information produced by said contents file producing means.

118. The electronic document file producing apparatus as claimed in claim 116, further comprises operating program adding means for adding said plurality of operating programs and said operating program use information provided by the operating program provider to said electronic document file based on said contents file and said contents file use information produced by said contents file producing means.

119. An encapsulated document structure comprising:
an operating program read by a provided-side computer connected to a network so as to cause the provided-side computer to perform various functions;
use information regarding an encapsulated document provided to said provided-side computer through said network; and
sending location information for sending said use information to a providing-side computer connected to said network,
wherein said operating program, said use information and said sending location information are encapsulated into a single document, and said operating program includes use information transmitting program for transmitting said use information according to said sending location information at a predetermined timing.

120. The encapsulated document structure as claimed in claim 119, wherein and said operating program includes:
a contents information display program for displaying contents information that is a substance of expression on a document;
a permission information reception program for receiving permission information regarding permission of display of said contents information form said provided-side computer through said network; and
a contents information display program for displaying said contents information in accordance with said permission information.

121. The encapsulated document structure as claimed in claim 120, wherein said permission information is encrypted feature amount information of said contents information; said operating program further includes a feature amount determination program for determining whether or not the encrypted feature amount information is equal to predetermined feature amount; and said contents information display program displays said contents information in accordance with a result of determination of said feature amount determination program.

122. The encapsulated document structure as claimed in claim 121, wherein said feature amount determination program determines whether or not the encrypted feature amount information of said contents information is equal to computed feature amount information computed from said contents information existing in said encapsulated document, and said contents information display program displays said contents information when the encrypted feature amount information of said contents information is determined by said feature amount determination program equal to the computed feature amount information computed from said contents information existing in said encapsulated document.

123. An encapsulated document structure comprising:
a storage area where contents information, which is a substance of expression on a document, is stored;
an operating program read by a provided-side computer connected to a network so as to cause the provided-side computer to perform various functions; and
use information regarding an encapsulated document provided to said provided-side computer through said network,
wherein said storage area, said operating program and said use information are encapsulated into a single document, and said operating program includes an encrypted contents information display program for displaying said contents information stored in said storage area.

124. An encapsulated document processing apparatus, comprising:
request information receiving means for receiving request information from a provided-side computer through a network;
encapsulated document producing means for producing an encapsulated document having a predetermined encapsulated document structure in accordance with the request information received by said request information receiving means; and
encapsulated document transmitting means for sending the encapsulated document produced by said encapsulated document producing means to said provided-side computer through said network,
wherein said predetermined encapsulated document structure comprises:
an operating program read by said provided-side computer connected to a network so as to cause said provided-side computer to perform various functions;
use information regarding an encapsulated document provided to said provided-side computer through said network; and
sending location information for sending said use information to a providing-side computer connected to said network,
wherein said operating program, said use information and said sending location information are encapsulated into a single document, and said operating program includes use information transmitting program for transmitting said use information according to said sending location information at a predetermined timing.

125. The encapsulated document processing apparatus as claimed in claim 124, further comprising:
charge information producing means for producing charge information of use fee of said encapsulated document by computing the use fee in accordance with said request information received by said request information receiving means;
charge information transmitting means for transmitting the charge information of the use fee produced by said charge information producing means to said provided-side computer through said network; and
payment information receiving means for receiving payment information on the use fee from said provided-side computer through said network,
wherein said encapsulated document transmitting means sends said encapsulated document produced by said encapsulated document producing means to said provided-side computer through network when the payment information on the use fee is received by said payment information receiving means.

126. The encapsulated document processing apparatus as claimed in claim 124, wherein said encapsulated document producing means includes:
operating program producing means for producing an operating program in accordance with said request information received by said request information receiving means, the operating program being read by said provided-side computer and causing provided-side computer to perform various functions;
use information setting means for setting use information regarding said encapsulated document provided to said provided-side computer through said network; and
encapsulating means for encapsulating said operating program produced by said operating program producing means and said use information set by said use information setting means into a single document.

127. The encapsulated document processing apparatus as claimed in claim 124, wherein said encapsulated document producing means includes:
operating program producing means for producing an operating program in accordance with said request information received by said request information receiving means, the operating program being read by said provided-side computer and causing provided-side computer to perform various functions;
encryption key producing means for producing an encryption key owned by the providing-side;
operating program encryption means fro encrypting said operating program with the encryption key produced by said encryption key producing means;
use information setting means for setting use information regarding said encapsulated document provided to said provided-side computer through said network; and
encapsulating means for encapsulating said operating program encrypted by said operating program encrypting means and said use information set by said use information setting means into a single file.

128. An encapsulated document processing apparatus, comprising:
use information receiving means for receiving use information from a provided-side computer through a network;
charge information producing means for producing charge information of use fee of said encapsulated document by computing the use fee in accordance with said request information received by said use information receiving means;
charge information transmitting means for transmitting the charge information of the use fee produced by said charge information producing means to said provided-side computer through said network;
payment information receiving means for receiving payment information on the use fee from said provided-side computer through said network; and
permission information transmitting means for transmitting permission information to said provided-side computer through said network when the charge information on the use fee is received by said payment information receiving means, the permission information for permitting and execution of a saving process of contents information that is a substance of expression on a document.

129. An encapsulated document structure, comprising:
contents information that is a substance of expression on a document;
an operating program read by an accessing-side computer connected to a network, the operating program causing the accessing-side computer to perform various functions; and
sending location information for sending various kinds of information to a providing-side computer connected to said through said network,
wherein said contents information, said operating program and said sending location information are encapsulated into a single document, and
wherein said operating program includes:
an operation processing program of which operation process on said contents information is limited based on authority information; and
a limitation cancellation program for canceling a limitation in the operation process of said operation processing program by sending various kinds of information based on said sending location information.

130. The encapsulated document structure as claimed in claim 129, wherein said contents information is encrypted, and said limitation cancellation program acquires decryption key information for decrypting the encrypted contents document based on said sending location information through said network so as to decrypt the encrypted contents information based on the decryption key information acquired.

131. The encapsulated document structure as claimed in claim 130, wherein decryption key producing information request information is encapsulated into said single document together with said contents information, said operating program and said sending location information, the decryption key producing information request information for requesting said providing-side computer to send decryption key producing information necessary for producing said decryption key information, and
said limitation cancellation program includes:
a decryption key producing information requesting program for requesting said decryption key producing information by sending said decryption key producing information request information to said providing-side computer through said network based on said sending location information;
decryption key producing information reception program for receiving said decryption key producing information from said providing-side computer through said network;
a decryption key producing program for producing said decryption key information based on said decryption key producing information received by said decryption key producing information reception program; and
a decryption program for decrypting the encrypted contents information based on said decryption key information produced by said decryption key producing program.

132. An encapsulated document processing apparatus, comprising:
storage area acquisition means for acquiring a storage area where contents information, which is a substance of expression on a document, is saved;
request information receiving means for receiving request information through from a provided-side computer through a network;
operating program producing means for producing and operating program in accordance with said request information received by said request information receiving means, the operating program being read by said an accessing-side computer and causing said accessing-side computer to perform various kinds of functions;
sending location information setting means for setting sending location information for sending various kinds of information to a providing-side computer through said network;
encapsulation means for encapsulating said storage area, said operating program produced by said operating program producing program and said sending location information set by said sending location information setting means into a single document; and
encapsulated document transmitting means for transmitting the encapsulated document produced by said encapsulating means to said provided-side computer through said network,
wherein said operating program producing means includes:
an operation processing program of which operation process on said contents information is limited based on authority information; and
a limitation cancellation program for canceling the limitation in the operation process of said operating program by sending various kinds of information based on said sending location information.

133. The encapsulated document processing apparatus as claimed in claim 132, further comprising contents information encryption means for encrypting said contents information, which is stored in said storage area acquired by said storage area acquisition means, according to encryption key information as said authority information, wherein said encapsulated document transmitting means transmits said encapsulated document, which has said contents information encrypted by said contents information encryption means and stored in said storage area, to said provided-side computer or said accessing-side computer through said network.

134. The encapsulated document processing apparatus as claimed in claim 133, wherein said limitation cancellation program includes:
a decryption key producing information request program for requesting decryption key producing information necessary for producing decryption key information for decrypting said contents information, a request being sent to said providing-side computer through said network based on said sending location information;
a decryption key producing information reception program for receiving said decryption key producing information from said providing-side computer through said network;
a decryption key producing program for producing said decryption key information based on said decryption key producing information received by said decryption key producing information reception program; and
decryption program for decrypting said encrypted contents information based on said decryption key information produced by said decryption key producing program.

135. An encapsulated document processing apparatus, comprising:
decryption key request information receiving means for receiving decryption key request information from an accessing-side computer through a network, the decryption key request for requesting decryption key information for decrypting encrypted contents information, which is a substance of expression on a document;
decryption key producing means for producing said decryption key information based on said decryption key request information received by said decryption key request information receiving means; and
decryption key information transmitting means for transmitting said decryption key information, which is produced by said decryption key producing means, to said accessing-side computer through said network.

136. The encapsulated document processing apparatus as claimed in claim 135, further comprising fee-charging means for charging a use fee of said contents information to said accessing-side computer when said decryption key information is transmitted by said decryption key information transmitting means.

137. An encapsulated document processing apparatus, comprising;
decryption key production request information receiving means for receiving decryption key production information request information from a providing-side computer through a network, the decryption key production information request information for requesting decryption key producing information necessary for producing decryption key information for decrypting encrypted contents information, which is a substance of expression regarding a document;
decryption key producing information producing means for producing said decryption key producing information based on said decryption key producing information request information received by said decryption key production request information receiving means;
decryption key producing information transmitting means for transmitting said decryption key producing information, which is produced by said decryption key producing information producing on means, to an accessing-side computer through said network; and
fee-charging means for charging a use fee of said contents information to said accessing-side computer when said decryption key producing information is transmitted by said decryption key producing information transmitting means.
